(19) United States
(12) Patent Application Publication
(10) Pub. No.: US 2018/0329622 A1
(43) Pub. Date: Nov. 15, 2018

(54) Portable Computing Input Devices and Methods

(71) Applicant: Apple Inc., Cupertino, CA (US)

(72) Inventors: Julian Missig, Redwood City, CA (US); Linda L. Dong, Altadena, CA (US); Jeffrey T. Bernstein, San Francisco, CA (US); Morgan H. Winer, Sunnyvale, CA (US)

(21) Appl. No.: 15/710,761

(22) Filed: Sep. 20, 2017

Related U.S. Application Data
(60) Provisional application No. 62/505,778, filed on May 12, 2017.

(51) Int. Cl. G06F 3/0488; G06F 3/0481; G06F 1/16

(52) U.S. Cl. CPC G06F 3/04883; G06F 3/04886; G06F 2203/04106; G06F 1/1613; G06F 2203/04808; G06F 3/04817

(57) ABSTRACT

The present disclosure provides a method for mirrored control between devices performed at a first electronic device including one or more processors, memory, and a touch-sensitive display. The method includes: sending an item from a first instant messenger application running on the first electronic device to a second instant messenger application running on a second electronic device; displaying the item in the first instant messenger application, wherein the item is concurrently displayed in the second instant messenger application; receiving information corresponding to an interaction with the item; and in response to receiving information corresponding to the interaction, updating the item on the first electronic device, wherein the update to the item is mirrored on the second electronic device.

### RELATED APPLICATIONS

This application claims priority to U.S. Provisional Application Ser. No. 62/505,778, filed May 12, 2017, entitled “Portable Computing Input Devices and Methods,” which is incorporated by reference herein in its entirety.

### TECHNICAL FIELD

This disclosure relates generally to portable computing systems, and in particular to improved input devices and methods for portable computing systems.

### BACKGROUND

While there have been major improvements made to portable computing devices, the size of the physical or virtual keyboard remains an issue. For example, virtual keyboards displayed on touch-screens of portable computing devices are small and difficult to interact with. Moreover, the size of physical keyboards for portable computing devices, like laptops, are limited by the size of the portable computing devices themselves. For example, a laptop computer keyboard cannot be any larger than the laptop computer's housing, which is oftentimes small. Also, some users of touch-screen portable computing devices use protective cases that include a physical keyboard that is the same or smaller than the size of the case. Due to the space constraints described above, these smaller keyboards typically include fewer keys. As such, it is desirable to provide an I/O device and input method, for portable computing devices that addresses the shortcomings of conventional keyboards and their associated input methods.

### SUMMARY

Accordingly, there is a need for an improved keyboard and input method for portable computing devices that introduces new multi-functional keys to replace less frequently used keys found on conventional full-size keyboards. In some embodiments, the improved keyboard is a physical keyboard that includes sensors, such as touch sensors, contact intensity sensors, and/or microphones. Such methods and systems optionally complement or replace conventional methods and systems for receiving key inputs. The methods and systems in accordance with embodiments described herein not only require fewer keys, but also reduce the cognitive burden on a user and produce a more efficient human-machine interface. For battery-operated devices, a more efficient input mechanism also requires less computing resources, thereby increasing the battery life of the device.

The above deficiencies and other problems associated with user inputs for portable multifunction devices with touch-sensitive surfaces are reduced or eliminated by the disclosed devices. In some embodiments, the portable multifunction device is, e.g., a notebook computer, tablet computer, or handheld device. In some embodiments, the portable multifunction device is a personal electronic device (e.g., a wearable electronic device, such as a watch). In some embodiments, the device has a touchpad. In some embodiments, the device has a touch-sensitive display (also known as a “touch screen” or “touch-screen display”). In some embodiments, the device has one or more processors, memory and one or more modules, programs or sets of instructions stored in the memory for performing multiple functions including generating one or more graphical user interfaces (GUIs). In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

In accordance with some embodiments, a method of punctuation character entry is performed at a portable multifunction device comprising one or more processors, memory, and a touch-sensitive display. The method includes: providing a key on which is depicted at least one pair of open and close punctuation characters; displaying editable content on the display; detecting a first input selecting the key; and in response to detecting the first input selecting the key, determining whether to insert an open or a close punctuation character. In accordance with a determination to insert an open punctuation character, the method includes displaying in the editable content the open punctuation character of the at least one pair of open and close punctuation characters, displaying an insertion marker after the open punctuation character, and displaying a close punctuation character adjacent the insertion marker opposite to the open punctuation character. In accordance with a determination to insert the close punctuation character, the method includes displaying the close punctuation character in the editable content on the display.

In accordance with some embodiments, a portable multifunction device is provided that includes a touch-sensitive display unit configured to display editable content and to detect contacts; and a processing unit coupled with the touch-sensitive display unit. The processing unit is configured to: provide a key on which is depicted at least one pair of open and close punctuation characters; display editable content on the touch-sensitive display unit; detect a first input selecting the key; and in response to detecting the first input selecting the key, determine whether to insert an open or a close punctuation character. The processing unit is further configured to, in accordance with a determination to insert an open punctuation character, display in the editable content the open punctuation character of the at least one pair of open and close punctuation characters, display an insertion marker after the open punctuation character, and display a close punctuation character adjacent the insertion marker opposite to the open punctuation character. The processing unit is further configured to, in accordance with a determination to insert the close punctuation character, display the close punctuation character in the editable content on the display.

In accordance with some embodiments, a method of character entry is performed at a portable multifunction device comprising one or more processors, memory, a touch screen display, and a physical keyboard removably coupled to the portable multifunction device. The method includes: detecting an input on a key of the physical keyboard; determining if the input is of a first type or a second type distinct from the first type; upon determining that the input is of the first type, displaying a first set of characters associated with the key for selection; and upon determining that the input is of the second type, displaying a second set of characters associated with the key for selection.

In accordance with some embodiments, a portable multifunction device is provided that includes a touch screen display unit configured to receive touch inputs and display user interfaces; a physical keyboard unit removably coupled to the portable multifunction device; and a processing unit coupled with the touch screen display and the physical keyboard unit. The processing unit is configured to: detect an input on a key of the physical keyboard unit; determine if the input is of a first type or a second type distinct from the first type; upon determining that the input is of the first type, enable display of a first set of characters associated with the key for selection; and upon determining that the input is of the second type, enable display of a second set of characters associated with the key for selection.

In accordance with some embodiments, a method for processing a currency entry is performed at a portable multifunction device comprising one or more processors, memory, a display, and a physical keyboard removably coupled to the portable multifunction device. The physical keyboard contains at least one sensor for detecting contact intensities of inputs on keys of the physical keyboard. The method includes: detecting an input on a dedicated currency key of the physical keyboard; in response to receiving the input, determining if the input is of a first type or a different second type; upon determining that the input is of the first type, inserting a currency symbol based on a location of the portable multifunction device; and upon determining that the input is of the second type, displaying a set of different currency characters on the display for selection, wherein upon a selection of a currency character in the set of different currency characters, a numerical value associated with a first currency displayed on the display is converted from the first currency to a second currency corresponding to the selected currency character.

In accordance with some embodiments, a portable multifunction device for processing a currency entry is provided that includes a display unit configured to display user interfaces; a physical keyboard unit removably coupled to the portable multifunction device, where the physical keyboard unit contains at least one sensor unit for detecting contact intensities of inputs on keys of the physical keyboard unit; and a processing unit coupled with the display unit, and the physical keyboard unit. The processing unit is configured to: detect an input on a dedicated currency key of the physical keyboard unit; in response to receiving the input, determine if the input is of a first type or a different second type; upon determining that the input is of the first type, insert a currency symbol based on a location of the portable multifunction device; and upon determining that the input is of the second type, enable display of a set of different currency characters on the display for selection, where upon a selection of a currency character in the set of different currency characters, a numerical value associated with a first currency displayed on the display is converted from the first currency to a second currency corresponding to the selected currency character.

In accordance with some embodiments, a method for processing contact details entry is performed at a portable multifunction device comprising one or more processors, memory, a display, and a physical keyboard removably coupled to the portable multifunction device. The method includes: displaying at least a portion of text on the display; detecting an input on a dedicated contacts key of the physical keyboard; in response to detecting the input, automatically suggesting one or more contact details based on the portion of text; receiving a selection of a contact detail of the one or more contact details; and displaying the contact detail on the display.

In accordance with some embodiments, a portable multifunction device for processing contact details entry is provided that includes a display unit configured to display user interfaces; a physical keyboard unit removably coupled to the portable multifunction device; and a processing unit coupled with the display unit, and the physical keyboard unit. The processing unit is configured to: enable display of at least a portion of text on the display unit; detect an input on a dedicated contacts key of the physical keyboard unit; in response to detecting the input, automatically suggest one or more contact details based on the portion of text; receive a selection of a contact detail of the one or more contact details; and enable display of the contact detail on the display unit.

In accordance with some embodiments, a method for switching between active windows is performed at a portable multifunction device comprising one or more processors, memory, a display, and a physical keyboard removably coupled to the portable multifunction device. The physical keyboard contains at least one sensor for detecting contact intensities of inputs on keys of the physical keyboard. The method includes: displaying a user interface for an open application on the display; detecting an input on a dedicated home key of the physical keyboard; in response to detecting the input, determining whether the input is of a first type or a second type; in accordance with a determination that the input is the first type, displaying a home screen on the display; and in accordance with a determination that the input is the second type, displaying a navigable list of concurrently open applications including the open application on the portable multifunction device.

In accordance with some embodiments, a portable multifunction device for processing contact details entry is provided that includes a display unit configured to display user interfaces; a physical keyboard unit removably coupled to the portable multifunction device; and a processing unit coupled with the display unit, and the physical keyboard unit. The processing unit is configured to: enable display of at least a portion of text on the display unit; detect an input on a dedicated contacts key of the physical keyboard unit; in response to detecting the input, automatically suggest one or more contact details based on the portion of text; receive a selection of a contact detail of the one or more contact details; and enable display of the contact detail on the display unit.

In accordance with some embodiments, a method for selecting content is performed at a portable multifunction device comprising one or more processors, memory, a display, and a physical keyboard removably coupled to the portable multifunction device. The method includes: displaying content of an electronic document on the display; displaying a cursor within the electronic document; detecting an input on a dedicated select key of the physical keyboard; and in response to detecting the input: selecting a portion of the content in the document closest to the cursor; and displaying the portion of the content as selected content on the display.

In accordance with some embodiments, a portable multifunction device for selecting content is provided that includes a display unit configured to display user interfaces; a physical keyboard unit removably coupled to the portable multifunction device; and a processing unit coupled with the display unit and the physical keyboard unit. The processing unit is configured to: enable display of content of an electronic document on the display unit; enable display of a cursor within the electronic document; detect an input on a dedicated select key of the physical keyboard unit; and in response to detecting the input: select a portion of the content in the document closest to the cursor; and enable display of the portion of the content as selected content on the display unit.

In accordance with some embodiments, a method of tabbing is performed at a portable multifunction device comprising one or more processors, memory, a display, and a physical keyboard removably coupled to the portable multifunction device. The method includes: detecting an input on a dedicated tab key of the physical keyboard; in response to detecting the input, determining whether the portable multifunction device is in an editing mode to edit content; in accordance with a determination that the portable multifunction device is not in an editing mode: identifying an active window of the portable multifunction device and an active pane in the active window; and switching to a pane of the active window different from the active pane; and in accordance with a determination that the portable multifunction device is in an editing mode, displaying a list of suggested words for selection to be inserted into the content.

In accordance with some embodiments, a portable multifunction device for tabbing is provided that includes a display unit configured to display user interfaces; a physical keyboard unit removably coupled to the portable multifunction device; and a processing unit coupled with the display unit and the physical keyboard unit. The processing unit is configured to: detect an input on a dedicated tab key of the physical keyboard unit; in response to detecting the input, determine whether the portable multifunction device is in an editing mode to edit content; in accordance with a determination that the portable multifunction device is not in an editing mode: identify an active window of the portable multifunction device and an active pane in the active window; and switch to a pane of the active window different from the active pane; and in accordance with a determination that the portable multifunction device is in an editing mode, enable display of a list of suggested words for selection to be inserted into the content.

In accordance with some embodiments, a method for inserting or sharing content is performed at a portable multifunction device comprising one or more processors, memory, a display, and a physical keyboard removably coupled to the portable multifunction device. The method includes: displaying content on the display; detecting an input on a dedicated share key of the physical keyboard; in response to detecting the input, determining whether the content is editable; in accordance with a determination that the content is editable, displaying an insert menu through which a user can insert content into the content; and in accordance with a determination that the content is not editable, displaying a share menu through which a user can share a portion of the content.

In accordance with some embodiments, a portable multifunction device for inserting or sharing content is provided that includes a display unit configured to display user interfaces; a physical keyboard unit removably coupled to the portable multifunction device; and a processing unit coupled with the display unit and the physical keyboard unit. The processing unit is configured to: enable display of content on the display unit; detect an input on a dedicated share key of the physical keyboard unit; in response to detecting the input, determine whether the content is editable; in accordance with a determination that the content is editable, enable display of an insert menu through which a user can insert content into the content; and in accordance with a determination that the content is not editable, enable display of a share menu through which a user can share a portion of the content.

In accordance with some embodiments, a method for providing a notification to a user is performed at a portable multifunction device comprising one or more processors, memory, a display, and a physical keyboard removably coupled to the portable multifunction device. The physical keyboard contains at least one sensor for detecting contact intensities of inputs on keys of the physical keyboard. The method includes: detecting an input on a dedicated notification key of the physical keyboard; determining if the input is of a first type or a different second type; upon determining that the input is of the first type: determining whether a new notification is available; upon determining that the new notification is available, activating an application associated with the new notification to view the notification; upon determining that no new notification is available, displaying a notification center; and upon determining that the input is of the second type: displaying the notification center on the display; and ceasing to display the notification center upon a release of the notification key.

In accordance with some embodiments, a portable multifunction device for providing a notification to a user is provided that includes a display unit configured to display user interfaces; a physical keyboard unit removably coupled to the portable multifunction device, wherein the physical keyboard unit contains at least one sensor for detecting contact intensities of inputs on keys of the physical keyboard unit; and a processing unit coupled with the display unit and the physical keyboard unit. The processing unit is configured to: detect an input on a dedicated notification key of the physical keyboard unit; determine if the input is of a first type or a different second type; upon determining that the input is of the first type: determine whether a new notification is available; upon determining that the new notification is available, activate an application associated with the new notification to view the new notification; upon determining that no new notification is available, enable display of a notification center; and upon determining that the input is of the second type: enable display of the notification center on the display unit; and cease to display the notification center upon a release of the notification key.

In accordance with some embodiments, a detachable keyboard with one or more touch-sensitive input strips, comprising: a housing having top, bottom, left, and right sides; a plurality of physical keys arranged in a key area at least partially within the housing; at least one connector disposed at the top side of the housing to connect the detachable keyboard to a touch screen device; and at least one elongate touch-sensitive strip disposed at the bottom, left, or right side of the housing, where a length of the touch-sensitive strip extends across a majority of its respective side of the housing.

In accordance with some embodiments, a detachable keyboard with one or more touch sensitive strips is provided that includes a housing unit having top, bottom, left, and right sides; a plurality of physical keys arranged in a key area unit at least partially within the housing unit; at least one connector unit disposed at the top side of the housing to connect the detachable keyboard to a touch screen device; and at least one elongate touch sensitive strip unit disposed at the bottom, left, or right side of the housing, where a length of the touch sensitive strip unit extends across a majority of its respective side of the housing unit.

In accordance with some embodiments, a method for scrolling through content is performed at a portable multifunction device comprising one or more processors, memory, a touch screen display, and a physical keyboard removably coupled to the portable multifunction device. The method includes: displaying content on the touch screen display; detecting an input of an arrow key located on the physical keyboard, wherein one or more contact intensity sensors are coupled to the arrow key for detecting contact intensities of inputs on the arrow key; in response to detecting the input, determining whether the input is of a first type or a second type different from the first type; upon determining that the input is of the first type: scrolling the content on the display at a first speed faster than a normal scrolling speed; detecting a continued contact with the arrow key; and in response to detecting the continued contact with the arrow key, maintaining the first speed of the scrolling faster than the normal scrolling speed; and upon determining that the input is of the second type: determining a contact intensity of the input; and scrolling the content on the display at a second speed determined based on the contact intensity of the input.

In accordance with some embodiments, a portable multifunction device for scrolling through content is provided that includes a touch screen display unit configured to display user interfaces and to detect touch inputs; a physical keyboard unit removably coupled to the portable multifunction device; and a processing unit coupled with the touch screen display unit and the physical keyboard unit. The processing unit is configured to: enable display of content on the touch screen display unit; detect an input of an arrow key located on the physical keyboard unit, wherein one or more contact intensity sensors are coupled to the arrow key for detecting contact intensities of inputs on the arrow key; in response to detecting the input, determine whether the input is of a first type or a second type different from the first type; upon determining that the input is of the first type: scroll the content on the touch screen display unit at a first speed faster than a normal scrolling speed; detect a continued contact with the arrow key; and in response to detecting the continued contact with the arrow key, maintain the first speed of the scrolling faster than the normal scrolling speed; and upon determining that the input is of the second type: determine a contact intensity of the input; and scroll the content on the touch screen display unit at a second speed determined based on the contact intensity of the input.

In accordance with some embodiments, a method of inchworm scrolling is performed at a portable multifunction device comprising one or more processors, memory, a display, and a physical keyboard removably coupled to the portable multifunction device. The method includes: displaying content of an electronic document on the display, the content includes a first portion displayed at a first location and a second portion displayed at a second location adjacent to the first location; detecting an input on an arrow key located on the keyboard; in response to detecting the input: moving the first portion to a third location in a direction associated with the arrow key, while maintaining the second portion stationary at the second location; and subsequent to moving the first portion, moving the second portion to a fourth location in a direction associated with the arrow key, while maintaining the first portion stationary at the third location.

In accordance with some embodiments, a portable multifunction device for inchworm scrolling is provided that includes a display unit configured to display user interfaces; a physical keyboard unit removably coupled to the portable multifunction device; and a processing unit coupled with the display unit and the physical keyboard unit. The processing unit is configured to: enable display of content of an electronic document on the display unit, the content includes a first portion displayed at a first location and a second portion displayed at a second location adjacent to the first location; detect an input on an arrow key located on the keyboard; in response to detecting the input: move the first portion to a third location in a direction associated with the arrow key, while maintaining the second portion stationary at the second location; and subsequent to moving the first portion, move the second portion to a fourth location in a direction associated with the arrow key, while maintaining the first portion stationary at the third location.

In accordance with some embodiments, a method for switching between virtual keyboards is performed at an electronic device including one or more processors, memory, and a touch-sensitive display. The method includes: displaying a first virtual keyboard of a first size on the display; in response to detecting a pre-defined gesture on the display, concurrently displaying multiple keyboards, including the first keyboard reduced to a second size smaller than the first size; detecting a selection of one of the multiple keyboards; ceasing to display the multiple keyboards; and displaying the selected one of the multiple keyboards on the display at the first size.

In accordance with some embodiments, an electronic device is provided that includes a touch-sensitive display unit configured to receive user inputs and display user interfaces and a processing unit coupled to the touch-sensitive display unit. The processing unit is configured to: enable display of a first virtual keyboard of a first size on the display unit; in response to detecting a pre-defined gesture on the display unit, concurrently enable display of multiple keyboards, including the first keyboard reduced to a second size smaller than the first size; detect a selection of one of the multiple keyboards; cease to display the multiple keyboards; and enable display of the selected one of the multiple keyboards on the display unit at the first size.

In accordance with some embodiments, a method for switching between lower and upper case characters is performed at an electronic device including one or more processors, memory, and a touch-sensitive display. The method includes: displaying on the display a virtual keyboard without a shift key, wherein keys on the keyboard have a first appearance; detecting a contact at a location on the virtual keyboard followed by a movement of the contact in a direction; and in response to detecting the contact at the location on the virtual keyboard followed by the movement of the contact in the direction, changing the appearance of the keys on the keyboard to a second appearance different from the first appearance.

In accordance with some embodiments, an electronic device is provided that includes a touch-sensitive display unit configured to receive user inputs and display user interfaces and a processing unit coupled to the touch-sensitive display unit. The processing unit is configured to: enable display of on the display unit a virtual keyboard without a shift key, wherein keys on the keyboard have a first appearance; detect a contact at a location on the virtual keyboard followed by a movement of the contact in a direction; and in response to detecting the contact at the location on the virtual keyboard followed by the movement of the contact in the direction, change the appearance of the keys on the keyboard to a second appearance different from the first appearance.

In accordance with some embodiments, a method for communicating between users is performed at an electronic device including one or more processors, memory, and a touch-sensitive display. The method includes: displaying a user interface of an instant messenger application on the display; analyzing an instant message displayed in the user interface of the instant messenger application to identify a user's intention to perform an action associated with an application different from the instant messenger application; upon determining an intention to perform the action, displaying an affordance to perform the action in the user interface of the instant messenger application; while displaying the affordance in the user interface of the instant messenger application, detecting a user input on the affordance in the user interface of the instant messenger application; and in response to detecting the user input, facilitating the action.

In accordance with some embodiments, an electronic device is provided that includes a touch-sensitive display unit configured to receive user inputs and display user interfaces and a processing unit coupled to the touch-sensitive display unit. The processing unit is configured to: enable display of a user interface of an instant messenger application on the display unit; analyze an instant message displayed in the user interface of the instant messenger application to identify a user's intention to perform an action associated with an application different from the instant messenger application; upon determining an intention to perform the action, enable display of an affordance to perform the action in the user interface of the instant messenger application; while enabling display of the affordance in the user interface of the instant messenger application, detect a user input on the affordance in the user interface of the instant messenger application; and in response to detecting the user input, facilitate the action.

In accordance with some embodiments, a method for mirrored control between devices is performed at a first electronic device including one or more processors, memory, and a touch-sensitive display. The method includes: sending an item from a first instant messenger application running on the first electronic device to a second instant messenger application running on a second electronic device; displaying the item in the first instant messenger application, wherein the item is concurrently displayed in the second instant messenger application; receiving information corresponding to an interaction with the item; and in response to receiving information corresponding to the interaction, updating the item on the first electronic device, wherein the update to the item is mirrored on the second electronic device.

In accordance with some embodiments, a first electronic device is provided that includes a touch-sensitive display unit configured to receive user inputs and display user interfaces and a processing unit coupled to the touch-sensitive display unit. The processing unit is configured to: send an item from a first instant messenger application running on the first electronic device to a second instant messenger application running on a second electronic device; enable display of the item in the first instant messenger application, wherein the item is concurrently displayed in the second instant messenger application; receive information corresponding to an interaction with the item; and in response to receiving information corresponding to the interaction, update the item on the first electronic device, wherein the update to the item is mirrored on the second electronic device.

In accordance with some embodiments, an electronic device includes a touch-sensitive display, optionally one or more sensors to detect intensities of contacts with the touch-sensitive display, one or more processors, memory, and one or more programs; the one or more programs are stored in the memory and configured to be executed by the one or more processors and the one or more programs include instructions for performing or causing performance of the operations of any of the methods described herein. In accordance with some embodiments, a computer readable storage medium has stored therein instructions which when executed by an electronic device with a touch-sensitive display, and optionally one or more sensors to detect intensities of contacts with the touch-sensitive display, cause the device to perform or cause performance of the operations of any of the methods described herein. In accordance with some embodiments, a graphical user interface on an electronic device with a touch-sensitive display, optionally one or more sensors to detect intensities of contacts with the touch-sensitive display, a memory, and one or more processors to execute one or more programs stored in the memory includes one or more of the elements displayed in any of the methods described herein, which are updated in response to inputs, as described in any of the methods described herein. In accordance with some embodiments, an electronic device includes: a touch-sensitive display, and optionally one or more sensors to detect intensities of contacts with the touch-sensitive display; and means for performing or causing performance of the operations of any of the methods described herein. In accordance with some embodiments, an information processing apparatus, for use in an electronic device with a touch-sensitive display, and optionally one or more sensors to detect intensities of contacts with the touch-sensitive display, includes means for performing or causing performance of the operations of any of the methods described herein.

Thus, portable multifunction devices with touch-sensitive displays are provided with faster, more efficient input devices, methods and interfaces, thereby increasing the effectiveness, efficiency, and user satisfaction with such devices. Such methods and interfaces may complement or replace conventional input methods and systems.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling, in accordance with some embodiments.

FIG. 2A is a schematic diagram of a portable multifunction device having a touch screen, in accordance with some embodiments.

FIG. 2B illustrates an exemplary user interface for a multifunction device with a touch-sensitive surface that is separate from the display in accordance with some embodiments.

FIG. 3A is a schematic diagram of a user interface for a menu of applications on a portable multifunction device, in accordance with some embodiments.

FIG. 3B is an illustrative diagram of a portable computing system, in accordance with some embodiments.

FIGS. 4A-4C are flow charts illustrating a method of punctuation character entry, in accordance with some embodiments.

FIGS. 5A-5J illustrate exemplary user interfaces for punctuation character entry, in accordance with some embodiments.

FIG. 6 is a functional block diagram of an electronic device, in accordance with some embodiments.

FIG. 7 is a flow chart illustrating a method of character entry, in accordance with some embodiments.

FIGS. 8A-8F illustrate exemplary user interfaces for emoji and punctuation character entry, in accordance with some embodiments.

FIG. 9 is a functional block diagram of an electronic device, in accordance with some embodiments.

FIGS. 10A-10B are flow charts illustrating a method of currency character entry, in accordance with some embodiments.

FIGS. 11A-11H illustrate exemplary user interfaces for currency character entry, in accordance with some embodiments.

FIG. 12 is a functional block diagram of an electronic device, in accordance with some embodiments.

FIG. 13 is a flow chart illustrating a method of contact details entry, in accordance with some embodiments.

FIGS. 14A-14E illustrate exemplary user interfaces for contact details entry, in accordance with some embodiments.

FIG. 15 is a functional block diagram of an electronic device, in accordance with some embodiments.

FIGS. 16A-16B are flow charts illustrating a method of displaying home screen and multitasking screen, in accordance with some embodiments.

FIGS. 17A-17E illustrate exemplary user interfaces for a home screen and a multitasking screen, in accordance with some embodiments.

FIG. 18 is a functional block diagram of an electronic device, in accordance with some embodiments.

FIG. 19 is a flow chart illustrating a method of content selection using a dedicated select key on a physical keyboard, in accordance with some embodiments.

FIGS. 20A-20C illustrate exemplary user interfaces for content selection, in accordance with some embodiments.

FIG. 21 is a functional block diagram of an electronic device, in accordance with some embodiments.

FIG. 22 is a flow chart illustrating a method of using a multifunction tab key, in accordance with some embodiments.

FIGS. 23A-23C illustrate exemplary user interfaces using a multifunction tab key, in accordance with some embodiments.

FIG. 24 is a functional block diagram of an electronic device, in accordance with some embodiments.

FIG. 25 is a flow chart illustrating a method of content sharing and insertion using a dedicated share key, in accordance with some embodiments.

FIGS. 26A-26B illustrate exemplary user interfaces for content sharing and insertion using a dedicated share key, in accordance with some embodiments.

FIG. 27 is a functional block diagram of an electronic device, in accordance with some embodiments.

FIG. 28 is a flow chart illustrating a method of providing notification using a dedicated notification key, in accordance with some embodiments.

FIGS. 29A-29F illustrate exemplary user interfaces of using a dedicated notification key, in accordance with some embodiments.

FIG. 30 is a functional block diagram of an electronic device, in accordance with some embodiments.

FIGS. 31A-31B are schematic diagrams of a detachable keyboard and a system comprising the detachable keyboard and a portable multifunction device, in accordance with some embodiments.

FIGS. 32A-32L illustrate exemplary user interfaces on a portable multifunction device connecting to a detachable keyboard, in accordance with some embodiments.

FIG. 33 is a functional block diagram of an electronic device, in accordance with some embodiments.

FIGS. 34A-34B are flow charts illustrating a method of arrow key scrolling, in accordance with some embodiments.

FIGS. 35A-35H illustrate exemplary user interfaces of arrow key scrolling, in accordance with some embodiments.

FIG. 36 is a functional block diagram of an electronic device, in accordance with some embodiments.

FIG. 37 is a flow chart illustrating a method of text scrolling using an arrow key, in accordance with some embodiments.

FIGS. 38A-38B illustrate exemplary user interfaces for text scrolling using an arrow key, in accordance with some embodiments.

FIG. 39 is a functional block diagram of an electronic device, in accordance with some embodiments.

FIG. 40 is a flow chart illustrating a method of keyboard switching, in accordance with some embodiments.

FIGS. 41A-41N illustrate exemplary user interfaces of keyboard switching, in accordance with some embodiments.

FIG. 42 is a functional block diagram of an electronic device, in accordance with some embodiments.

FIG. 43 is a flow chart illustrating a method for switching between lower and upper case characters, in accordance with some embodiments.

FIGS. 44A-44G illustrate exemplary user interfaces of switching between lower and upper case characters, in accordance with some embodiments.

FIG. 45 is a functional block diagram of an electronic device, in accordance with some embodiments.

FIGS. 46A-46C are flow charts illustrating a method for communicating between users, in accordance with some embodiments.

FIGS. 47A-47L illustrate exemplary user interfaces for communicating between users, in accordance with some embodiments.

FIG. 48 is a functional block diagram of an electronic device, in accordance with some embodiments.

FIGS. 49A-49C are flow charts illustrating a method for mirrored control between devices, in accordance with some embodiments.

FIGS. 50A-50L illustrate exemplary user interfaces for mirrored control between devices, in accordance with some embodiments.

FIG. 51 is a functional block diagram of an electronic device, in accordance with some embodiments.

### DESCRIPTION OF EMBODIMENTS

The following describes systems and methods that allow a user to more efficiently use smaller keyboards typically used with portable computing devices. For example, some embodiments describe how users can efficiently enter punctuation characters in an electronic document using a keyboard with fewer keys than is typical on a full-sized keyboard. While the systems and methods described herein provide fewer keys on either a virtual or a physical keyboard, the fewer keys still allow a user to enter characters or perform actions traditionally available only when using full-size keyboards. Further, some of the keys have multiple functions, where in some embodiments, the system or keyboard automatically and without human intervention determines the function of the key based on the context. The improved keyboard also reduces the number of steps that a user must perform to locate and enter a character, thereby increasing efficiency and ease of use.

### Exemplary Devices

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Embodiments of computing devices, user interfaces for such devices, and associated processes for using such devices are described. In some embodiments, the computing device is a portable communications device such as a mobile telephone that also contains other functions, such as PDA and/or music player functions. Exemplary embodiments of portable multifunction devices include, without limitation, the IPHONE, IPAD, and IPOD TOUCH devices from Apple Computer, Inc. of Cupertino, Calif.

In the discussion that follows, a computing device that includes a touch-sensitive display is described. It should be understood, however, that the computing device may include one or more other physical user-interface devices, such as a separate display, physical keyboard, a mouse, and/or a joystick.

The device supports a variety of applications, such as one or more of the following: a drawing application, a presentation application, a word processing application, a website creation application, a disk authoring application, a spreadsheet application, a gaming application, a telephone application, a video-conferencing application, an e-mail application, an instant messaging application, a fitness application, a photo management application, a digital camera application, a digital video camera application, a web browsing application, a digital music player application, a digital video player application, and/or a home automation application.

The various applications that may be executed on the device may use at least one common physical user-interface device, such as the touch-sensitive surface. One or more functions of the touch-sensitive surface as well as corresponding information displayed on the device may be adjusted and/or varied from one application to the next and/or within a respective application. In this way, a common physical architecture (such as the touch-sensitive surface) of the device may support the variety of applications with user interfaces that are intuitive and transparent.

The user interfaces may include one or more soft keyboard embodiments. The soft keyboard embodiments may include standard (QWERTY) and/or non-standard configurations of symbols on the displayed icons of the keyboard, such as those described in U.S. patent application Ser. No. 11/459,606, “Keyboards For Portable Electronic Devices,” filed Jul. 24, 2006, and Ser. No. 11/459,615, “Touch Screen Keyboards For Portable Electronic Devices,” filed Jul. 24, 2006, the contents of which are hereby incorporated by reference in their entirety. The keyboard embodiments may include a reduced number of icons (or soft keys) relative to the number of keys in existing physical keyboards, such as that for a typewriter. This may make it easier for users to select one or more icons in the keyboard, and thus, one or more corresponding symbols. The keyboard embodiments may be adaptive. For example, displayed icons may be modified in accordance with user actions, such as selecting one or more icons and/or one or more corresponding symbols. One or more applications on the device may utilize common and/or different keyboard embodiments. Thus, the keyboard embodiment used may be tailored to at least some of the applications. In some embodiments, one or more keyboard embodiments may be tailored to a respective user. For example, one or more keyboard embodiments may be tailored to a respective user based on a word usage history (lexicography, slang, individual usage) of the respective user. Some of the keyboard embodiments may be adjusted to reduce a probability of a user error when selecting one or more icons, and thus one or more symbols, when using the soft keyboard embodiments.

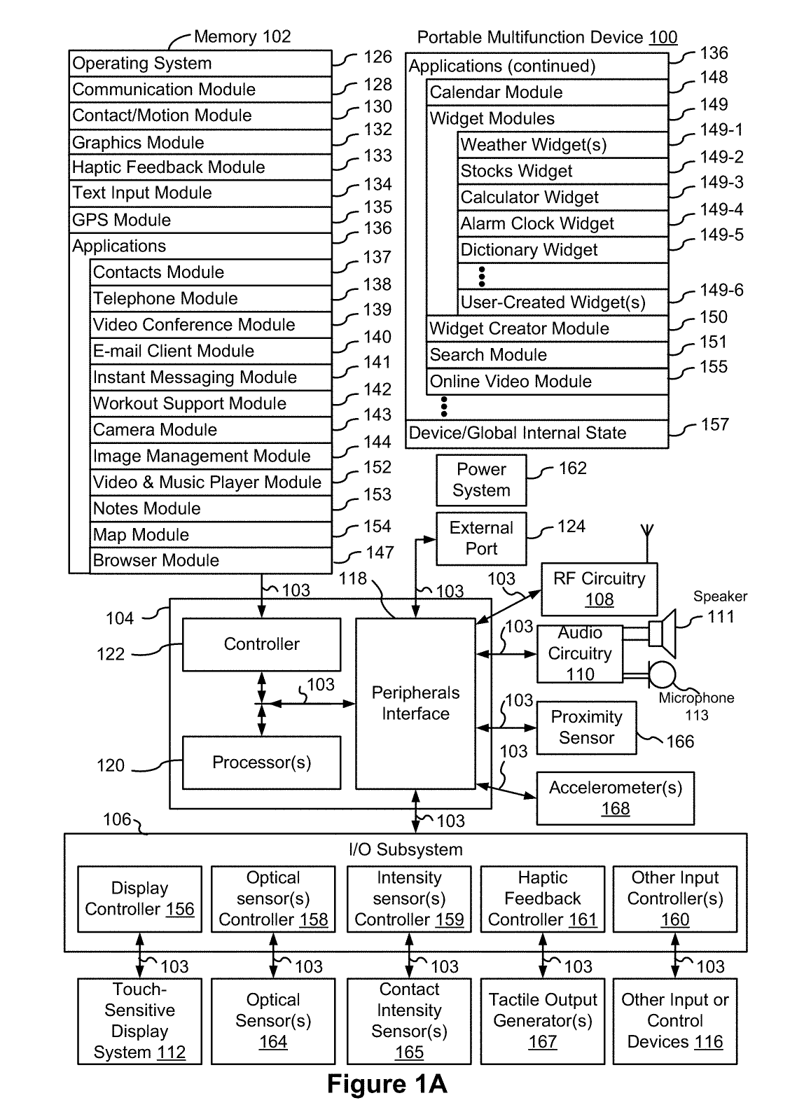

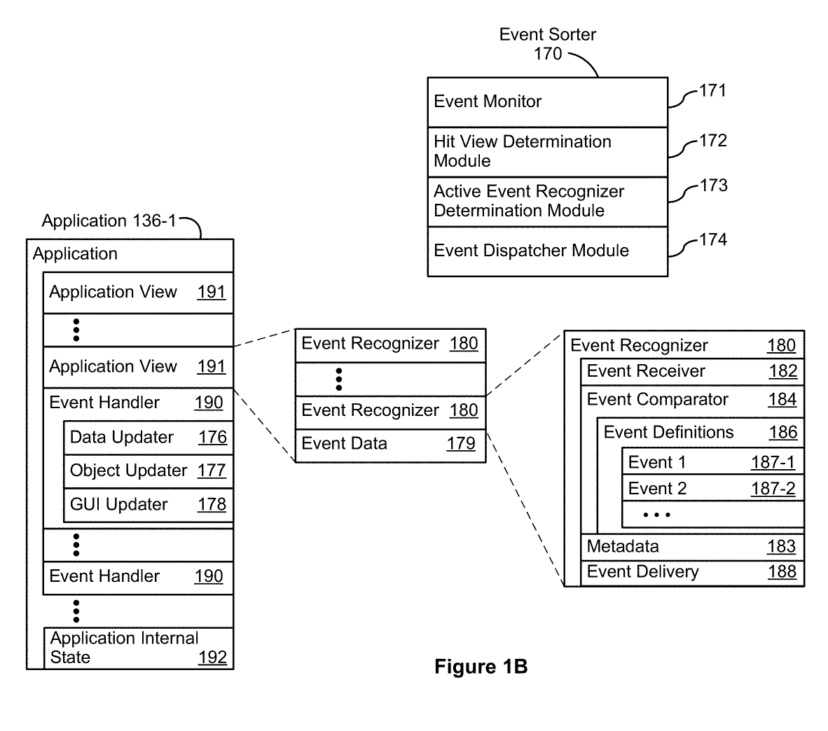

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad of a device). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.1 in), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

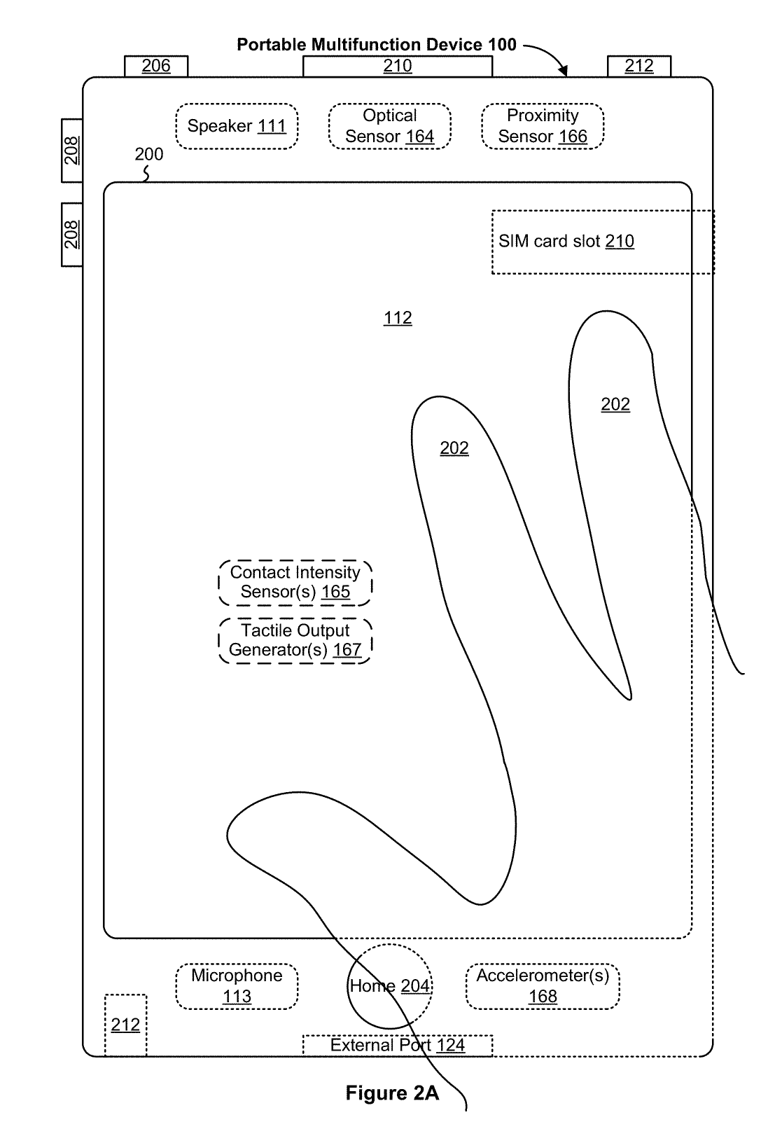

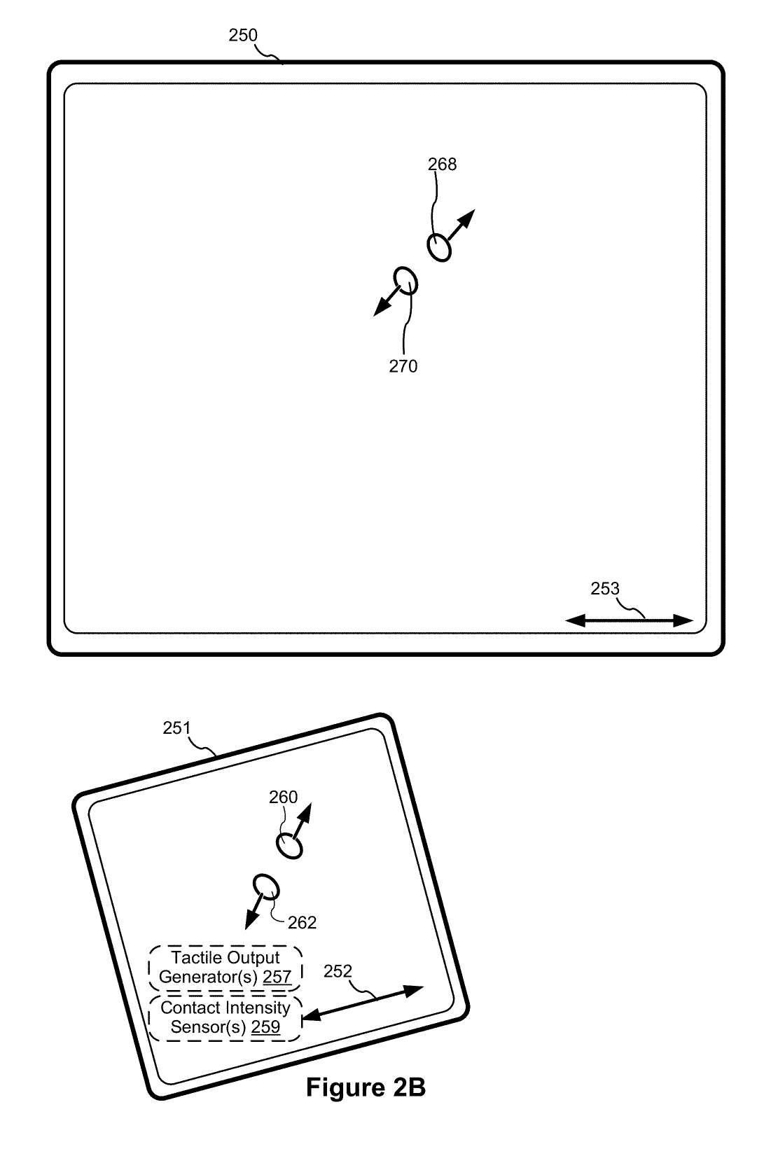

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2A). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2A) optionally include an up/down button for volume control of speaker 111 and/or microphone 113. The one or more buttons optionally include a push button (e.g., 206, FIG. 2A).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user-interface objects.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In an exemplary embodiment, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In an exemplary embodiment, projected mutual capacitance sensing technology is used, such as that found in the iPhone®, iPod Touch®, and iPad® from Apple Inc. of Cupertino, Calif.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. Tactile output generator(s) 167 optionally include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

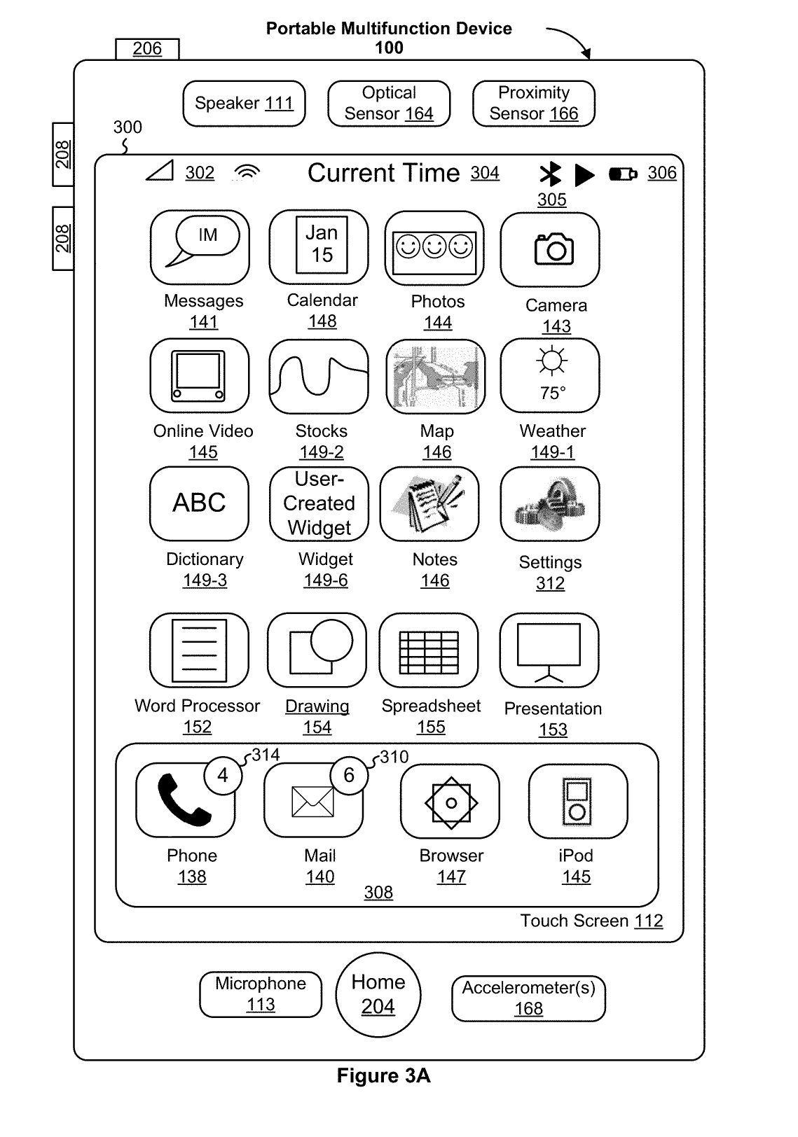

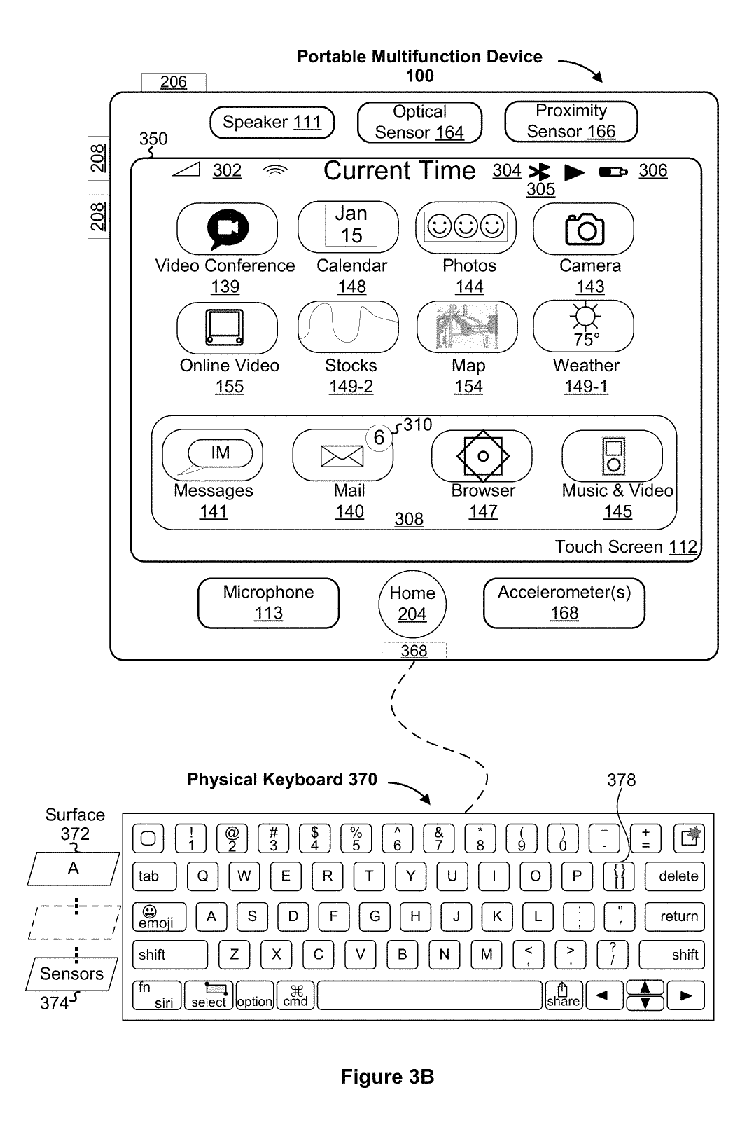

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, Calif. In some embodiments, the external port is a Lightning connector that is the same as, or similar to and/or compatible with the Lightning connector used in some iPhone®, iPod Touch®, and iPad® devices from Apple Inc. of Cupertino, Calif.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages and to view received instant messages. In some embodiments, transmitted and/or received instant messages optionally include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and music player module 146, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display system controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display system controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display system controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display system controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display system controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display system controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display system controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display system controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (in FIG. 1A) includes event sorter 170 (e.g., in operating system 126) and a respective application 136-1 (e.g., any of the aforementioned applications 137-153).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state stored in the memory 102 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected may correspond to programmatic levels within a programmatic or view hierarchy of the application. For example, the lowest level view in which a touch is detected may be called the hit view, and the set of events that are recognized as proper inputs may be determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 may utilize or call data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which may include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch the event information may also include speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double-tap on a displayed object. The double-tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers may interact with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 145. In some embodiments, object updater 177 creates and updates objects used in application 136-1. For example, object updater 176 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens, e.g., coordinating mouse movement and mouse button presses with or without single or multiple keyboard presses or holds, user movements taps, drags, scrolls, etc., on touch-pads, pen stylus inputs, movement of the device, oral instructions, detected eye movements, biometric inputs, and/or any combination thereof, which may be utilized as inputs corresponding to sub-events which define an event to be recognized.

FIG. 2A illustrates a portable multifunction device 100 having a touch screen (e.g., touch-sensitive display system 112, FIG. 1A) in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display.

In some embodiments, device 100 includes the touch-screen display, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensity of contacts on touch-sensitive display system 112 and/or one or more tactile output generators 167 for generating tactile outputs for a user of device 100.

FIG. 2B illustrates an exemplary user interface on a device (e.g., device 100, FIG. 1A) with a touch-sensitive surface 251 (e.g., a tablet or touchpad) that is separate from the display 250. Device 100 also, optionally, includes one or more contact intensity sensors (e.g., one or more of sensors 259) for detecting intensity of contacts on touch-sensitive surface 251 and/or one or more tactile output generators 257 for generating tactile outputs for a user of device 100.

Although many of the examples that follow will be given with reference to inputs on touch screen display 112 (where the touch-sensitive surface and the display are combined), in some embodiments, the device detects inputs on a touch-sensitive surface that is separate from the display, as shown in FIG. 2B. In some embodiments, the touch-sensitive surface (e.g., 251 in FIG. 2B) has a primary axis (e.g., 252 in FIG. 2B) that corresponds to a primary axis (e.g., 253 in FIG. 2B) on the display (e.g., 250). In accordance with these embodiments, the device detects contacts (e.g., 260 and 262 in FIG. 2B) with the touch-sensitive surface 251 at locations that correspond to respective locations on the display (e.g., in FIG. 2B, 260 corresponds to 268 and 262 corresponds to 270). In this way, user inputs (e.g., contacts 260 and 262, and movements thereof) detected by the device on the touch-sensitive surface (e.g., 251 in FIG. 2B) are used by the device to manipulate the user interface on the display (e.g., 250 in FIG. 2B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad or touch-sensitive surface 251 in FIG. 2B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A or the touch screen in FIG. 2A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations, focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “intensity” of a contact on a touch-sensitive surface refers to the force or pressure (force per unit area) of a contact (e.g., a finger contact or a stylus contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average or a sum) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be readily accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch-screen display can be set to any of a large range of predefined thresholds values without changing the trackpad or touch-screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds may include a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second intensity threshold results in a third operation. In some embodiments, a comparison between the characteristic intensity and one or more intensity thresholds is used to determine whether or not to perform one or more operations (e.g., whether to perform a respective option or forgo performing the respective operation) rather than being used to determine whether to perform a first operation or a second operation.

In some embodiments, a portion of a gesture is identified for purposes of determining a characteristic intensity. For example, a touch-sensitive surface may receive a continuous swipe contact transitioning from a start location and reaching an end location (e.g., a drag gesture), at which point the intensity of the contact increases. In this example, the characteristic intensity of the contact at the end location may be based on only a portion of the continuous swipe contact, and not the entire swipe contact (e.g., only the portion of the swipe contact at the end location). In some embodiments, a smoothing algorithm may be applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

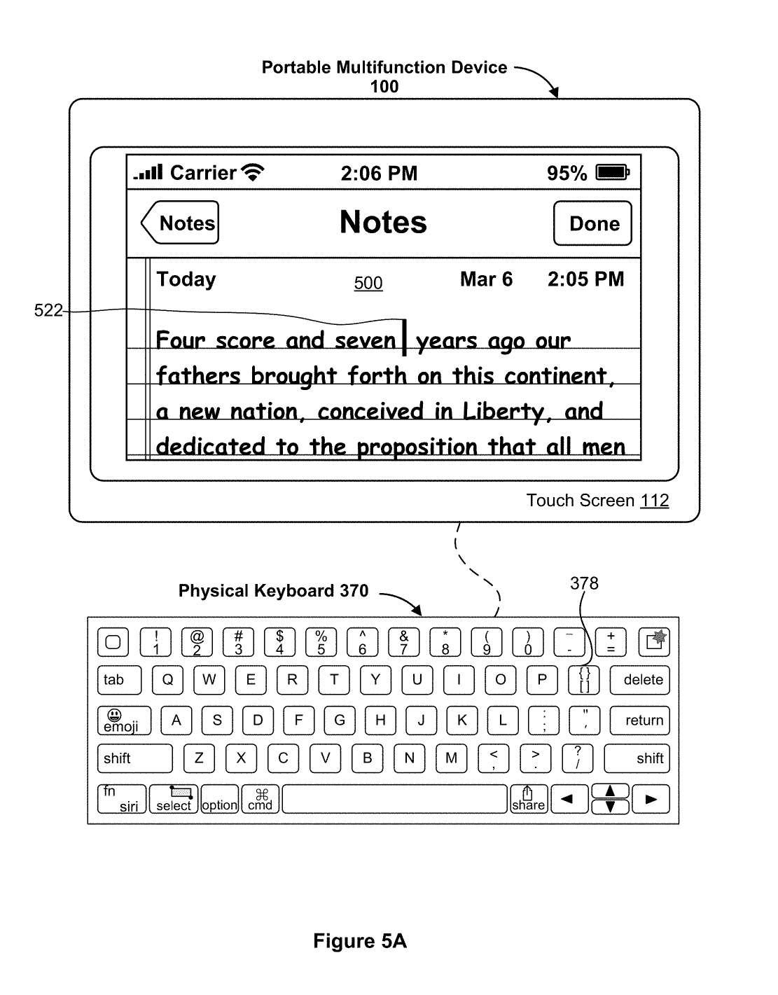

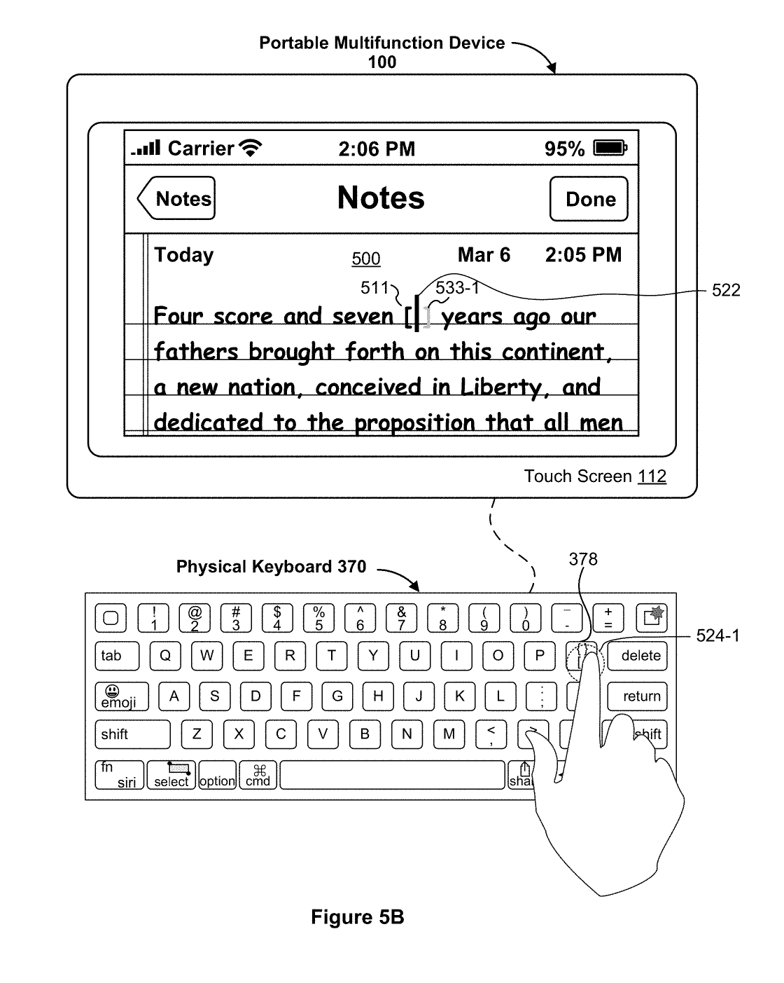

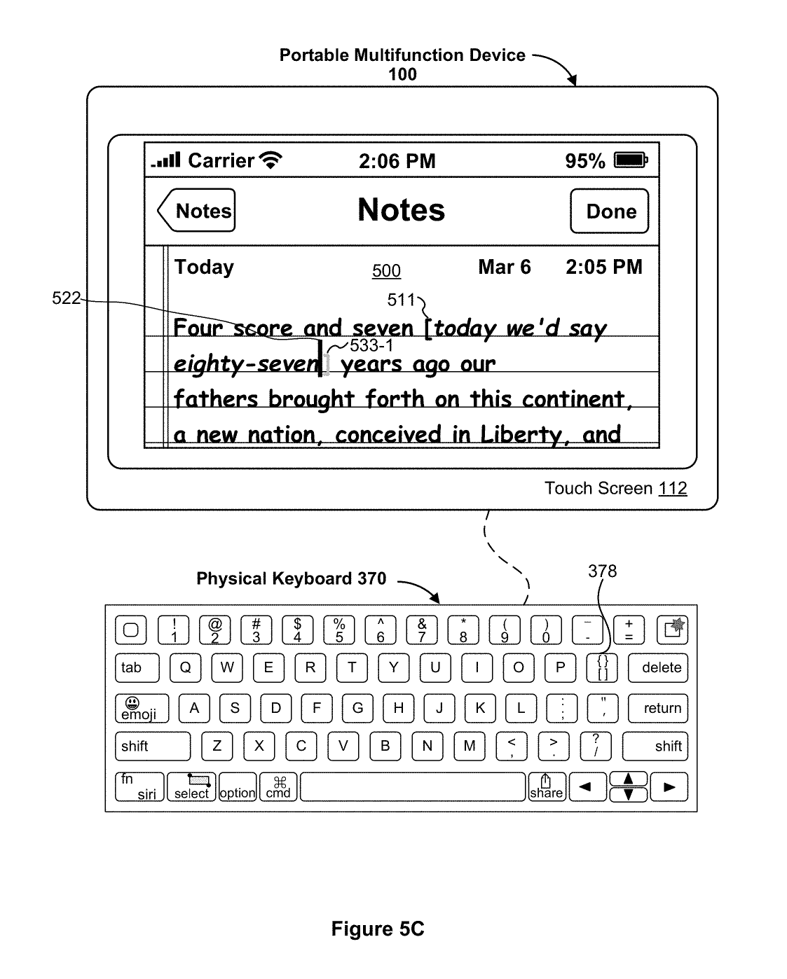

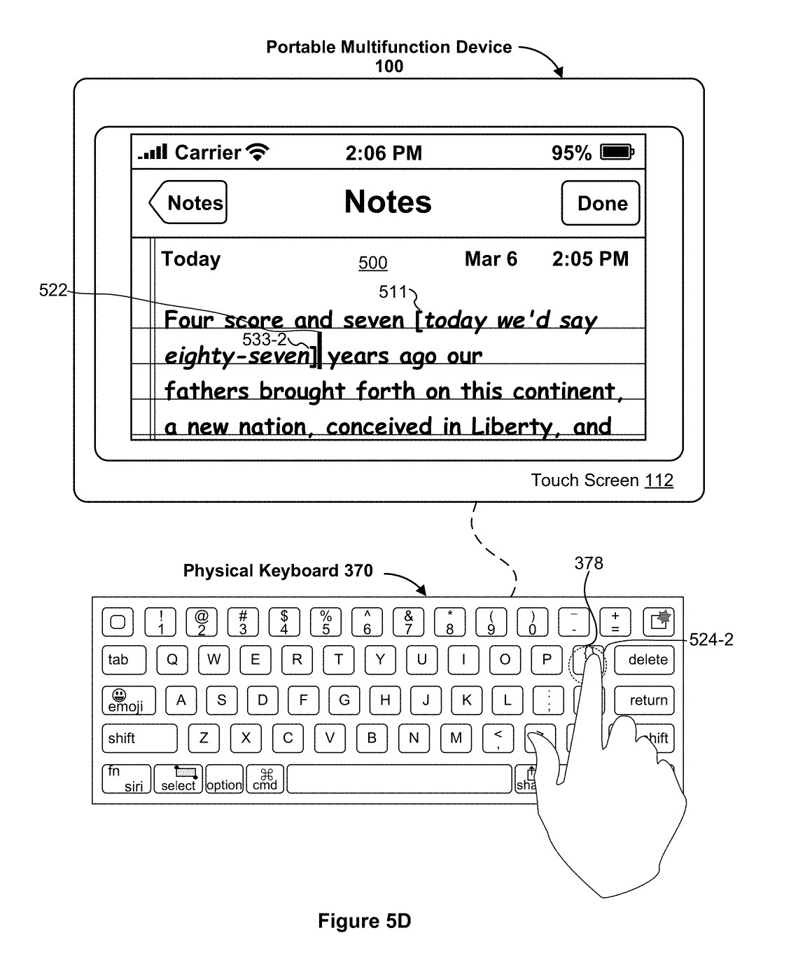

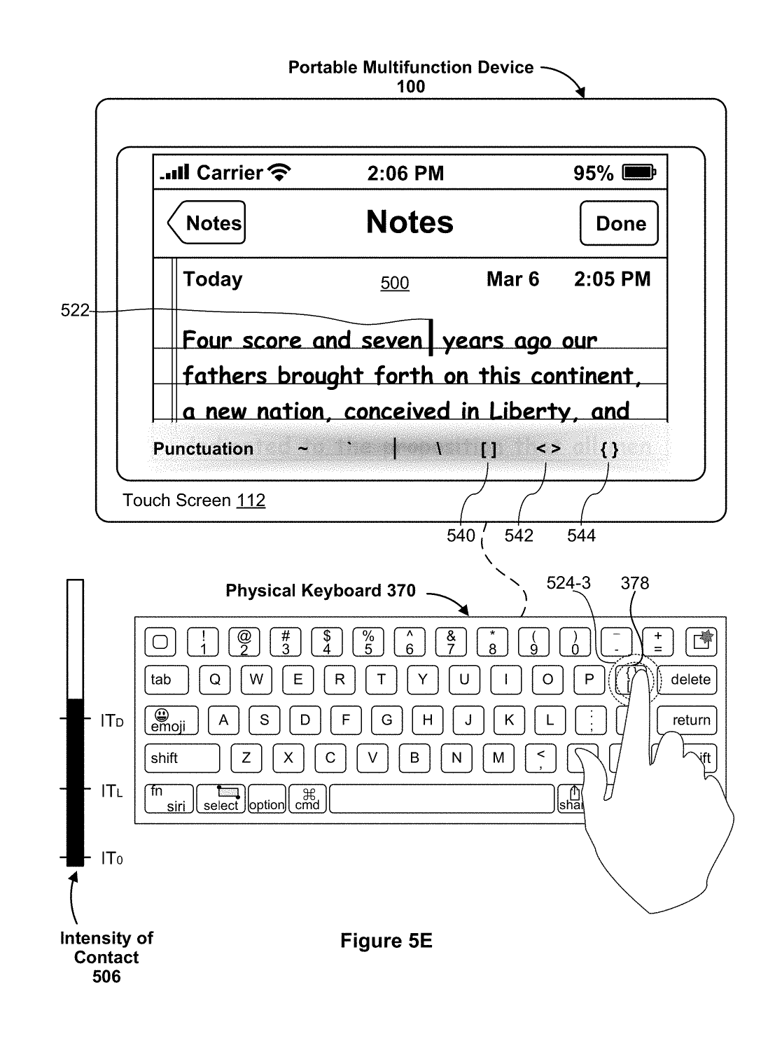

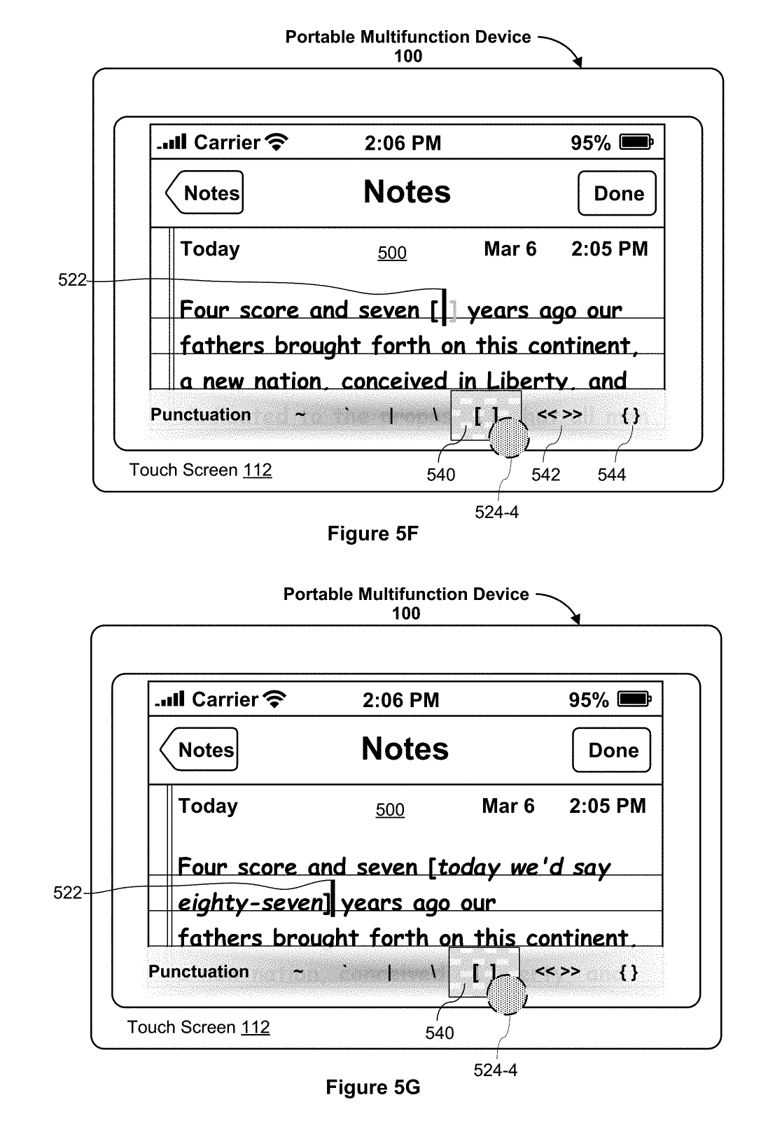

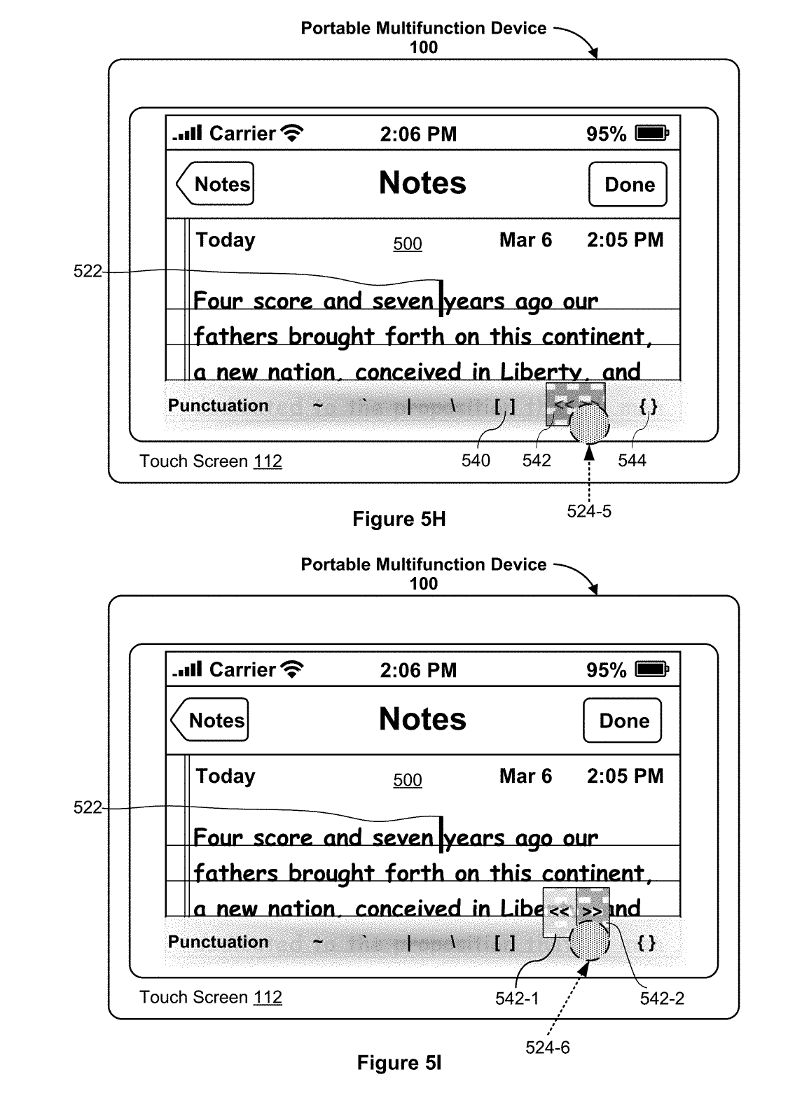

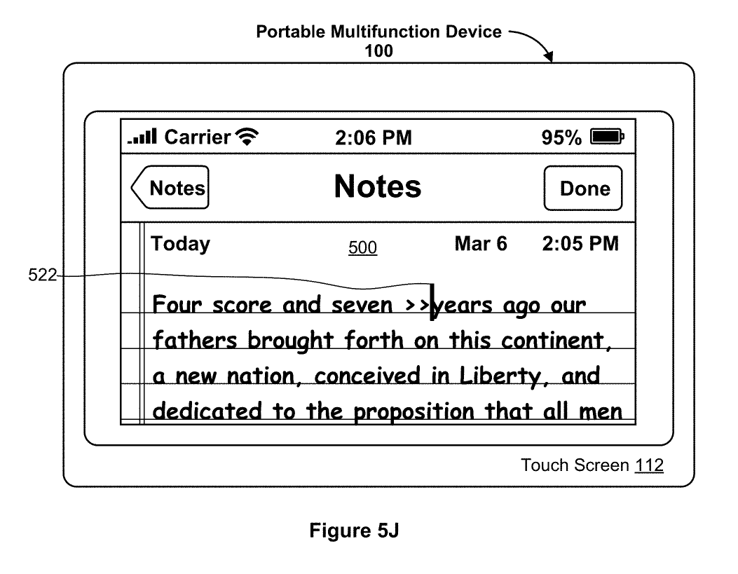

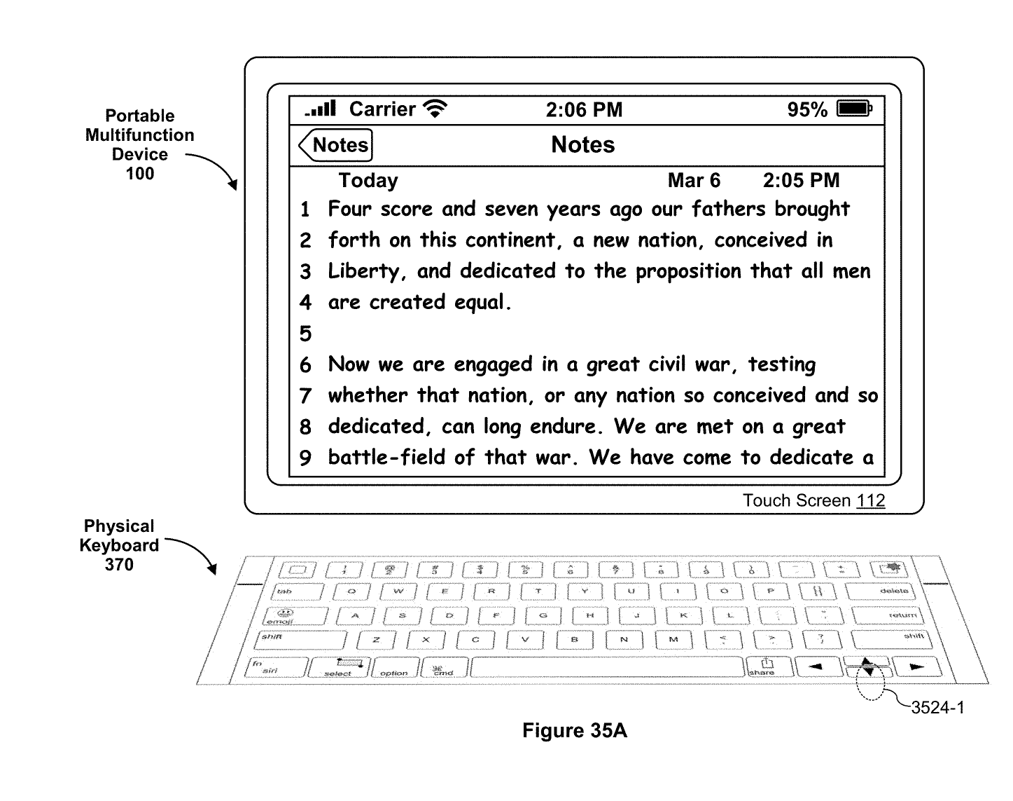

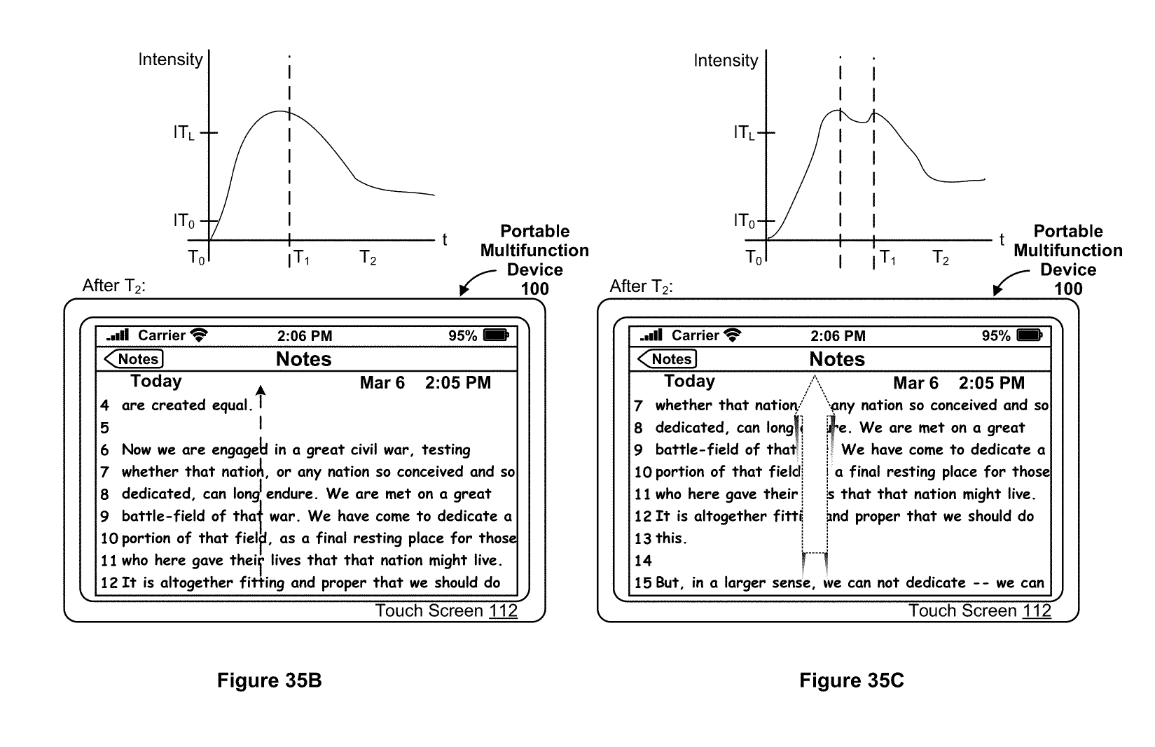

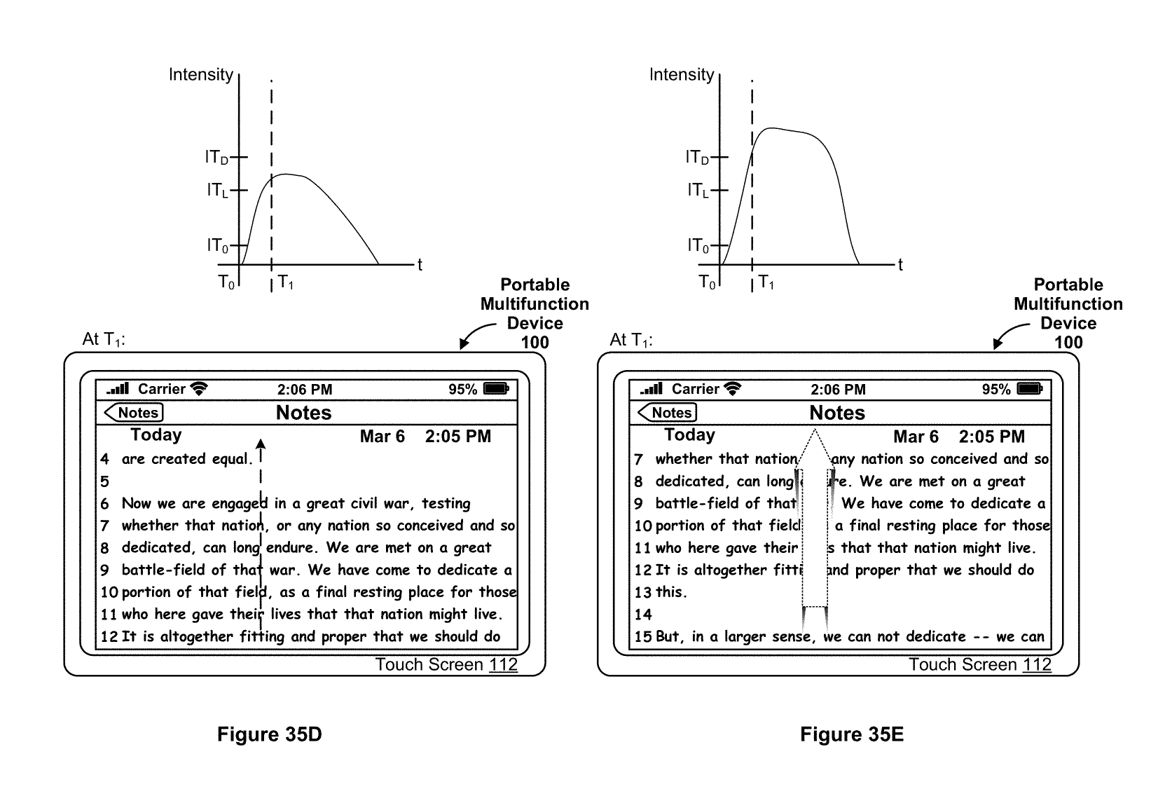

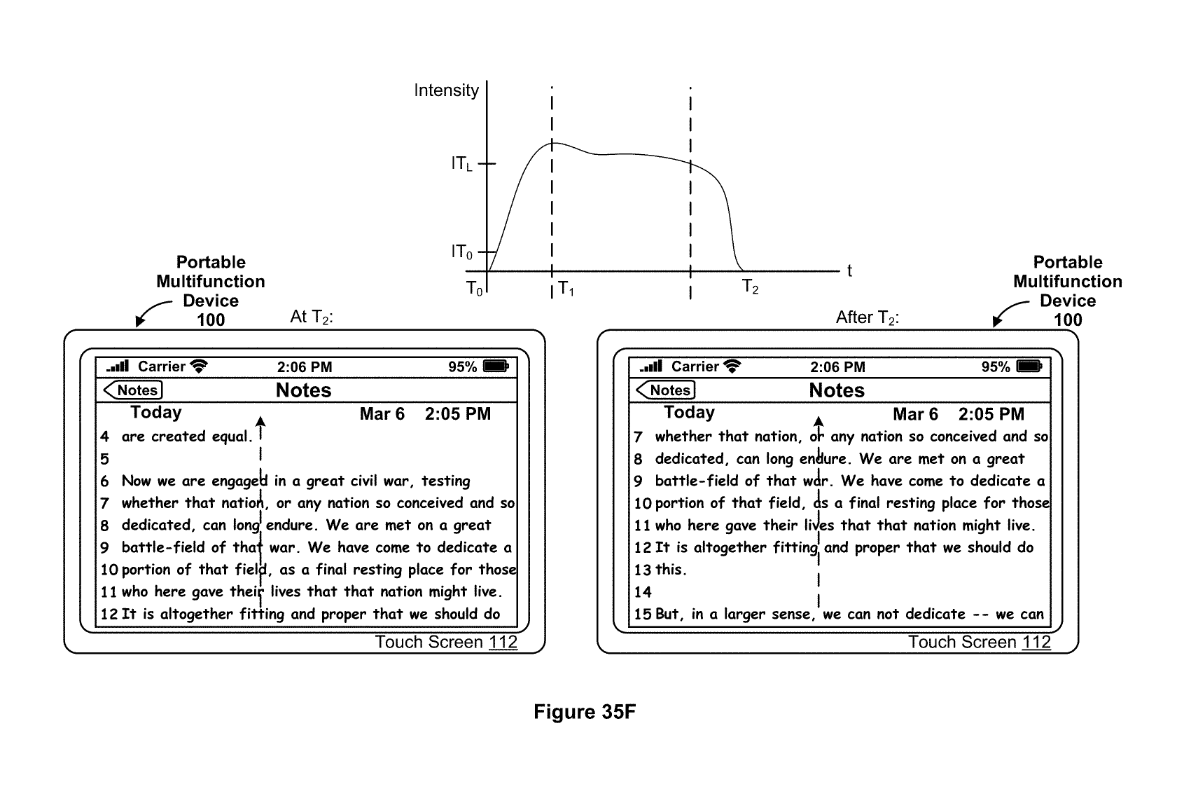

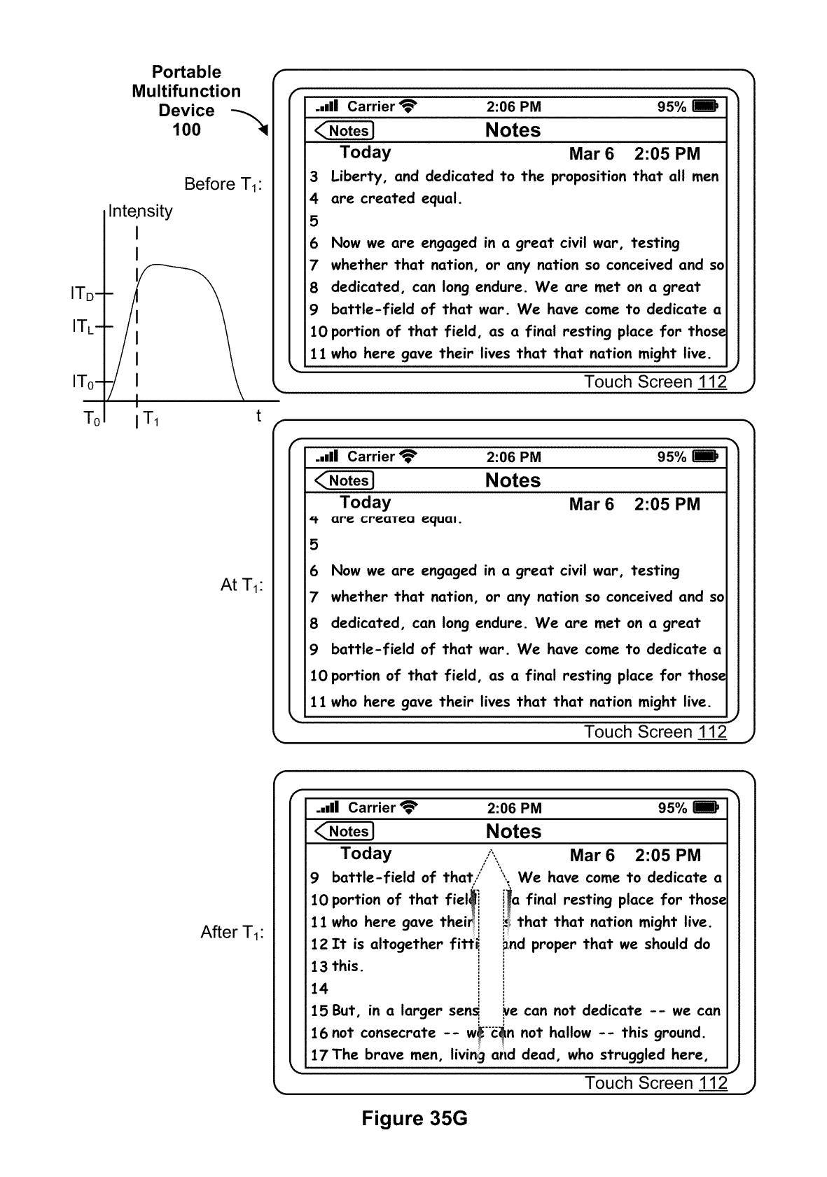

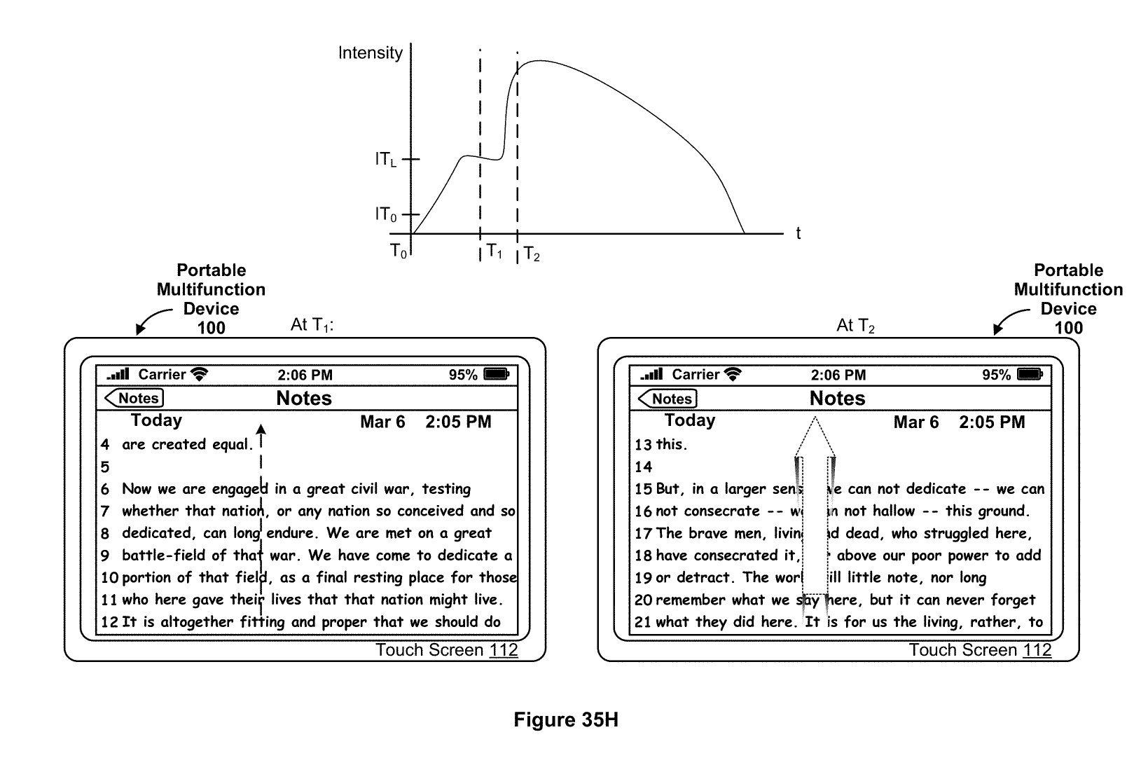

The user interface figures (e.g., FIGS. 5E and 35B-35H) described below optionally include various intensity diagrams that depict an example of the current intensity of the contact on the touch-sensitive surface relative to one or more intensity thresholds (e.g., a contact detection intensity threshold IT₀, a light press intensity threshold IT_{L}, a deep press intensity threshold IT_{D}, and/or one or more other intensity thresholds). This intensity diagram is typically not part of the displayed user interface, but is provided to aid in the interpretation of the figures. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold IT₀ below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

In some embodiments, the response of the device to inputs detected by the device depends on criteria based on the contact intensity during the input. For example, for some “light press” inputs, the intensity of a contact exceeding a first intensity threshold during the input triggers a first response. In some embodiments, the response of the device to inputs detected by the device depends on criteria that include both the contact intensity during the input and time-based criteria. For example, for some “deep press” inputs, the intensity of a contact exceeding a second intensity threshold during the input, greater than the first intensity threshold for a light press, triggers a second response only if a delay time has elapsed between meeting the first intensity threshold and meeting the second intensity threshold. This delay time is typically less than 200 ms in duration (e.g., 40, 100, or 120 ms, depending on the magnitude of the second intensity threshold, with the delay time increasing as the second intensity threshold increases). This delay time helps to avoid accidental deep press inputs. As another example, for some “deep press” inputs, there is a reduced-sensitivity time period that occurs after the time at which the first intensity threshold is met. During the reduced-sensitivity time period, the second intensity threshold is increased. This temporary increase in the second intensity threshold also helps to avoid accidental deep press inputs. For other deep press inputs, the response to detection of a deep press input does not depend on time-based criteria.

In some embodiments, one or more of the input intensity thresholds and/or the corresponding outputs vary based on one or more factors, such as user settings, contact motion, input timing, application running, rate at which the intensity is applied, number of concurrent inputs, user history, environmental factors (e.g., ambient noise), focus selector position, and the like. Exemplary factors are described in U.S. patent application Ser. Nos. 14/399,606 and 14/624,296, which are incorporated by reference herein in their entireties.

An increase of characteristic intensity of the contact from an intensity below the light press intensity threshold IT_{L} to an intensity between the light press intensity threshold IT_{L} and the deep press intensity threshold IT_{D} is sometimes referred to as a “light press” input. An increase of characteristic intensity of the contact from an intensity below the deep press intensity threshold IT_{D} to an intensity above the deep press intensity threshold IT_{D} is sometimes referred to as a “deep press” input. An increase of characteristic intensity of the contact from an intensity below the contact-detection intensity threshold IT₀ to an intensity between the contact-detection intensity threshold IT₀ and the light press intensity threshold IT_{L} is sometimes referred to as detecting the contact on the touch-surface. A decrease of characteristic intensity of the contact from an intensity above the contact-detection intensity threshold IT₀ to an intensity below the contact-detection intensity threshold IT₀ is sometimes referred to as detecting liftoff of the contact from the touch-surface. In some embodiments IT₀ is zero. In some embodiments, IT₀ is greater than zero. In some illustrations a shaded circle or oval is used to represent intensity of a contact on the touch-sensitive surface. In some illustrations, a circle or oval without shading is used represent a respective contact on the touch-sensitive surface without specifying the intensity of the respective contact.

In some embodiments, described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., the respective operation is performed on a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., the respective operation is performed on an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., the respective operation is performed on an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold. As described above, in some embodiments, the triggering of these responses also depends on time-based criteria being met (e.g., a delay time has elapsed between a first intensity threshold being met and a second intensity threshold being met).

FIG. 3A is a schematic of a user interface for a menu of applications on portable multifunction device 100, in accordance with some embodiments. Similar user interfaces may be implemented on a desktop device in accordance with some embodiments. In some embodiments, user interface 300 includes the following elements, or a subset or superset thereof:
Signal strength indicator(s) 302 for wireless communication(s), such as cellular and Wi-Fi signals;
Time 304;
Bluetooth indicator 305;
Battery status indicator 306;
Tray 308 with icons for frequently used applications, such as:
   Phone 138, which may include an indicator 314 of the number of missed calls or voicemail messages;
   E-mail client 140, which may include an indicator 310 of the number of unread e-mails;
   Browser 147; and
   Video and music player 145, also referred to as iPod (trademark of Apple Inc.) module 152; and
Icons for other applications, such as:
   IM 141;
   Calendar 148;
   Image management 144;
   Camera 143;
   Online video module 145, also referred to as YouTube (trademark of Google Inc.) module 145;
   Stocks 149-2;
   Map 146;
   Weather 149-1;
   Dictionary 149-3;
   User-Created Widget 149-6;
   Notes 153;
   Settings 312, which provides access to settings for device 100 and its various applications 136;
   Word processor 153-1;
   Drawing 153-2;
   Spreadsheet 153-3; and
   Presentation 153-4.

FIG. 3B is an illustrative diagram of a portable computing system including a portable multifunction device 100 and a physical keyboard 370, in accordance with some embodiments. The portable multifunction device 100 may be, for example, an IPAD device from Apple Computer, Inc. of Cupertino, Calif., or any other portable computing device. As explained above with reference to FIGS. 1A-1B and 2A-2B, the portable multifunction device 100 is configured to acquire capacitive, resistive, optical, acoustic, or even inductive, mechanical, chemical, or electromagnetic measurements that indicate the points of contacts with the touch screen 112. In addition to the touch screen 112, the portable multifunction device 100 is configured to receive inputs from other sources, such as the physical keyboard 370.

In some embodiments, the physical keyboard 370 is communicatively coupled to the portable multifunction device 100 via a contact or array of contacts (e.g., Smart Connect from Apple Computer, Inc. of Cupertino, Calif.), via a wired connection (e.g., USB, PS/2), or via a wireless communication link (e.g., optical, Bluetooth, Wi-Fi, or the like). In some embodiments, a connector 368 of the portable multifunction device 100 couples to and communicates with the physical keyboard 370. For example, a case may be attached to the portable multifunction device 100 through the connector 368, and the case is also attached to or communicatively coupled to the rear surface of the keyboard 370 to establish communication channels.

As can be seen in FIG. 3B, the physical keyboard 370 includes a set of physical keys, i.e., not virtual keys displayed on a flat touch-screen. In some embodiments, a subset of the physical keys has a QWERTY, Dvorak, or other keyboard layout with alphanumeric, numeric, and/or editing/function sections (e.g., standard, extended, or compact) according to ISO/IEC 9995, ANSI-INCITS 154-1988, JIS X 6002-1980, or other similar standards. Each physical key has at least one associated input. The input may be associated with a visible or printable character, a non-visible or non-printable character, a function, or some other input. The input associated with a physical key may be shown by a letter, word, symbol, or other indicia shown (e.g., printed, embossed, engraved, and/or raised) on the surface of the key in Latin script, Arabic characters, Chinese characters, or any other suitable script or font.

Relative to conventional keyboards, the keyboard 270 conserves space by removing conventional keys that are not used often and frees up keyboard space to make room for new multi-functional keys, i.e., reducing the overall number of keys. For example, conventional full-size keyboards often have a pair of open and close punctuation characters shown on separate keys (e.g., keys “9” and “0”). Instead of separate keys for separate characters, the keyboard 370, in accordance with some embodiments, has a physical key 378 that is associated with more than one pair of punctuation characters, e.g., both { } and [ ] as indicated by the characters shown on the key 378. When a user actuates the key 378 by pressing on the key, the system may respond by entering {,}, [, or], as described in greater detail below with reference to FIGS. 5A-5J.

In addition to character keys, and depending on the embodiment, the keyboard 370 includes one or more of the following multifunction keys: a command key, such as a home key (e.g., indicated by a square and located next to numeral 1), an emoji key, a select key, a tab key, an option key, a cmd key, a share key, a shift key, a notification key (e.g., shown next to +/= and delete keys), arrows and so on. In some embodiments, selection of a combination of a command key and a character key allows a specific character of a plurality of characters associated with one key to be entered. For example, the selection of a combination of the command key “option” and the punctuation character key 378 allows an input of] to be entered. In other embodiments, command keys may be used to execute commands that are not necessarily associated with any characters. For example, pressing a particular command key or combination of command keys may cause the system to execute certain functions, such as switching between applications or the like. The functions of these command keys are described in greater detail below.

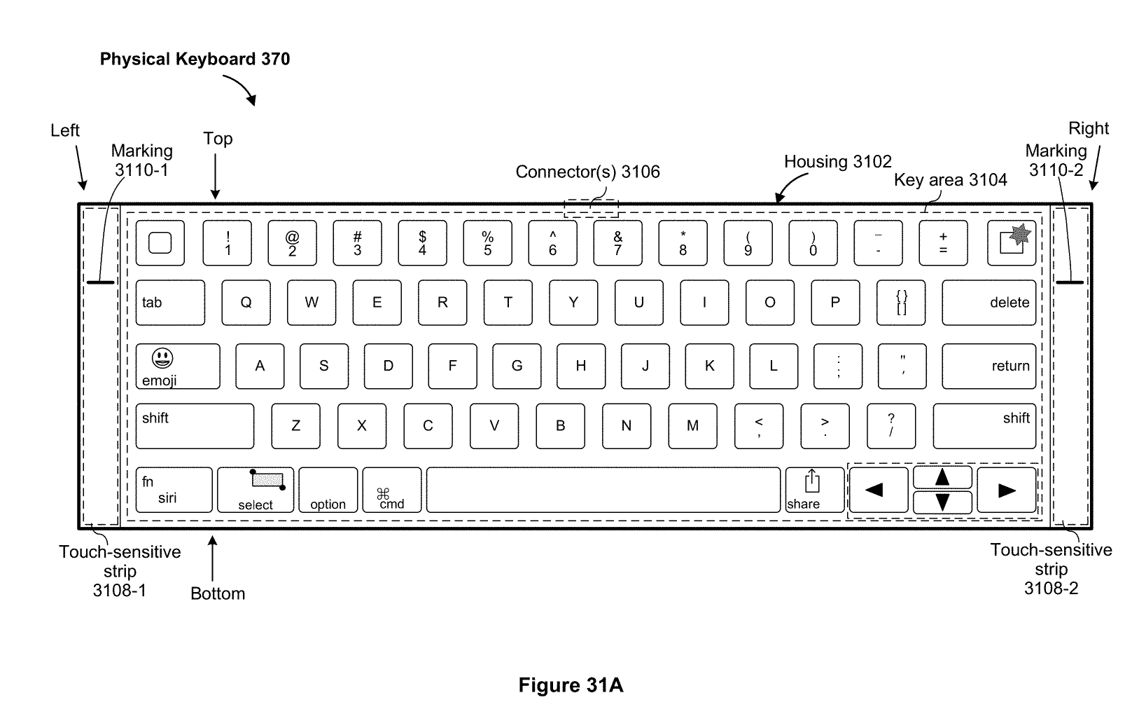

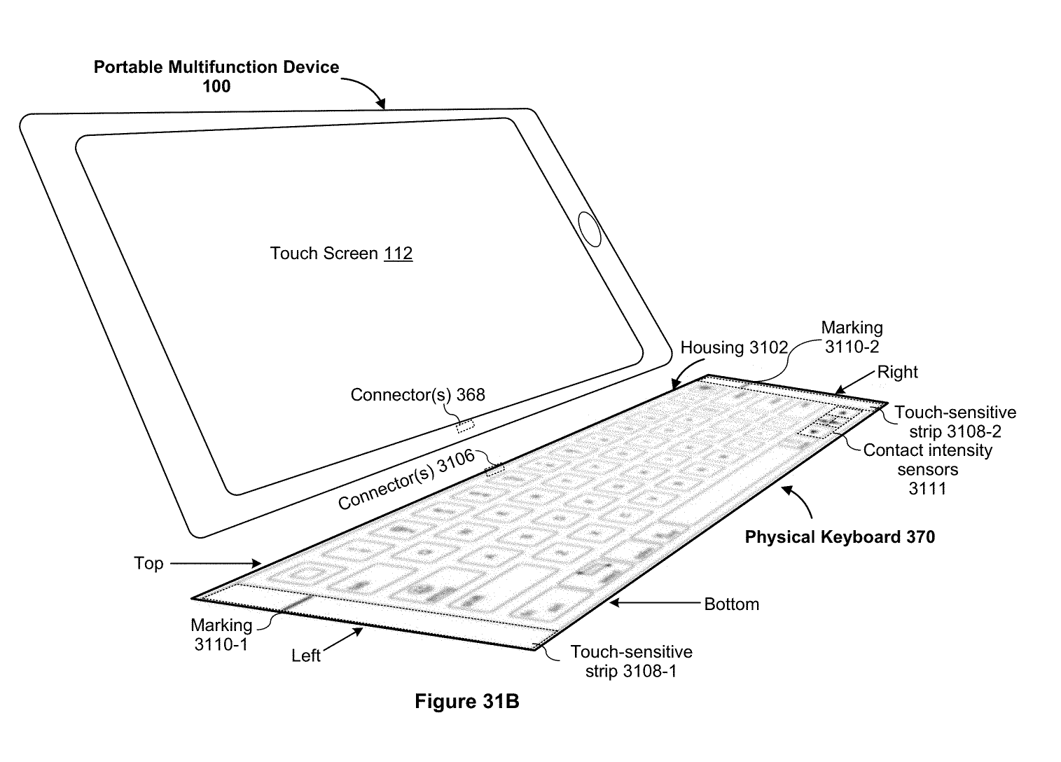

FIG. 3B also illustrates a partial exploded oblique view of a portion of the keyboard 370. As shown in FIG. 3B, and in some embodiments, the keyboard 370 includes sensors 374 operatively connected to the keyboard surface 372 of the physical keyboard 370. In some embodiments, the surface 372 includes individual keycaps and/or the area outside the keys. In some embodiments, the keyboard surface 372 includes an external side and an internal side opposite from the external side. In some embodiments, the external side contains the label for each key (e.g., “A”) and provides an engagement surface for a finger, stylus, or other object as described above. In some embodiments, the internal side of the keyboard surface 372 provides a connection surface to which components that are internal to the key attach, including the sensors 374. In some embodiments, a signal generated by the sensors 374, which corresponds to an input associated with a contact on the physical keyboard surface 372, is received by the processor of the portable multifunction device 100. In some embodiments, similar to the contact intensity sensor(s) 165 in the portable multifunction device 100 described above, these sensors 374 are configured to acquire contact intensity information (e.g., pressure information or a proxy for pressure information). In some embodiments, at least a portion of the physical keyboard 370 has a touch-sensitive surface, and a subset of the sensors 374 is collocated with, or proximate to, the touch-sensitive surface of the physical keyboard 370. The usage of the sensors in connection with the keyboard 370 are described in greater detail below with reference to FIGS. 31A-31B, 32A-32L, 35A-35H, and 38A-38B.

### User Interfaces and Associated Processes

Attention is now directed towards embodiments of processes and associated user interfaces (“UI”) that may be implemented on an electronic device with a display and/or a touch-sensitive display, such as the portable multifunction device 100.

Parenthesis Helper

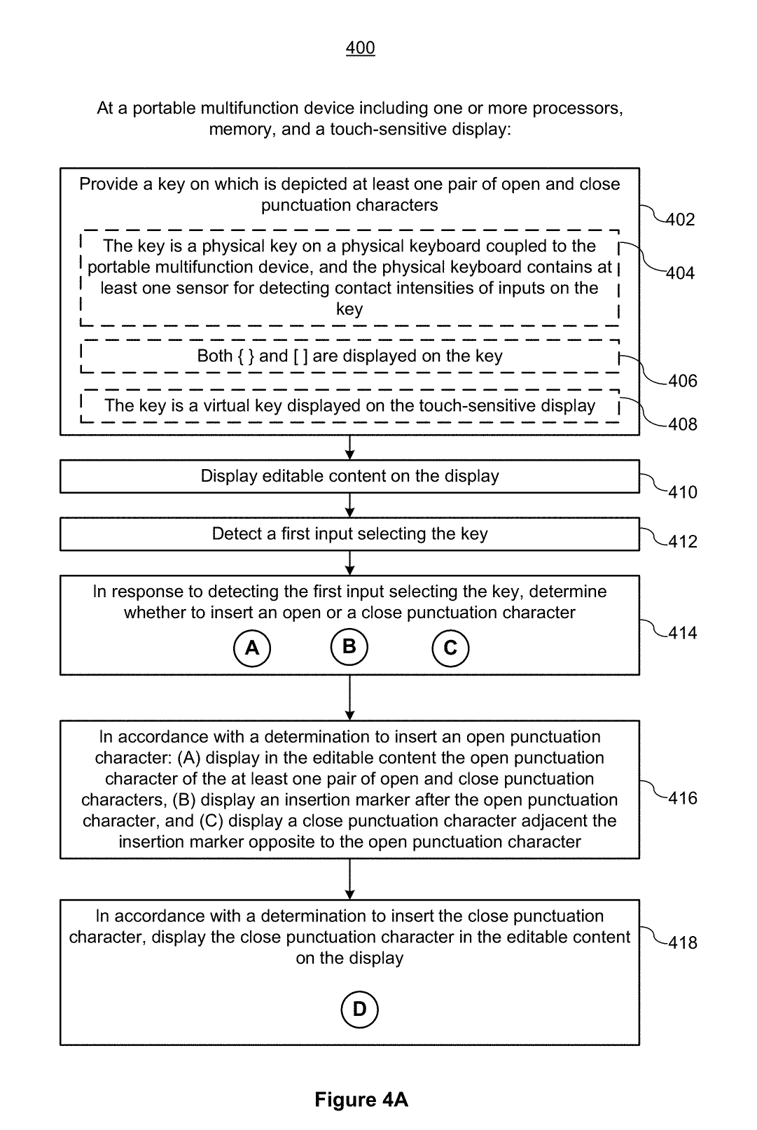

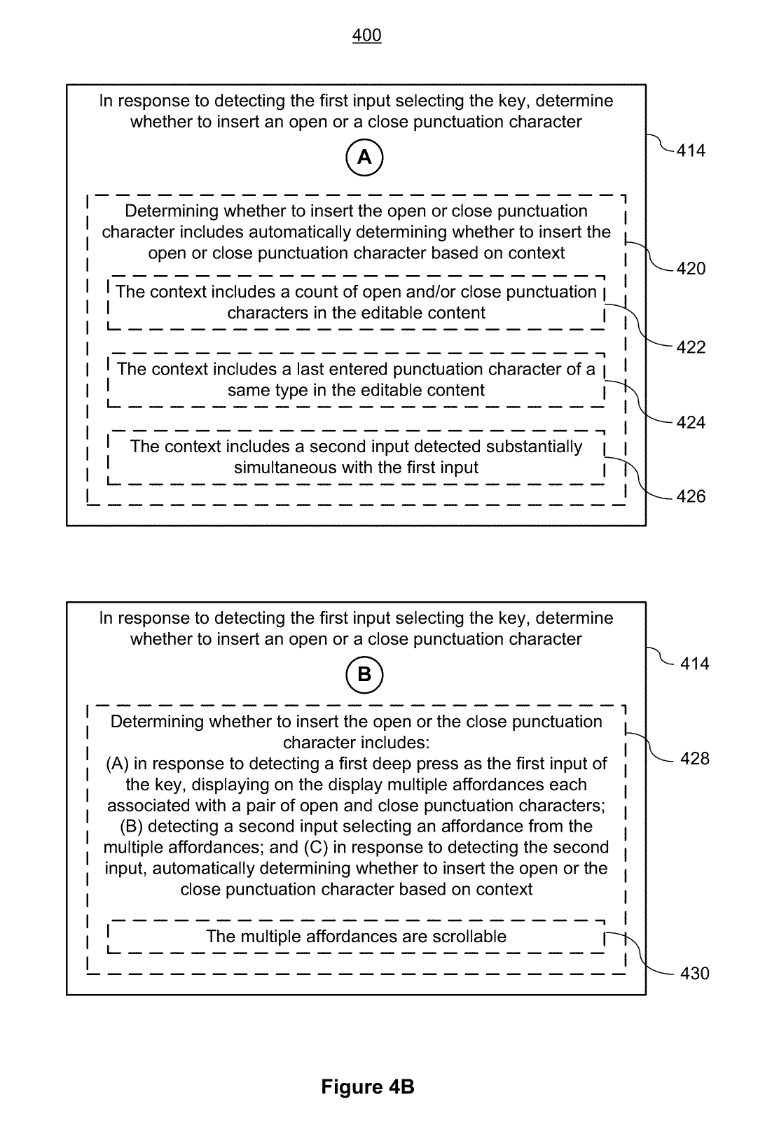

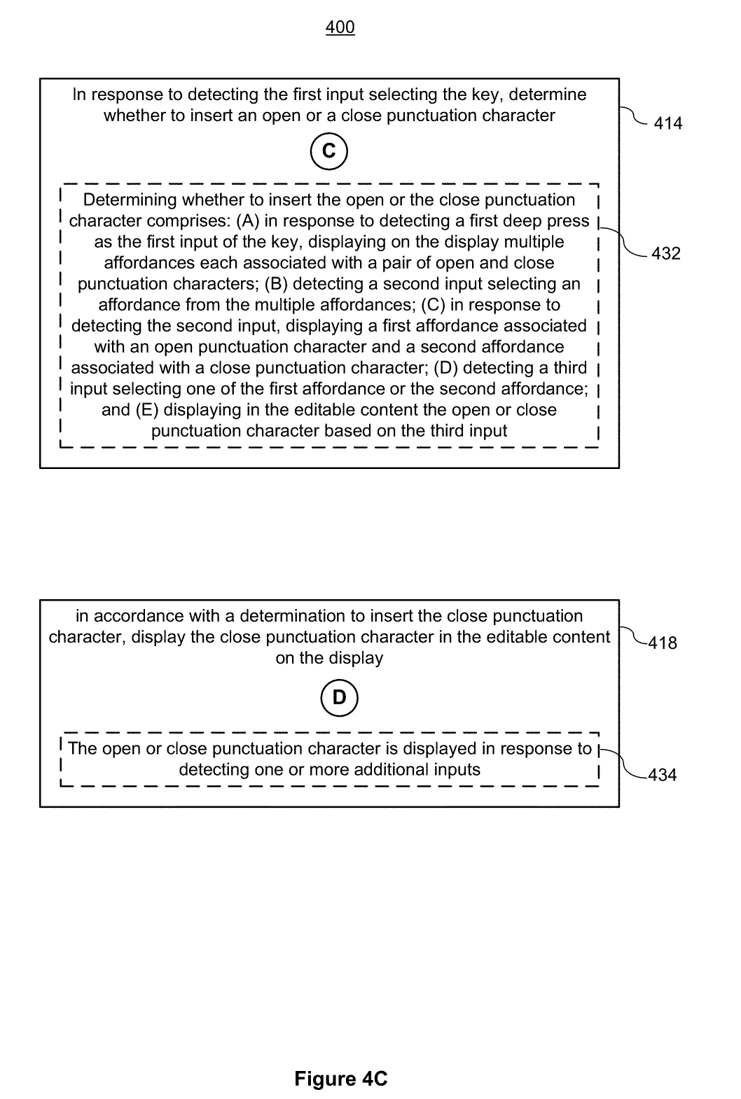

FIGS. 4A-4C are flow charts illustrating a method 400 of punctuation character entry, in accordance with some embodiments. FIGS. 5A-5J, which illustrate exemplary user interfaces for punctuation character entry, are used to illustrate the processes depicted in FIGS. 4A-4C. The method 400 is performed at a portable multifunction device (e.g., the device 100 in FIG. 1A) with a touch-sensitive display (e.g., the touch screen display 112 in FIG. 1A).

As described below, the method 400 provides an efficient mechanism for entering punctuation characters at a portable multifunction device. This method is faster and easier to perform than conventional punctuation character entry methods and systems, e.g., conventional punctuation character entry through a conventional keyboard with more than one key associated with one pair of open and close punctuation characters. The method is also intuitive for users, thereby reducing the cognitive burden on the user, and creating a more efficient human-machine interface. A more efficient input mechanism also requires less computing resources, thereby increasing battery life of the device.

The device 100 provides (402) a key on which is depicted at least one pair of open and close punctuation characters. In some embodiments, the key is a physical key (404) on a physical keyboard coupled to the portable multifunction device. Also in some embodiments. The physical keyboard contains at least one sensor (e.g., the sensors 374, FIG. 3B), e.g., for detecting contact and/or contact intensities of inputs on the key. As explained above in connection with FIG. 3B, in some embodiments, the keyboard 370 is communicatively coupled to the portable multifunction device 100 by one or more contacts (e.g., Smart Connect from Apple Computer, Inc. of Cupertino, Calif.), via a wired connection (e.g., USB, PS/2), or via a wireless communication link (e.g., optical, Bluetooth, Wi-Fi, or the like).

Having one physical key for multiple pairs of open and close punctuation characters allows a user to use the physical keyboard for punctuation entries without reaching up from the keyboard. Further, replacing multiple punctuation character keys on conventional keyboard with one dedicated punctuation character key saves space, thus making the improved keyboard suitable for portable multifunction devices.

In some embodiments (e.g., as depicted in FIG. 5A) both { } and [ ] are displayed (406) (e.g., printed, embossed, engraved, and/or raised) on a punctuation character key 378 of the physical keyboard 370. In some embodiments, the punctuation character key is a virtual key (408) displayed on the touch screen display 112. In some embodiments, one or more pairs of open and close punctuation characters can be displayed on one virtual key, e.g., both {and} are displayed on one virtual key, or both { } and [ ] are displayed on the same virtual key.

Having one virtual key for multiple pairs of open and close punctuation characters saves space and makes the improved keyboard more suitable for portable multifunction devices. Further, the methods and systems in accordance with embodiments described herein not only require fewer keys, but also reduce the cognitive burden on a user, e.g., the user only needs to remember one punctuation key for all punctuation entries and the user can locate an intended punctuation character through fewer inputs, thus producing a more efficient human-machine interface. For battery-operated devices, a more efficient input mechanism also requires less computing resources, thereby increasing the battery life of the device.

Having provided the punctuation character key, the device displays (410) editable content on the display and detects (412) a first input selecting the key. In response to detecting the first input selecting the key, the device determines (414) whether to insert an open or a close punctuation character. In accordance with a determination that an open punctuation character is to be inserted, the device displays (416) in the editable content the open punctuation character of the at least one pair of open and close punctuation characters, displays an insertion marker after the open punctuation character, and displays a close punctuation character adjacent the insertion marker opposite to the open punctuation character. In accordance with a determination to insert the close punctuation character, the device displays (418) the close punctuation character in the editable content on the display.

For example, in FIG. 5A, editable content 500 is displayed on the touch screen display 112 with an insertion marker 522 placed behind the phrase “Four score and seven.” In FIG. 5B, the device 100 detects an input 524-1 selecting the punctuation character key 378 labeled with both { } and [ ]. In response to detecting the input 524-1 and based on a determination to insert an open punctuation character, the device 100 displays the open bracket [511 followed by an insertion marker 522, and a close bracket] 533-1 adjacent the insertion marker 522, opposite to the open bracket [511.

In some embodiments, the close punctuation character displayed adjacent the insertion marker 522 and opposite to the open bracket is a ghost image of the close punctuation character to indicate a proposed placement of the close punctuation character into the editable content and to indicate that the close punctuation character has not been entered into the editable content yet. For example, in FIGS. 5B-5C, the displayed close bracket] has a different appearance from the open bracket [511, e.g., the ghost image is displayed in lighter color. The display of the ghost image indicates a possible placement of the close bracket] and indicates that the close bracket] has not been inserted into the editable content yet, and will not be inserted until the device 100 receives another input 524-2 (FIG. 5D) on the punctuation character key 378, after which an actual close punctuation character replaces the ghost image at the position of the ghost image when the key 378 is pressed. As shown in FIGS. 5C and 5D, after entering notes “today we'd say eighty-seven” after the open bracket [511, the lighter colored close bracket] 533-1 is placed after the word “eighty-seven” to indicate a possible placement of the close bracket, and the ghost image is replaced by the real close bracket 533-2 after the word “eighty-seven” in response to the press 524-2 on the punctuation character key 378. The replacement close bracket] 533-2 has the same appearance as the open bracket [511.

Referring back to method 400, in FIG. 4B, in some embodiments, determining whether to insert the open or the close punctuation character includes (420) automatically determining whether to insert the open or close punctuation character based on context. In some embodiments, the context includes (422) a count of open and/or close punctuation characters in the editable content. In some embodiments, the context includes (424) a last entered punctuation character of a same type in the editable content. In some embodiments, the context includes (426) a second input detected substantially simultaneously with the first input.

For example, in FIG. 5B, in response to the press 524-1 on the punctuation character key 378, based on a count of zero open brackets and/or a count of zero close brackets in the editable content 500, the device automatically determines that the open bracket 511 should be inserted into the editable content 500. Subsequently, in FIG. 5D, in response to the press 524-2 on the punctuation character key 378, and based on a count of one open bracket and/or a count of zero close brackets, or based on the last entered bracket being the open bracket 511, the device automatically determines that the close bracket 533-2 should be inserted into the editable content 500. Although not shown in FIGS. 5C-5D, in some embodiments, in response to a combination of a function key (e.g., the option key) and the punctuation character key 378, the device always enters one of the brackets, e.g., the close bracket.

Automatically determining whether to insert an open or close punctuation character in accordance with embodiments described herein reduces the cognitive burden on a user, thus producing a more efficient human-machine interface. For battery-operated devices, a more efficient input mechanism also requires less computing resources, thereby increasing the battery life of the device.

Referring back to method 400, in FIG. 4B, in some embodiments, determining whether to insert the open or the close punctuation character occurs automatically based on context, including (428) the steps: (A) in response to detecting a first deep press as the first input of the key, displaying on the display multiple affordances each associated with a pair of open and close punctuation characters; (B) detecting a second input selecting an affordance from the multiple affordances; and (C) in response to detecting the second input, automatically determining whether to insert the open or the close punctuation character based on context. In some embodiments, the multiple affordances are scrollable (430).

For example, in FIG. 5E, the device detects a deep press 524-3 as a first input on the punctuation character key 378, such that the contact intensity exceeds the deep press threshold IT_{D} (as shown in intensity diagram 506). In response to detecting the deep press 524-3, the device displays multiple affordances 540-544, each associated with a pair of open and close punctuation characters. In some embodiments, the multiple affordances 540-544 are contained in a list of scrollable punctuation characters, and at least part of the list is displayed on the touch screen 112 overlaying the editable content 500. In some embodiments, the overlay is translucent to partially display the editable content 500. In some embodiments, the list also includes other non-paired characters, such as ˜, †, | etc., and is ordered such that the most frequently used punctuation characters are listed first and less frequently used characters can be displayed by scrolling through the list. In some embodiments, the frequency of the characters used is continually updated based on the user's actual usage.

Although FIG. 5E illustrates displaying a strip of punctuation characters at the bottom of the touch screen 112 in response to a deep press 524-3 on the punctuation character key 378, in some embodiments, other keys can be used to bring up a list of other punctuation characters. For example, as described in greater detail below, a multifunctional emoji key can provide a list of emoji characters and other special characters including punctuation characters for selection, thus allowing a user to write with the full range of characters. Further, in some embodiments, the punctuation character list is displayed automatically. For example, in response to detecting that the insertion marker is located adjacently behind a word in a sentence for a predetermined period of time, the device automatically displays the list of the punctuation characters to facilitate editing of the content.

Providing a list of punctuation characters for selection in response to a deep press on a dedicated punctuation key allows a single key to be used for a range of character entries. Thus, providing the dedicated punctuation key saves space and reduces the cognitive burden on a user, producing a more efficient human-machine interface and making the improved keyboards and methods described herein suitable for portable multifunction devices. For battery-operated devices, a more efficient input mechanism also requires less computing resources, thereby increasing the battery life of the device.

In some embodiments, as shown in FIG. 5E and further illustrated in FIGS. 5F and 5G, one pair of open/close brackets [ ] is associated with one virtual key 540, another pair of open/close brackets << >> is associated with a different virtual key 542, and a pair of curly brackets { } is associated with yet another virtual key 544. In both FIGS. 5F and 5G, the device detects a second input 524-4 selecting the virtual key 540, e.g., by a tap 524-4 on the touch screen 112 as shown in FIGS. 5F-5G, or through keyboard arrow key scrolling followed by pressing the return/enter key or spacebar (not shown). In response to detecting the input 524-4, the device automatically determines whether to insert an open bracket (e.g., FIG. 5F) or a close bracket (e.g., FIG. 5G) based on context. In FIG. 5F, based on a count of zero open brackets and/or a count of zero close brackets in the editable content 500, or based on no-known last entered bracket, the device inserts the open bracket into the editable content 500, while in FIG. 5G, based on a count of one open bracket and/or a count of zero close brackets in the editable content 500, or based on an open bracket being the last entered bracket, the device inserts the close bracket into the editable content 500.

Referring back to the method 400, in FIG. 4C, in some embodiments, determining whether to insert the open or the close punctuation character includes (432) the steps: (A) in response to detecting a first deep press as the first input of the key, displaying on the display multiple affordances each associated with a pair of open and close punctuation characters; (B) detecting a second input selecting an affordance from the multiple affordances; (C) in response to detecting the second input, displaying a first affordance associated with an open punctuation character and a second affordance associated with a close punctuation character; (D) detecting a third input selecting one of the first affordance or the second affordance; and (E) displaying in the editable content the open or close punctuation character based on the third input.

For example, after detecting a deep press 524-3 as a first input on the punctuation character key 378 (e.g., the contact intensity on the key 378 detected by the sensor(s) 374 exceeds a deep press threshold, IT_{D}), the device displays multiple affordances 540-544, each associated with a pair of open and close punctuation characters as shown in FIGS. 5H and 5I. In FIGS. 5H-5I, the punctuation characters are displayed as a scrollable list in order from the most to least frequently used, e.g., [ ] being more frequently used than << >> or { } by the user. Further shown in FIGS. 5H and 5, the device detects a second input 524-5 selecting the virtual key 542, e.g., by a tap, long press, deep press, or a long deep press (e.g., for a duration longer than a predetermined threshold) on the affordance 542 displayed on the touch screen display 112. Though FIGS. 5H and 5I illustrate the second input 524-5 on the touch screen display 112, in some embodiments, the second input is detected on the physical key 378 (FIG. 5E). In response to detecting the second input 524-5, as shown in FIG. 5I, the device splits the affordance 542 into two affordances by displaying a first affordance 542-1 associated with the open bracket << and a second affordance 542-2 associated with the close bracket >>. In FIG. 5I, the device further detects a third input 524-6, e.g., by tapping on the second affordance 542-2. In some embodiments, the second input 524-5 and the third input 524-6 are portions of a single input, e.g., while the second input 524-5 remains in contact with the touch screen 112, sliding the finger to move the contact to the location corresponding to the second affordance 542-2, and the third input 524-6 corresponds to a lift-off of the contact from the touch screen 112 to select the second affordance 542-2. In response to selecting the second affordance 542-2 associated with the close bracket >>, the device displays in the editable content 500 the close bracket >>, as shown in FIG. 5J.

Splitting one affordance into two affordances for punctuation character entry in response to a deep press allows a single punctuation key to be used for a range of character entries. Thus, providing the dedicated punctuation key saves space and reduces the cognitive burden on a user, thus producing a more efficient human-machine interface and making the improved keyboards and methods described herein suitable for portable multifunction devices. For battery-operated devices, a more efficient input mechanism also requires less computing resources, thereby increasing the battery life of the device.

Referring back to method 400, in FIG. 4C, in some embodiments, the open or close punctuation character is displayed (434) in response to detecting one or more additional inputs. In other words, an automatic punctuation character entry based on context can be overwritten by one or more manual punctuation entries.

For example, in the example shown in FIGS. 5I-5J, the close punctuation character >> can be entered by itself even if the editable content does not contain any prior or paired punctuation character. In another example, a desired punctuation character can be entered through a sequence of key entries including: a first input on a key corresponds to a pair of open and close punctuation characters, a deletion of the punctuation character entered, and a second input on the same key corresponds to the pair of open and close punctuation characters. For example, after [is inserted into the editable content in response to an input on the punctuation character key, a user may want to change the open bracket [to a close bracket]. The user may delete the open bracket [just entered, and select the same punctuation character key immediately after. In response to detecting this key sequence, the device replaces the open bracket [with the close bracket].

Combining the automated punctuation character entry and manual entry, the methods and systems described herein reduce the cognitive burden on a user, thus producing a more efficient human-machine interface and making the improved keyboards and methods described herein suitable for portable multifunction devices. For battery-operated devices, a more efficient input mechanism also requires less computing resources, thereby increasing the battery life of the device.

It should be understood that the particular order in which the operations in FIGS. 4A-4C have been described is merely exemplary and is not intended to indicate that the described order is the only order in which the operations could be performed. One of ordinary skill in the art would recognize various ways to reorder the operations described herein. For brevity, these details are not repeated here.

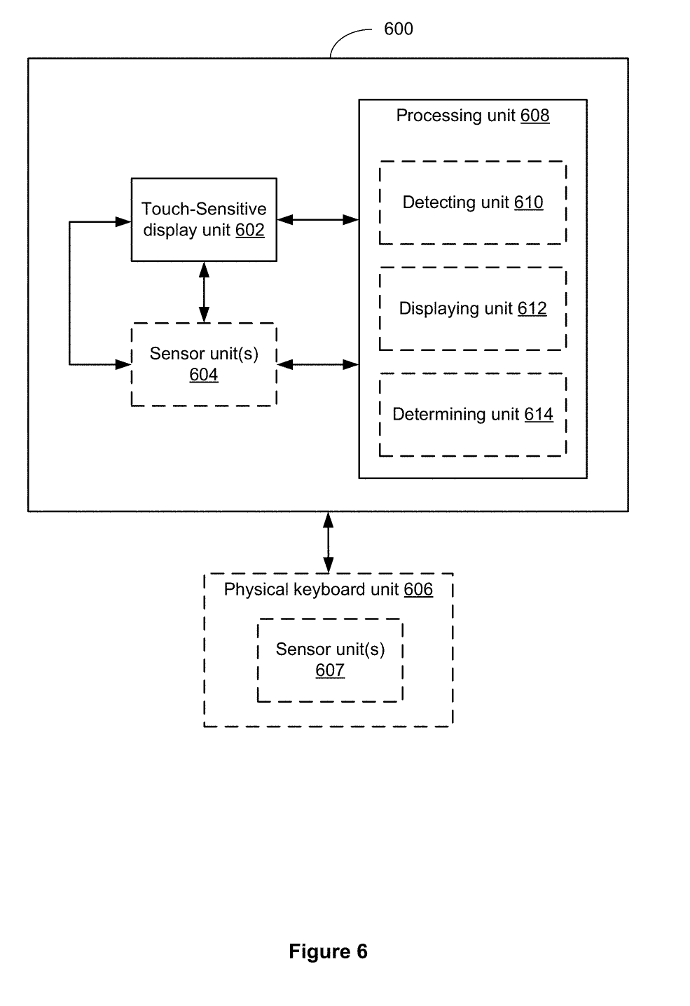

In accordance with some embodiments, FIG. 6 shows a functional block diagram of a portable multifunction device 600 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 6 are, optionally, combined or separated into sub-blocks to implement the principles of the various described embodiments. Therefore, the description herein optionally supports any possible combination or separation or further definition of the functional blocks described herein.

As shown in FIG. 6, a portable multifunction device 600 includes a touch-sensitive display unit 602 configured to display user interfaces (editable content on the display unit) and configured to detect touch inputs (contacts), and a processing unit 608 coupled with the touch-sensitive display unit 602. In some embodiments, processing unit 608 includes one or more of the following sub-units: detecting unit 610, displaying unit 612, and determining unit 614.

The processing unit 608 is configured to provide a key on which is depicted at least one pair of punctuation characters (e.g., open and close characters), facilitate the display of editable content on display unit 602, and detect (e.g., using detecting unit 610) a first input selecting the key. In some embodiments, processing unit 608 is configured to, in response to detecting (e.g., using detecting unit 610) the first input selecting the key, determine (e.g., using determining unit 614) which first punctuation character to insert (e.g., open or close character). The processing unit 608 is further configured to, in accordance with a determination of which first punctuation character to insert, cause the display (e.g., using displaying unit 612) to display the first punctuation character in the editable content, and, in some embodiments, an insertion marker after the first punctuation character. In some embodiments, the processing unit 608 is also configured to cause the display (e.g., using displaying unit 612) to display a second punctuation character adjacent the insertion marker and opposite to the first punctuation character. The second punctuation character can be displayed in ghost form, e.g., lighter or in outline as compared to the first punctuation character. The processing unit 608 is further configured to, in accordance with a determination to insert the first and/or second punctuation characters, cause the display (e.g., using displaying unit 612) of the second punctuation character in the editable content on display unit 602.

In some embodiments, the processing unit 608 enables display (e.g., using displaying unit 612) of both { } and [ ] on the key. In some embodiments, the key is a virtual key displayed on display unit 602. In some other embodiments, the key is a physical key on a physical keyboard coupled to the electronic device.

In some embodiments, determining (e.g., using determining unit 614) whether to insert the first or second (or open or close) punctuation character includes processing unit 608 automatically determining (e.g., using determining unit 614) whether to insert the first or second (or open or close) punctuation character based on context. In some embodiments, the context includes a count of first and/or second (or open and/or close) punctuation characters in the editable content. In some embodiments, the context includes a last entered punctuation character of a same type in the editable content. In some embodiments, the context includes a second input detected substantially simultaneously with the first input.

In some embodiments, determining (e.g., using determining unit 614) whether to insert the first or second (or open or close) punctuation character comprises: processing unit 608, in response to detecting a first deep press as the first input of the key, enabling display (e.g., using displaying unit 612) on display unit 602 of multiple affordances each associated with a pair of first or second (or open or close) punctuation character; detecting (e.g., using detecting unit 610) a second input selecting an affordance from the multiple affordances; and in response to detecting the second input, automatically determining (e.g., using determining unit 614) whether to insert the first or second (or open or close) punctuation character based on context.

In some embodiments, determining (e.g., using determining unit 614) whether to insert the first or second (or open or close) punctuation character comprises: processing unit 608, in response to detecting a first deep press as the first input of the key, enabling display (e.g., using displaying unit 612) on display unit 602 of multiple affordances each associated with a pair of first and second (or open and close) punctuation characters, detecting (e.g., using detecting unit 610) a second input selecting an affordance from the multiple affordances, in response to detecting the second input, enabling display (e.g., using displaying unit 612) of a first affordance associated with a first (or open) punctuation character and a second affordance associated with a second (or close) punctuation character, detecting (e.g., using detecting unit 610) a third input selecting one of the first affordance or the second affordance, and enabling display (e.g., using displaying unit 612) in the editable content of the first or second (or open or close) punctuation character based on the third input.

In some embodiments, the multiple affordances are scrollable.

In some embodiments, the processing unit 608 is configured to, in response to detecting one or more additional inputs, enable display of the first or second (or open or close) punctuation character.

The operations in the information processing methods described above are, optionally implemented by running one or more functional modules in information processing apparatus such as general purpose processors (e.g., as described above with respect to FIGS. 1A and 3A-3B) or application specific chips.

The operations described above with reference to FIGS. 4A-4C are, optionally, implemented by components depicted in FIGS. 1A-1B or FIG. 6. For example, detecting operations 610, displaying operations 612, and determining operations 614 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Emoji Key

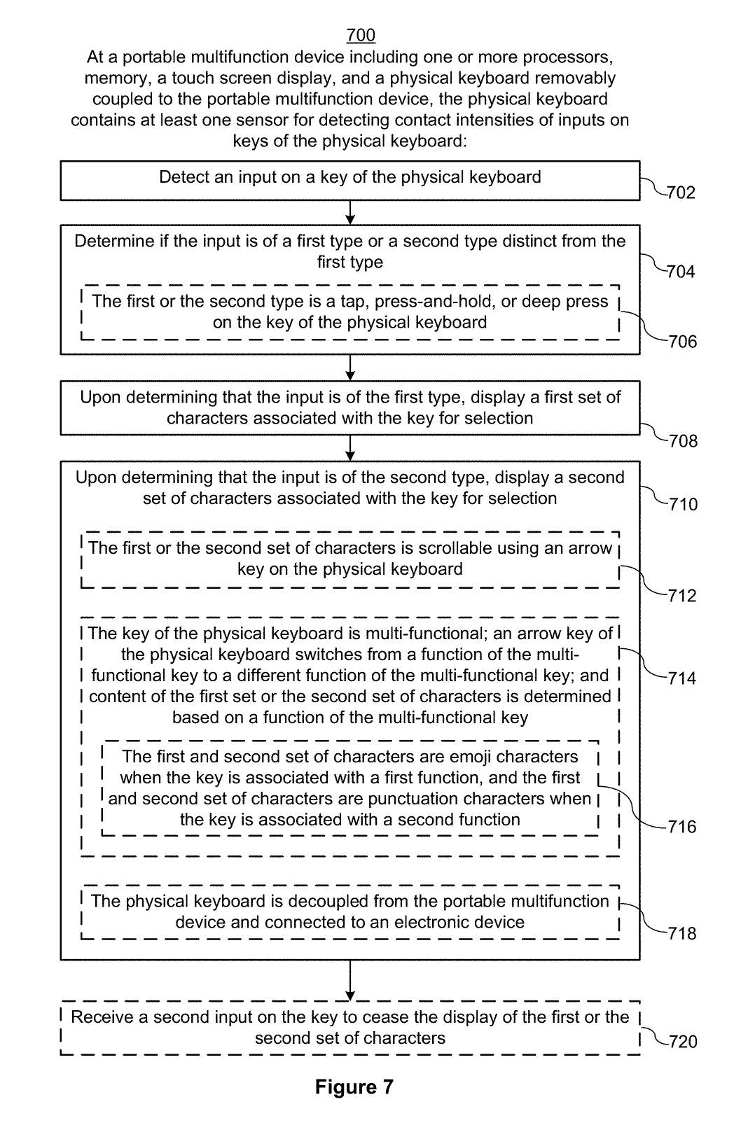

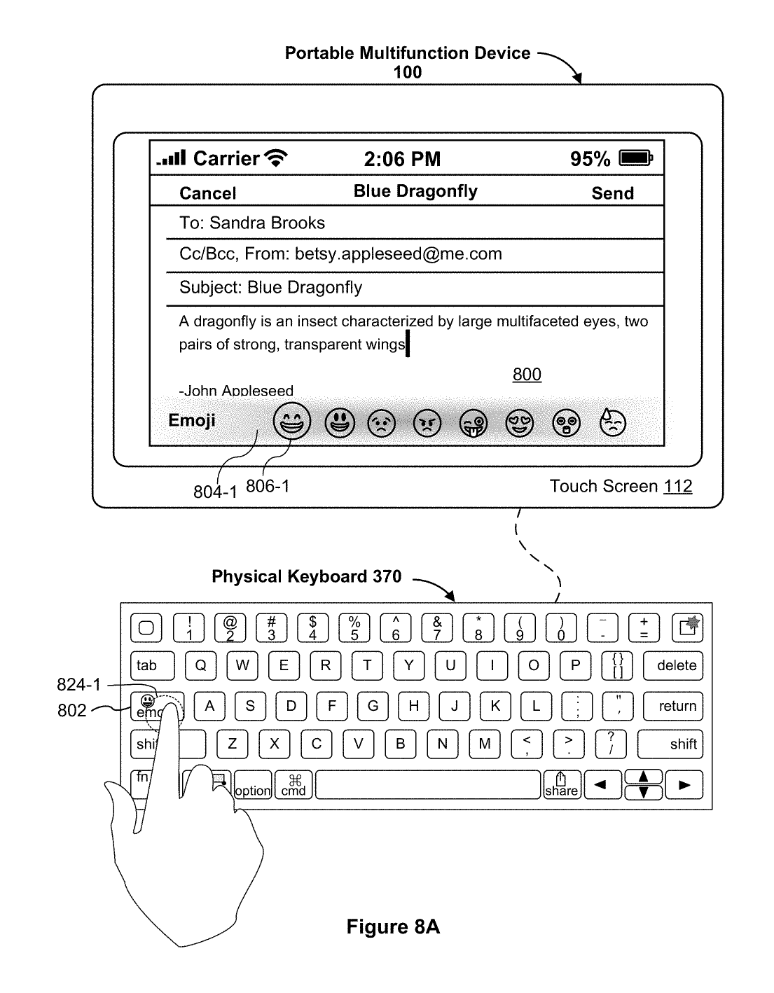

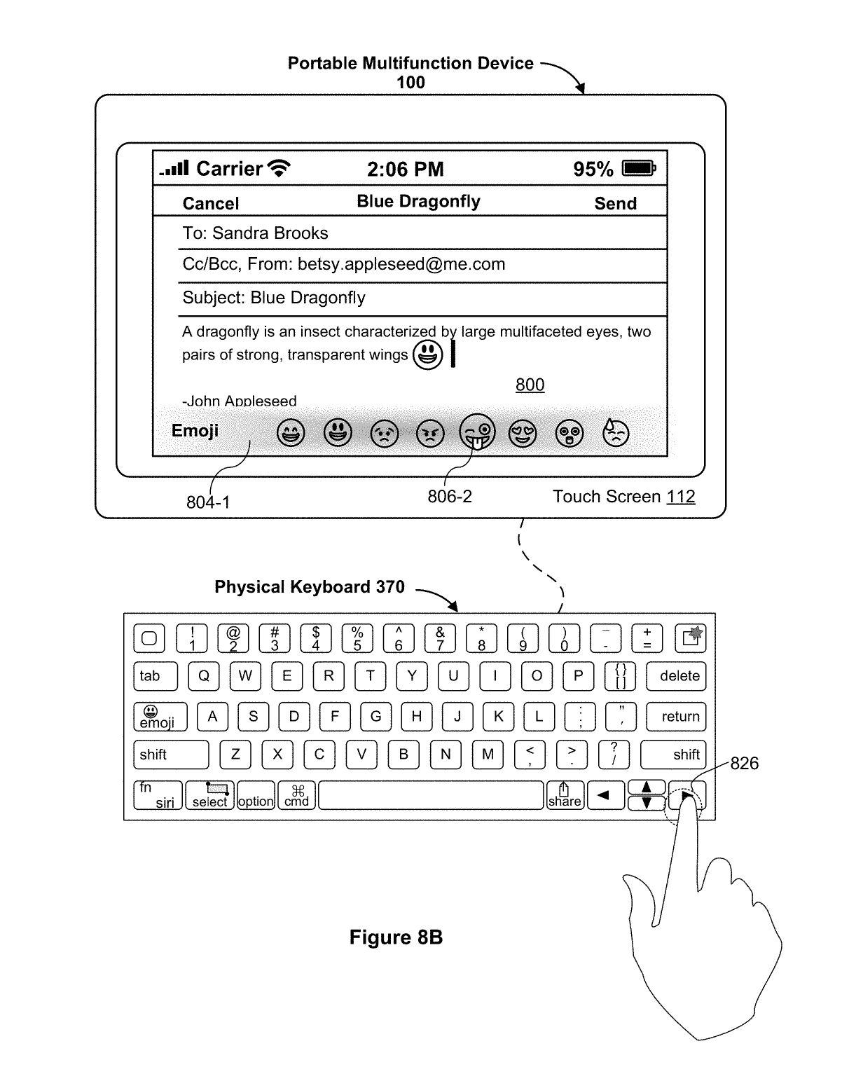

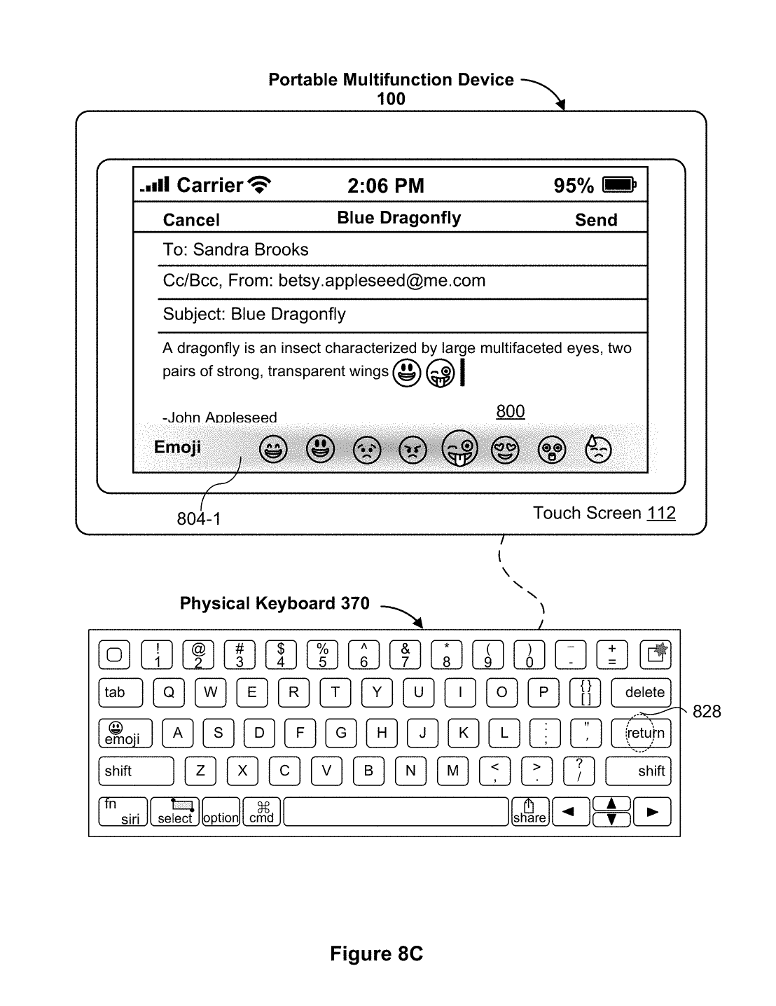

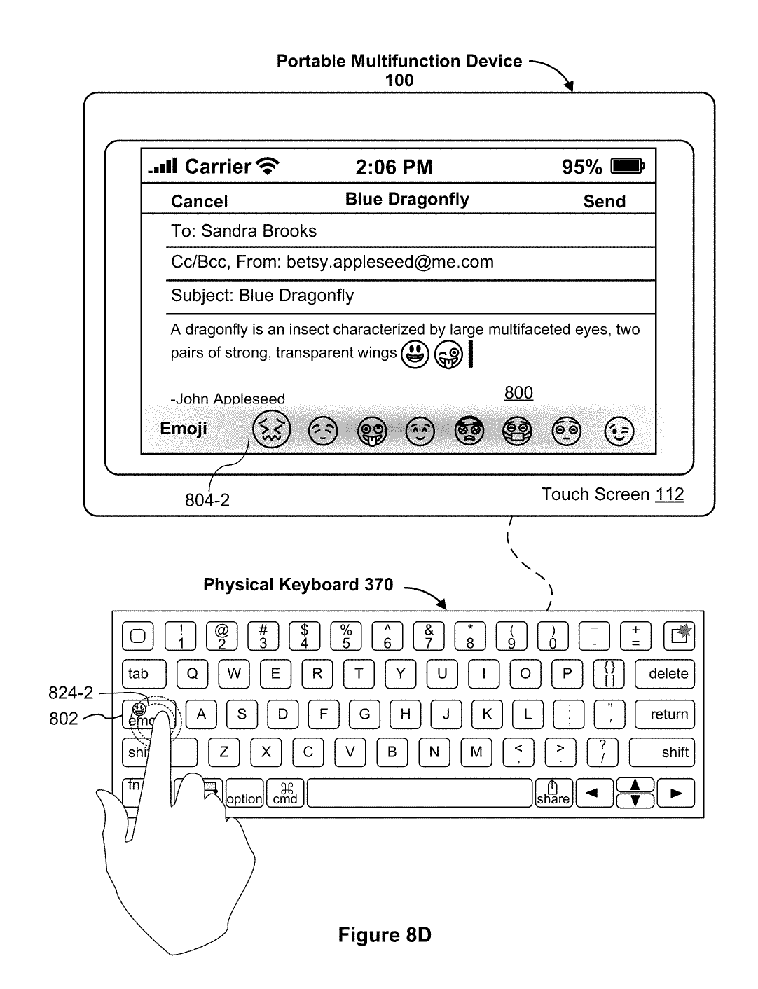

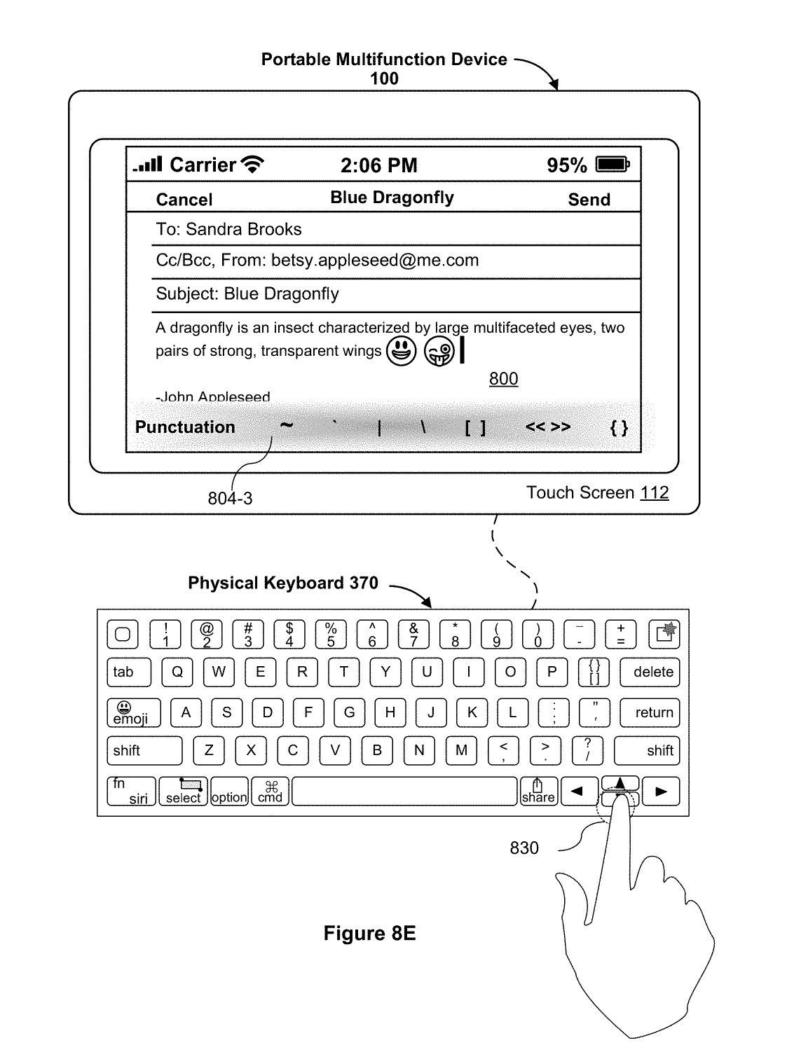

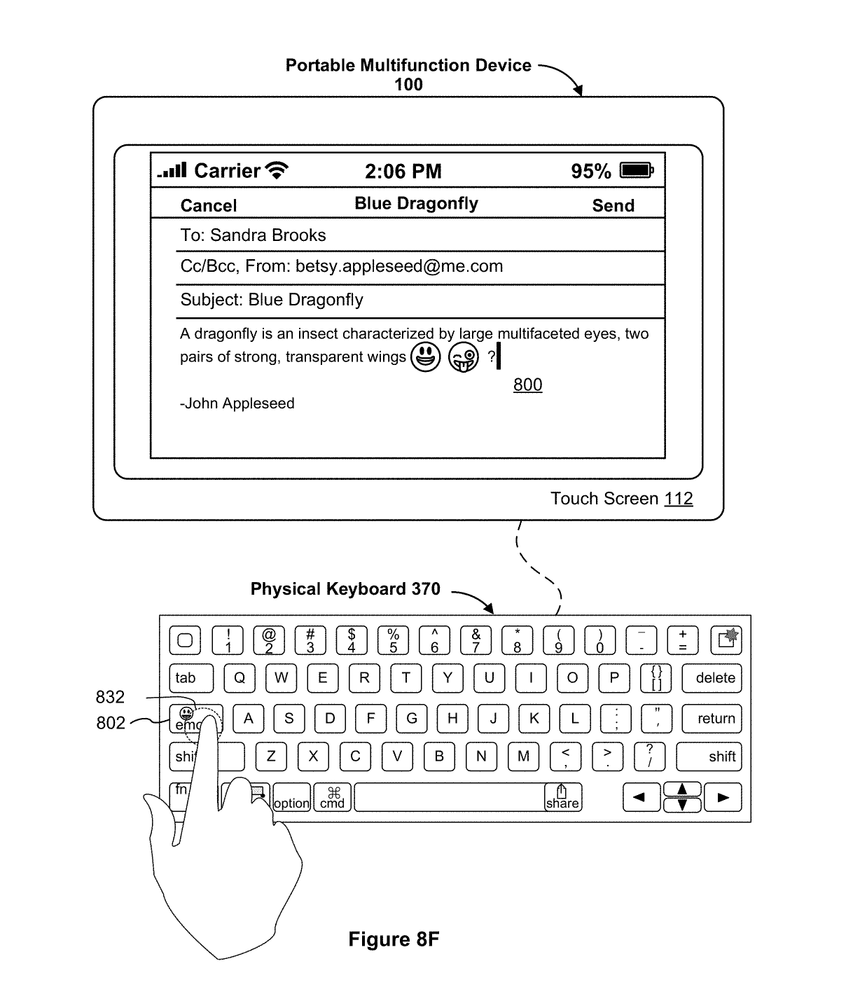

FIG. 7 is a flow chart illustrating a method 700 of character entry, in accordance with some embodiments. FIGS. 8A-8F, which illustrate exemplary user interfaces for emoji and punctuation character entry, are used to illustrate the processes in FIG. 7. The method 700 is performed at a portable multifunction device (e.g., the device 100 in FIG. 1A) with a touch-sensitive display (e.g., the touch screen display 112 in FIG. 1A) and a physical keyboard (e.g., the physical keyboard 370 in FIG. 3B) removably couple to the portable multifunction device. The physical keyboard contains at least one sensor (e.g., the sensors 374 in FIG. 3B) for detecting contact intensities of inputs on keys of the physical keyboard. As explained above in connection with FIG. 3B, in some embodiments, the keyboard 370 is communicatively coupled to the portable multifunction device 100 by one or more electrical contacts (e.g., Smart Connect from Apple Computer, Inc. of Cupertino, Calif.), via a wired connection (e.g., USB, PS/2), or via a wireless communication link (e.g., optical, Bluetooth, Wi-Fi, or the like). In some embodiments, as shown in FIGS. 8A-8E, the device 100 provides a physical multifunction emoji key 802 on the physical keyboard 370.

As described below, the method 700 provides an efficient mechanism for entering emoji and punctuation characters at a portable multifunction device. This method is faster and easier to perform than conventional emoji and punctuation character entry methods and systems, e.g., conventional character entry through a conventional keyboard with multiple keys and key entries for entering desired emoji and/or punctuation characters. The method is also intuitive for users, thereby reducing the cognitive burden on the user, and creating a more efficient human-machine interface. A more efficient input mechanism also requires less computing resources, thereby increasing battery life of the device.

The device 100 detects (702) an input on a key of the physical keyboard and determines (704) if the input is of a first type or a second type distinct from the first type. In some embodiments, the first and second types are (706) a tap, press-and-hold, or a deep press on the key of the physical keyboard. For example, in FIG. 8A, an input 824-1 is detected on the emoji key 802 of the physical keyboard 370, the device 100 determines that the input 824-1 is a tap and classifies the input as a first type. In FIG. 8D, a different input 824-2 is detected on the emoji key 802 and the device 100 determines that the input 824-2 is a second type, e.g., press-and-hold or deep press.

Upon determining that the input is of the first type, the device displays (708) a first set of characters associated with the key for selection, and upon determining that the input is of the second type, the device displays (710) a second set of characters associated with the key for selection.

For example, in FIG. 8A, in response to determining that the input 824-1 on the emoji key 802 is the first type (e.g., tap) of input, a first set of characters 804-1 including common emojis is displayed for user selection. In another example, in FIG. 8D, in response to determining that the input 824-2 on the emoji key 802 is the second type (e.g., press-and-hold or deep press), a different set of characters 804-2 including less common or less frequently used characters is displayed for user selection. In some embodiments, the set of characters for display is personalized such that the commonly used emoji characters are determined based on the usage of a user of the device 100. In some embodiments, instead of an emoji key, any other suitable key can be provided. For example, in some embodiments, a general punctuation key is provided. The punctuation key is configured to receive two different types of inputs, in response to which the device will display two different associated sets of characters, e.g., different sets of punctuation characters.

Referring back to FIG. 7, in some embodiments, the first or the second set of characters is scrollable (712) using an arrow key on the physical keyboard. For example, in FIG. 8A, the device displays a smiley face emoji character 806-1 that is larger than other characters in the scrollable list of emoji characters. The larger size indicates that the smiley face character 806-1 can be entered into the editable content 800 in response to a selection input, e.g., a keyboard return key entry. In some embodiments, the set of emoji characters can be scrolled using the arrow keys and/or by receiving additional inputs (e.g., taps) on the emoji key 802. In FIG. 8B, in some embodiments, in response to one or more inputs 826 on the right arrow key, the device displays and highlights a different emoji character 806-2 (e.g., by displaying it larger than the other characters in the scrollable list) indicating that the character 806-2 can be entered into the editable content 800 in response to a selection input, e.g., a keyboard return key entry 828 as shown in FIG. 8C.

Though FIGS. 8A-8C illustrate scrolling and selecting the emoji characters using keyboard entries, alternatively, the user can reach up to the touch screen display 112 to scroll and select through touch screen entries. By using all keyboard entries, though, a user can use the portable multifunction device 100 without reaching up from the keyboard.

In some embodiments, the key of the physical keyboard is multi-functional (714) so that a user can enter a full range of characters. An arrow key of the physical keyboard allows the device to switch from one function of the multi-functional key to a different function, and the content displayed in the first or second set of characters is determined based on a function of the multi-functional key. In some embodiments, the first and second set of characters are (716) emoji characters when the selection of the key is associated with a first function, and the first and second set of characters are punctuation characters when the selection of the key is associated with a second function. For example, the emoji key 802 in FIG. 8D can be associated with both emoji and punctuation character entry functions, such that the same key can be used for both emoji and punctuation character entry. For example, after the key 802 was previously pressed and the set of emoji characters 804-2 was displayed for selection (FIG. 8D), in response to detecting an input 830 on the up or down arrow key on the keyboard (FIG. 8E), the device switches the function of the key 802 from emoji to punctuation character entry and displays a set of punctuation characters 804-3 for selection (FIG. 8E). In some embodiments, instead of using the arrow key to switch from one function of the multifunction key 802 to another function of the multifunction key 802, a configurable key combination is used. For example, a combination of the shift key and the multifunction key 802 can activate a different function of the multifunction key 802. As another example, the up/down arrow key can change display from one set of emoji characters to a different set of emoji characters with different colors, emotions, etc.

Having a multi-functional key for both emoji and punctuation characters entry saves space and reduces the size of the physical keyboard. Further, switching from one function of the key to another function of key using an arrow key (e.g., an up arrow key) provides an efficient way of selecting the desired function for character entry. Methods and systems described herein thus provide faster and easier emoji and punctuation character entry than conventional methods and systems, e.g., conventional emoji and punctuation character entry through a conventional keyboard with multi keys and key entries for entering desired emoji or punctuation characters. Further, allowing the user to toggle different functions of the multifunction key using the arrow key is intuitive for users, thereby reducing the cognitive burden on the user, and creating a more efficient human-machine interface. A more efficient input mechanism also requires less computing resources, thereby increasing battery life of the device.

Referring back to FIG. 7, in some embodiments, the physical keyboard is (718) decoupled from the portable multifunction device and connected to an electronic device. For example, the physical keyboard 370 as shown in FIG. 3B and FIGS. 8A-8F can be connected to a different electronic device that does not have a touch screen. When connecting to a different electronic device that does not have a touch screen, the multifunction keys on the physical keyboard 370 provide expanded functions, e.g., entry of emoji and punctuation characters without resorting to other input methods and devices.

In some embodiments, the device further receives (720) a second input on the key to cease the display of the first or the second set of characters. For example, in FIG. 8F, the device receives a second input 832 on the emoji key 802. In response to detecting the second input 832, the device dismisses the punctuation or emoji character entry list 804. Alternatively, in other embodiments, subsequent inputs of the emoji key 802 causes the device 100 to scroll through the different characters displayed on the screen.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein. For brevity, these details are not repeated here.

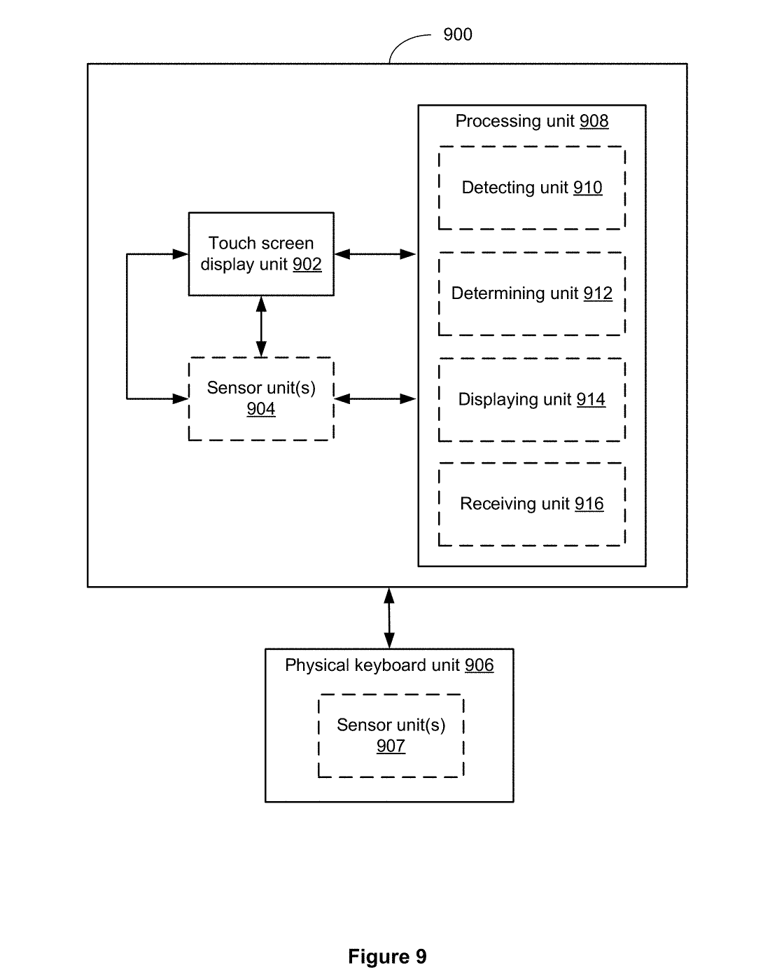

In accordance with some embodiments, FIG. 9 shows a functional block diagram of a portable multifunction device 900 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 9 are, optionally, combined or separated into sub-blocks to implement the principles of the various described embodiments. Therefore, the description herein optionally supports any possible combination or separation or further definition of the functional blocks described herein.

As shown in FIG. 9, a portable multifunction device 900 includes a touch-sensitive display unit 902 configured to display user interfaces (editable content on the display unit) and configured to detect touch inputs (contacts), and a processing unit 908 coupled with the touch-sensitive display unit 902. In some embodiments, the portable multifunction device includes one or more sensor units 904 and the processing unit 908 is coupled with the touch-sensitive display unit 902 and the one or more sensor units 904. In some embodiments, processing unit 908 includes one or more of the following sub-units: detecting unit 910, determining unit 912, displaying unit 914, and receiving unit 916. In some embodiments, the portable multifunction device 900 is removably coupled to a physical keyboard unit 906 (e.g., the physical keyboard 370), which further includes one or more sensor units 907 (e.g., the sensors 374, FIG. 3B).

The processing unit 908 is configured to detect (e.g., with the detecting unit 910) an input on a key of the physical keyboard unit 906. The processing unit 908 is configured to determine (e.g., with the determining unit 912) if the input is of a first type or a second type distinct from the first type. Upon determining that the input is of the first type, the processing unit 908 is configured to display (e.g., with the displaying unit 914) a first set of characters associated with the key for selection. Upon determining that the input is of the second type, the processing unit 908 is configured to display (e.g., with the displaying unit 914) a second set of characters associated with the key for selection.

In some embodiments, the first or the second type is a tap, press-and-hold, or deep press (e.g., detected with the one or more sensor units 907) on the key of the physical keyboard unit 906.

The processing unit 908 is further configured to receive (e.g., with the receiving unit 916) a second input on the key to cease the display of the first or the second set of characters.

In some embodiments, the first or the second set of characters is scrollable using an arrow key on the physical keyboard unit 906.

In some embodiments, the key of the physical keyboard unit 906 is multi-functional; an arrow key of the physical keyboard unit 906 switches from a function of the multi-functional key to a different function of the multi-functional key; and content of the first set or the second set of characters is determined based on a function of the multi-functional key.

In some embodiments, the first and second set of characters are emoji characters when the key is associated with a first function, and the first and second set of characters are punctuation characters when the key is associated with a second function.

In some embodiments, the physical keyboard unit 906 is decoupled from the portable multifunction device and connected to an electronic device.

The operations in the information processing methods described above are, optionally implemented by running one or more functional modules in information processing apparatus such as general purpose processors (e.g., as described above with respect to FIGS. 1A and 3A-3B) or application specific chips.

The operations described above with reference to FIGS. 8A-8F are, optionally, implemented by components depicted in FIGS. 1A-1B or FIG. 9. For example, detection operation 910, determining operation 912, displaying operation 914, and receiving operation 916 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Currency Key

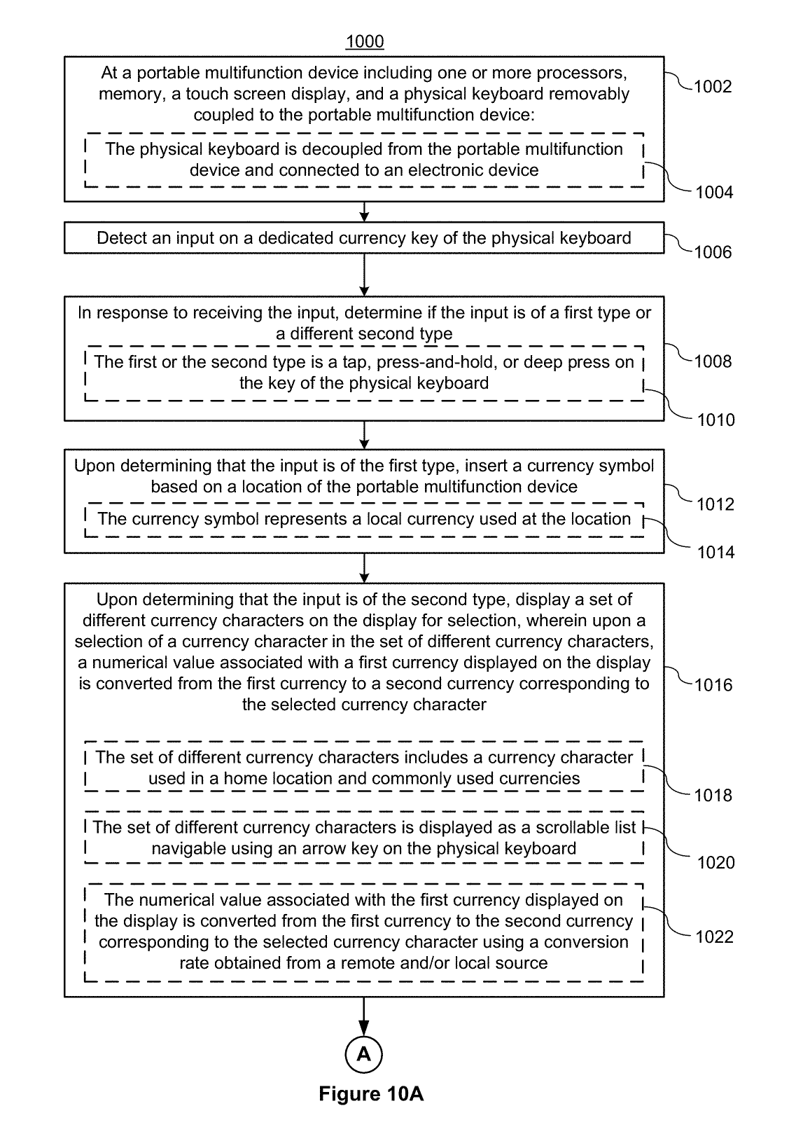

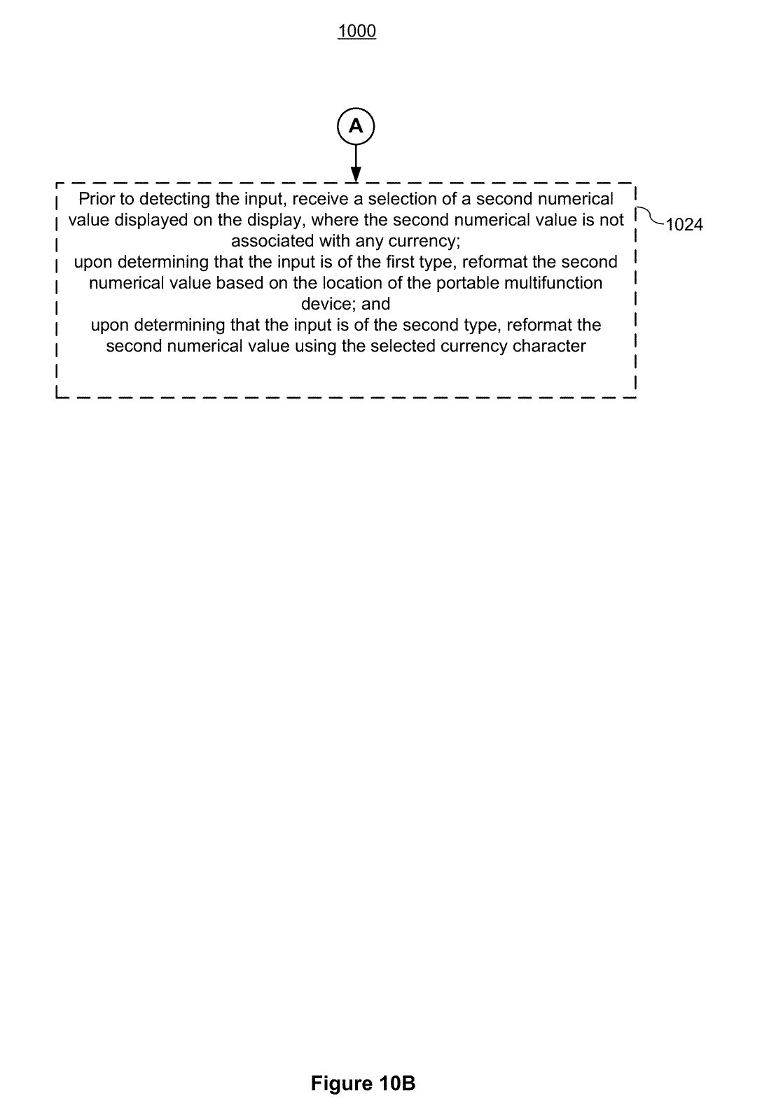

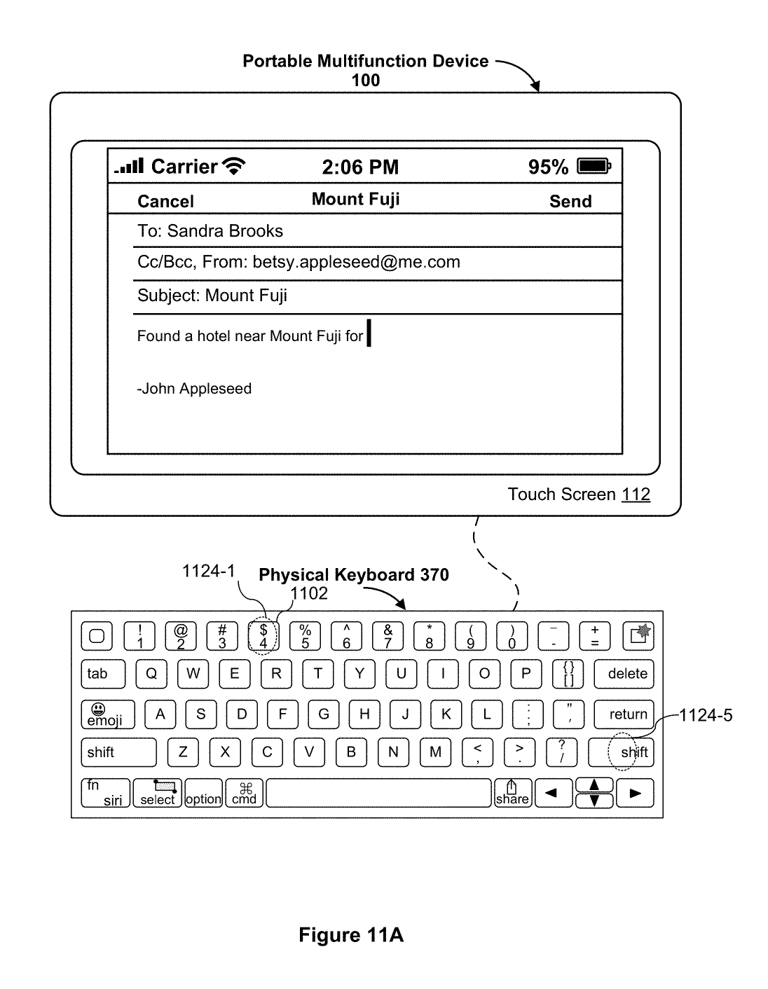

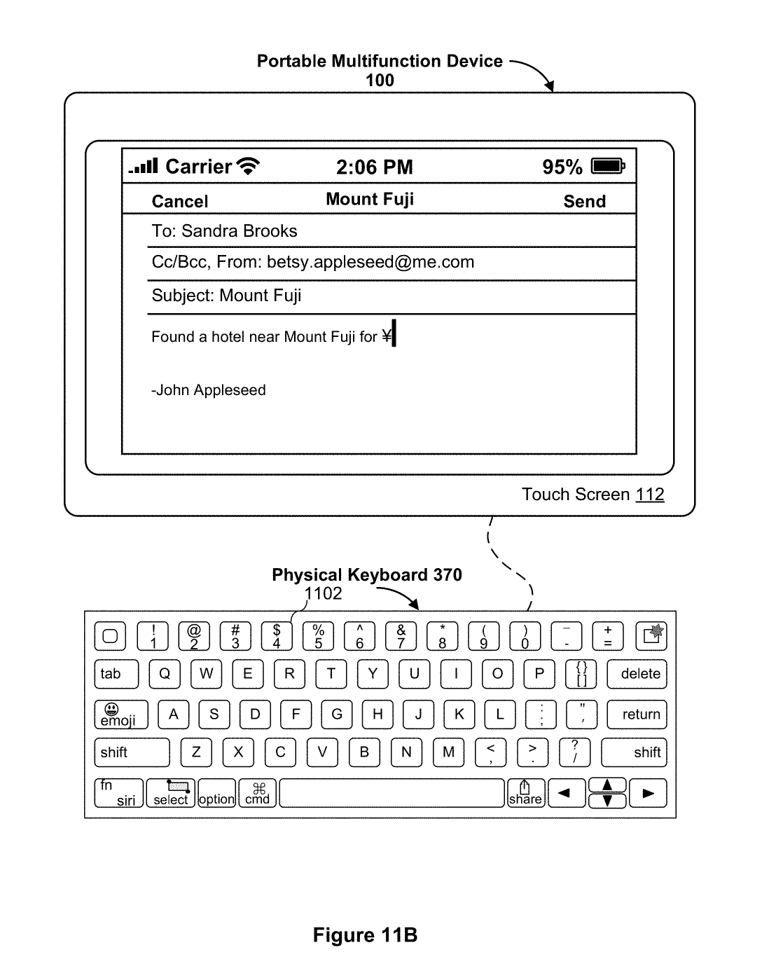

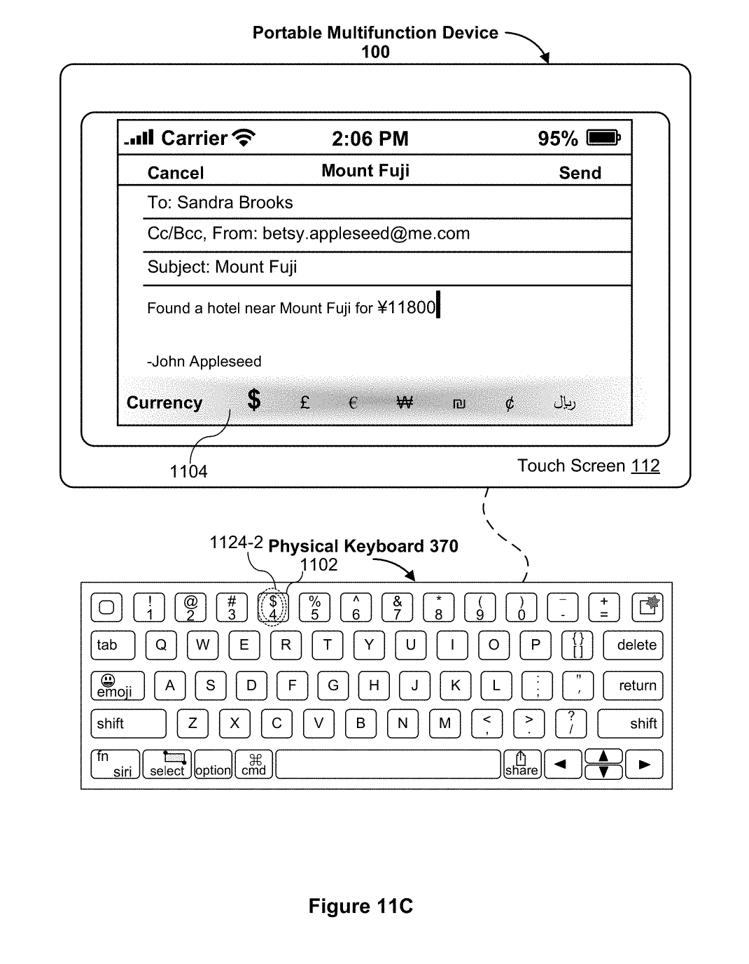

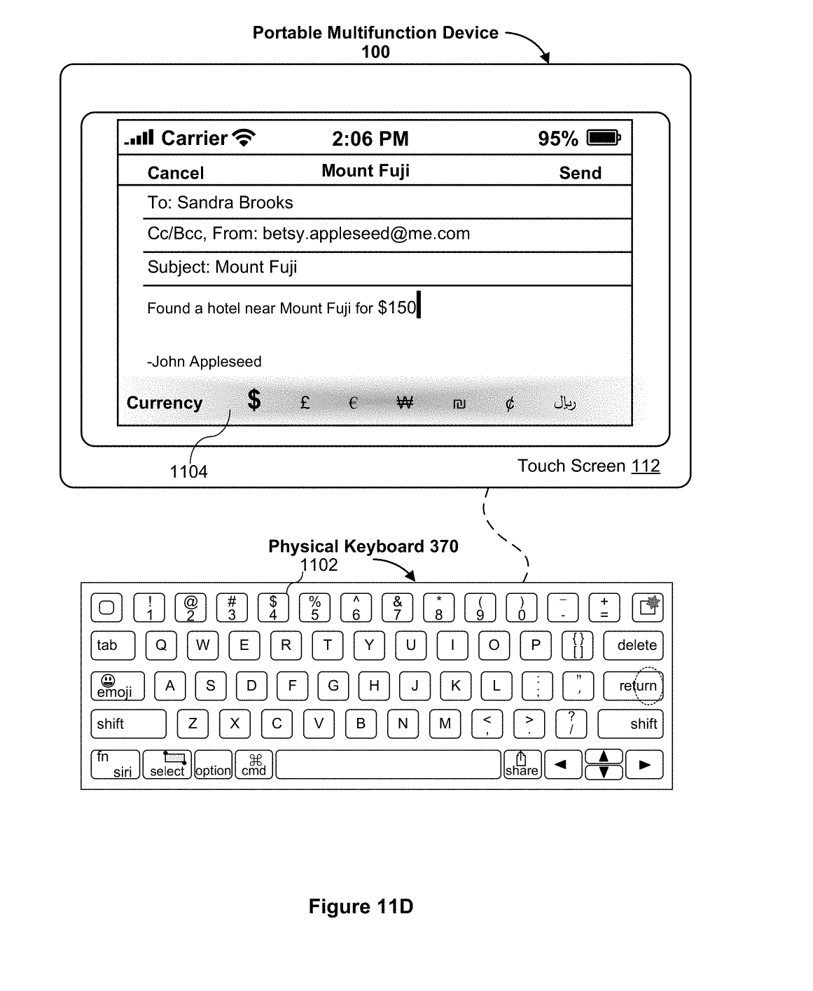

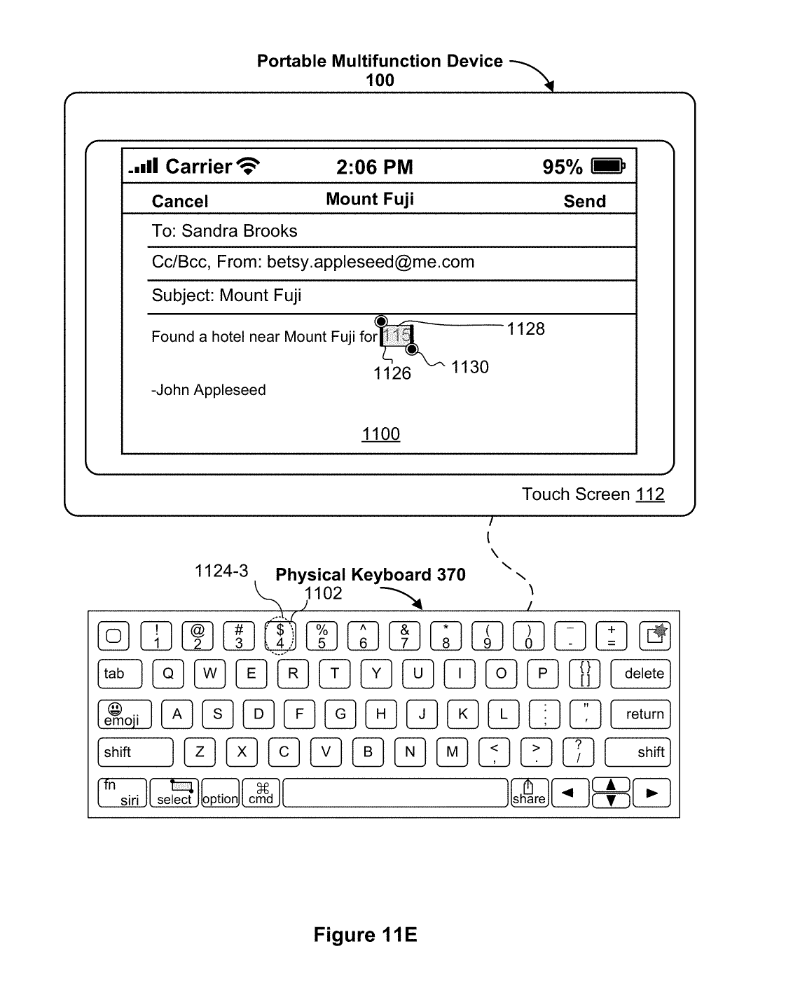

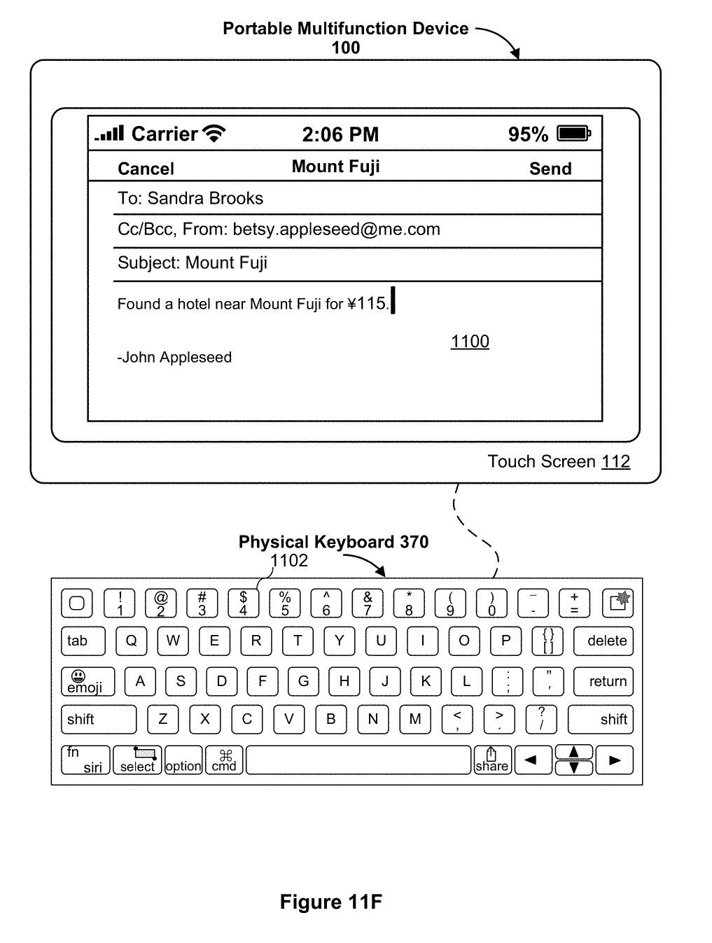

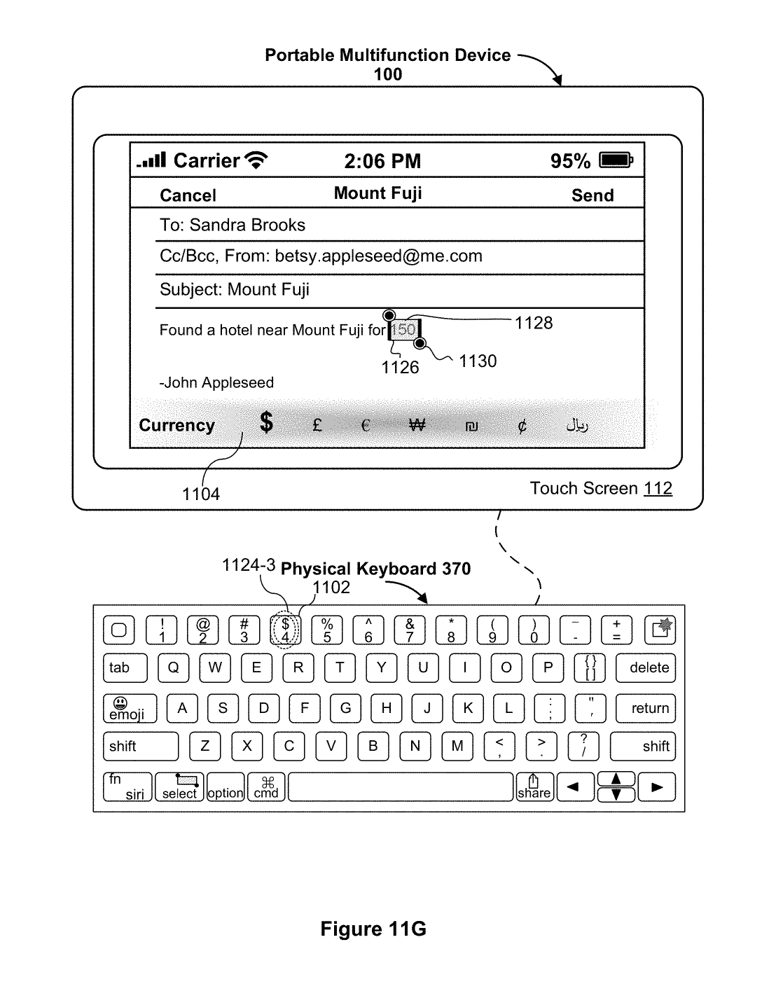

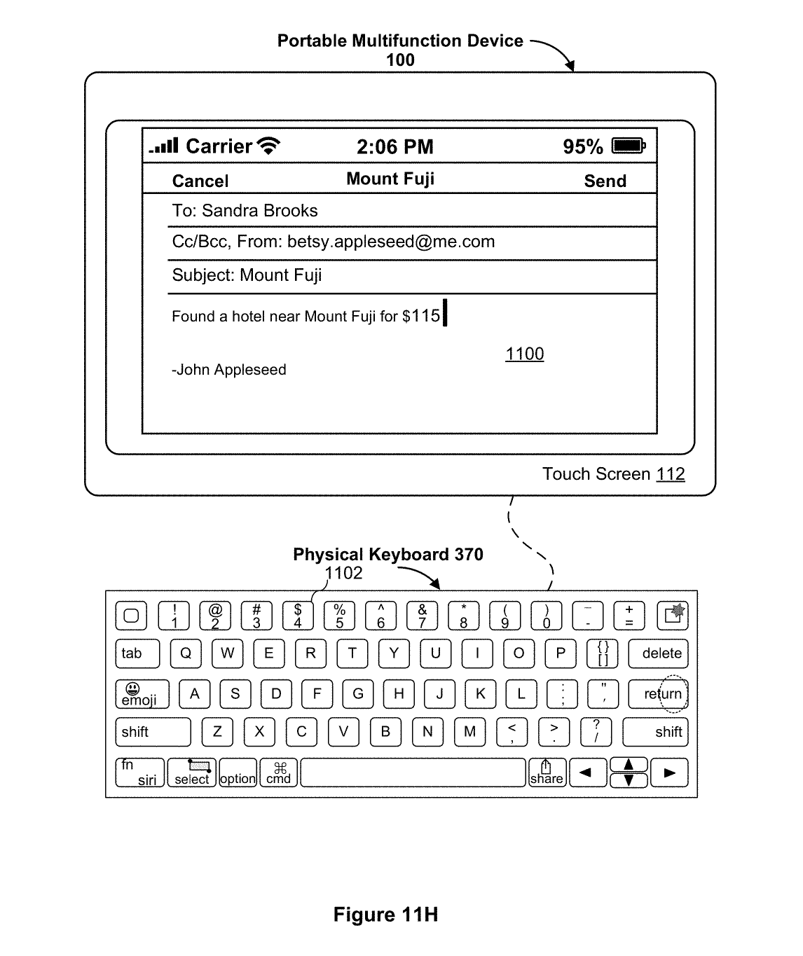

FIGS. 10A-10B are flow charts illustrating a method 1000 of currency character entry, in accordance with some embodiments. FIGS. 11A-11H, which illustrate exemplary user interfaces for currency character entry, are used to illustrate the processes in FIGS. 10A-10B. The method 1000 is performed (1002) at a portable multifunction device (e.g., the device 100 in FIG. 1A) with a touch-sensitive display (e.g., the touch screen display 112 in FIG. 1A) and a physical keyboard (e.g., the physical keyboard 370 in FIG. 3B) removably coupled to the portable multifunction device. The physical keyboard contains at least one sensor (e.g., the sensor 374, FIG. 3B) for detecting contact intensities of inputs on keys of the physical keyboard. As explained above in connection with FIG. 3B, in some embodiments, the keyboard 370 is communicatively coupled to the portable multifunction device 100 by one or more contacts (e.g., Smart Connect from Apple Computer, Inc. of Cupertino, Calif.), via a wired connection (e.g., USB, PS/2), or via a wireless communication link (e.g., optical, Bluetooth, Wi-Fi, or the like). In some embodiments, the physical keyboard is (1004) decoupled from the portable multifunction device and connected to an electronic device. For example, the physical keyboard 370, as shown in FIG. 3B and FIGS. 11A-11H can be connected to a different electronic device that does not have a touch screen. When connecting to a different electronic device that does not have a touch screen, the multifunction keys on the physical keyboard 370 provide expanded functions, e.g., entering currency symbols and performing currency conversion without the user resorting to other input methods and devices. In some embodiments, as shown in FIGS. 11A-11H, the device 100 provides a physical multifunction currency key 1102. This physical multifunction currency key 1102 can be shared or dedicated, i.e., associated with only a currency function.

As described below, the method 1000 provides an efficient mechanism for currency functionality, such as automatic currency conversion and automatically selecting a local currency symbol, at a portable multifunction device. This method is faster and easier to perform than conventional currency entry methods and systems, e.g., conventional character entry through a conventional keyboard with multiple entries required to locate a local currency symbol and/or convert currency including a manual lookup of the appropriate currency conversion rate. The method is also intuitive for users, thereby reducing the cognitive burden on the user, and creating a more efficient human-machine interface. A more efficient input mechanism also requires less computing resources, thereby increasing battery life of the device.

The device 100 detects (1006) an input on the dedicated or shared currency key of the physical keyboard. For example, in FIG. 11A, the device detects an input 1124-1 on the dedicated physical currency key 1102 of the physical keyboard 370.

In response to receiving the input, the device determines (1008) if the input is of a first type or a different second type. In some embodiments, the first or the second type is (1010) a tap, press-and-hold (e.g., by measuring the duration of the press and comparing with a predetermined duration threshold), or deep press (e.g., by measuring the contact intensities of the press using the at least one contact intensity sensor contained in the physical keyboard 370 and comparing with a predetermined threshold, IT_{D}) on the key of the physical keyboard. An example is shown in FIG. 11A, which shows an input 1124-1 detected on the currency key 1102 of the physical keyboard 370 in conjunction with an input 1124-5 on the shift key. The device 100 determines that the input 1124-1 is a tap and classifies the input as a first type. In FIG. 11C, a different input 1124-2 is detected on the currency key 1102 and the device 100 determines that the input 1124-2 is a second type, e.g., press-and-hold or deep press.

Determining whether an input is, for example, a simple tap or a press-and-hold and accordingly providing different currency character entry is an efficient way of entering currency symbols and performing automated currency conversion. Methods and systems described herein are faster and easier to use than conventional currency entry methods and systems, e.g., conventional character entry through a conventional keyboard with multiple entries for entering currency appropriate for the context and manual lookup of a currency conversion rate. Further, providing a list of alternative currency symbols for selection reduces the cognitive burden on the user, and creates a more efficient human-machine interface. A more efficient input mechanism also requires less computing resources, thereby increasing battery life of the device.

Upon determining that the input is of the first type, the device inserts (1012) a currency symbol based on a location of the portable multifunction device. In some embodiments, the currency symbol represents (1014) a local currency used at the location. For example, in FIGS. 11A-11B, the portable multifunction device 100 may be located near Mount Fuji. In response to the input 1124-1 being a tap, the device inserts a Japanese Yen symbol Y, which represents the local currency used at Mount Fuji.

In some embodiments, the device determines the location of the portable multifunction device using data retrieved from GPS module 136, or the location associated with the global/public IP address assigned to the device. In some embodiments, the device determines the location of the portable multifunction device using keywords in the editable text, e.g., based on the text “Mount Fuji” in the editable content. The device further determines, e.g., based on information stored locally on the device or retrieved from a remote source that Yen is used as a local currency. In another embodiment, the device determines the type of currency to be converted into based on the context. For example, the device determines that surrounding text mentions Mount Fuji, which is in Japan, and as such it is likely that the conversion should be into Yen.

Upon determining that the input is of the second type, the device displays (1016) a set of different currency characters on the display for selection, wherein upon a selection of a currency character in the set of different currency characters, a numerical value associated with a first currency displayed on the display is converted from the first currency to a second currency corresponding to the selected currency character. In some embodiments, the set of different currency characters includes (1018) a currency character used in a home location and commonly used currencies. In some embodiments, the set of different currency characters is displayed (1020) as a scrollable list navigable using an arrow key on the physical keyboard. In some embodiments, the numerical value associated with the first currency displayed on the display is converted (1022) from the first currency to the second currency corresponding to the selected currency character using a conversion rate obtained from a remote and/or local source.

For example, in FIG. 11C, a set of different currency characters 1104 is displayed on the touch screen 112 in response to detecting the input 1124-2 on the currency key 1102. The set of currency characters 1104 includes a currency character used in the United States, e.g., $, that is determined to be the local currency used in a home location of the device 100. Further, commonly used currency characters such as the Pound sign £ and the Euro sign [symbol] are displayed. In some embodiments, the set of currency characters for display is personalized such that the commonly used currency characters are determined based on the usage on the device 100, e.g., the characters [symbol] , [symbol] , [symbol] , [symbol] in the set 1104 are the currency characters most often used by the user of the device 100. In some embodiments, as shown in FIG. 11C, the device determines that the numerical value 11800 is associated with the Yen symbol ¥. In FIG. 11D, the device responds to an input on the return key by selecting the $ symbol and uses a conversion rate obtained from a local and/or remote source to convert ¥11800 to $150. In some embodiments, the device periodically retrieves a set of currency conversion rates from a remote server and stores the set of currency conversion rates on a local repository of the portable multifunction device, so that the data can be retrieved faster locally when needed. In some embodiments, the device detects a network connection of the portable multifunction device of sufficient speed and retrieves the currency conversion rate from a remote source when a currency symbol is selected. In some embodiments, the currency conversion rate can be looked up on the remote source based on location(s) and/or currency symbol(s). For example, in FIG. 11D, the GPS data obtained from the portable multifunction device can be transmitted along with the selected symbol $ to a remote server for retrieval of a conversion rate between Yen and US Dollars. Alternatively, the combination of ¥ and the selected symbol $ may be transmitted to the remote server for the conversion rate lookup. As another alternative, the location obtained from the editable content (e.g., Mount Fuji) and the selected symbol $ may be transmitted to the remote server for the conversion rate lookup.

Referring back to method 1000, in FIG. 10B, in some embodiments, prior to detecting the input, the device receives (1024) a selection of a second numerical value displayed on the display, where the second numerical value is not associated with any currency. Upon determining that the input is of the first type, the device reformats the second numerical value based on the location of the portable multifunction device; and upon determining that the input is of the second type, the device reformats the second numerical value using the selected currency character.

For example, in FIG. 11E, a numerical value 115 is displayed in the editable content 1100 that is not associated with any currency symbol. The user selects the numerical value “115”, as indicated by the selection indicators 1126, 1128 and 1130. The device then detects an input 1124-3, e.g., a tap on the currency key 1102. In response to detecting the tap input 1124-3 that is of the first type, the device determines that the device is located in Japan and that the local currency for Japan is Y. In accordance with the determination, the device reformats the numerical value “115” by adding a Y symbol in front of the numerical value, as shown in FIG. 11F. On the other hand, as shown in FIG. 11G, in response to detecting a deep press or press-and-hold input 1124-3 on the currency key 1102 while the numerical value “115” is selected, the device displays a list of currency symbols for selection. In FIG. 11H, responsive to an input on the return key to select the $ symbol, the device inserts a $ symbol in front of the numerical value.

Automated currency conversion based on a location or context of the device provides an efficient way of entering appropriate currency symbols. Methods and systems described herein are faster and easier to use than conventional currency entry methods and systems, e.g., conventional character entry through a conventional keyboard with multiple entries for entering currency appropriate for the context and manual lookup of the currency conversion rate. Thus, such methods and systems reduce the cognitive burden on the user, and create a more efficient human-machine interface. A more efficient input mechanism also requires less computing resources, thereby increasing battery life of the device.

It should be understood that the particular order in which the operations in FIGS. 10A-10B have been described is merely exemplary and is not intended to indicate that the described order is the only order in which the operations could be performed. One of ordinary skill in the art would recognize various ways to reorder the operations described herein. For brevity, these details are not repeated here.

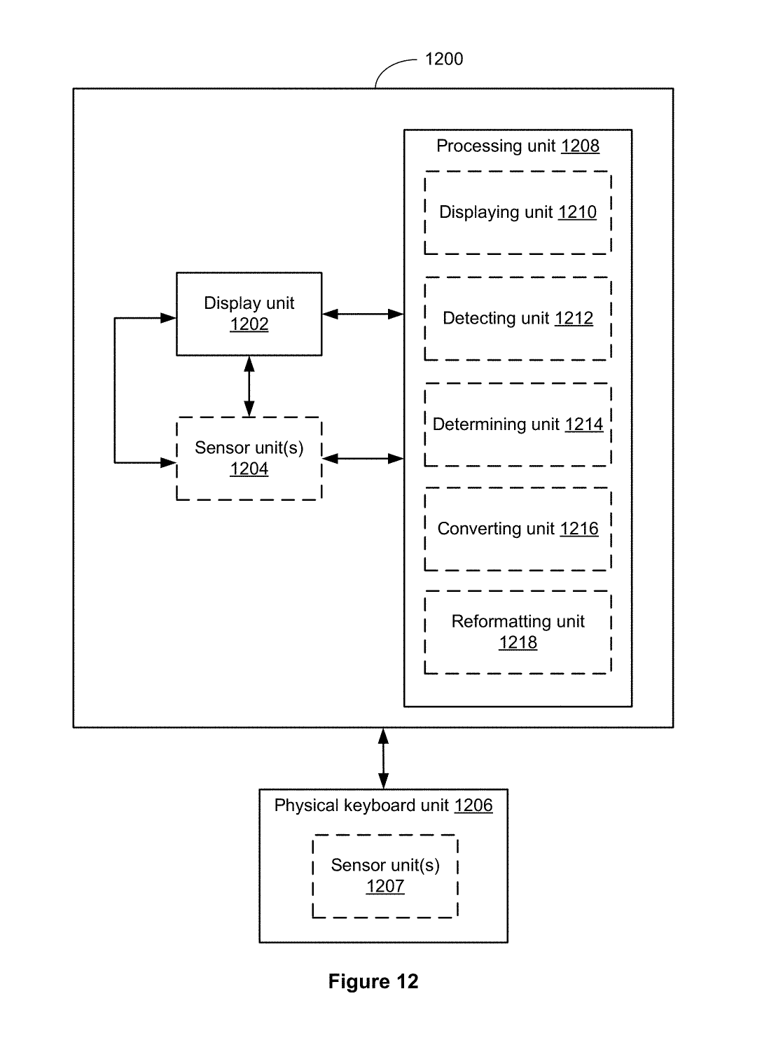

In accordance with some embodiments, FIG. 12 shows a functional block diagram of a portable multifunction device 1200 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 12 are, optionally, combined or separated into sub-blocks to implement the principles of the various described embodiments. Therefore, the description herein optionally supports any possible combination or separation or further definition of the functional blocks described herein.

As shown in FIG. 12, a portable multifunction device 1200 includes a touch-sensitive display unit 1202 configured to display user interfaces (editable content on the display unit) and configured to detect touch inputs (contacts), and a processing unit 1208 coupled with the touch-sensitive display unit 1202. In some embodiments, the portable multifunction device includes one or more sensor units 1204 and the processing unit 1208 is coupled with the touch-sensitive display unit 1202 and the one or more sensor units 1204. In some embodiments, processing unit 1208 includes one or more of the following sub-units: displaying unit 1210, detecting unit 1212, determining unit 1214, converting unit 1216, and reformatting unit 1216. In some embodiments, the portable multifunction device 1200 is removably coupled to a physical keyboard unit 1206 (e.g., the physical keyboard 370), which further includes one or more sensor units 1207 (e.g., the sensors 374, FIG. 3B).

The processing unit 1208 is configured to detect (e.g., with the detecting unit 1212) an input on a dedicated currency key of the physical keyboard unit. The processing unit 1208 is further configured to determine (e.g., with the determining unit 1214) if the input is of a first type or a different second type. Upon determining that the input is of the first type, the processing unit 1208 is configured to insert (e.g., with the displaying unit 1210) a currency symbol based on a location of the portable multifunction device. On the other hand, upon determining that the input is of the second type, the processing unit 1208 is configured to display (e.g., with the displaying unit 1210) a set of different currency characters on the display unit 1202 for selection, where upon a selection of a currency character in the set of different currency characters, a numerical value associated with a first currency displayed on the display is converted from the first currency to a second currency corresponding to the selected currency character.

In some embodiments, the physical keyboard unit is decoupled from the portable multifunction device and connected to an electronic device.

In some embodiments, the first or the second type is a tap, press-and-hold, or deep press on the dedicated currency key of the physical keyboard unit.

In some embodiments, the currency symbol represents a local currency used at the location.

In some embodiments, the set of different currency characters includes a currency character used in a home location and commonly used currencies.

In some embodiments, the set of different currency characters is displayed as a scrollable list navigable using an arrow key on the physical keyboard unit.

In some embodiments, the numerical value associated with the first currency displayed on the display is converted from the first currency to the second currency corresponding to the selected currency character using a conversion rate obtained from a remote and/or local source.

In some embodiments, the processing unit 1208 is further configured to, prior to detecting the input, receive a selection of a second numerical value displayed on the display unit, the second numerical value is not associated with any currency. Upon determining that the input is of the first type, the processing unit 1208 is configured to reformat (e.g., with the reformatting unit 1218) the second numerical value based on the location of the portable multifunction device; and upon determining that the input is of the second type, the processing unit 1208 is configured to reformat (e.g., with the reformatting unit 1218) the second numerical value using the selected currency character.

The operations in the information processing methods described above are, optionally implemented by running one or more functional modules in information processing apparatus such as general purpose processors (e.g., as described above with respect to FIGS. 1A and 3A-3B) or application specific chips.

The operations described above with reference to FIGS. 11A-11H are, optionally, implemented by components depicted in FIGS. 1A-1B or FIG. 12. For example, displaying operation 1210, detecting operation 1212, determining operation 1214, converting operation 1216, and reformatting operation 1218 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Contact Details Key

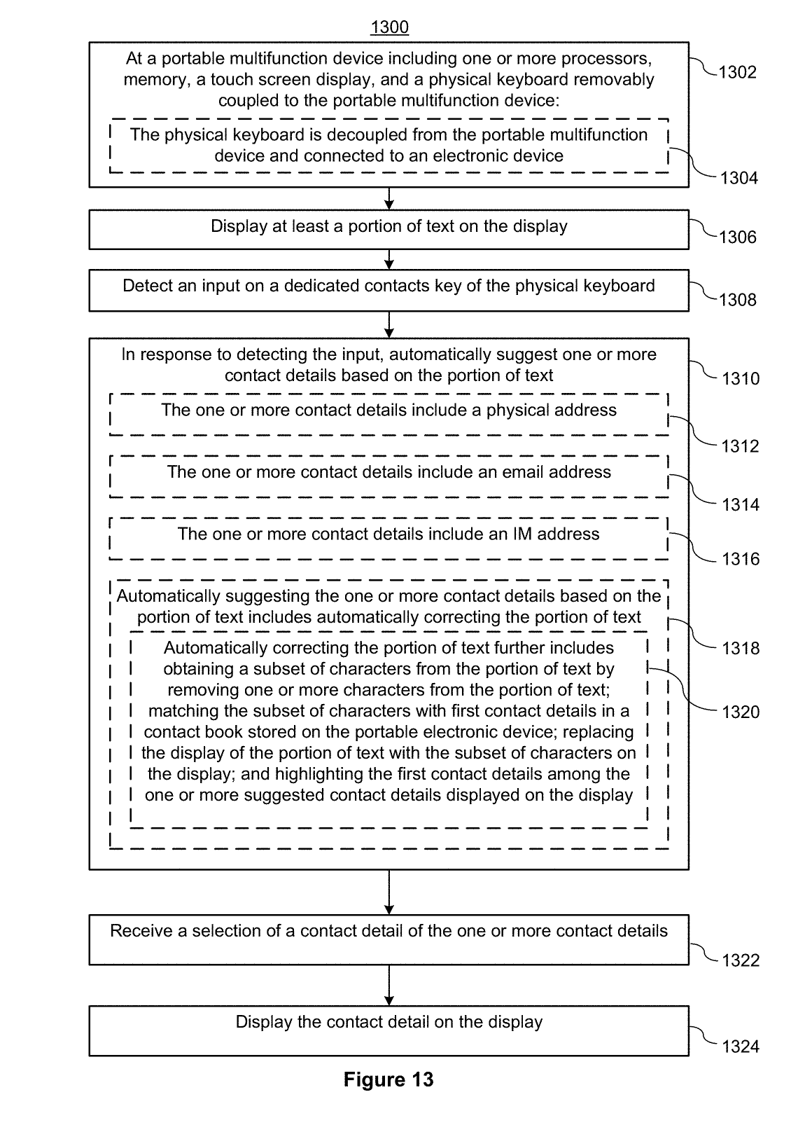

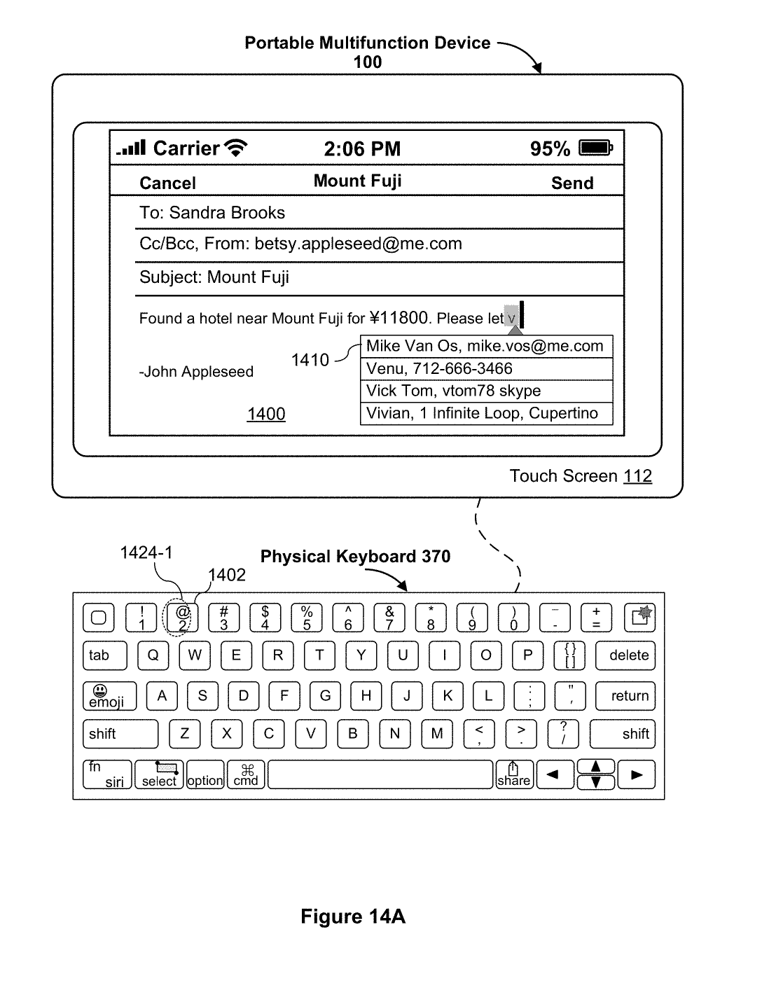

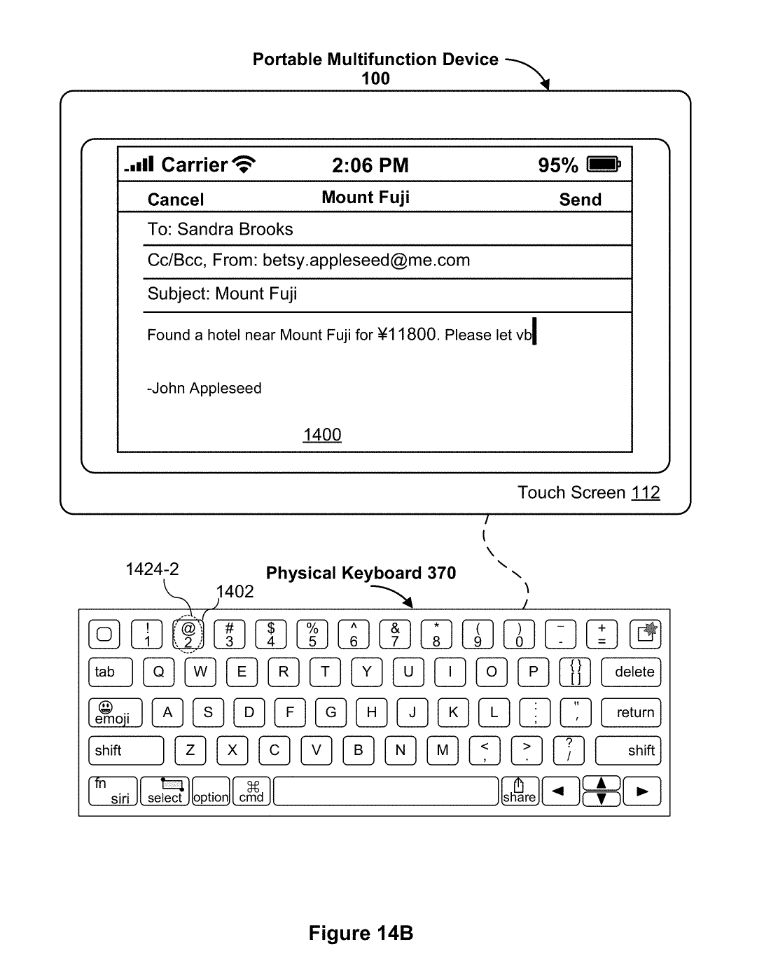

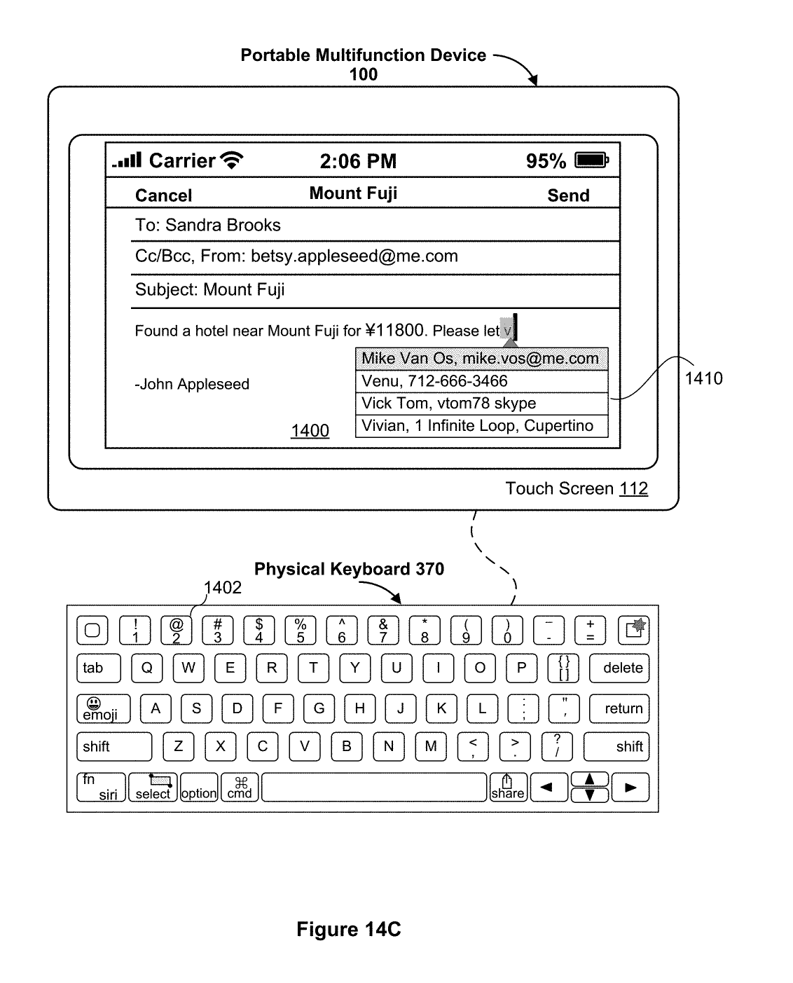

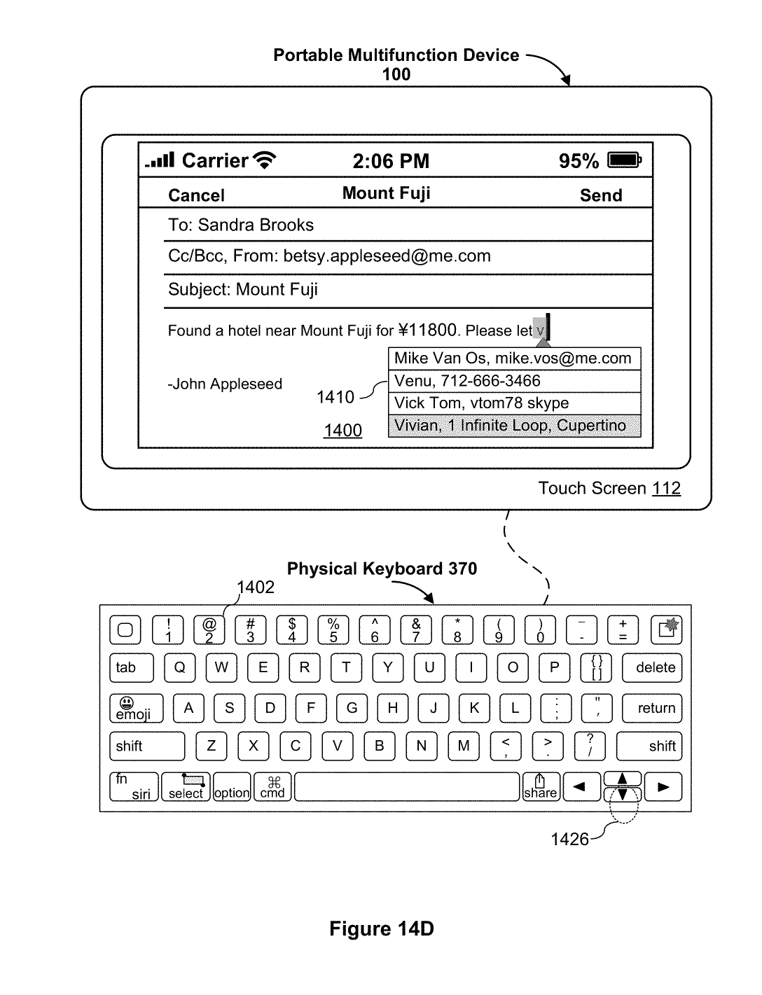

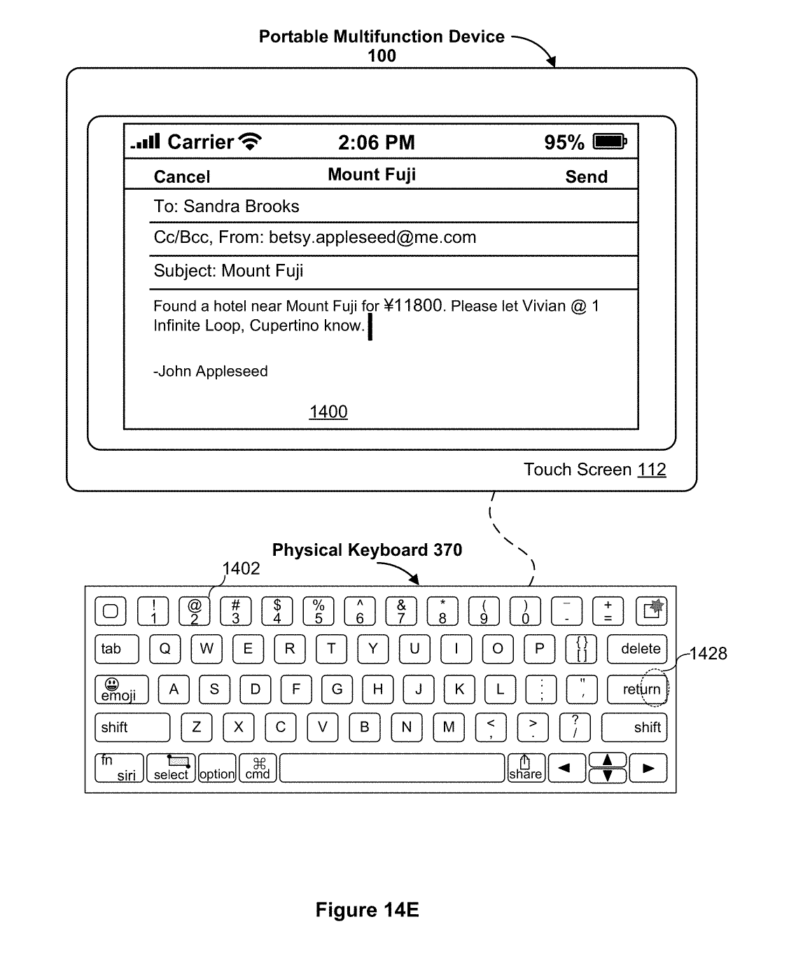

FIG. 13 is a flow chart illustrating a method 1300 of contact details entry, in accordance with some embodiments. FIGS. 14A-14E, which illustrate exemplary user interfaces for contact details entry, are used to illustrate the processes in FIG. 13. The method 1300 is performed (1302) at a portable multifunction device (e.g., the device 100 in FIG. 1A) with a touch-sensitive display (e.g., the touch screen display 112 in FIG. 1A) and a physical keyboard (e.g., the physical keyboard 370 in FIG. 3B) removably coupled to the portable multifunction device. As explained above in connection with FIG. 3B, in some embodiments, the keyboard 370 is communicatively coupled to the portable multifunction device 100 by one or more contacts (e.g., Smart Connect from Apple Computer, Inc. of Cupertino, Calif.), via a wired connection (e.g., USB, PS/2), or via a wireless communication link (e.g., optical, Bluetooth, Wi-Fi, or the like). In some embodiments, the physical keyboard is (1304) decoupled from the portable multifunction device and connected to an electronic device. For example, the physical keyboard 370 as shown in FIG. 3B and FIGS. 14A-14E can be connected to a different electronic device that does not have a touch screen. When connecting to a different electronic device that does not have a touch screen, the multifunction keys on the physical keyboard 370 provide expanded functions, e.g., entering contact details including both physical and electronic entries without the user resorting to other input methods and devices. In some embodiments, as shown in FIGS. 14A-14E, the device 100 provides a physical multifunction contacts key 1402 on the physical keyboard 370.

As described below, the method 1300 provides an efficient mechanism for entering contact details, such as addresses, at a portable multifunction device. This method is faster and easier to perform than conventional address entry methods and systems, e.g., conventional address entry through a conventional keyboard with multiple entries for entering contact details appropriate for the context. The method is also intuitive for users, thereby reducing the cognitive burden on the user, and creating a more efficient human-machine interface. A more efficient input mechanism also requires less computing resources, thereby increasing battery life of the device.

The device 100 displays (1306) at least a portion of text on the display, and subsequently detects (1308) an input on a dedicated or shared address key of the physical keyboard. In response to detecting the input, the device automatically suggests (1310) one or more contact details based on the portion of text. In some embodiments, the one or more contact details include (1312) any details for a contact in a user's contact book, including a phone number, a physical address (1312), an email address (1314), or an IM address (1316), etc.

For example, in FIG. 14A, a partial address “v” is entered into the editable content 1400 and displayed on the touch screen 112. In some embodiments, as shown in FIG. 14A, the partial address includes a word or a partial word that is closest to the cursor or preceding the cursor. In some embodiments, the partial address is content that has been selected and highlighted using one or more selection indicators. In some embodiments, the partial address does not need to be selected, and the text closest to the cursor is used. The device detects an input 1424-1, e.g., a tap on the dedicated or shared address key 1402 of the physical keyboard 370. In response to detecting the input 1424-1, the device automatically suggests a list of addresses 1410 based on the partial address “v” and displays the list 1410 adjacent (or near) the partial address “v”. In FIG. 14A, entries in the list 1410 comprise contact details that are associated with the partial address “v”, including but not limited to an email address “Mike Van Os, mike.os@me.com”, a phone entry “Venu, 712-666-3466”, a user name for a messenger or other communication medium “Vick Tom, vtom78 skype”, and/or a physical address “Vivian, 1 Infinite Loop, Cupertino.” Each of these contact details is related to the partial address, e.g., contains the letter “v” as part of the address. In some embodiments, the partial address used for deriving the list of suggested addresses is highlighted after the input on the dedicated address key 1402 to facilitate the editing of the partial address. In some embodiments, while the list of suggested contact details is displayed, further editing of the partial contact details dynamically updates the content of the list, e.g., one or more addresses may be added or removed from the list 1410 or the device may cease to display the list 1410 if the user completes entering the contact details.

Having a list of contact details based on a partial text entry that includes not only electronic addresses but also physical addresses expands the contact detail entry capacity of the physical keyboard. Conventional physical keyboards often do not provide a contacts key or suggest entering contacts associated with the contacts key. Thus, the method described herein provides an efficient mechanism for entering contact details at a portable multifunction device. By providing a list of suggestions, the method is also intuitive for users, thereby reducing the cognitive burden on the user, and creating a more efficient human-machine interface. A more efficient input mechanism also requires less computing resources, thereby increasing battery life of the device.

Referring back to FIG. 13, in some embodiments, automatically suggesting the one or more contact details based on the partial text includes (1318) automatically correcting the portion of text. In some embodiments, automatically correcting the portion of text further includes (1320) obtaining a subset of characters from the portion of text by removing one or more characters from the portion of text; matching the subset of characters with first contact details in a contact book stored on the portable electronic device; replacing the display of the portion of text with the subset of characters on the display; and highlighting the first contact details among the one or more suggested contact details displayed on the display.

For example, in FIG. 14B, a portion of text “vb” is entered into the editable content 1400 and displayed on the touch screen 112. The device detects an input 1424-2, e.g., a tap on the dedicated contacts key 1402 of the physical keyboard 370. In FIG. 14C, in response to detecting the tap 1424-2, the device automatically suggests a list of contact details 1410 based on the portion of text “vb” and automatically corrects the portion of text to “v” based on a determination that none of the contacts from a contact book match the portion of text “vb” and one or more of the contacts from the contact book match a subset of the portion of text “vb”, e.g. “v”. Further, email address “Mike Van Os, mike.os@me.com” in the list 1410 is highlighted to indicate that the email address is the suggested contact in the list 1410.

Automatic contact details correction provides an efficient mechanism for entering contact details, such as addresses, and assures that contact details are correctly entered. The method is also intuitive for users, as by pressing the contacts key, the user relies on the electronic device to look up entries in the contact book and suggest the best match, thereby reducing the cognitive burden on the user, and creating a more efficient human-machine interface. A more efficient input mechanism also requires less computing resources, thereby increasing battery life of the device.

In some embodiments, the list 1410 is scrollable, e.g., using the arrow keys on the keyboard 370 to scroll through and then select an entry in the list using a return key of the keyboard 370. Referring back to FIG. 13, the device further receives (1322) a selection of a contact detail of the one or more contact details and displays (1324) the contact detail on the display. As shown in FIG. 14D, instead of selecting the suggested first entry in the list 1410, the user scrolls through the list 1410 by pressing the arrow key. In response to detecting the input 1426 on the arrow key, the device highlights a different entry in the list 1410. In response to detecting the input 1428 on the return key, as shown in FIG. 14E, the device displays the selected physical address “Vivian, 1 Infinite Loop, Cupertino” in the editable content 1400. In some embodiments, once a contact detail is selected and entered into the editable content 1400, the list 1410 is dismissed.

It should be understood that the particular order in which the operations in FIG. 13 have been described is merely exemplary and is not intended to indicate that the described order is the only order in which the operations could be performed. One of ordinary skill in the art would recognize various ways to reorder the operations described herein. For brevity, these details are not repeated here.

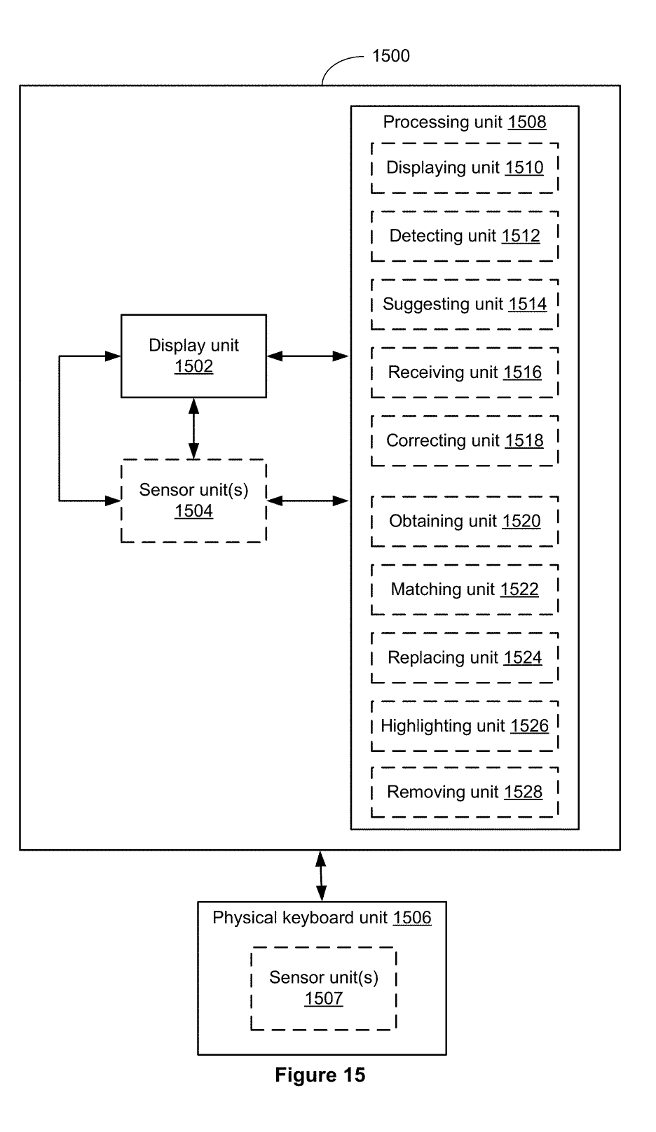

In accordance with some embodiments, FIG. 15 shows a functional block diagram of a portable multifunction device 1500 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 15 are, optionally, combined or separated into sub-blocks to implement the principles of the various described embodiments. Therefore, the description herein optionally supports any possible combination or separation or further definition of the functional blocks described herein.

As shown in FIG. 15, a portable multifunction device 1500 includes a touch-sensitive display unit 1502 configured to display user interfaces (editable content on the display unit) and configured to detect touch inputs (contacts), and a processing unit 1508 coupled with the touch-sensitive display unit 1502. In some embodiments, the portable multifunction device includes one or more sensor units 1504 and the processing unit 1508 is coupled with the touch-sensitive display unit 1502 and the one or more sensor units 1504. In some embodiments, processing unit 1508 includes one or more of the following sub-units: displaying unit 1510, detecting unit 1512, suggesting unit 1514, receiving unit 1516, correcting unit 1518, obtaining unit 1520, matching unit 1522, replacing unit 1524, highlighting unit 1526, and removing unit 1528. In some embodiments, the portable multifunction device 1500 is removably coupled to a physical keyboard unit 1506 (e.g., the physical keyboard 370), which further includes one or more sensor units 1507 (e.g., the sensors 374, FIG. 3B).

The processing unit 1508 is configured to display (e.g., with the displaying unit 1510) at least a portion of text on the display. The processing unit 1508 is further configured to detect (e.g., with the detecting unit 1512) an input on a dedicated contacts key of the physical keyboard unit 1506. In response to detecting the input, the processing unit 1508 is configured to automatically suggest (e.g., with the suggesting unit 1514) one or more contact details based on the portion of text. The processing unit 1508 is further configured to receive (e.g., with the receiving unit 1516) a selection of a contact detail of the one or more contact details; and display (e.g., with the displaying unit 1510) the contact detail on the display unit 1502.

In some embodiments, the physical keyboard unit 1506 is decoupled from the portable multifunction device and connected to an electronic device. In some embodiments, the one or more contact details include a physical address. In some embodiments, the one or more contact details include an email address. In some embodiments, the one or more contact details include an IM address. In some embodiments, automatically suggesting the one or more contact details based on the portion of text includes automatically correcting (e.g., with the correcting unit 1518) the portion of text.

In some embodiments, automatically correcting the portion of text includes (a) obtaining (e.g., with the obtaining unit 1520) a subset of characters from the portion of text by removing (e.g., the removing unit 1528) one or more characters from the portion of text; (b) matching (e.g., with the matching unit 1522) the subset of characters with first contact details in a contact book stored on the portable electronic device; (c) replacing (e.g., with the replacing unit 1524) the display of the portion of text with the subset of characters on the display unit 1502; and (d) highlighting (e.g., with the highlighting unit 1528) the first contact details among the one or more suggested contact details displayed on the display unit 1502.

The operations in the information processing methods described above are, optionally implemented by running one or more functional modules in information processing apparatus such as general purpose processors (e.g., as described above with respect to FIGS. 1A and 3A-3B) or application specific chips.

The operations described above with reference to FIGS. 14A-14E are, optionally, implemented by components depicted in FIGS. 1A-1B or FIG. 15. For example, displaying operation 1510, detecting operation 1512, suggesting operation 1514, receiving operation 1516, correcting operation 1518, obtaining operation 1520, matching operation 1522, replacing operation 1524, highlighting operation 1526, and removing operation 1528 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Dedicated Home Key

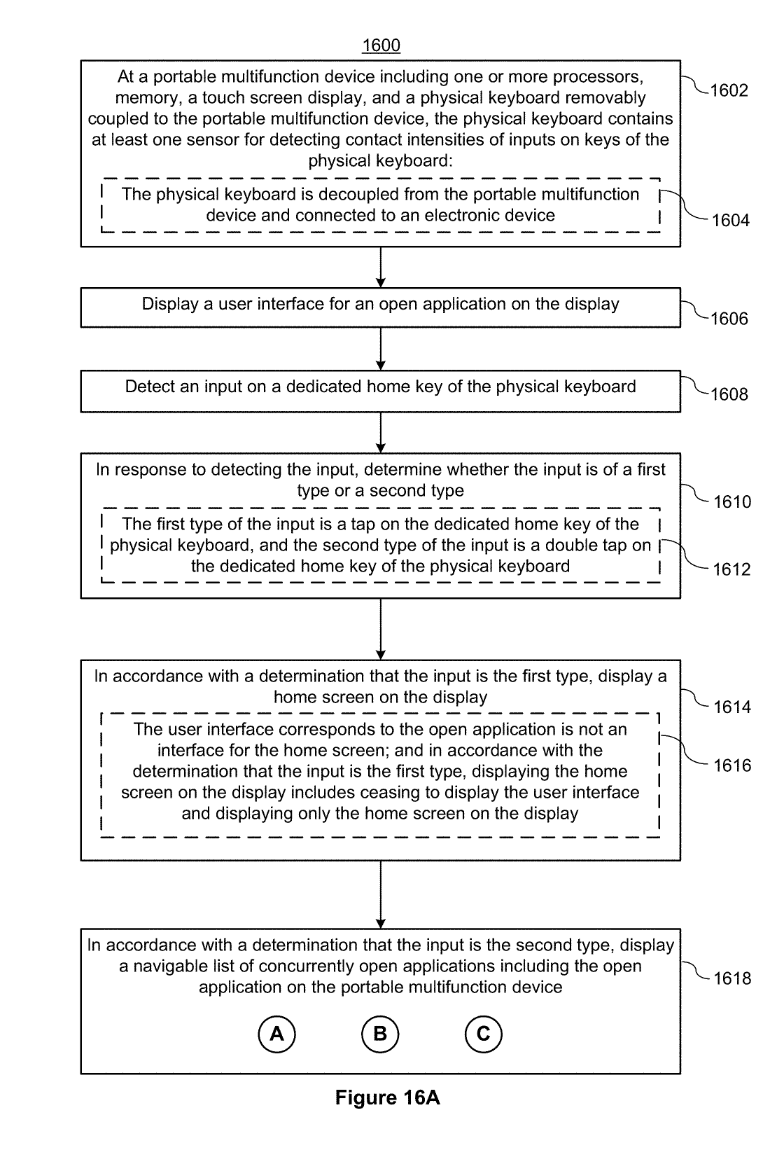

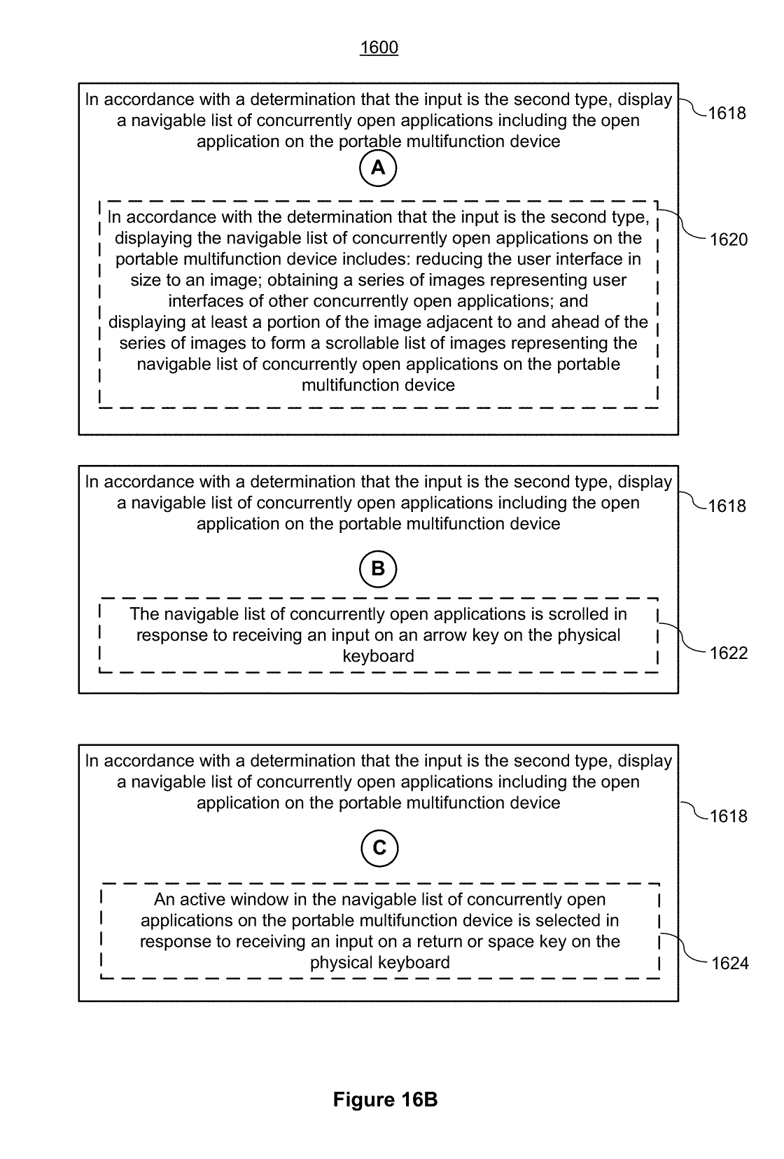

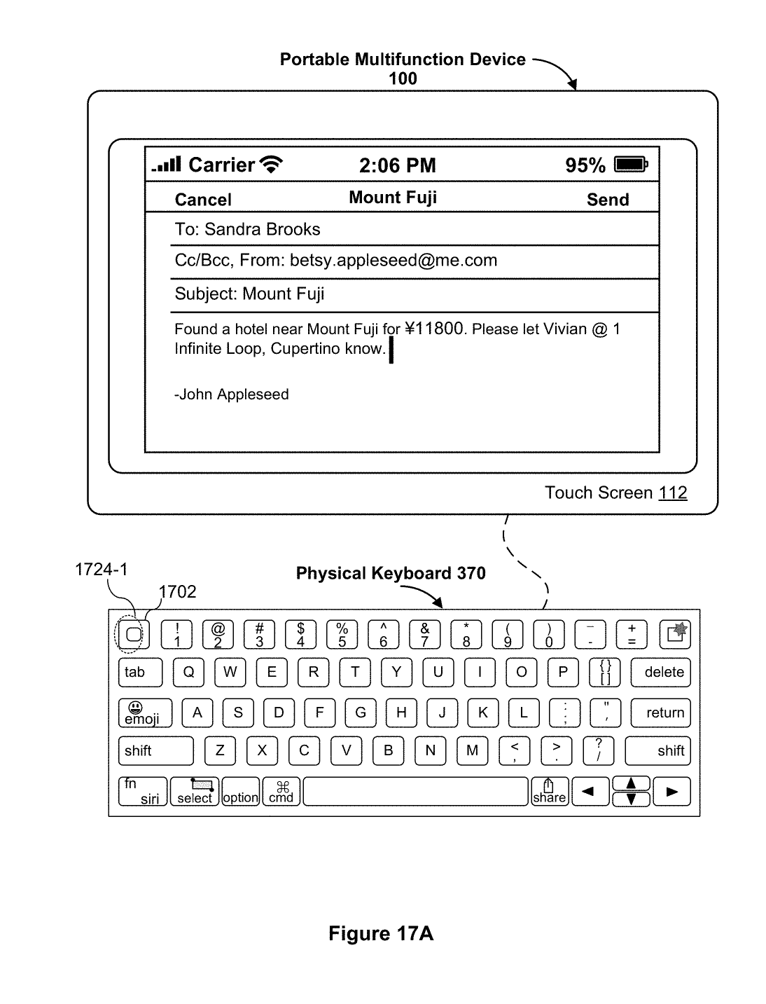

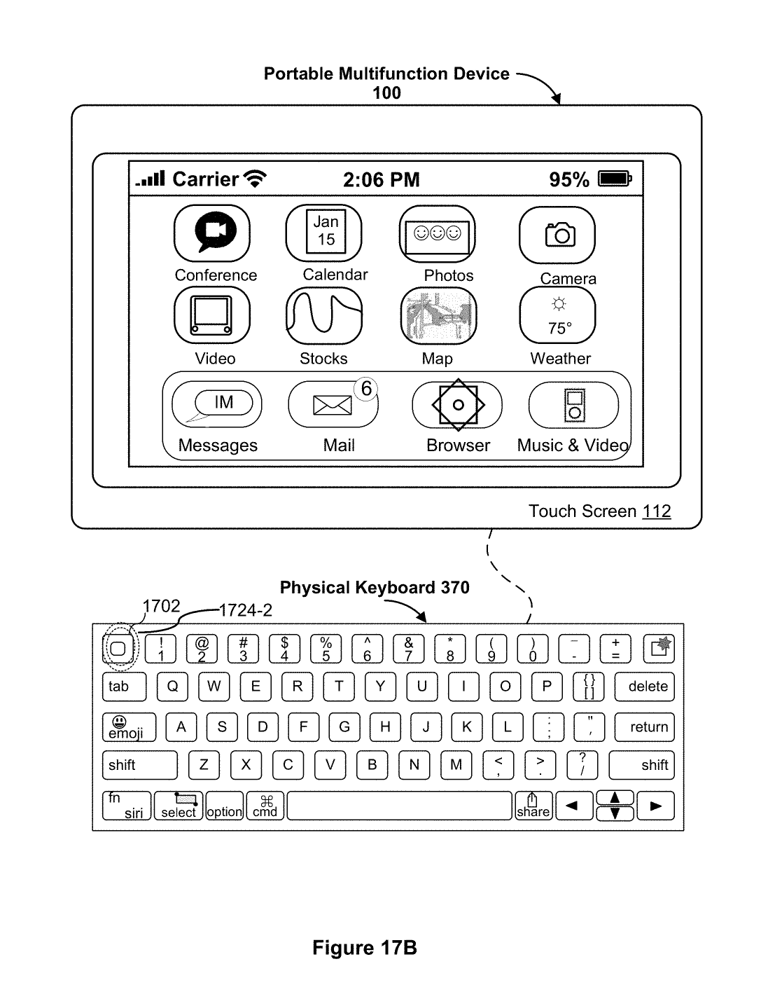

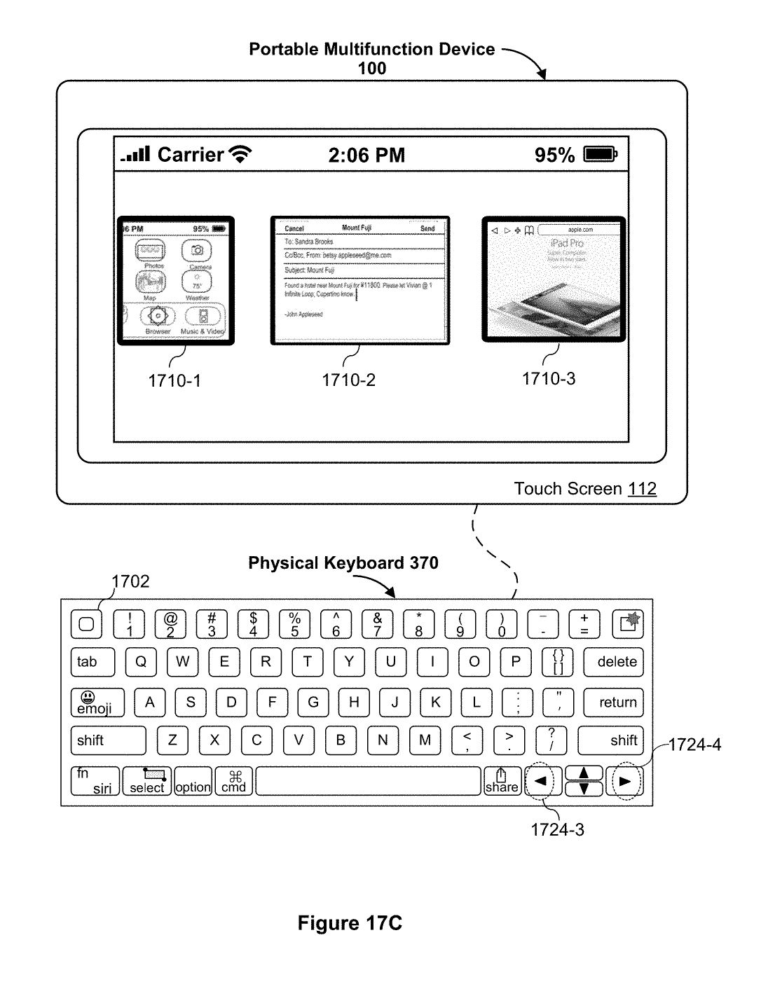

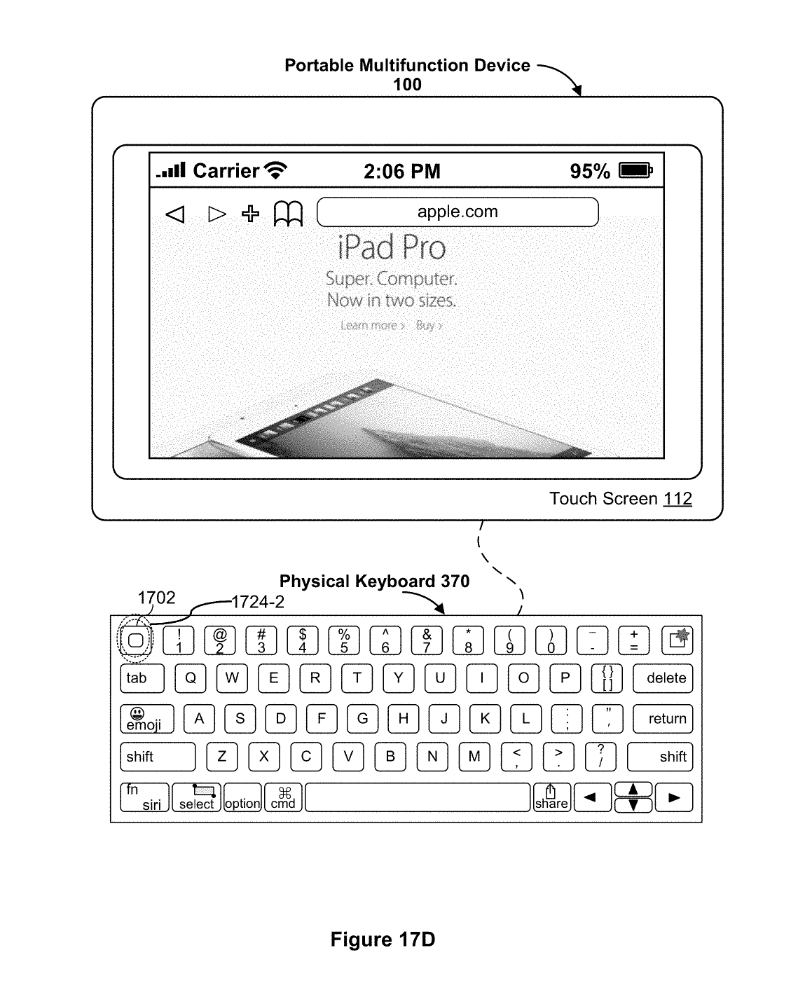

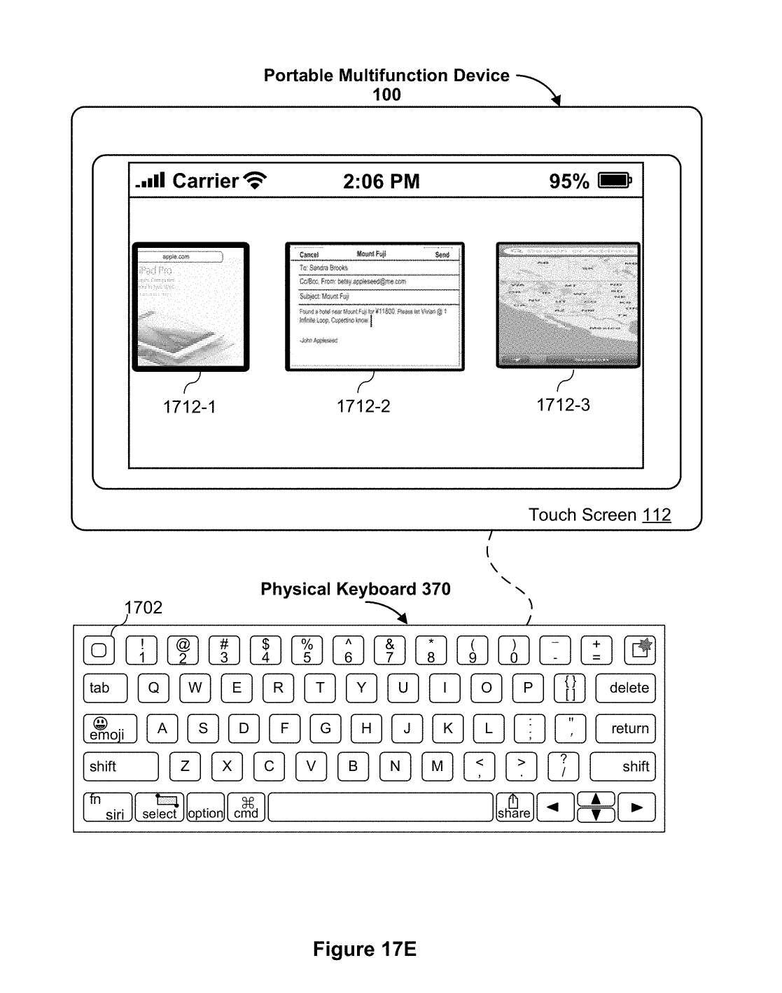

FIGS. 16A-16B are flow charts illustrating a method 1600 of displaying a home screen and a multitasking screen, in accordance with some embodiments. FIGS. 17A-17E, which illustrate exemplary user interfaces for displaying a home screen and a multitasking screen for switching applications, are used to illustrate the processes in FIGS. 16A-16B. The method 1600 is performed (1602) at a portable multifunction device (e.g., the device 100 in FIG. 1A) with a touch-sensitive display (e.g., the touch screen display 112 in FIG. 1A) and a physical keyboard (e.g., the physical keyboard 370 in FIG. 3B) removably coupled to the portable multifunction device. The physical keyboard contains at least one sensor (e.g., the sensors 374, FIG. 3B) for detecting contact intensities of inputs on keys of the physical keyboard. As explained above in connection with FIG. 3B, in some embodiments, the keyboard 370 is communicatively coupled to the portable multifunction device 100 by contact (e.g., Smart Connect from Apple Computer, Inc. of Cupertino, Calif.), via a wired connection (e.g., USB, PS/2), or via a wireless communication link (e.g., optical, Bluetooth, Wi-Fi, or the like). In some embodiments, the physical keyboard is (1604) decoupled from the portable multifunction device and connected to an electronic device. For example, the physical keyboard 370 as shown in FIG. 3B and FIGS. 17A-17E can be connected to a different electronic device that does not have a touch screen. When connecting to a different electronic device that does not have a touch screen, the multifunction keys on the physical keyboard 370 provide expanded functions, e.g., displaying a home screen and switching to different open applications without the user resorting to other input methods and devices. In some embodiments, as shown in FIGS. 17A-17E, the device 100 provides a physical multifunction home key 1702 on the physical keyboard 370.

As described below, the method 1600 provides an efficient mechanism for displaying a home screen at a portable multifunction device. This method is faster and easier to perform than conventional methods and systems, e.g., conventional home screen displays and methods of switching applications through a conventional keyboard with multiple keys and multiple key entries. The method is also intuitive for users, thereby reducing the cognitive burden on the user, and creating a more efficient human-machine interface. A more efficient input mechanism also requires less computing resources, thereby increasing battery life of the device.

The device 100 displays (1606) on a display a user interface for an application that is open, and subsequently detects (1608) an input on a dedicated home key of the physical keyboard. The device then determines (1610) if the input is of a first type or a different second type. In some embodiments, the first type of the input is (1612) a tap on the dedicated home key of the physical keyboard, and the second type of the input is a double tap (or a harder or longer press) on the dedicated home key of the physical keyboard. For example, in FIG. 17A, an input 1724-1 is detected on the home key 1702 of the physical keyboard 370, the device 100 determines that the input 1724-1 is a tap and classifies the input as a first type. In FIG. 17B, a different input 1724-2 is detected on the home key 1702 and the device 100 determines that the input 1724-2 is a second type, e.g., double tap.

In accordance with a determination that the input is the first type, the device displays (1614) a home screen on the display. In some embodiments, the user interface, which is displayed before a selection of the home key, corresponds to the open application and is not an interface for the home screen (1616). In accordance with the determination that the input is of the first type, the home screen is displayed on the display and the prior user interface is no longer displayed, i.e., only the home screen is displayed on the display.

For example, in FIG. 17A, an interface for composing an email is displayed on the display prior to receiving the tap 1724-1 on the dedicated home key 1702. In response to receiving the tap input 1724-1, the device ceases to display the email interface and displays the home screen interface on the display, as shown in FIG. 17B. Although FIG. 17A illustrates only one open application interface on the display prior to receiving the tap input 1724-1, when more than one open application windows are concurrently displayed on the display prior to receiving the tap input, in response to receiving the tap input, the device ceases to display all of these open application windows and fills the entire touch screen 112 with the home screen interface.

Although some portable multifunction devices have a home button for displaying the home screen, conventional keyboards often do not have a dedicated home button. Having a home button on the keyboard, which provides the function of displaying the home screen responsive to a tap, obviates the need for the user to reach up from the keyboard. Thus, the method described herein provides an efficient mechanism for displaying a home screen at a portable multifunction device. This method is faster and easier to perform than conventional methods and systems, e.g., navigating to the home screen using the interface on the portable multifunction device 100. The method is also intuitive for users, thereby reducing the cognitive burden on the user, and creating a more efficient human-machine interface. A more efficient input mechanism also requires less computing resources, thereby increasing battery life of the device.

Referring back to the method 1600, in FIG. 16A, in accordance with a determination that the input is the second type, the device displays (1618) a navigable list of concurrently open applications including the open application on the portable multifunction device. In some embodiments, in accordance with the determination that the input is the second type, displaying the navigable list of concurrently open applications on the portable multifunction device includes (1620): (a) reducing the user interface in size to an image, e.g. taking a live snapshot of the user interface and/or obtaining a live thumbnail image of the user interface; (b) obtaining a series of images representing user interfaces of other concurrently open applications; and (c) displaying at least a portion of the image adjacent to and ahead of the series of images to form a scrollable list of images representing the navigable list of concurrently open applications on the portable multifunction device.

For example, in FIG. 17B, the home screen interface is displayed at a first size (e.g., full screen size) on the display prior to receiving a double tap input 1724-2 on the dedicated home key 1702. In response to receiving the double tap input 1724-2, the device transitions from displaying only the home screen interface to displaying a multitasking interface, as shown in FIG. 17C.

In some embodiments, this transition includes first producing a reduced-scale image and then transitioning the home screen into the reduced-scale image, e.g., a live thumbnail image of the home screen. The reduced-scale image is at a second size that is smaller than the first size, e.g., icon sized or an image that is smaller than a full screen size. The device further obtains a series of reduced-scale images that represent user interfaces of other concurrently open applications. For example, in FIG. 17C, at least two concurrently open applications are executing on the device 100, one is an email application (e.g., the user interface shown in FIG. 17A) and another is a browser application (e.g., the user interface shown in FIG. 17D). In response to the double tap input 1724-2, the device obtains one live thumbnail image 1710-2 that corresponds to the email application interface shown in FIG. 17A and obtains another live thumbnail image 1710-3 that corresponds to the web browser interface shown in FIG. 17D. After obtaining the reduced-scale images, at least a portion of the reduced-scale image of the home screen 1710-1 is displayed in a scrollable list of images 1710. Adjacent the image 1710-1, the scrollable list of images 1710 contains other reduced-scale images 1710-2 and 1710-3 that represent user interfaces of other concurrently open applications. Because the home screen interface was in focus prior to receiving the double tap input 1724-2, the image 1710-1 representing the home screen interface is displayed ahead of other live thumbnail images in the scrollable list 1710.

Having a multifunction home button saves space on the physical keyboard. Further, the method described herein is faster and easier to perform than conventional methods and systems, e.g., navigating to the home screen using the interface on the portable multifunction device 100. In addition, having a home button that provides both the function of displaying the home screen and the function of displaying the multitasking screen is intuitive, thereby reducing the cognitive burden on the user, and creating a more efficient human-machine interface. A more efficient input mechanism also requires less computing resources, thereby increasing battery life of the device.

Referring back to the method 1600, in accordance with some embodiments, in FIG. 16B, the navigable list of concurrently open applications is scrolled (1622) in response to receiving an input on an arrow key on the physical keyboard. For example, in FIG. 17C, the navigable list of concurrently open applications can be scrolled towards the left edge of the display 112 in response to an input or selection 1724-3 of the left arrow key, and scrolled towards the right edge of the display 112 in response to an input or selection 1724-4 of the right arrow key.

In some embodiments, an active window in the navigable list of concurrently open applications on the portable multifunction device is selected (1624) in response to receiving an input on a return or space key on the physical keyboard. For example, in FIG. 17C, after using the left and/or the right arrow key to scroll the list, the user may use the return key or the space bar on the physical keyboard 370 to select the snapshot (e.g., reduced-scale image of the application) displayed at the center of the display. In response to selecting the third snapshot 1710-3 (FIG. 17C), the device displays the application user interface (e.g., the browser) on the display 112, as shown in FIG. 17D. Subsequently, in response to detecting another double tap 1724-2 on the home key while the interface is displayed, the device replaces the interface with the multitasking screen that includes a series of reduced-scale images 1712 (called snapshots or thumbnail images) corresponding to concurrently open applications (FIG. 17E). In FIG. 17E, at least three open applications are executing on the device 100, namely: a browser application, an email application, and a map application. The live thumbnail image 1712-1 corresponds to the browser application and at least a portion of the image 1712-1 is displayed. The second image 1712-2 corresponding to the email application interface (FIG. 17A) is displayed adjacent the image 1712-1. At least a portion of the third image 1712-3 corresponding to the map application interface is displayed adjacent the second image 1712-2. The scrollable list of images 1712 represents the navigable list of concurrently open applications (e.g., browser, email, and map) on the portable multifunction device.

In some embodiments, the first image in the scrollable list of images corresponds to the open application that was in focus the input 1724 was detected on the home key 1702. For example, in FIG. 17E, because the browser interface was in focus when the input 1724-3 was detected, the reduced-scale image 1712-1 corresponding to the browser application interface is displayed at the left (or in the center) in relation to the other images in the scrollable list 1712. In comparison, in FIG. 17C, because the home screen was in focus when the input 1724-2 was detected, the reduced-scale image 1710-1 representing the home screen interface is displayed at the left (or in the center) of other images in the scrollable list 1710.

Using the arrow, return, and/or space keys on the keyboard for navigating between the snapshots of the open applications obviates the need for reaching up from the keyboard to navigate and select an application. Thus, the method described herein provides an efficient mechanism for navigating a multitasking screen at a portable multifunction device. This method is both faster and easier to perform than conventional methods and systems. The method is also intuitive for users, thereby reducing the cognitive burden on the user, and creating a more efficient human-machine interface. A more efficient input mechanism also requires less computing resources, thereby increasing battery life of the device.

It should be understood that the particular order in which the operations in FIGS. 16A-16B have been described is merely exemplary and is not intended to indicate that the described order is the only order in which the operations could be performed. One of ordinary skill in the art would recognize various ways to reorder the operations described herein. For brevity, these details are not repeated here.

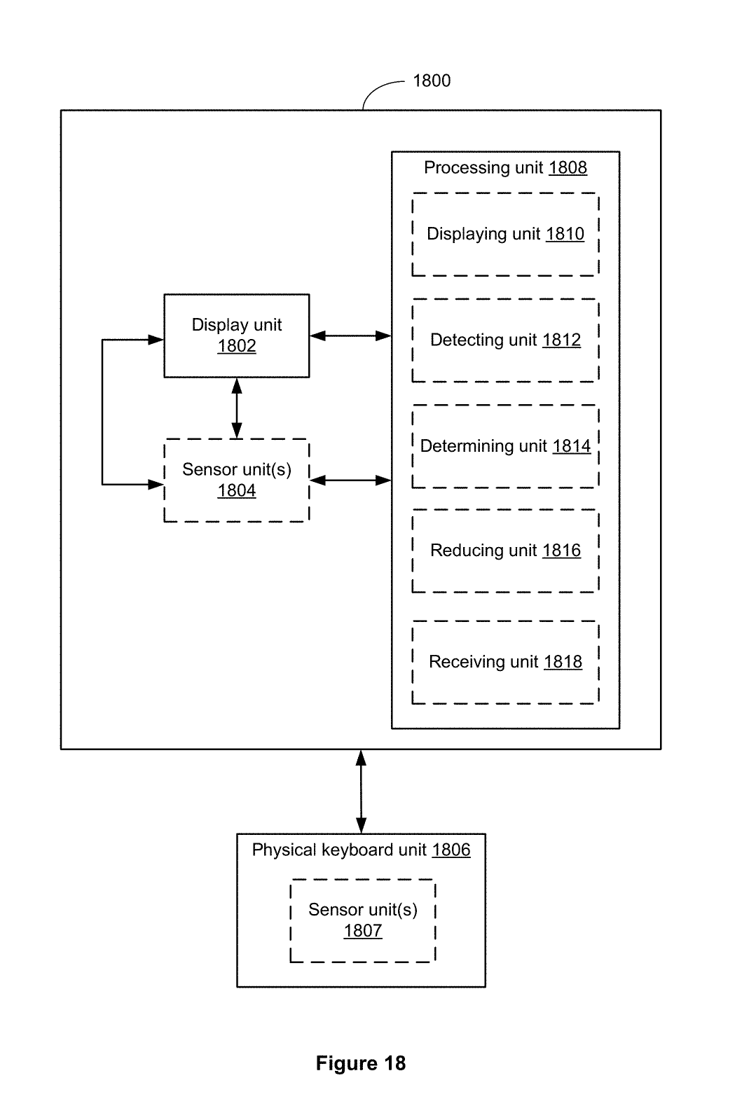

In accordance with some embodiments, FIG. 18 shows a functional block diagram of a portable multifunction device 1800 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 18 are, optionally, combined or separated into sub-blocks to implement the principles of the various described embodiments. Therefore, the description herein optionally supports any possible combination or separation or further definition of the functional blocks described herein.

As shown in FIG. 18, a portable multifunction device 1800 includes a touch-sensitive display unit 1802 configured to display user interfaces (editable content on the display unit) and configured to detect touch inputs (contacts), and a processing unit 1808 coupled with the touch-sensitive display unit 1802. In some embodiments, the portable multifunction device includes one or more sensor units 1804 and the processing unit 1808 is coupled with the touch-sensitive display unit 1802 and the one or more sensor units 1804. In some embodiments, processing unit 1808 includes one or more of the following sub-units: displaying unit 1810, detecting unit 1812, determining unit 1814, reducing unit 1816, and receiving unit 1818. In some embodiments, the portable multifunction device 1800 is removably coupled to a physical keyboard unit 1806 (e.g., the physical keyboard 370), which further includes one or more sensor units 1807 (e.g., the sensors 374, FIG. 3B).

The processing unit 1808 is configured to detect (e.g., with the detecting unit 1812) an input on a dedicated home key of the physical keyboard unit 1806. In response to detecting the input, the processing unit 1808 is configured to determine (e.g., with the determining unit 1814) whether the input is of a first type or a second type. In accordance with a determination that the input is the first type, the processing unit 1808 is configured to display (e.g., with the displaying unit 1810) a home screen on the display unit 1802. On the other hand, in accordance with a determination that the input is the second type, the processing unit 1808 is configured to display (e.g., with the displaying unit 1810) a navigable list of concurrently open applications including the open application on the portable multifunction device.

In some embodiments, the physical keyboard unit 1806 is decoupled from the portable multifunction device and connected to an electronic device.

In some embodiments, the first type of the input is a tap on the dedicated home key of the physical keyboard unit 1806, and the second type of the input is a double tap on the dedicated home key of the physical keyboard unit 1806.

In some embodiments, the user interface corresponds to the open application is not an interface for the home screen; and in accordance with the determination that the input is the first type, displaying the home screen on the display unit 1802 includes ceasing to display (e.g., with the displaying unit 1810) the user interface and displaying only the home screen on the display unit 1802.

In some embodiments, in accordance with the determination that the input is the second type, displaying the navigable list of concurrently open applications on the portable multifunction device includes reducing (e.g., with the reducing unit 1816) the user interface to a smaller size; displaying (e.g., with the displaying unit 1810) the smaller sized user interface in a predefined area of a series of predefined areas, where the predefined area is in the first place of the series of predefined areas; and displaying snapshots of at least some of the concurrently open applications in remaining predefined areas of the series of predefined areas on the display unit 1802.

In some embodiments, the navigable list of concurrently open applications is scrolled in response to receiving an input on an arrow key on the physical keyboard unit 1806.

In some embodiments, an active window in the navigable list of concurrently open applications on the portable multifunction device is selected in response to receiving (e.g., with the receiving unit 1818) an input on a return or space key on the physical keyboard unit 1806.

The operations in the information processing methods described above are, optionally implemented by running one or more functional modules in information processing apparatus such as general purpose processors (e.g., as described above with respect to FIGS. 1A and 3A-3B) or application specific chips.

The operations described above with reference to FIGS. 17A-17E are, optionally, implemented by components depicted in FIGS. 1A-1B or FIG. 18. For example, displaying operation 1810, detecting operation 1812, determining operation 1814, and reducing operation 1816 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Dedicated Select Key

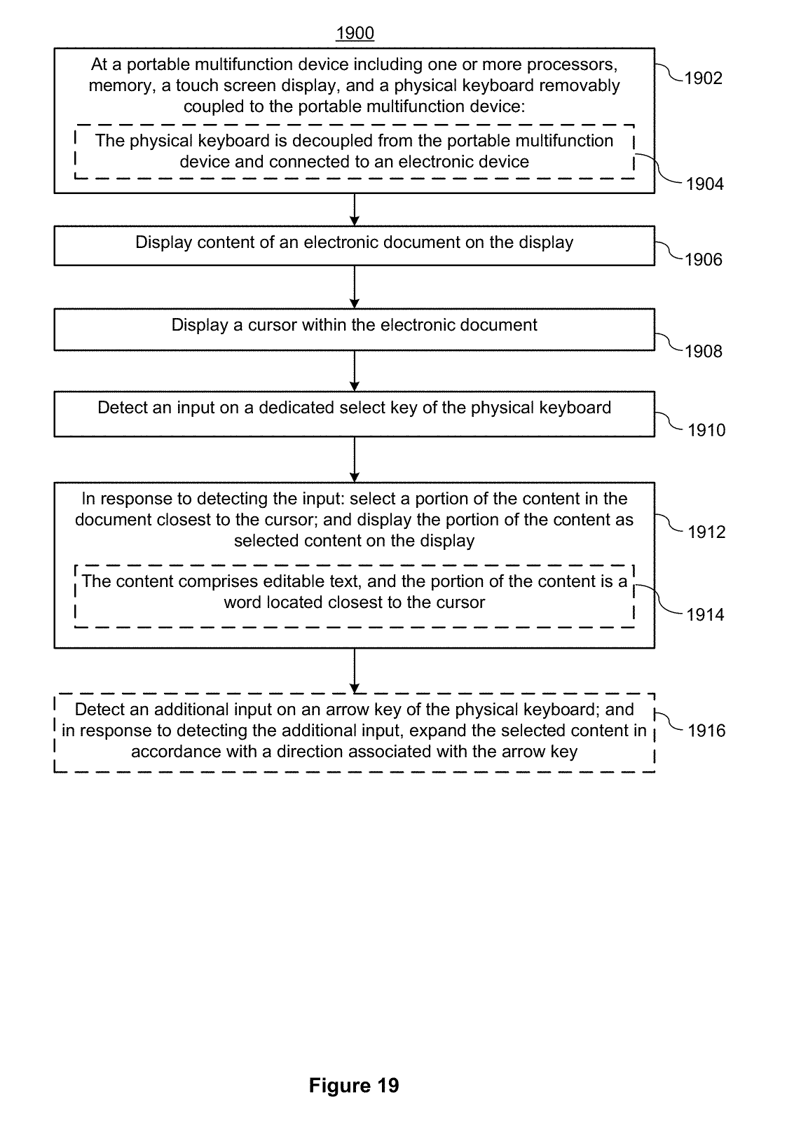

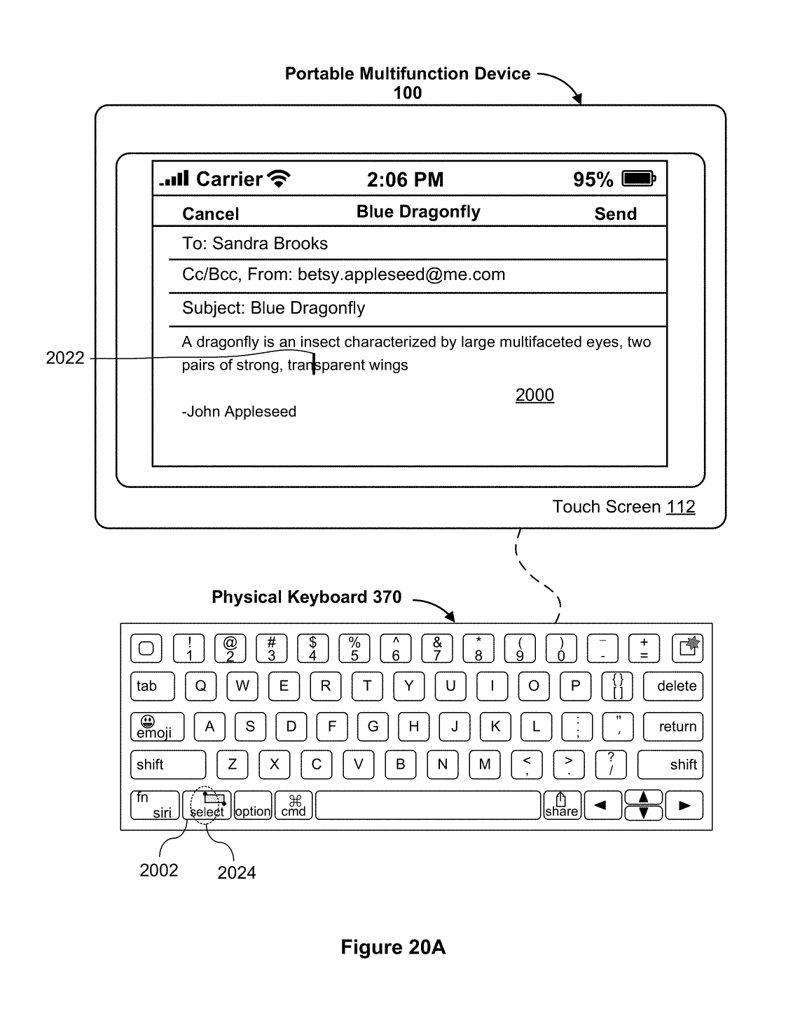

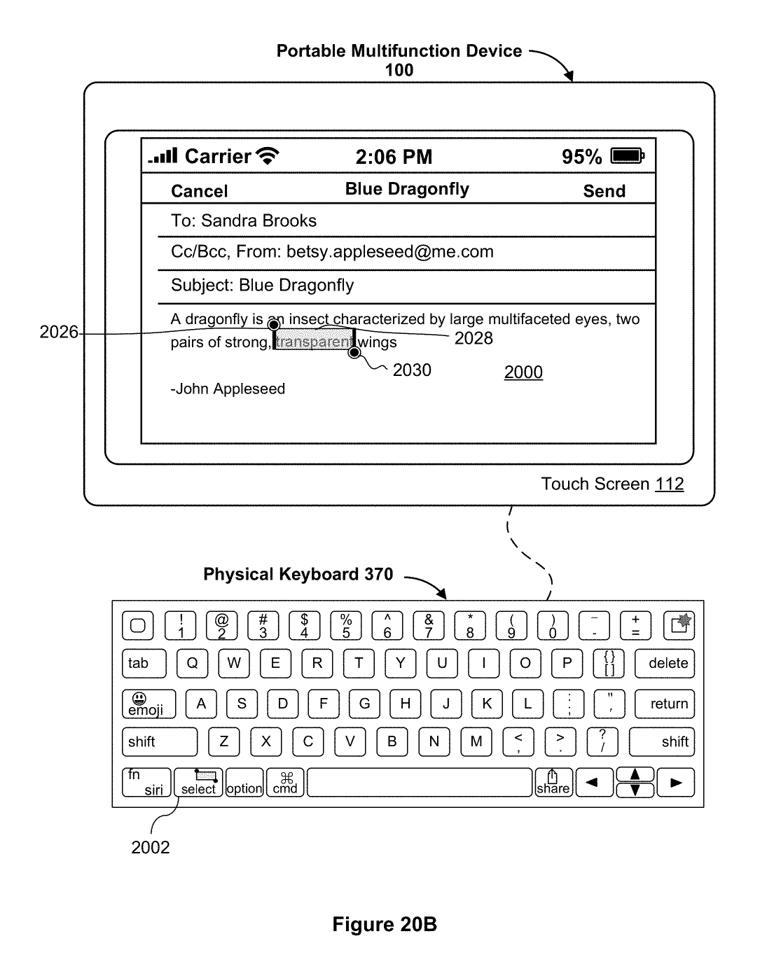

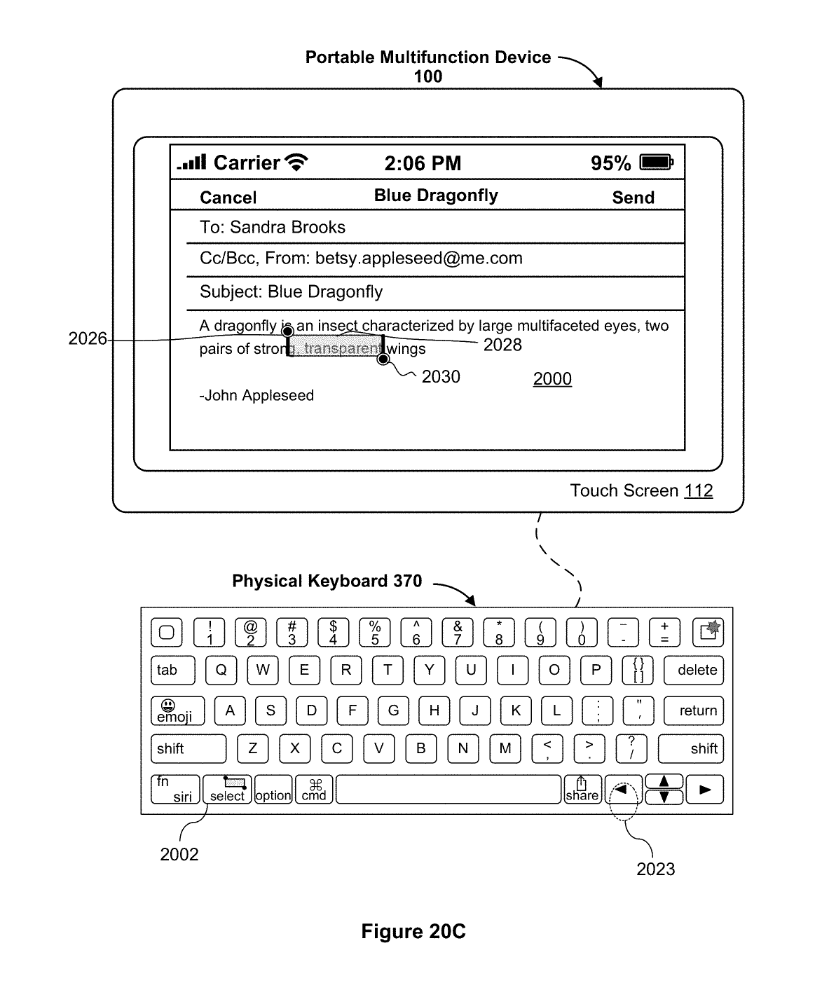

FIG. 19 is a flow chart illustrating a method 1900 of content selection using a dedicated select key on a physical keyboard, in accordance with some embodiments. FIGS. 20A-20C, which illustrate exemplary user interfaces for content selection, are used to illustrate the processes in FIG. 19. The method 1900 is performed (1902) at a portable multifunction device (e.g., the device 100 in FIG. 1A) with a touch-sensitive display (e.g., the touch screen display 112 in FIG. 1A) and a physical keyboard (e.g., the physical keyboard 370 in FIG. 3B) removably coupled to the portable multifunction device. As explained above in connection with FIG. 3B, in some embodiments, the keyboard 370 is communicatively coupled to the portable multifunction device 100 by contact (e.g., Smart Connect from Apple Computer, Inc. of Cupertino, Calif.), via a wired connection (e.g., USB, PS/2), or via a wireless communication link (e.g., optical, Bluetooth, Wi-Fi, or the like). In some embodiments, the physical keyboard is (1904) decoupled from the portable multifunction device and connected to an electronic device. For example, the physical keyboard 370 as shown in FIG. 3B and FIGS. 20A-20C can be connected to a different electronic device that does not have a touch screen. In some embodiments, as shown in FIGS. 20A-20C, the device 100 provides a physical select key 2002 on the physical keyboard 370.

As described below, the method 1900 provides an efficient mechanism for content selection at a portable multifunction device. This method is faster and easier to perform than conventional content selection methods and systems, e.g., conventional content selection through a conventional keyboard with multiple key inputs for selecting content. The method is also intuitive for users, thereby reducing the cognitive burden on the user, and creating a more efficient human-machine interface. A more efficient input mechanism also requires less computing resources, thereby increasing battery life of the device.

The device 100 displays (1906) content of an electronic document on the display, and displays (1908) a cursor within the electronic document. The device then detects (1910) an input on a dedicated select key of the physical keyboard. In response to detecting the input, the device selects (1912) a portion of the content in the document closest to the cursor, and displays the portion of the content as selected content on the display.

In some embodiments, the content comprises (1914) editable text, and the portion of the content is a word located closest to the cursor. For example, in FIG. 20A, an electronic document, e.g., email 2000 is displayed in the email composer. The email content is editable text, including a word “transparent” located closest to the cursor 2022. The cursor 2022 is displayed in between the character “n” and “s” of the word “transparent”. The device detects an input 2024, e.g., a tap on the dedicated select key 2002. In response to detecting the input 2024, the device selects the word “transparent”, which was the closest to the cursor prior to the selection. In FIG. 20B, the word selection is highlighted by the selection indicators 2026, 2028 and 2030.

In some embodiments, the device further detects (1916) an additional input on an arrow key of the physical keyboard. In response to detecting the additional input, the device expands the selected content in accordance with a direction associated with the arrow key. For example, in FIG. 20C, while the content is selected, an input 2023 on the left arrow key expands the selection to include more characters to the left of the word “transparent.” Likewise, though not shown in FIG. 20C, in response to detecting an input on the right, down, or up arrow key of the physical keyboard 370, the selected portion expands in accordance with the direction of the arrow key.

Selecting a word closest to the cursor and providing the ability to adjust (e.g., expand or shrink) the selection using arrow keys is faster and easier to perform than conventional content selection methods and systems. Conventional keyboards often do not have a select button and a user cannot select content without using other input methods. Using the arrow keys for selection adjustment is also intuitive for users, thereby reducing the cognitive burden on the user, and creating a more efficient human-machine interface. A more efficient input mechanism also requires less computing resources, thereby increasing battery life of the device.

It should be understood that the particular order in which the operations in FIG. 19 have been described is merely exemplary and is not intended to indicate that the described order is the only order in which the operations could be performed. One of ordinary skill in the art would recognize various ways to reorder the operations described herein. For brevity, these details are not repeated here.

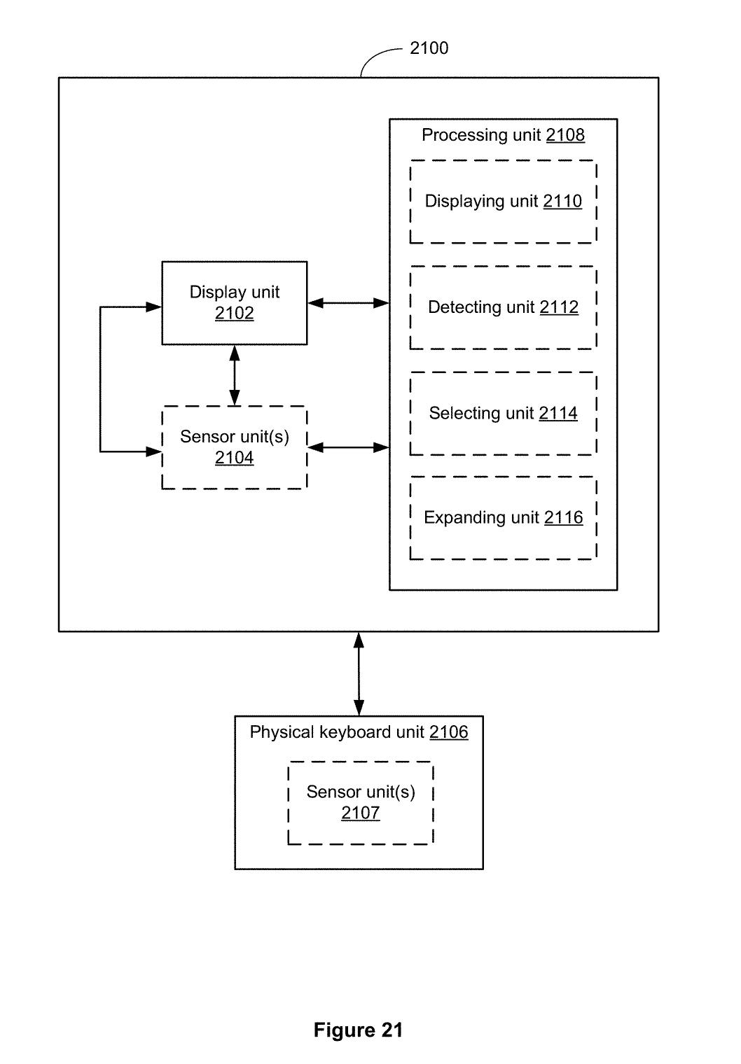

In accordance with some embodiments, FIG. 21 shows a functional block diagram of a portable multifunction device 2100 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 21 are, optionally, combined or separated into sub-blocks to implement the principles of the various described embodiments. Therefore, the description herein optionally supports any possible combination or separation or further definition of the functional blocks described herein.

As shown in FIG. 21, a portable multifunction device 2100 includes a touch-sensitive display unit 2102 configured to display user interfaces (editable content on the display unit) and configured to detect touch inputs (contacts), and a processing unit 2108 coupled with the touch-sensitive display unit 2102. In some embodiments, the portable multifunction device includes one or more sensor units 2104 and the processing unit 2108 is coupled with the touch-sensitive display unit 2102 and the one or more sensor units 2104. In some embodiments, processing unit 2108 includes one or more of the following sub-units: displaying unit 2110, detecting unit 2112, selecting unit 2114, and expanding unit 2116. In some embodiments, the portable multifunction device 2100 is removably coupled to a physical keyboard unit 2106 (e.g., the physical keyboard 370), which further includes one or more sensor units 2107 (e.g., the sensors 374, FIG. 3B).

The processing unit 2108 is configured to display (e.g., with the displaying unit 2110) content of an electronic document on the display unit 2102. The processing unit 2108 is further configured to display (e.g., with the displaying unit 2110) a cursor within the electronic document; detect (e.g., with the detecting unit 2112) an input on a dedicated select key of the physical keyboard unit 2106. In response to detecting the input, the processing unit 2108 is configured to select (e.g., with the selecting unit 2114) a portion of the content in the document closest to the cursor; and display (e.g., with the displaying unit 2110) the portion of the content as selected content on the display unit 2102.

In some embodiments, the physical keyboard unit 2106 is decoupled from the portable multifunction device and connected to an electronic device.

In some embodiments, the content comprises editable text, and the portion of the content is a word located closest to the cursor.

In some embodiments, the processing unit 2108 is further configured to detect (e.g., with the detecting unit 2112) an additional input on an arrow key of the physical keyboard unit; and in response to detect the additional input, expand (e.g., with the expanding unit 2116) the selected content in accordance with a direction associated with the arrow key.

The operations in the information processing methods described above are, optionally implemented by running one or more functional modules in information processing apparatus such as general purpose processors (e.g., as described above with respect to FIGS. 1A and 3A-3B) or application specific chips.

The operations described above with reference to FIGS. 20A-20C are, optionally, implemented by components depicted in FIGS. 1A-1B or FIG. 21. For example, displaying operation 2110, detecting operation 2112, selecting operation 2114, and expanding operation 2116 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Multifunction Tab Key

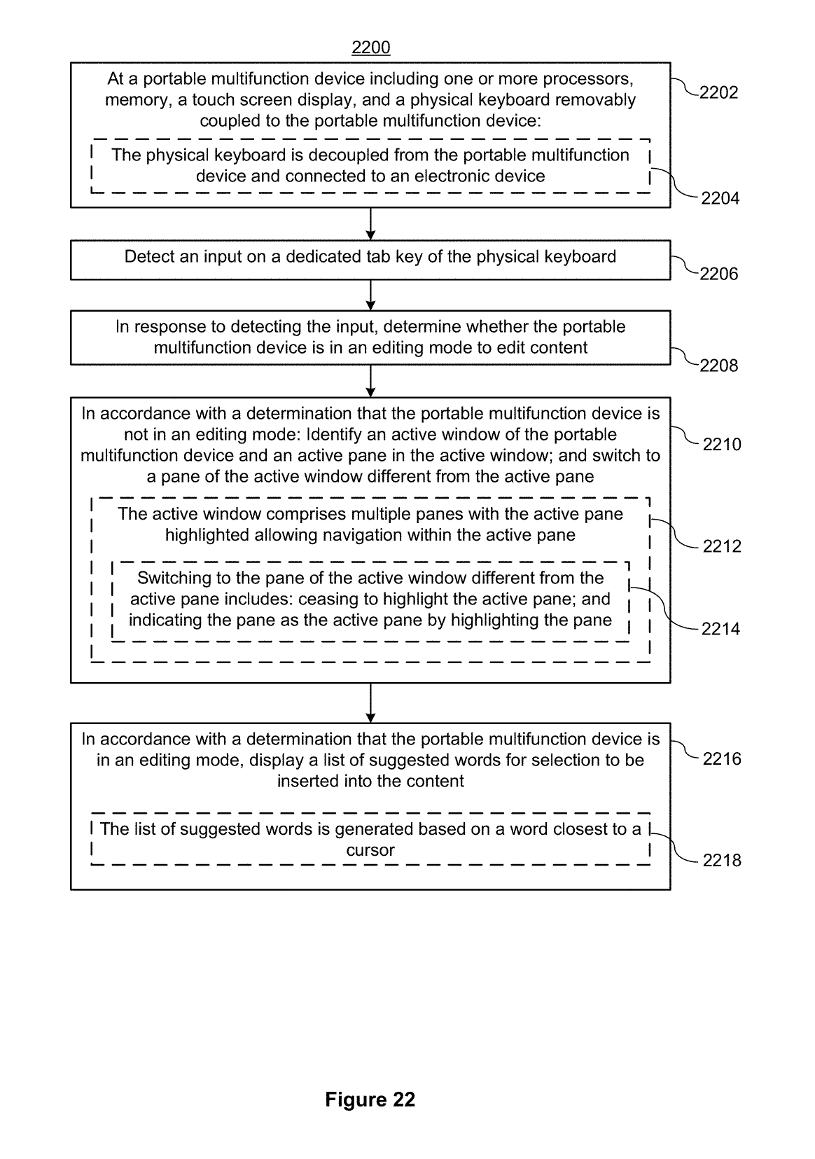

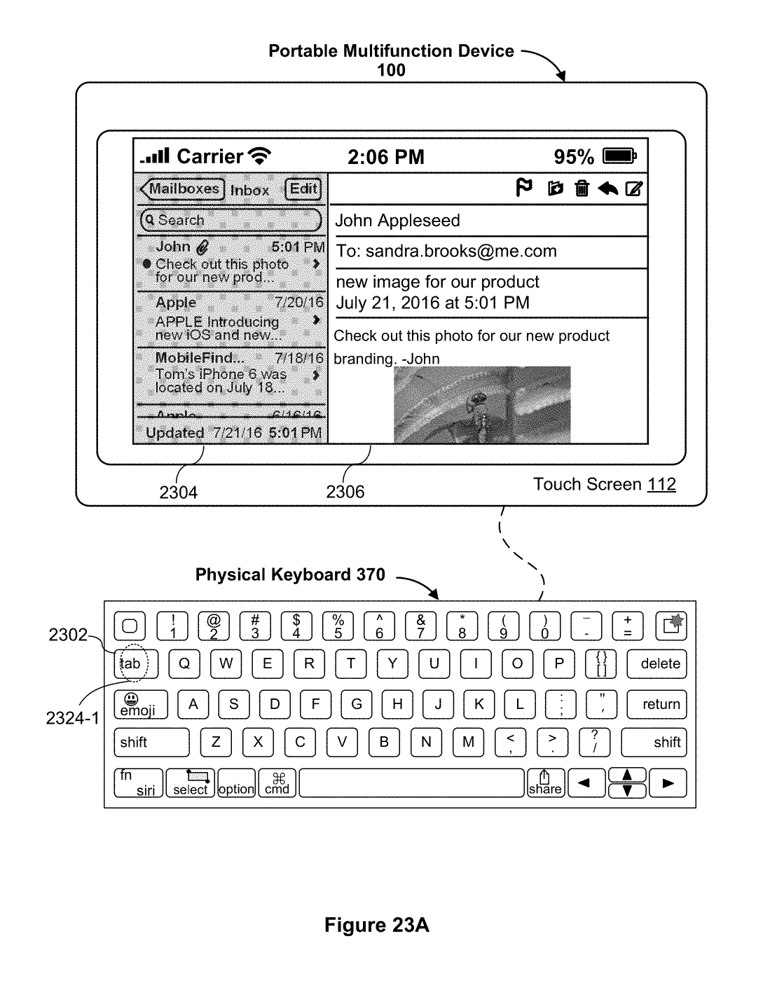

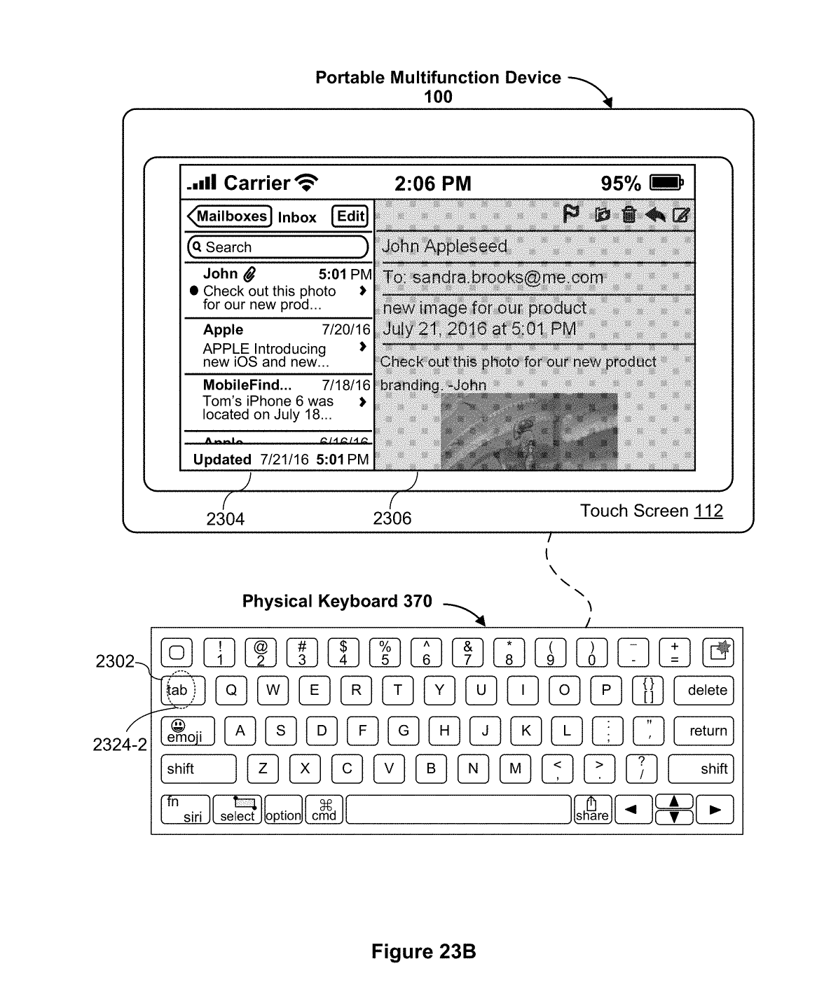

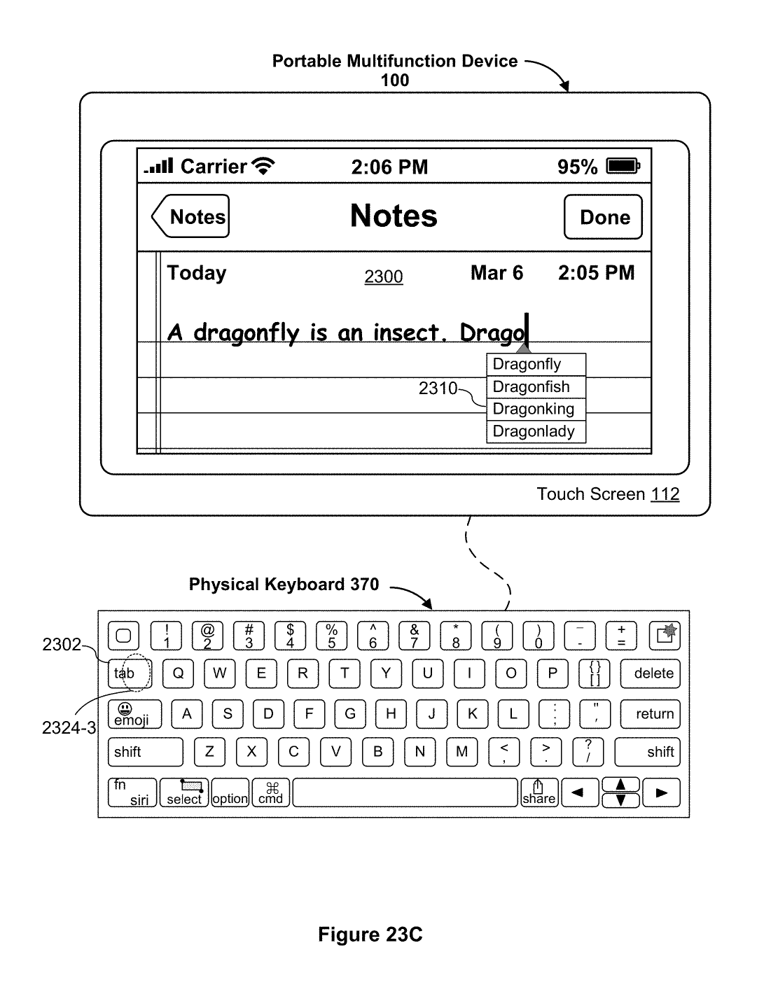

FIG. 22 is a flow chart illustrating a method 2200 of using a multifunction tab key, in accordance with some embodiments. FIGS. 23A-23C, which illustrate exemplary user interfaces of using a multifunction tab key, are used to illustrate the processes in FIG. 22. The method 2200 is performed (2202) at a portable multifunction device (e.g., the device 100 in FIG. 1A) with a touch-sensitive display (e.g., the touch screen display 112 in FIG. 1A) and a physical keyboard (e.g., the physical keyboard 370 in FIG. 3B) removably coupled to the portable multifunction device. As explained above in connection with FIG. 3B, in some embodiments, the keyboard 370 is communicatively coupled to the portable multifunction device 100 by contact (e.g., Smart Connect from Apple Computer, Inc. of Cupertino, Calif.), via a wired connection (e.g., USB, PS/2), or via a wireless communication link (e.g., optical, Bluetooth, Wi-Fi, or the like). In some embodiments, the physical keyboard is (2204) decoupled from the portable multifunction device and connected to an electronic device. For example, the physical keyboard 370 as shown in FIG. 3B and FIGS. 23A-23C can be connected to a different electronic device that does not have a touch screen. In some embodiments, as shown in FIGS. 23A-23C, the device 100 provides a physical select key 2302 on the physical keyboard 370 coupled to the portable multifunction device 100.

As described below, the method 2200 provides a multifunction tab key that can be used for pane switching in an active window and/or providing auto suggestion at a portable multifunction device. This method is faster and easier to perform than conventional pane switching and auto suggestion methods and systems, e.g., conventional pane switching and auto suggestion through a conventional keyboard with multiple key entries for pane switching and auto suggestion. The method is also intuitive for users, thereby reducing the cognitive burden on the user, and creating a more efficient human-machine interface. A more efficient input mechanism also requires less computing resources, thereby increasing battery life of the device.

The device 100 detects (2206) an input on a dedicated tab key of the physical keyboard. In response to detecting the input, the device determines (2208) whether the portable multifunction device is in an editing mode to edit content. In accordance with a determination that the portable multifunction device is not in an editing mode, the device identifies (2210) an active window of the portable multifunction device and an active pane in the active window, and switches to a pane of the active window different from the active pane. In some embodiments, the active window comprises (2212) multiple panes with the active pane highlighted allowing navigation within the active pane.

For example, in FIG. 23A, the active window for an email interface displayed on the touch screen 112 includes two panes 2304 and 2306 when the email application is not in an editing mode. The left pane 2304 includes a list of emails in the inbox with snippets of each message. When the left pane 2304 is the active pane, as shown in FIG. 23A, the active pane is highlighted, e.g., shown by a different shading, color, and/or border, and a user can use the up or down arrow key on the physical keyboard to scroll up or down the email list. Adjacent the left pane 2304 is the right pane 2306, which contains an expanded view of a message. When the right pane 2306 is active, as shown in FIG. 23B, the email content pane 2306 is highlighted, and the user can view the entire message within the email content pane using the arrow keys.

In some embodiments, using the dedicated tab key to switch to a different pane from the active pane includes (2214) ceasing to highlight the previously active pane, and highlighting the newly active pane. For example, initially the left pane 2304 containing a list of emails is highlighted as indicated by the shade in FIG. 23A. In response to detecting the input 2324-1 on the tab key 2302, the device ceases to highlight the left pane 2304, and highlights the right pane 2306 to indicate that the right pane 2306 containing the expanded view of a message is active. At this point, the user can use the up or down arrow key on the physical keyboard to scroll up or down the entire message, as shown in FIG. 23B.

The above examples relate to the active pane switching function associated with the tab key when the portable multifunction device is not in an editing mode. Referring back to FIG. 22, in accordance with a determination that the portable multifunction device is in an editing mode, the device displays (2216) a list of suggested words for selection to be inserted into the content in response to detecting an input on the multifunction tab key. In some embodiments, the list of suggested words is generated (2218) based on a word closest to a cursor.

For example, in FIG. 23C, a partial entry of a word has been entered into the editable content 2300. In response to detecting the input 2324-3 on the tab key 2302, the device displays a list of suggested words 2310 for selection. In some embodiments, the list of suggested words is generated based on the word or partial word closest to the cursor, e.g., Dragonfly, Dragonfish, Dragonking, and Dragonlady are all related to the partial word “Drago” preceding the cursor. In some embodiments, the list of suggested words is generated based on a selection of content in the editable content 2300. The user can then scroll through the list 2310 to select a word for insertion into the editable content 2300. In some embodiments, the list of suggested words also includes definitions and/or pronunciations of the suggested words, or the ability to lookup the word in a dictionary or thesaurus. In some embodiments, if there is another editable pane or form within the same user interface, selecting the tab key will move the cursor to the next editable form or pane.

It should be understood that the particular order in which the operations in FIG. 22 have been described is merely exemplary and is not intended to indicate that the described order is the only order in which the operations could be performed. One of ordinary skill in the art would recognize various ways to reorder the operations described herein. For brevity, these details are not repeated here.

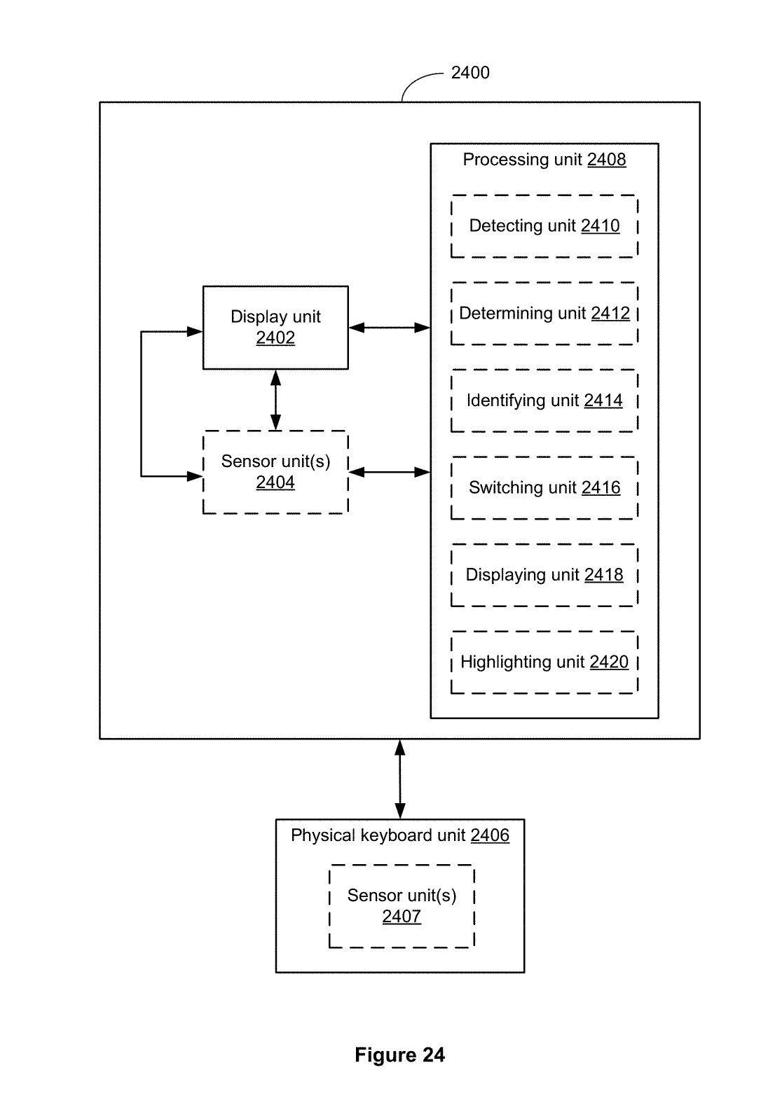

In accordance with some embodiments, FIG. 24 shows a functional block diagram of a portable multifunction device 2400 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 24 are, optionally, combined or separated into sub-blocks to implement the principles of the various described embodiments. Therefore, the description herein optionally supports any possible combination or separation or further definition of the functional blocks described herein.

As shown in FIG. 24, a portable multifunction device 2400 includes a touch-sensitive display unit 2402 configured to display user interfaces (editable content on the display unit) and configured to detect touch inputs (contacts), and a processing unit 2408 coupled with the touch-sensitive display unit 2402. In some embodiments, the portable multifunction device includes one or more sensor units 2404 and the processing unit 2408 is coupled with the touch-sensitive display unit 2402 and the one or more sensor units 2404. In some embodiments, processing unit 2408 includes one or more of the following sub-units: detecting unit 2410, determining unit 2412, identifying unit 2414, switching unit 2416, displaying unit 2418, and highlighting unit 2420. In some embodiments, the portable multifunction device 2400 is removably coupled to a physical keyboard unit 2406 (e.g., the physical keyboard 370), which further includes one or more sensor units 2407 (e.g., the sensors 374, FIG. 3B).

The processing unit 2408 is configured to detect (e.g., with the detecting unit 2410) an input on a dedicated tab key of the physical keyboard unit 2406. In response to detecting the input, the processing unit 2408 is configured to determine (e.g., with the determining unit 2412) whether the portable multifunction device is in an editing mode to edit content. In accordance with a determination that the portable multifunction device is not in an editing mode, the processing unit 2408 is configured to identify (e.g., with the identifying unit 2414) an active window of the portable multifunction device and an active pane in the active window; and switch (e.g., with the switching unit 2416) to a pane of the active window different from the active pane. On the other hand, in accordance with a determination that the portable multifunction device is in an editing mode, the processing unit 2408 is configured to display (e.g., with the displaying unit 2418) a list of suggested words for selection to be inserted into the content.

In some embodiments, the physical keyboard unit 2406 is decoupled from the portable multifunction device and connected to an electronic device.

In some embodiments, the active window comprises multiple panes with the active pane highlighted allowing navigation within the active pane.

In some embodiments, switching to the pane of the active window different from the active pane includes ceasing to highlight (e.g., with the highlighting unit 2420) the active pane; and indicating the pane as the active pane by highlighting (e.g., with the highlighting unit 2420) the pane.

In some embodiments, the list of suggested words is generated based on a word closest to a cursor.

The operations in the information processing methods described above are, optionally implemented by running one or more functional modules in information processing apparatus such as general purpose processors (e.g., as described above with respect to FIGS. 1A and 3A-3B) or application specific chips.

The operations described above with reference to FIGS. 23A-23C are, optionally, implemented by components depicted in FIGS. 1A-1B or FIG. 24. For example, detecting operation 2410, determining operation 2412, identifying operation 2414, switching operation 2416, displaying operation 2418, and highlighting operation 2420 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Dedicated Share Key

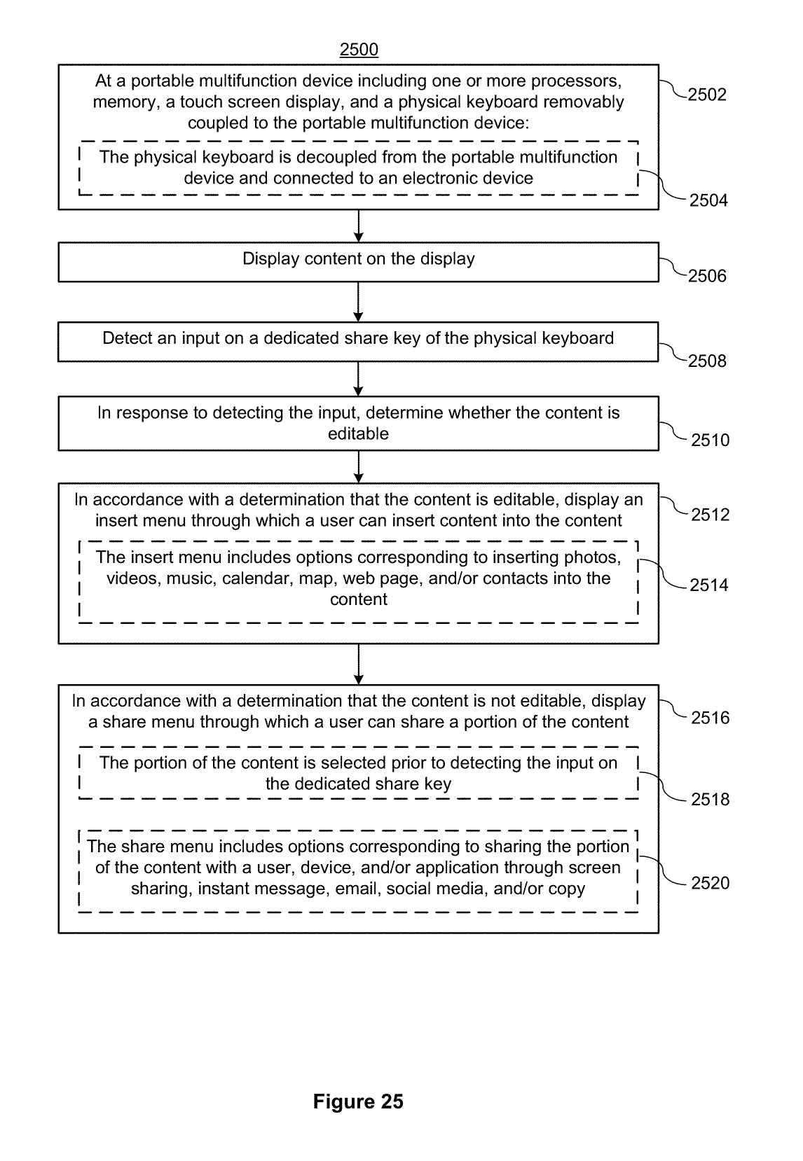

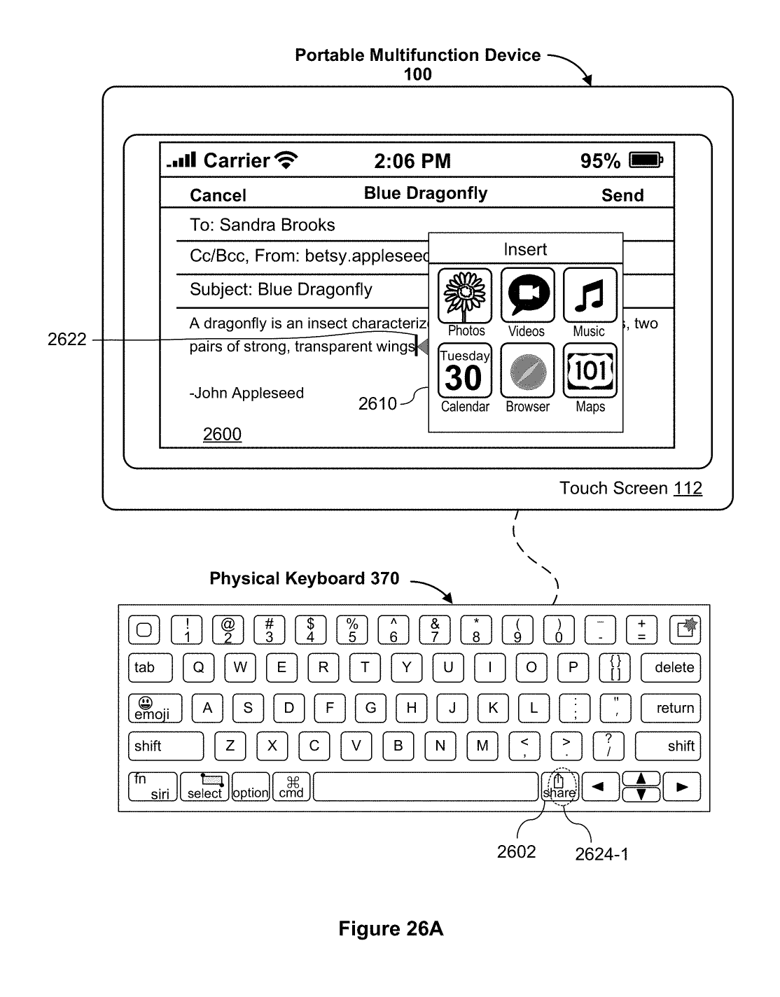

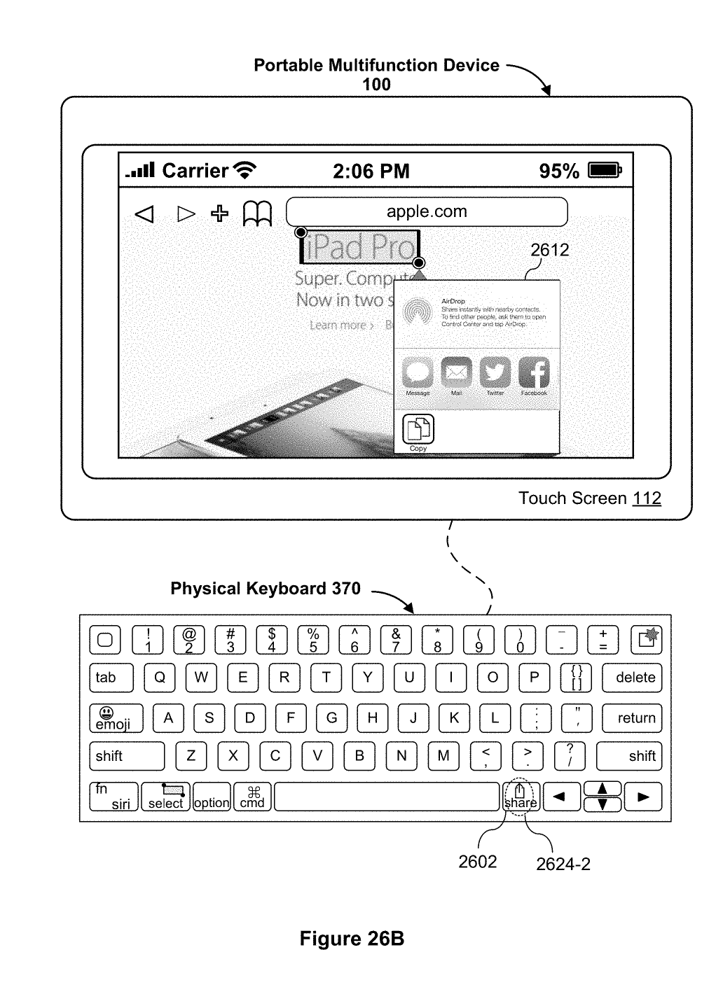

FIG. 25 is a flow chart illustrating a method 2500 of content sharing and insertion using a dedicated share key, in accordance with some embodiments. FIGS. 26A-26B, which illustrate exemplary user interfaces of using a multifunction share key, are used to illustrate the processes in FIG. 25. The method 2500 is performed (2502) at a portable multifunction device (e.g., the device 100 in FIG. 1A) with a touch-sensitive display (e.g., the touch screen display 112 in FIG. 1A) and a physical keyboard (e.g., the physical keyboard 370 in FIG. 3B) removably coupled to the portable multifunction device. As explained above in connection with FIG. 3B, in some embodiments, the keyboard 370 is communicatively coupled to the portable multifunction device 100 by contact (e.g., Smart Connect from Apple Computer, Inc. of Cupertino, Calif.), via a wired connection (e.g., USB, PS/2), or via a wireless communication link (e.g., optical, Bluetooth, Wi-Fi, or the like). In some embodiments, the physical keyboard is (2504) decoupled from the portable multifunction device and connected to an electronic device. For example, the physical keyboard 370 as shown in FIG. 3B and FIGS. 26A-26B can be connected to a different electronic device that does not have a touch screen. In some embodiments, as shown in FIGS. 26A-26B, the device 100 provides a physical share key 2602 on the physical keyboard 370 coupled to the portable multifunction device 100.

As described below, the method 2500 provides an efficient mechanism for sharing content among applications at a portable multifunction device or across devices. This method is faster and easier to perform than conventional content sharing methods and systems, e.g., conventional content sharing through a conventional keyboard with multiple keys for content sharing and multiple key entries for content sharing. The method is also intuitive for users, thereby reducing the cognitive burden on the user, and creating a more efficient human-machine interface. A more efficient input mechanism also requires less computing resources, thereby increasing battery life of the device.

The device displays (2506) content on the display and detects (2508) an input on a dedicated share key of the physical keyboard. In response to detecting the input or selection of the dedicated share key, the device determines (2510) whether the content is editable. In accordance with a determination that the content is editable, the device displays (2512) an insert menu through which a user can insert content into the content. In some embodiments, the insert menu includes (2514) options corresponding to inserting photos, videos, music, calendar, web page, map and/or contacts into the content.

For example, in FIG. 26A, an email composer interface is displayed and the email content 2600 is editable. In response to detecting an input 2624-1 on the dedicated share key 2602 and in accordance with a determination that the email content 2600 is editable, the device displays an insert menu 2610 next to the insertion marker 2622. The insert menu 2610 includes icons for inserting photos, videos, music, calendar, web page (or link to a web page), map and/or contacts (not shown).

Through the share menu, content from other applications on the device can be shared with the email application and quickly inserted into the editable content. This method is faster and easier to perform than conventional content sharing methods and systems, e.g., conventional insertion methods of first switching to a different application using one or more key entries, then selecting the content to be inserted using more key entries, and finally switching back to the editor for insertion of the selected content using yet more key entries. The method is also intuitive for users, thereby reducing the cognitive burden on the user, and creating a more efficient human-machine interface. A more efficient input mechanism also requires less computing resources, thereby increasing battery life of the device.

Referring back to FIG. 25, in some embodiments, in accordance with a determination that the content is not editable, the device displays (2516) a share menu through which a user can share the content or a portion of the content. In some embodiments, the portion of the content is selected (2518) prior to detecting the input on the dedicated share key. In some embodiments, the share menu includes (2520) options corresponding to sharing the portion of the content with a user or application through screen sharing, an instant message, email, social media, and/or making a copy.

For example, in FIG. 26B, a browser interface is displayed on the touch screen 112. The web content displayed in the browser interface is not editable. In response to detecting an input 2624-2 on the dedicated share key 2602 and in accordance with a determination that the web content is not editable, the device displays a share menu 2612. In FIG. 26B, the content “iPad Pro” was selected prior to receiving the input 2624-2 and the selected content “iPad Pro” is marked by the selection indicators. The share menu 2612 is displayed adjacent the selection indicators. The share menu 2612 includes options for sharing the selected content “iPad Pro” with a user, a device, or an application through screen sharing (e.g., via a short-range communication protocol such as AIRDROP), instant message, email, social media (e.g., TWITTER, FACEBOOK, and/or INSTAGRAM, etc.), and/or by making a copy of the selected content.

Having a multifunction share key for sharing non-editable content with other applications and for sharing content from other application with editable content is faster and easier to perform than conventional content sharing methods and systems. The method is also intuitive for users, as both sharing to and sharing from functions are implemented with one dedicated share key, thereby reducing the cognitive burden on the user, and creating a more efficient human-machine interface. A more efficient input mechanism also requires less computing resources, thereby increasing battery life of the device.

It should be understood that the particular order in which the operations in FIG. 25 have been described is merely exemplary and is not intended to indicate that the described order is the only order in which the operations could be performed. One of ordinary skill in the art would recognize various ways to reorder the operations described herein. For brevity, these details are not repeated here.

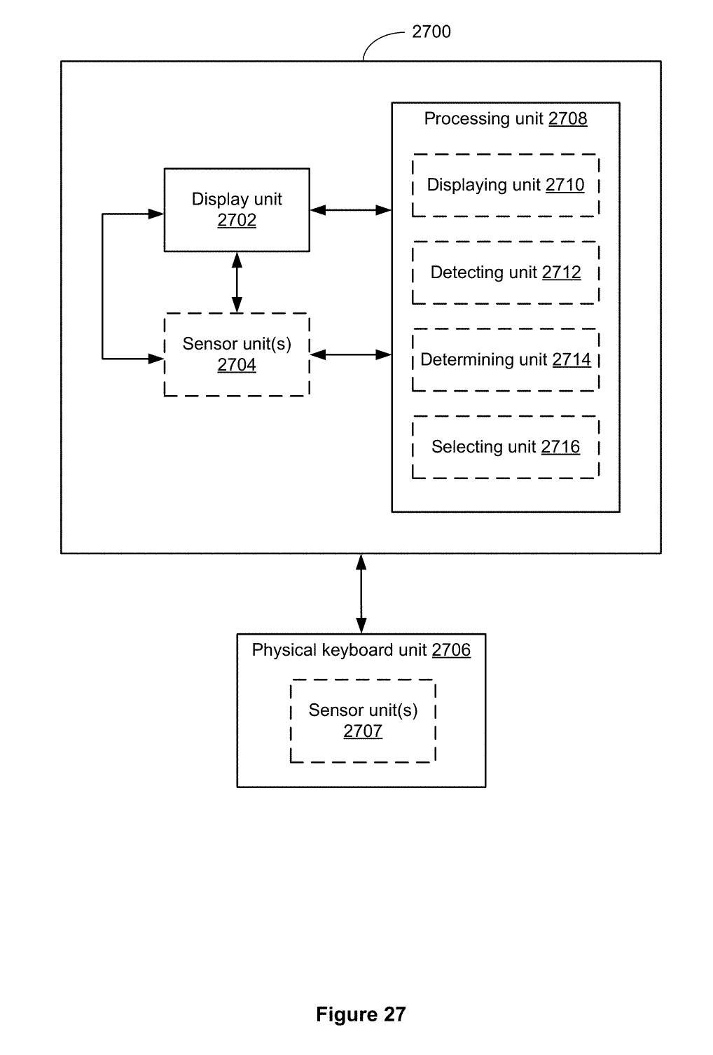

In accordance with some embodiments, FIG. 27 shows a functional block diagram of a portable multifunction device 2700 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 27 are, optionally, combined or separated into sub-blocks to implement the principles of the various described embodiments. Therefore, the description herein optionally supports any possible combination or separation or further definition of the functional blocks described herein.

As shown in FIG. 27, a portable multifunction device 2700 includes a touch-sensitive display unit 2702 configured to display user interfaces (editable content on the display unit) and configured to detect touch inputs (contacts), and a processing unit 2708 coupled with the touch-sensitive display unit 2702. In some embodiments, the portable multifunction device includes one or more sensor units 2704 and the processing unit 2708 is coupled with the touch-sensitive display unit 2702 and the one or more sensor units 2704. In some embodiments, processing unit 2708 includes one or more of the following sub-units: displaying unit 2710, detecting unit 2712, determining unit 2714, selecting unit 2716. In some embodiments, the portable multifunction device 2700 is removably coupled to a physical keyboard unit 2706 (e.g., the physical keyboard 370), which further includes one or more sensor units 2707 (e.g., the sensors 374, FIG. 3B).

The processing unit 2708 is configured to display (e.g., with the displaying unit 2710) content on the display unit 2702. The processing unit 2708 is further configured to detect (e.g., with the detecting unit 2712) an input on a dedicated share key of the physical keyboard unit 2706. In response to detecting the input, the processing unit 2708 is configured to determine (e.g., with the determining unit 2714) whether the content is editable. In accordance with a determination that the content is editable, the processing unit 2708 is configured to display (e.g., with the displaying unit 2710) an insert menu through which a user can insert content into the content; and in accordance with a determination that the content is not editable, the processing unit 2708 is configured to display (e.g., with the displaying unit 2710) a share menu through which a user can share a portion of the content.

In some embodiments, the physical keyboard unit 2706 is decoupled from the portable multifunction device and connected to an electronic device.

In some embodiments, the insert menu includes options corresponding to inserting photos, videos, music, calendar, web page, map, and/or contacts into the content.

In some embodiments, the portion of the content is selected prior to detecting the input on the dedicated share key.

In some embodiments, the share menu includes options corresponding to sharing the portion of the content with a user, device, and/or application through screen sharing, instant message, email, social media, and/or copy.

The operations in the information processing methods described above are, optionally implemented by running one or more functional modules in information processing apparatus such as general purpose processors (e.g., as described above with respect to FIGS. 1A and 3A-3B) or application specific chips.

The operations described above with reference to FIGS. 26A-26B are, optionally, implemented by components depicted in FIGS. 1A-1B or FIG. 27. For example, displaying operation 2710, detecting operation 2712, determining operation 2714, and selecting operation 2716 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Dedicated Notification Key

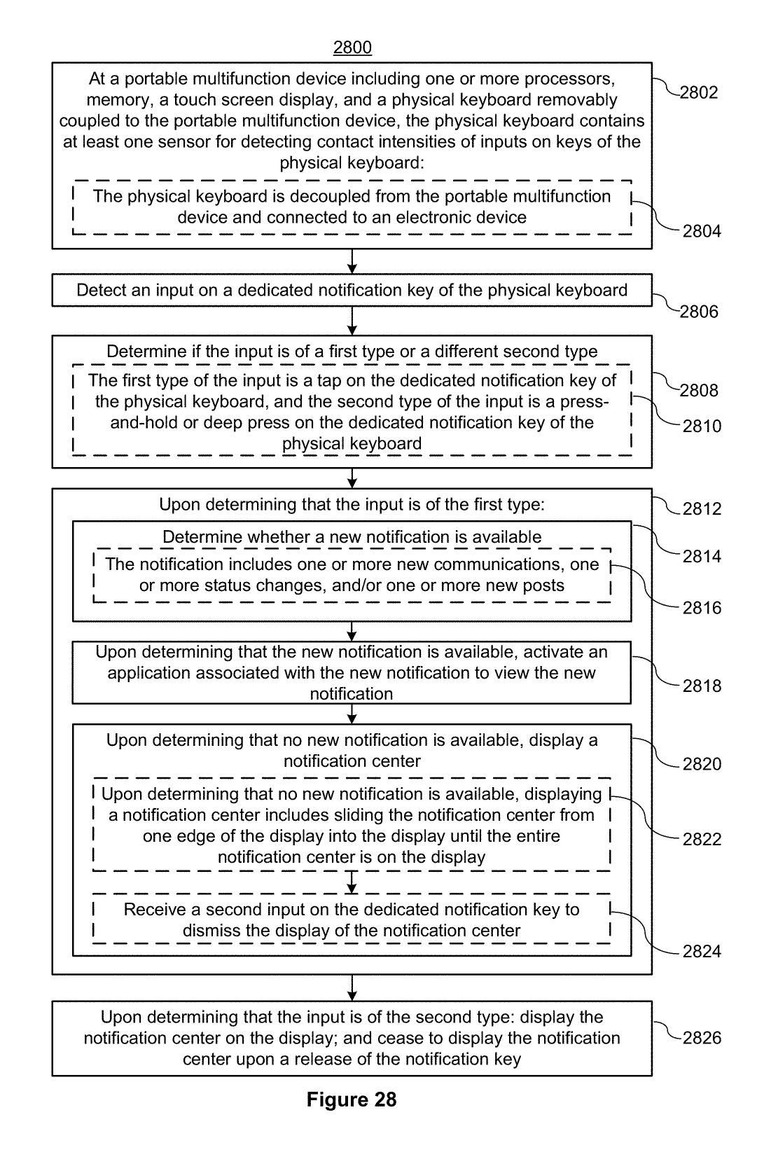

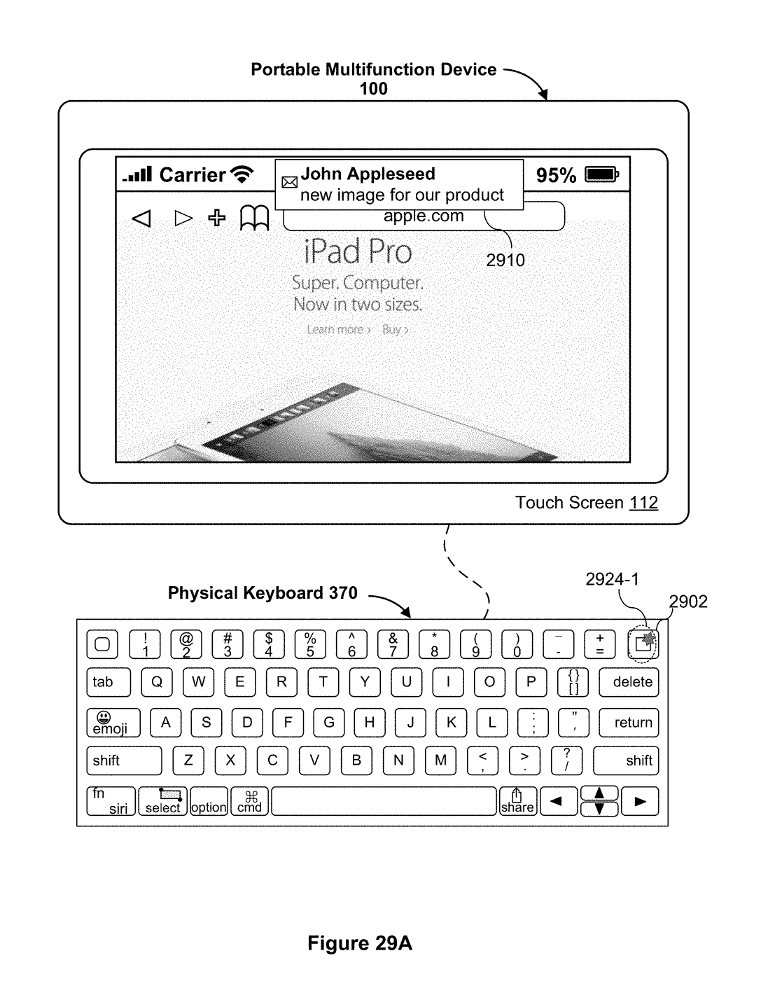

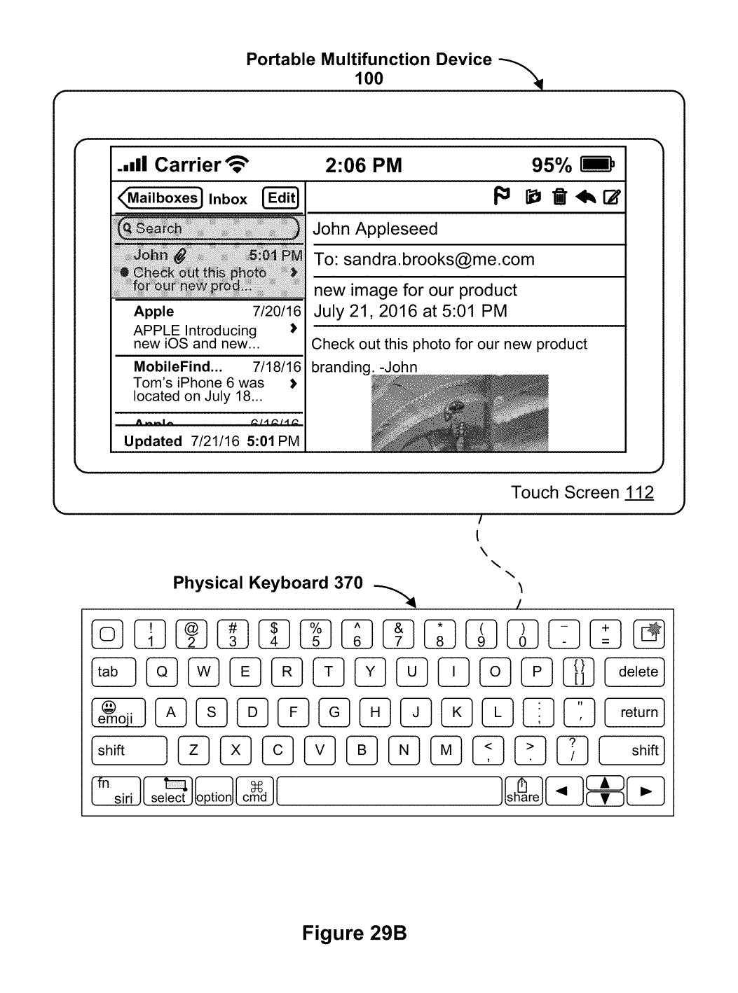

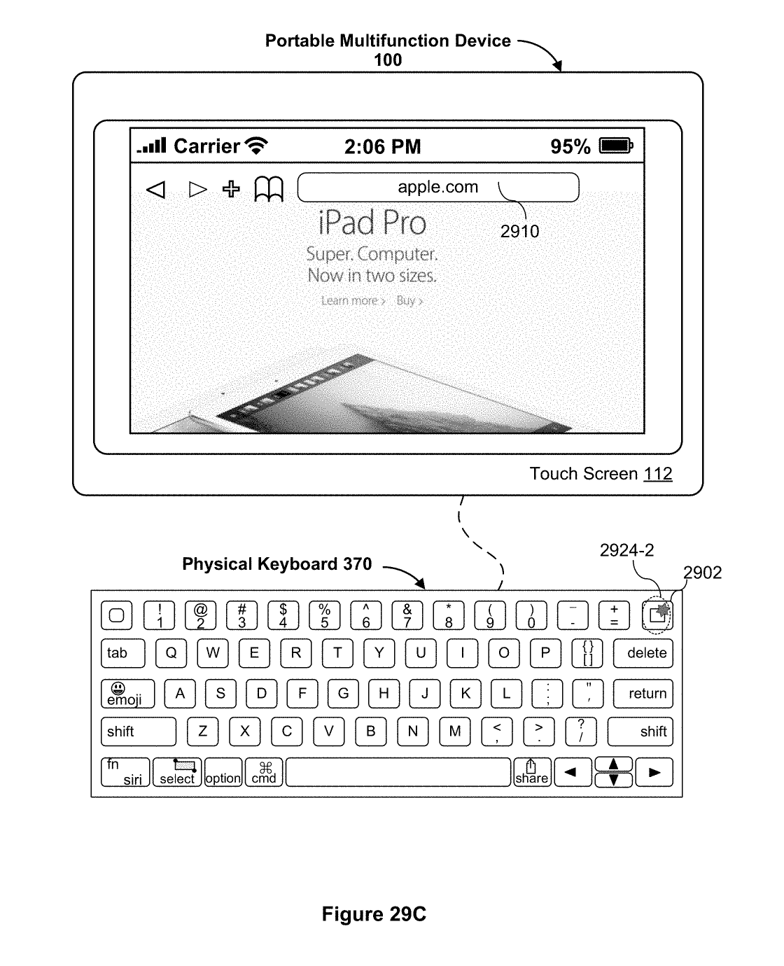

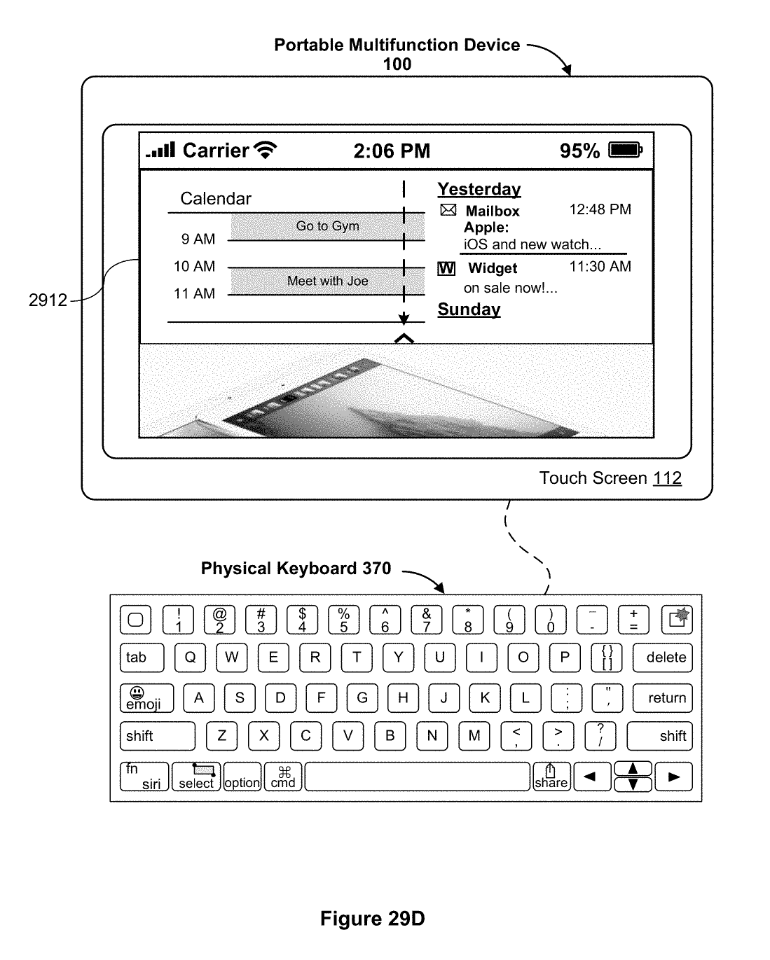

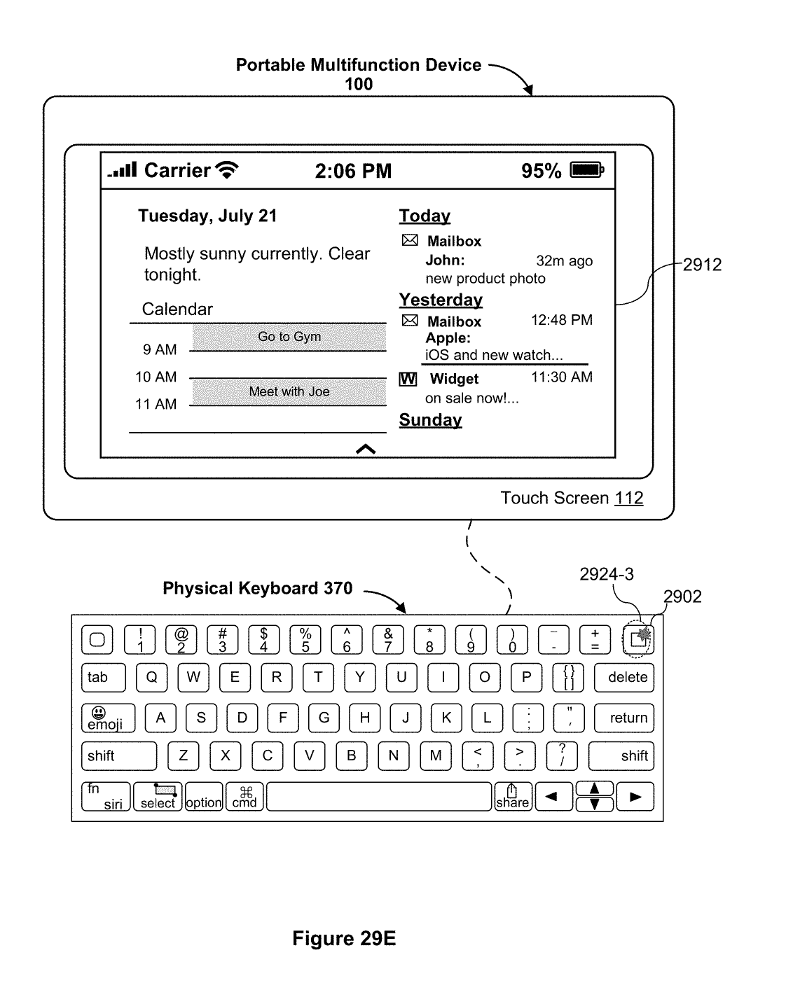

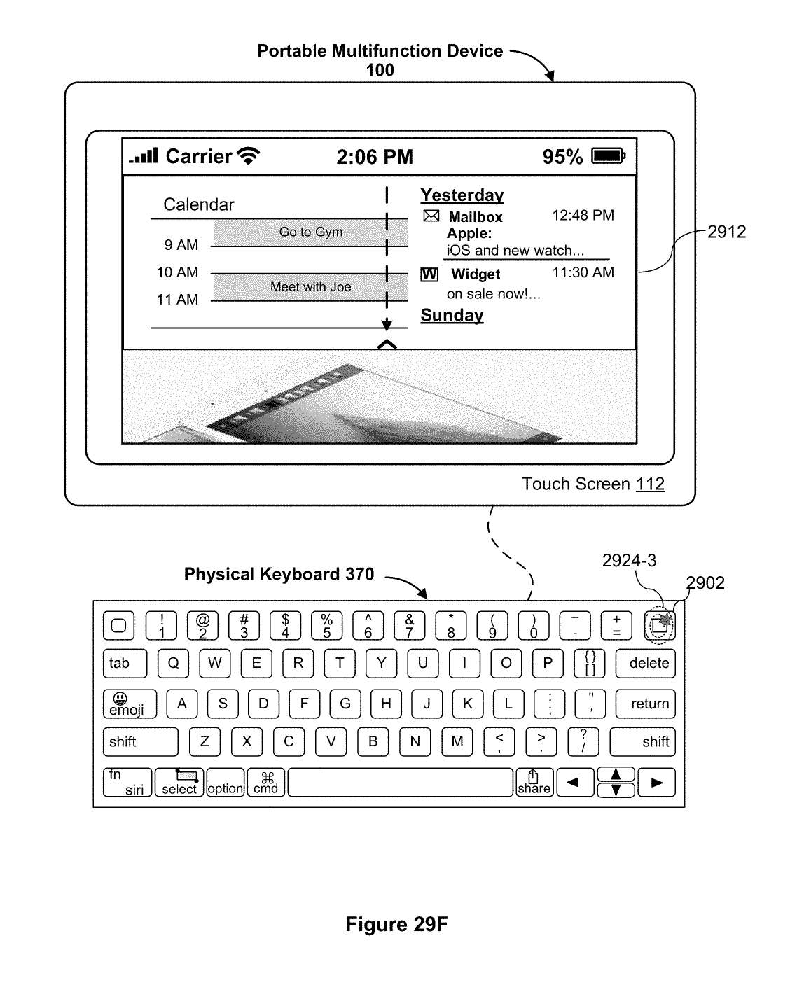

FIG. 28 is a flow chart illustrating a method 2800 of providing notification using a dedicated notification key, in accordance with some embodiments. FIGS. 29A-29F, which illustrate exemplary user interfaces of using a notification key, are used to illustrate the processes in FIG. 28. The method 2800 is performed (2802) at a portable multifunction device (e.g., the device 100 in FIG. 1A) with a touch-sensitive display (e.g., the touch screen display 112 in FIG. 1A) and a physical keyboard (e.g., the physical keyboard 370 in FIG. 3B) removably coupled to the portable multifunction device. The physical keyboard contains at least one sensor (e.g., the sensors 374, FIG. 3B) for detecting contact intensities of inputs on keys of the physical keyboard. As explained above in connection with FIG. 3B, in some embodiments, the keyboard 370 is communicatively coupled to the portable multifunction device 100 by contact (e.g., Smart Connect from Apple Computer, Inc. of Cupertino, Calif.), via a wired connection (e.g., USB, PS/2), or via a wireless communication link (e.g., optical, Bluetooth, Wi-Fi, or the like). In some embodiments, the physical keyboard is (2804) decoupled from the portable multifunction device and connected to an electronic device. For example, the physical keyboard 370 as shown in FIG. 3B and FIGS. 29A-29F can be connected to a different electronic device that does not have a touch screen. In some embodiments, as shown in FIGS. 29A-29F, the device 100 provides a physical notification key 2602 on the physical keyboard 370 coupled to the portable multifunction device 100.

As described below, the method 2800 provides an efficient mechanism for displaying notifications at a portable multifunction device. This method is faster and easier to perform than conventional notification displaying methods and systems, e.g., using a conventional keyboard with multiple key entries for displaying notifications. The method is also intuitive for users, thereby reducing the cognitive burden on the user, and creating a more efficient human-machine interface. A more efficient input mechanism also requires less computing resources, thereby increasing battery life of the device.

The device detects (2806) an input on a dedicated notification key of the physical keyboard. The device then determines (2808) if the input is of a first type or a different second type. In some embodiments, the first type of the input is a tap on the dedicated notification key of the physical keyboard, and the second type of the input is a press-and-hold (or deep press or double tap) on the dedicated notification key of the physical keyboard.

Upon determining that the input is of the first type (2812): the device determines (2814) whether a new notification is available. In some embodiments, the new notification includes (2816) one or more new communications, one or more status changes, and/or one or more new posts. For example, in FIG. 29A, the notification 2910 displayed on top of the touch screen 112 as a banner that contains a notification for a new incoming email communication. Further upon determining that the input is of the first type and a notification is available, the device activates (2818) an application associated with the notification; and upon determining that the input is of the first type and no new notification is available, the device displays (2820) a notification center. An example of a notification center 2912 is shown in FIG. 29D. As shown, in some embodiments, the notification center 2912 displays appointment and widget status updates in addition to email communications. In some embodiments, upon determining that no new notifications are available, a notification center slides (2822) onto the display from one edge of the display until the entire notification center is displayed. In some embodiments, the device further receives (2824) a second input on the dedicated notification key to dismiss the display of the notification center and return to the prior screen.

For example, in FIG. 29A, while a browser application interface is displayed on the touch screen 112, a new notification 2910 appears on the screen 112 as a banner to notify the user of a new email. While the new notification 2910 is displayed on the screen 112, the device detects an input 2924-1, e.g., a tap on the notification key 2902. The device determines that the tap 2924-1 is of the first type, and that a new notification 2910 is available. The device then activates the email application associated with the notification 2910 and displays the email application user interface, as shown in FIG. 29B. In FIG. 29B, the new email is opened and the content of the new email is displayed to the user in the email application user interface. In comparison, in FIG. 29C, when no new notification is available and the device detects the input 2924-2, e.g., a tap on the notification key 2902 that is of the first type, the notification center 2912 is displayed, as shown in FIG. 29D. In some embodiments, as indicated by the dotted line, the notification center 2912 is displayed by gradually sliding down from the top edge of the touch screen 112 and overlaying on top of the active window(s), e.g., the browser application interface, until the entire notification center 2912 is displayed on the touch screen display 112, as shown in FIG. 29E. In FIG. 29E, while the notification center 2912 is displayed on the touch screen 112, in response to receiving a second input, e.g., a tap 2924-3 on the notification key 2902, the device ceases to display the notification center 2912 and reveals the previously displayed active window.

Having a dedicated notification key and displaying content of the notification in response to a tap on the notification key provides an efficient mechanism for displaying notifications at a portable multifunction device. Conventional keyboards do not have a dedicated notification key, and instead, the user must rely on shortcut keys or other input methods to view notifications. Thus the method described herein is faster and easier to perform than conventional notification display methods and systems. The method is also intuitive for users, thereby reducing the cognitive burden on the user, and creating a more efficient human-machine interface. A more efficient input mechanism also requires less computing resources, thereby increasing battery life of the device.

Referring back to FIG. 28, upon determining that the input is of the second type: the device temporarily displays (2826) the notification center on the display and then ceases to display the notification center upon a release of the notification key. For example, FIG. 29F illustrates a quick view of the notification center 2912 by pressing and holding the notification key 2902 (and/or by maintaining a deep press on the notification key 2902). In some embodiments, upon determining that the input 2924-3 is of the second type, e.g., a press-and-hold (and/or deep press) on the notification key 2902, while the key 2902 is still pressed, the notification center 2912 is slid down from the top edge of the touch screen display 112. Though not shown in FIG. 29F, in response to a release of the notification key 2902, the device ceases to display the notification center 2912 by sliding the notification screen up to the top edge of the touch screen display 112.

Providing a preview of the notification center in response to a press-and-hold and/or deep press on the dedicated notification key is an efficient mechanism for displaying notifications at a portable multifunction device. Conventional keyboards do not have a dedicated notification key or a mechanism for previewing notifications. Thus the method described herein is faster and easier to perform than conventional notification display methods and systems. The method is also intuitive for users, e.g., while holding on to the notification key, the notification center is displayed and, upon release of the notification key, the notification ceases to display, thereby reducing the cognitive burden on the user, and creating a more efficient human-machine interface. A more efficient input mechanism also requires less computing resources, thereby increasing battery life of the device.

It should be understood that the particular order in which the operations in FIG. 28 have been described is merely exemplary and is not intended to indicate that the described order is the only order in which the operations could be performed. One of ordinary skill in the art would recognize various ways to reorder the operations described herein. For brevity, these details are not repeated here.

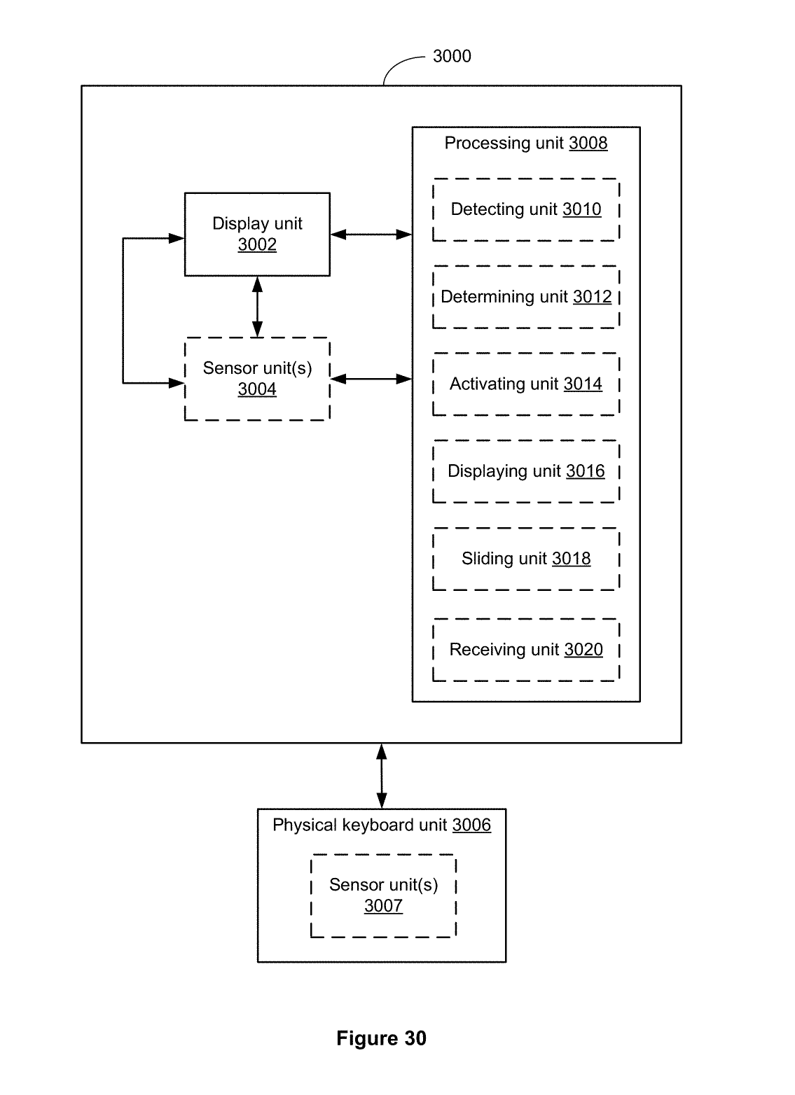

In accordance with some embodiments, FIG. 30 shows a functional block diagram of a portable multifunction device 3000 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 30 are, optionally, combined or separated into sub-blocks to implement the principles of the various described embodiments. Therefore, the description herein optionally supports any possible combination or separation or further definition of the functional blocks described herein.

As shown in FIG. 30, a portable multifunction device 3000 includes a touch-sensitive display unit 3002 configured to display user interfaces (editable content on the display unit) and configured to detect touch inputs (contacts), and a processing unit 3008 coupled with the touch-sensitive display unit 3002. In some embodiments, the portable multifunction device includes one or more sensor units 3004 and the processing unit 3008 is coupled with the touch-sensitive display unit 3002 and the one or more sensor units 3004. In some embodiments, processing unit 3008 includes one or more of the following sub-units: detecting unit 3010, determining unit 3012, activating unit 3014, displaying unit 3016, sliding unit 3018, receiving unit 3020. In some embodiments, the portable multifunction device 3000 is removably coupled to a physical keyboard unit 3006 (e.g., the physical keyboard 370), which further includes one or more sensor units 3007 (e.g., the sensors 374, FIG. 3B).

The processing unit 3008 is configured to detect (e.g., with the detecting unit 3010) an input on a dedicated notification key of the physical keyboard unit 3006. The processing unit 3008 is further configured to determine (e.g., with the determining unit 3012) if the input is of a first type or a different second type. Upon determining that the input is of the first type, the processing unit 3008 is configured to determine (e.g., with the determining unit 3012) whether a notification is available. Upon determining that the notification is available, the processing unit 3008 is configured to activate (e.g., with the activating unit 3014) an application associated with the notification, and upon determining that no notification is available, processing unit 3008 is configured to display (e.g., with the displaying unit 3016) a notification center. On the other hand, upon determining that the input is of the second type, the processing unit 3008 is configured to display (e.g., with the displaying unit 3016) the notification center on the display unit 3002; and cease to display (e.g., with the displaying unit 3016) the notification center upon a release of the notification key.

In some embodiments, the physical keyboard unit 3006 is decoupled from the portable multifunction device and connected to an electronic device.

In some embodiments, the first type of the input is a tap on the dedicated notification key of the physical keyboard unit 3006, and the second type of the input is a press-and-hold or deep press on the dedicated notification key of the physical keyboard unit 3006.

In some embodiments, the notification includes one or more received communications, one or more status changes, and/or one or more new posts.

In some embodiments, upon determining that no notification is available, displaying a notification center includes sliding (e.g., with the sliding unit 3018) the notification center from one edge of the display unit 3002 into the display unit 3002 until the entire notification center is on the display unit 3002.

The processing unit 3008 is further configured to receive (e.g., with the receiving unit 3020) a second input on the dedicated notification key to dismiss the display of the notification center.

The operations in the information processing methods described above are, optionally implemented by running one or more functional modules in information processing apparatus such as general purpose processors (e.g., as described above with respect to FIGS. 1A and 3A-3B) or application specific chips.

The operations described above with reference to FIGS. 29A-29F are, optionally, implemented by components depicted in FIGS. 1A-1B or FIG. 30. For example, detecting operation 3010, determining operation 3012, activating operation 3014, displaying operation 3016, sliding operation 3018, receiving operation 3020 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Touch-Strip

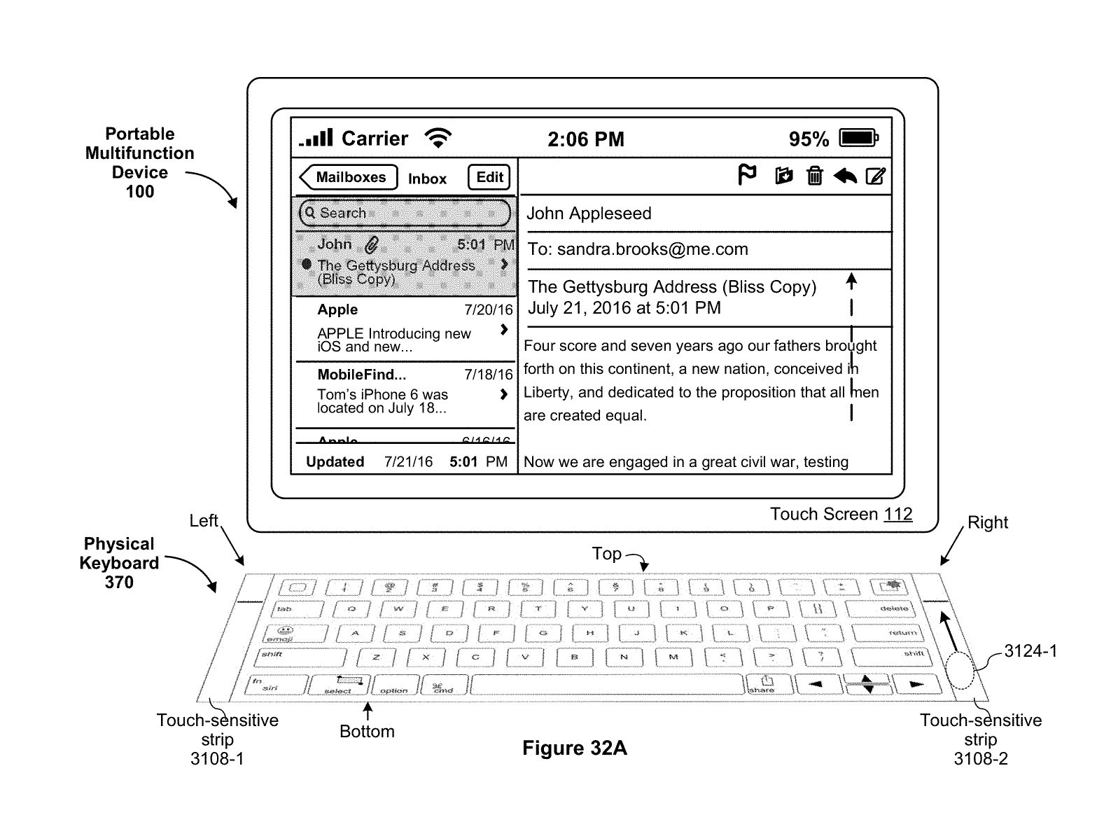

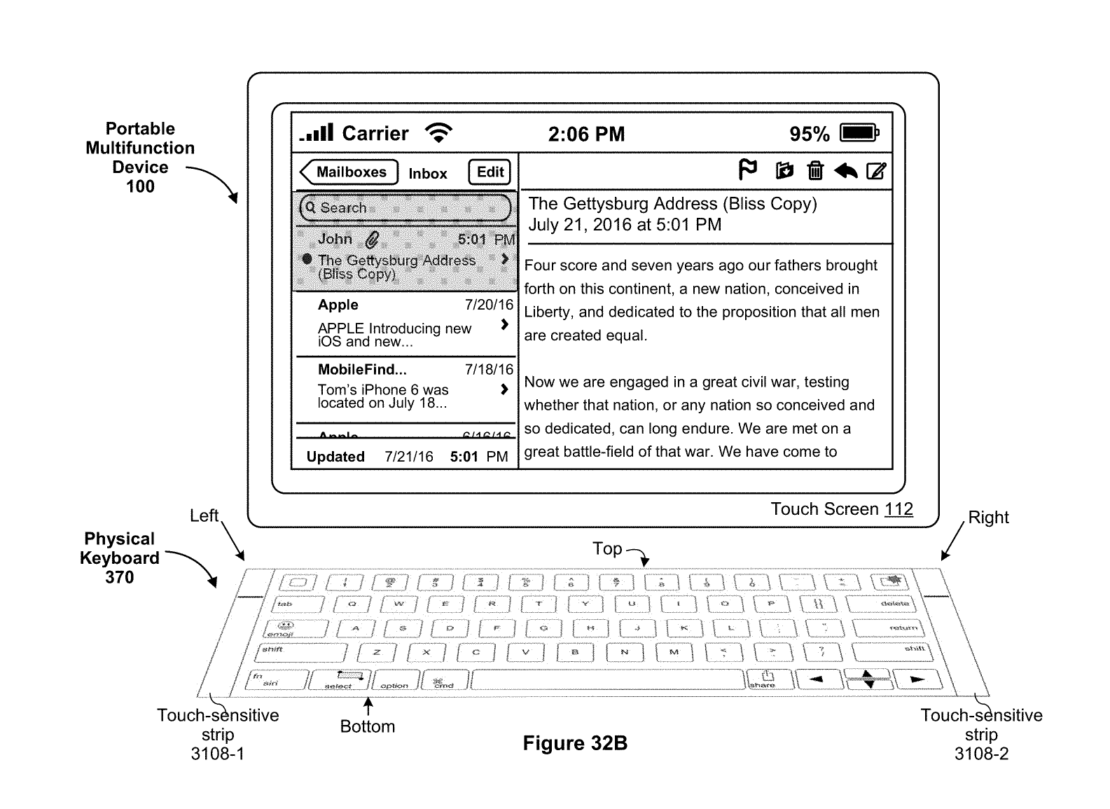

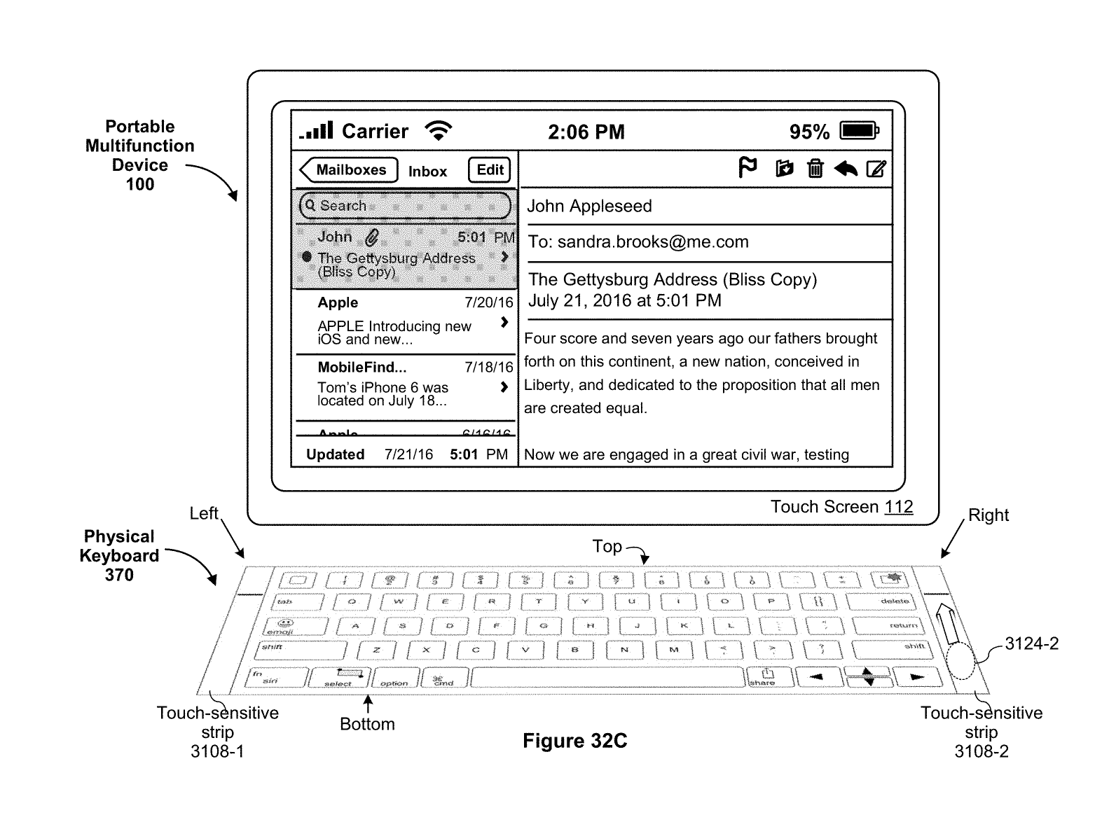

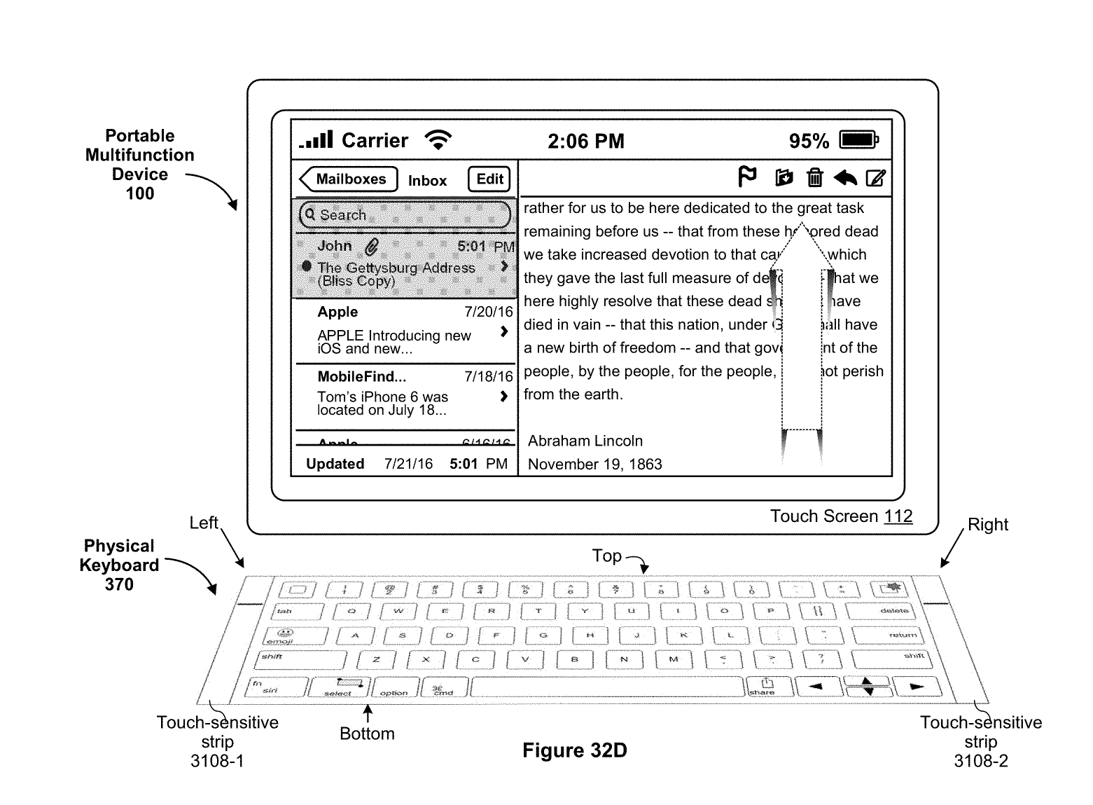

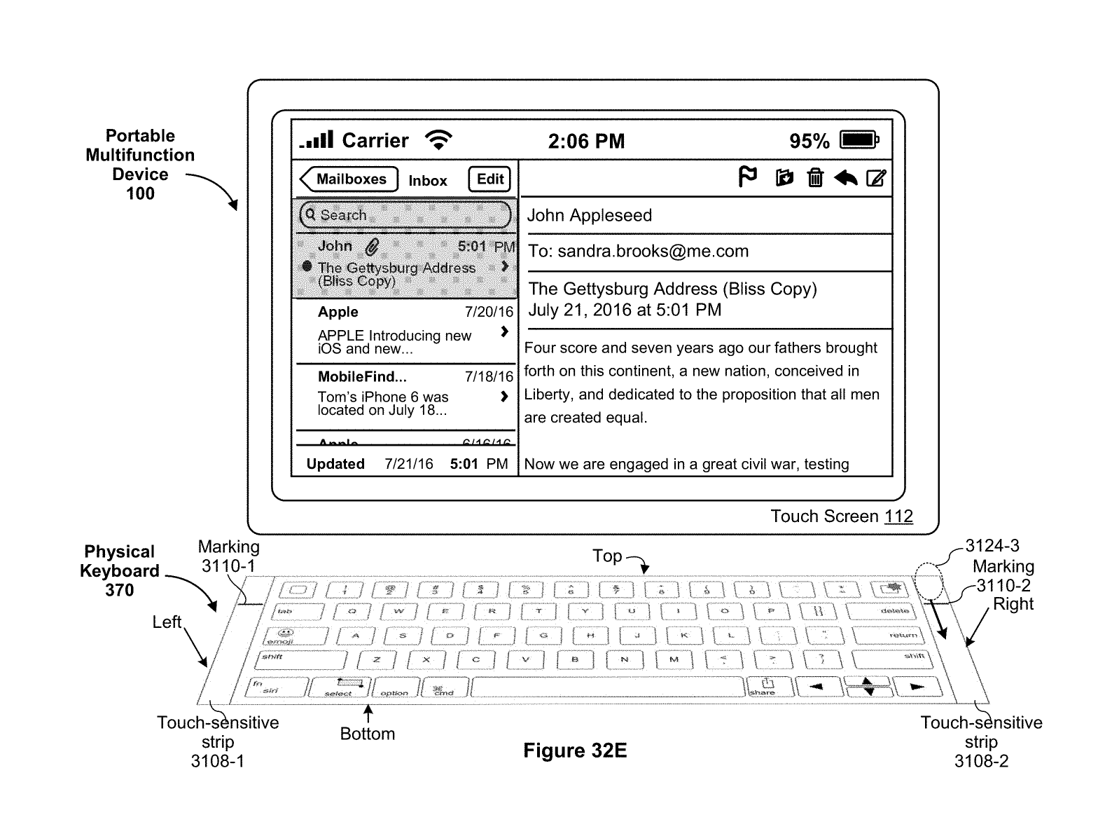

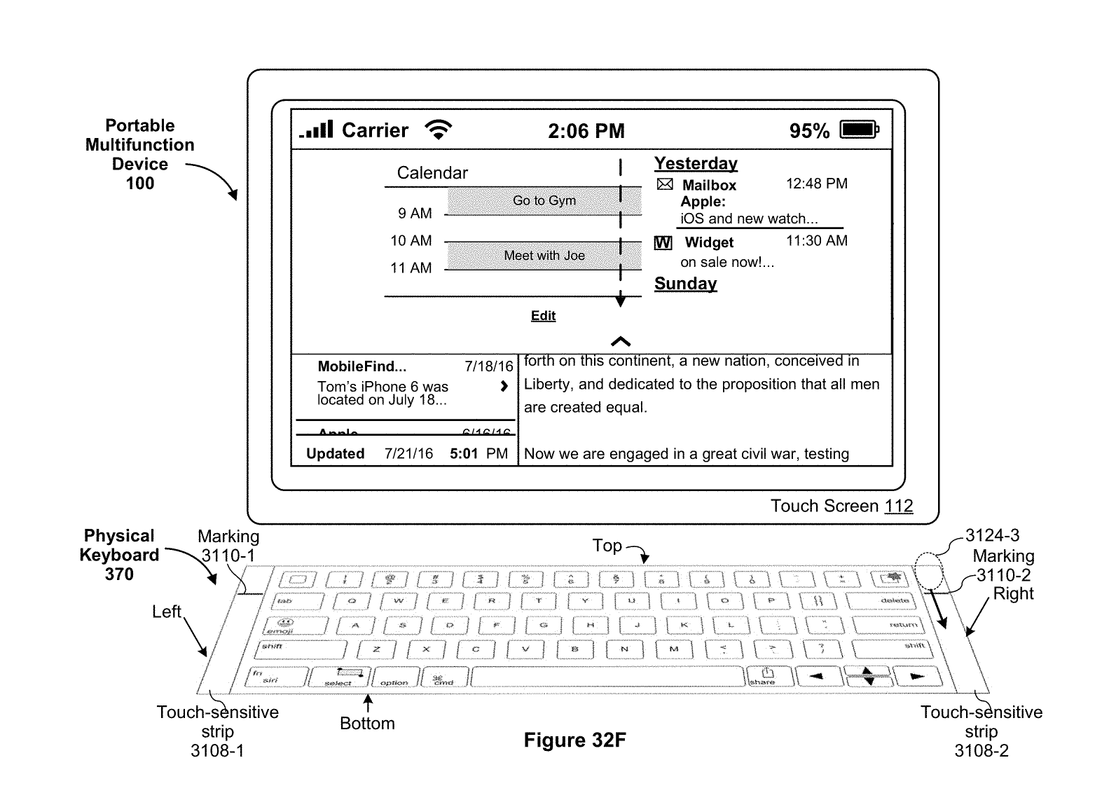

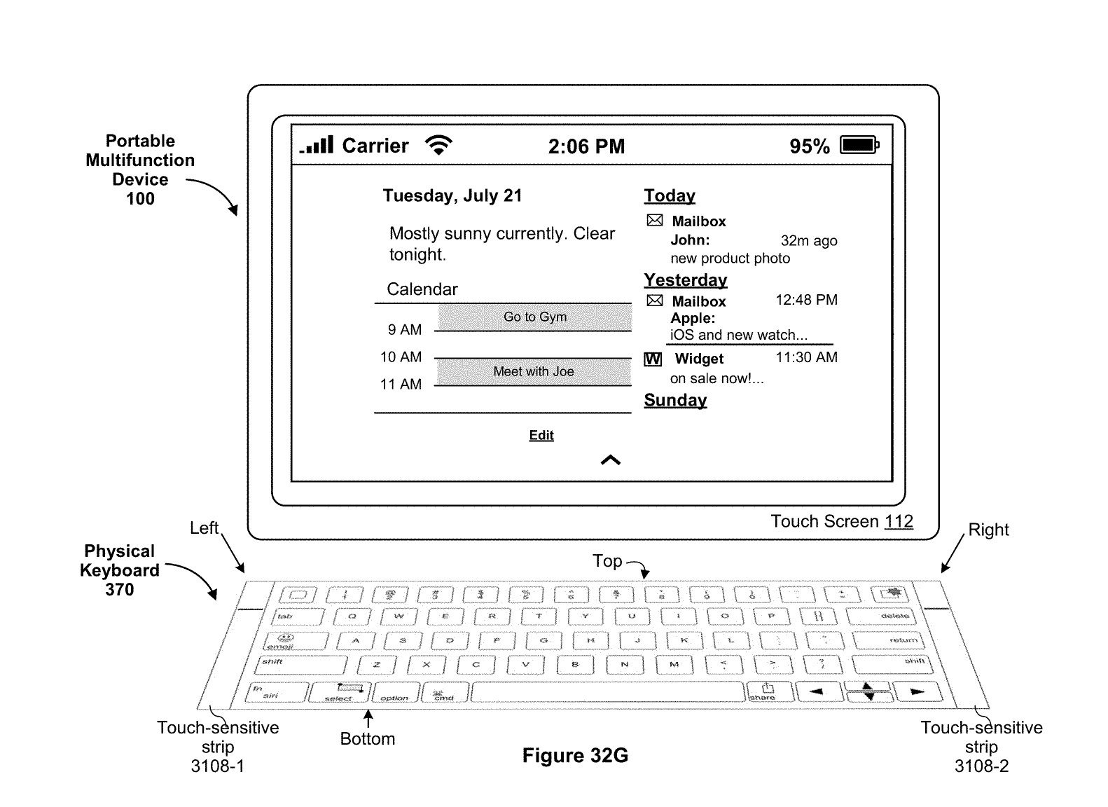

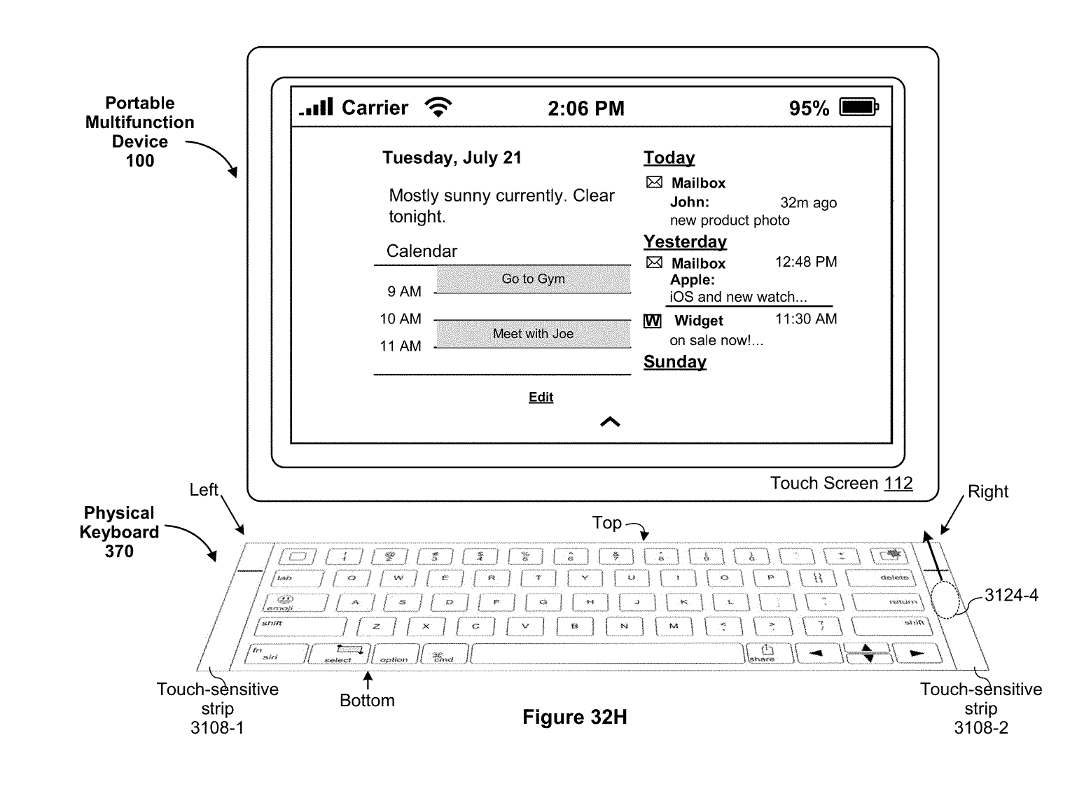

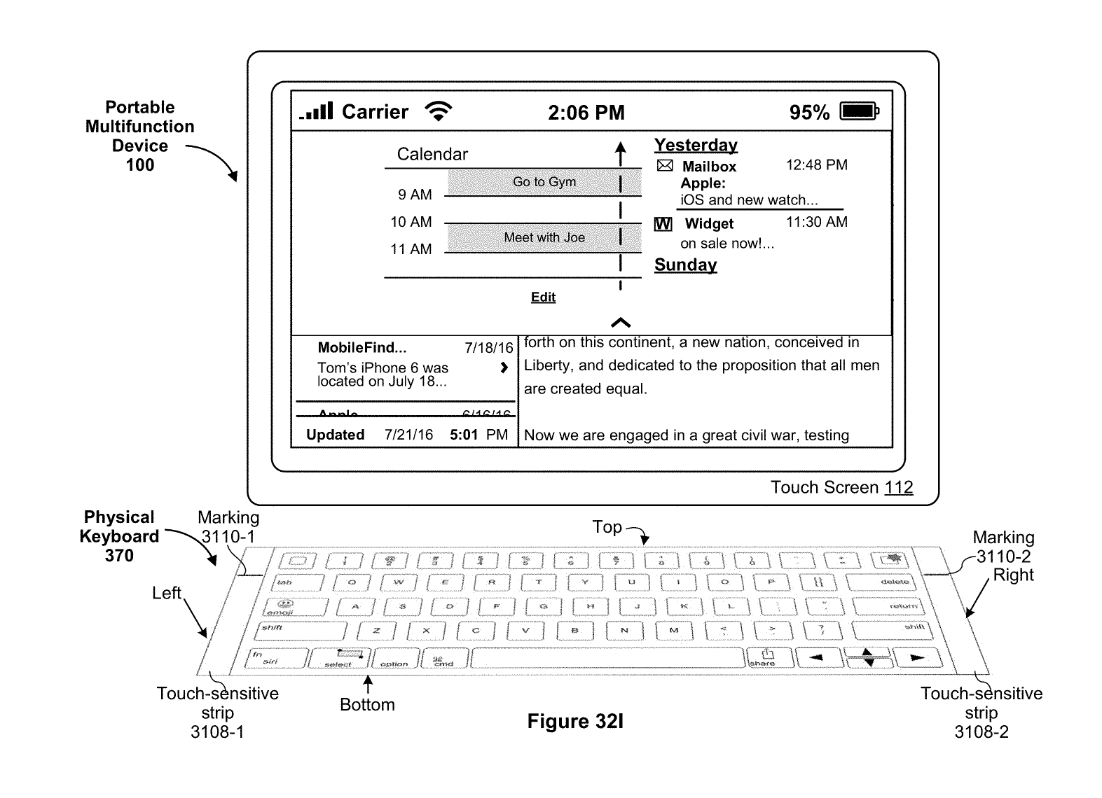

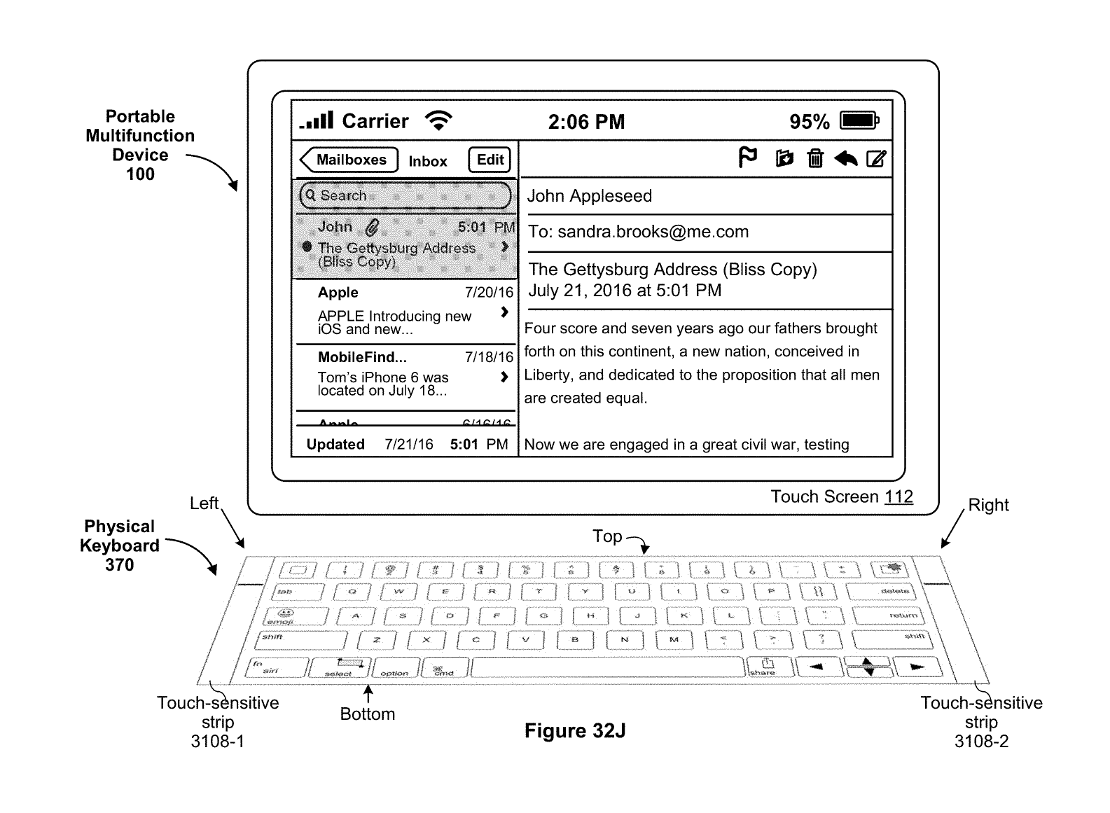

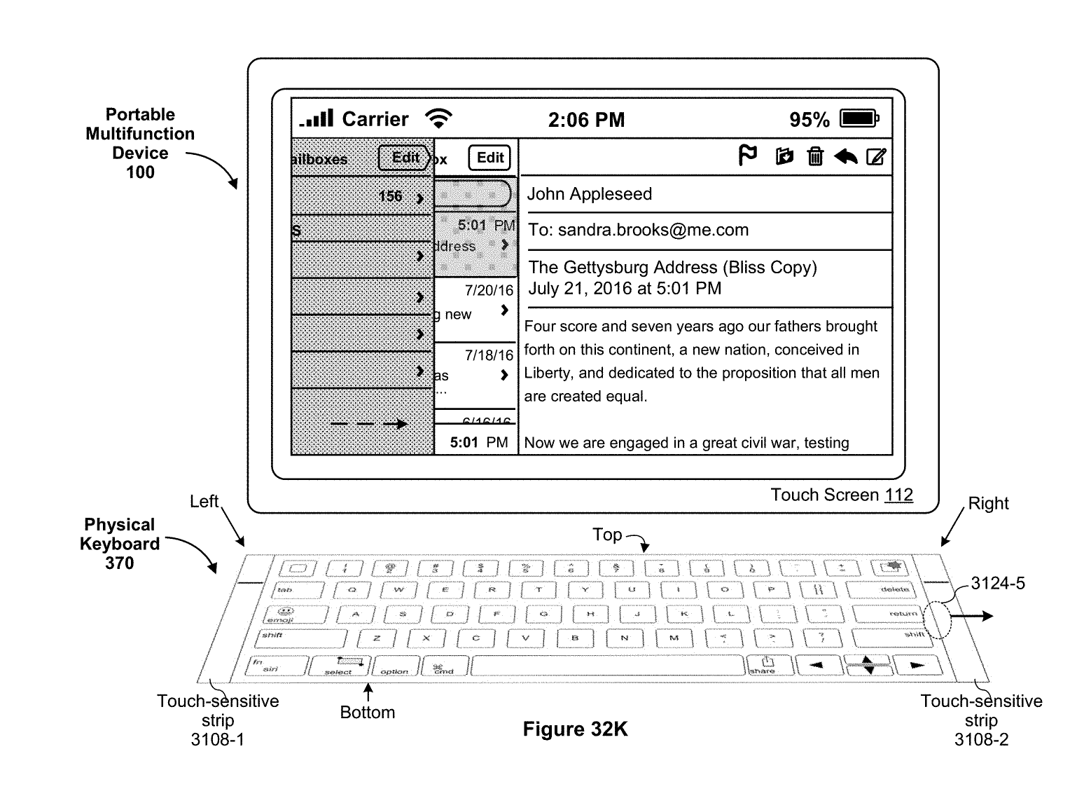

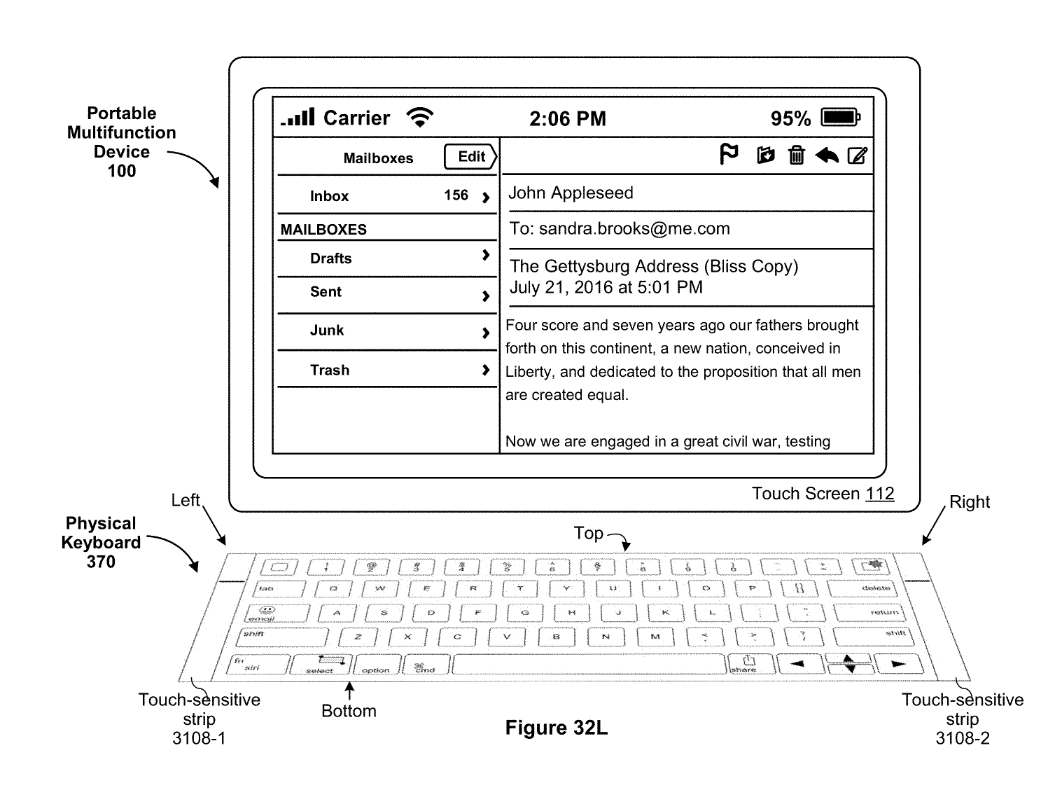

FIG. 31A illustrates a detachable keyboard (e.g., the keyboard 370 in FIG. 3B) with one or more touch-sensitive input strips, in accordance with some embodiments. FIG. 31B illustrates a system comprising a keyboard 370 and a touch screen device (e.g., the portable multifunction device 100, FIGS. 1A-1B), in accordance with some embodiments. FIGS. 32A-32L, which illustrate exemplary user interfaces on the portable multifunction device 100, are used to illustrate the usage of the detachable keyboard 370 with one or more touch-sensitive input strips.

In FIGS. 31A and 31B, the detachable keyboard 370 with one or more touch-sensitive input strips comprises a housing 3102. As shown, the housing 3102 has a top side, bottom side, left side, and right side. A plurality of physical keys are arranged in a key area 3104 that is at least partially contained within the housing 3102. In some embodiments, these keys include multifunctional keys described above. For example, the multifunctional keys arranged in the key area 3104 include an emoji key (e.g., the emoji key 802, FIGS. 8A-8F) for entering emoji and punctuation characters, a currency key (e.g., the currency key 1002, FIGS. 11A-11E) for entering currency character and automated currency conversion, an address key (e.g., the address key, FIGS. 14A-14E) for address suggestions and entries, a home key (e.g., the home key 1702, FIGS. 17A-17E) for displaying home screen and toggling active windows, a select key (e.g., the select key 2002, FIGS. 20A-20C) for content selection, a tab key (e.g., the tab key 2302, FIGS. 23A-23C) for active pane switching and word auto suggestions, a share key (e.g., the share key 2602, FIGS. 26A-26B) for content sharing, and a notification key (e.g., the notification key 2902, FIGS. 29A-29F) for displaying notifications. By removing less frequently used keys and including these multifunction keys, the size of the physical keyboard is reduced while reducing the need for the user to reach up from the keyboard.

In addition to the physical keys, in FIGS. 31A and 31B, at least one connector 3106 is disposed at the top side of the housing 3102 to connect the detachable keyboard 370 to a touch screen device, e.g., the portable multifunction device 100 (FIGS. 1A-1B), which has at least one corresponding connector 368. As explained above in connection with FIGS. 1A-1B and FIG. 3B, in some embodiments as shown in FIG. 31B, through the one or more connectors 3106 and the connector 368, the keyboard 370 is communicatively coupled to the portable multifunction device 100 by contact (e.g., Smart Connect from Apple Computer, Inc. of Cupertino, Calif.), via a wired connection (e.g., USB, PS/2), or via a wireless communication link (e.g., optical, Bluetooth, Wi-Fi, or the like). Thus, in some embodiments, the one or more connectors 3106 are electrical contacts; and in some embodiments, the one or more connectors 3106 are optical connectors. Using these connectors, in some embodiments, the physical keyboard 370 can be decoupled from the portable multifunction device and connected to one or more electronic devices. For example, the physical keyboard 370 as shown in FIG. 3B and FIGS. 31A-31B can be connected to a different electronic device that does not have a touch screen.

The keyboard 370 further comprises at least one elongate touch-sensitive strip 3108-1 disposed at the left side of the housing 3102, and at least one elongate touch-sensitive strip 3108-2 disposed at the right side of the housing 3102. Though not shown in FIGS. 31A and 31B, other elongate touch-sensitive strips can be disposed at the top and/or bottom sides of the housing 3102. Each touch-sensitive strip 3108 contains one or more sensors to detect one or more contacts with, sliding movements, and/or a breaking of contact with the sensor(s). Such sensors use capacitive, resistive, infrared, force, and/or surface acoustic wave technologies. Using these touch strips, the keyboard 370 provides hardware optimized for scrolling without needing a full trackpad on the keyboard and reduces the need for the user to reach up from the keyboard to the touch screen display of the portable multifunction device.

In some embodiments, a length of the touch-sensitive strip extends across a majority of each respective side of the housing. As shown in FIGS. 31A and 31B, the left elongate touch-sensitive strip 3108-1 is long enough to extend across a majority of the left side of the housing 3102 and the right elongate touch-sensitive strip 3108-2 is long enough to extend across a majority of the right side of the housing 3102. In some embodiments, the touch-sensitive strips include one or more markings 3110 (e.g., marking 3110-1 and marking 3110-2) to indicate different regions of the touch-sensitive strip. A touch input starting within a particular region of the touch-sensitive strip followed by movement of the contact on the touch-sensitive strip may cause the device 100 to perform a particular action, as described in greater detail below with reference to FIGS. 32E-32G.

In some embodiments, the keyboard 370 further comprises sensors, e.g. contact intensity sensors 3111, configured to acquire contact intensity information (e.g., pressure information or a proxy for pressure information) from user inputs. For example, in FIG. 31B, the contact intensity sensors 3111 are disposed below the arrow keys for detecting the pressure on the arrow keys. Though not shown in FIGS. 31A and 31B, in some embodiments, contact intensity sensors are disposed under or proximate the touch-sensitive strips 3108 of the physical keyboard 370, so that both contact and contact intensity on the touch-sensitive strips 3108 can be detected. Also not shown in FIGS. 31A and 31B, in some embodiments the keyboard 370 further comprises microphones or vibration sensors for detecting gestures, e.g., swipes on a surface. For example, the microphones or vibration sensors can be installed under the keyboard 370 such that when the keyboard 370 is placed on a surface, e.g., a desk surface, swipes on the desk surface can be detected by the microphone or vibration sensors thereby turning the desk surface to a touch-sensitive surface. Using these sensors, the keyboard 370 provides hardware optimized for scrolling without the need for a full trackpad reduces the need to reach up to the touch screen of the portable multifunction device.

In some embodiments, the contact intensity sensors can be used to sense a force on the arrow keys, and depending on the force, the velocity of scrolling can be adjusted. Similarly, the velocity of scrolling can be adjusted based on a speed of a swipe on the touch-sensitive strips.

FIGS. 32A-32L illustrate exemplary user interfaces on the portable multifunction device 100 that are used to illustrate the usage of the detachable keyboard 370 with the one or more touch-sensitive input strips. In some embodiments, the touch screen device (e.g., the portable multifunction device 100, FIGS. 1A-1B) comprises a processor and memory containing instructions for: detecting, via the at least one elongate touch-sensitive strip, a swipe along at least a portion of the length of the at least one elongate touch-sensitive strip; and in response to detecting the swipe, scrolling content displayed on the touch screen device in a direction associated with the swipe.

For example, in FIG. 32A, the portable multifunction device 100, via the right elongate touch-sensitive strip 3108-2 detects a swipe 3124-1 along the length of the right elongate touch-sensitive strip 3108-2 and toward the top side of the physical keyboard 370's housing. As shown in FIG. 32B, in response to detecting the swipe 3124-1, the device 100 scrolls the email content toward the top side of the display. In FIG. 32B, the “from” and “to” address lines in the email are scrolled off the display and more content from the second paragraph of the email content is scrolled onto the display 112.

In some embodiments, the speed of the scrolling is proportional to the speed of the swipe. For example, in FIG. 32C, a faster swipe 3124-2 (or a flick) is detected along the length of the right elongate touch-sensitive strip 3108-2 toward the top of the keyboard 370's housing. In response to detecting the faster swipe 3124-2, the device 100 scrolls the email content up and to the top of the touch screen display 112 at a proportionate and higher speed, as shown in FIG. 32D. As shown in FIGS. 32C and 32D, the email headers are scrolled up and off of the touch screen display 112, while the email content is scrolled up and almost reaches the end of the email. In comparison, in FIGS. 32A and 32B, in response to a slower swipe, a portion of the email headers remains on the touch screen display 112 and the second complete paragraph of the email content starts to move to the center of the display 112.

Thus, swiping on the touch-sensitive strips towards/away from the screen scrolls the content on the display up/down. Further, the content scrolling is performed in accordance with the contact movement on the touch-sensitive strips, e.g., a swipe on the touch-sensitive strips causes slow scrolling and a flick on the strips causes faster scrolling with an inertia effect, e.g., the scrolling slows down near the end of the movement. Using these touch strips, the keyboard 370 provides hardware optimized for scrolling without the need for a full trackpad and prevents unnecessary reaching up from the keyboard to the touch screen display of the portable multifunction device.

Turning to FIG. 32E, the device 100, via the right touch-sensitive strip 3108-2, detects a contact 3124-3 within a top region of the touch-sensitive strip 3108-2. The marking 3110-2 divides the touch-sensitive strip 3108-2 into a top region and a bottom region, where the top region is closer to the top side of the keyboard 370 housing. Though FIG. 32E shows one marking dividing the touch-sensitive strip 3108-2 into two regions, more than one marking can be used to divide the touch-sensitive strip 3108-2 into more than two regions.

In response to detecting the contact 3124-3 within the top region of the touch-sensitive strip and the subsequent movement of the contact 3124-3 in a direction away from the top side of the housing and/or the at least one connector, the device 100 gradually slides the notification center interface onto the touch screen 112 as an overlay from the one edge of the touch screen 112, as shown in FIG. 32F. This occurs until the entire notification center interface is displayed on the touch screen 112, as shown in FIG. 32G. In some embodiments, while the finger movement remains in contact with the touch-sensitive strip 3108-2, the sliding of the notification center is performed in accordance with the movement of the contact 3124-3, e.g., when the finger sliding on the touch-sensitive strip 3108-2 is slower, the sliding of the notification center is slower. In some embodiments, after a lift-off of the contact 3124-3 is detected and in accordance with a determination that the notification center has not been entirely displayed on the touch screen 112, the notification center continues to slide into the display to mimic an inertia effect of the swipe on the touch-sensitive strip 3108-2.

In some implementations, in response to detecting a downward swipe starting from a top portion of the touch strip, the notification center is pulled down. Similarly, a upward swipe pulls-up/closes the notification center.

In some embodiments, the memory of the touch screen device 100 further contains instructions for: detecting via the at least one elongate touch-sensitive strip, while the notification center is displayed on the display of the touch screen device, a second contact on the at least one elongate touch-sensitive strip, followed by a movement of the second contact in a direction to the top side of the detachable keyboard and toward the at least one connector; and in response to detecting the second contact followed by the movement of the second contact, ceasing to display the notification on the display of the touch screen device.

For example, in FIG. 32H, when the entire notification center is displayed on the touch screen 112, and the device 100, via the touch-sensitive strip 3108, detects a subsequent movement of the contact 3124-4 toward the top side of the housing, the device ceases to display the notification center by sliding the notification center interface off the touch screen 112 and reveals the user interface displayed underneath, as shown in FIG. 32I. Similarly, in some embodiments, the notification center is slid up on the touch screen 112 in accordance with the upward movement of the contact 3124-4. Again, this allows a user of the portable multifunction device to keep their hands on the keyboard without the need to reach up to the touch screen display.

In some embodiments, the touch screen device comprises a processor and memory containing instructions for: displaying a first pane in an active window on a display of the touch screen device; detecting, via the at least one elongate touch-sensitive strip, a contact followed by a movement of the contact in a direction parallel to the top side of the detachable keyboard; and in response to detecting the contact followed by the movement of the first, sliding a second pane into the display of the touch screen device in accordance with the direction and movement of the first contact until the second pane replaces the first pane in the application interface on the display, wherein the first pane and the second pane are in a navigational hierarchy specified for the active window.

For example, FIG. 32J shows an email application interface displayed on the touch screen 112 as the active window. The left side of the email application interface includes an inbox pane. The inbox pane can be navigated to by, for example, selecting the inbox from the mailboxes pane. The mailboxes pane can be navigated to, for example, by selecting the back button labeled as “Mailboxes.” Thus, the inbox and mailboxes panes are in a navigational hierarchy of the email application interface. In FIG. 32K, the device detects a contact 3124-5 on the touch-sensitive strip 3108-2 followed by a movement of the contact 3124-5 in a direction to the right and parallel to the top side of the keyboard 370. In response to detecting the contact 3124-5 followed by the rightward movement, the device slides the mailboxes pane into the display 112 of the device 100 in a rightward direction, as shown in FIG. 32K, until the mailboxes pane replaces the inbox pane in the email application interface on the display 112, as shown in FIG. 32L.

Thus, swiping side-to-side on the touch-sensitive strip reveals different navigational levels of the user interface hierarchy. Again, using the touch strips of the keyboard 370 reduces the need to reach up from the keyboard to the touch screen display of the portable multifunction device.

Though FIGS. 32J-32L illustrate the contact 3124-5 on the right touch-sensitive strip 3108-2, similar contacts 3124-5 can be detected on left, top, and/or bottom touch-sensitive strips of the keyboard 370. Further, although FIGS. 32A-32L illustrate a single contact 3124 on one of the touch-sensitive strips, in some embodiments, multiple contacts can be simultaneously detected on one or more of the touch-sensitive strips to implement multi-finger gestures, e.g., depinch to zoom etc.

It should be understood that the particular order in which the operations in FIGS. 31A-31B have been described is merely exemplary and is not intended to indicate that the described order is the only order in which the operations could be performed. One of ordinary skill in the art would recognize various ways to reorder the operations described herein. For brevity, these details are not repeated here.

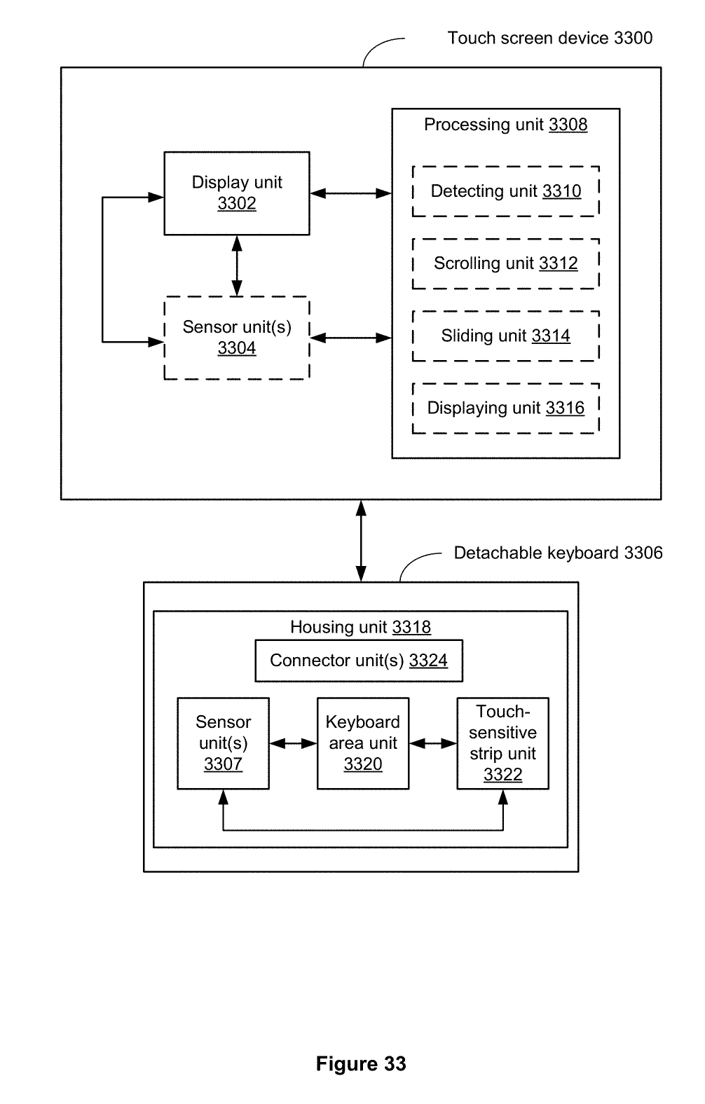

In accordance with some embodiments, FIG. 33 shows a functional block diagram of an electronic device 3300 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 33 are, optionally, combined or separated into sub-blocks to implement the principles of the various described embodiments. Therefore, the description herein optionally supports any possible combination or separation or further definition of the functional blocks described herein.

As shown in FIG. 33, a detachable keyboard 3306 with one or more touch-sensitive strips includes a housing unit 3318. As shown in FIGS. 31A and 31B, the housing unit 3318 has top, bottom left, and right sides. The detachable keyboard 3306 further includes a plurality of physical keys arranged in a key area unit 3320 that is at least partially within the housing unit 3318. The detachable keyboard 3306 further includes at least one connector unit 3324 disposed at the top side of the housing unit 3324 to connect the detachable keyboard 3306 to a touch screen device 3300, and at least one elongate touch-sensitive strip unit 3322 disposed at the bottom, left, or right side of the housing, where a length of the touch-sensitive strip unit 3322 extends across a majority of its respective side of the housing unit 3318. The detachable keyboard 3306 further includes one or more sensor units (e.g., the sensors 374, FIG. 3B) configured to detect touch inputs and/or contact intensities on the keys in the key area unit 3320 and/or the touch-sensitive strip unit 3322.

In some embodiments, the detachable keyboard 3306 further includes contact intensity sensor units 3307 for detecting contact intensities on the plurality of physical keys.

In some embodiments, the detachable keyboard 3306 further includes microphones for detecting swipes on a surface.

In some embodiments, the at least one connector unit 3324 is an electrical contact.

In some embodiments, the at least one connector unit 3324 is an optical connector.

In some embodiments, the touch screen device 3300 (e.g., the portable multifunction device 100) includes a display unit 3302 configured to display user interfaces (editable content on the display unit) and configured to detect touch inputs (contacts), and a processing unit 3308 coupled with the display unit 3302. In some embodiments, the touch screen device 3300 includes one or more sensor units 3304 and the processing unit 3308 is coupled with the display unit 3302 and the one or more sensor units 3304. In some embodiments, processing unit 3308 further includes one or more of the following sub-units: detecting unit 3310, scrolling unit 3312, sliding unit 3314, and displaying unit 3316.

In some embodiments, the memory of the touch screen device 3300 includes instructions for detecting (e.g., with the detecting unit 3310), via the at least one elongate touch sensitive strip unit 3322, a swipe along the length of the at least one elongate touch sensitive strip unit 3322; and in response to detecting the swipe, scrolling (e.g., with the scrolling unit 3312) content displayed on the touch screen device 3300 in a direction associated with the swipe. In such embodiments, a velocity of the scrolling is proportional to a speed of the swipe detected along the length of the at least one elongate touch sensitive strip unit 3322.

In some embodiments, the touch screen device 3300 comprises a processor (e.g., the processing unit 3308) and memory containing instructions for: detecting (e.g., with the detecting unit 3310), via the at least one elongate touch sensitive strip unit 3322, a first contact in a predefined region of the at least one elongate touch sensitive strip unit 3322, followed by a movement of the first contact in a direction perpendicular to the top side of the detachable keyboard 3306 and away from the at least one connector unit 3324; and in response to detecting the first contact followed by the movement of the first contact, sliding (e.g., with the sliding unit 3314) a notification center as an overlay into a display unit (e.g., the display unit 3302) of the touch screen device 3300 in accordance with the movement of the first contact until the entire notification center is on the display unit 3302. In such embodiments, the memory further includes instructions for detecting (e.g., with the detecting unit 3310) a lift-off of the first contact; and after detecting the lift-off of the first contact and in accordance with a determination that the notification center is not entirely on the display unit of the touch screen device, continuing to slide (e.g., with the sliding unit 3314) the notification center. Also in such embodiments, the memory further includes instructions for, while the notification center is displayed on the display 3302 of the touch screen device 3300, detecting (e.g., with the detecting unit 3310), via the at least one elongate touch sensitive strip unit 3322, a second contact on the at least one elongate touch sensitive strip unit 3322, followed by a movement of the second contact in a direction to the top side of the detachable keyboard and toward the at least one connector unit 3324; and in response to detecting the second contact followed by the movement of the second contact, ceasing to display (e.g., with the displaying unit 3310) the notification on the display unit 3302 of the touch screen device 3300.

In some embodiments, the touch screen device comprises a processor unit (e.g., the processing unit 3308) and memory containing instructions for displaying (e.g., with the displaying unit 3310) a first pane in an application interface on a display unit (e.g., the display unit 3302) of the touch screen device 3300; detecting (e.g., with the detecting unit 3310), via the at least one elongate touch sensitive strip unit 3322, a contact followed by a movement of the contact in a direction parallel to the top side of the detachable keyboard 3306; and in response to detecting the contact followed by the movement of the first, sliding (e.g., with the sliding unit 3314) a second pane into the display unit 3302 of the touch screen device 3300 in accordance with the direction and movement of the first contact until the second pane replaces the first pane in the application interface on the display unit 3302, wherein the first pane and the second pane are in a navigational hierarchy specified for the application interface.

The operations in the information processing methods described above are, optionally implemented by running one or more functional modules in information processing apparatus such as general purpose processors (e.g., as described above with respect to FIGS. 1A, 3A-3B, and 31A-31B) or application specific chips.

The operations described above with reference to FIGS. 31A-31B and 32A-32L are, optionally, implemented by components depicted in FIGS. 1A-1B or FIG. 33. For example, detecting operation 3310, scrolling operation 3312, sliding operation 3314, and displaying operation 3316 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Keyboard Arrow Scrolling

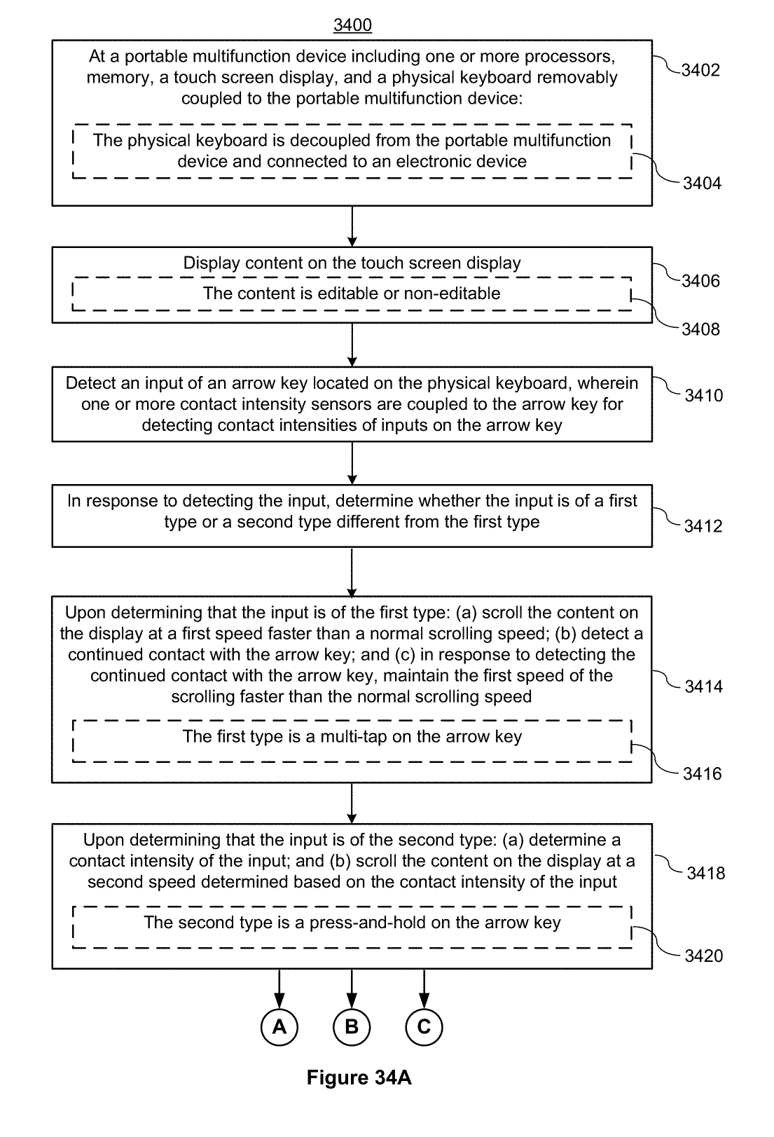

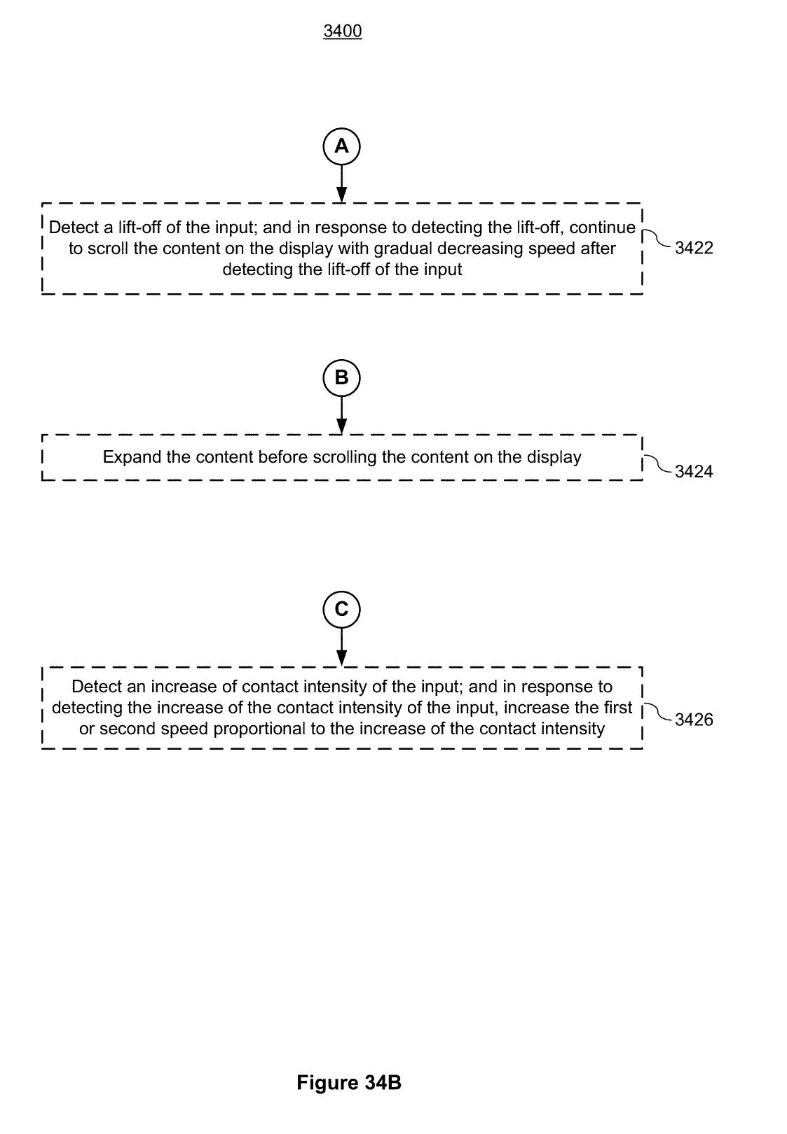

FIGS. 34A-34B are flow charts illustrating a method 3400 of improved keyboard arrow key scrolling, in accordance with some embodiments. FIGS. 35A-35H, which illustrate exemplary user interfaces for arrow key scrolling, are used to illustrate the processes in FIGS. 34A-34B. The method 3400 is performed (3402) at a portable multifunction device (e.g., the device 100 in FIG. 1A) with a touch-sensitive display (e.g., the touch screen display 112 in FIG. 1A) and a physical keyboard (e.g., the physical keyboard 370 in FIG. 3B and FIG. 31A-31B) removably coupled to the portable multifunction device. As explained above in connection with FIGS. 3B and 31A-31B, in some embodiments, the keyboard 370 is communicatively coupled to the portable multifunction device 100 by contact (e.g., Smart Connect from Apple Computer, Inc. of Cupertino, Calif.), via a wired connection (e.g., USB, PS/2), or via a wireless communication link (e.g., optical, Bluetooth, Wi-Fi, or the like). In some embodiments, the physical keyboard is (3404) decoupled from the portable multifunction device and connected to an electronic device. For example, the physical keyboard 370 as shown in FIG. 3B, FIGS. 31A-31B and FIGS. 35A-35H can be connected to a different electronic device that does not have a touch screen. In some embodiments, as shown in FIGS. 31A-31B, one or more contact intensity sensors are coupled to the arrow key for detecting contact intensities of inputs on the arrow key.

As described below, the method 3400 provides an efficient mechanism for arrow key scrolling using a physical keyboard coupled with a portable multifunction device. This method is faster and easier to perform than conventional methods and systems, e.g., conventional arrow key scrolling using a conventional keyboard. The method is also intuitive for users, thereby reducing the cognitive burden on the user, and creating a more efficient human-machine interface. A more efficient input mechanism also requires less computing resources, thereby increasing battery life of the device.

The device 100 displays (3406) content on the touch screen display. In some embodiments, the content is (3408) editable (e.g., the content includes editable text, such as an email in an email composition window) or non-editable (e.g., web content in a browser or a note/email in a non-editable document-display mode). The device then detects (3410) an input of an arrow key located on the physical keyboard, where one or more contact intensity sensors are coupled to the arrow key for detecting contact intensities of inputs on the arrow key (e.g., the sensors 374 in FIG. 3B and/or the sensors 3111 in FIG. 31B). In response to detecting the input, the device determines (3412) whether the input is of a first type or a second type different from the first type. Upon determining that the input is of the first type, the device scrolls (3414) the content on the display at a first speed that is faster than a normal scrolling speed; detects a continued contact with the arrow key; and in response to detecting the continued contact with the arrow key, maintains the first speed of the scrolling that is faster than the normal scrolling speed. In some embodiments, the first type (3416) is a multi-tap on the arrow key, e.g., a double-tap, triple-tap, or quadruple tap, etc.

For example, in FIG. 35A, initially, 9 lines of text are displayed on the touch screen 112, with the first one being on the top of the touch screen 112 and the 9th line being at the bottom. In FIG. 35B, in response to a single tap on the down arrow key, the device scrolls the text at a normal speed, e.g., the first three lines of text are moved off the display in response to a single stroke. Thus, the normal scrolling speed responsive to the single tap is to move 3 lines between T₀ and T₂.

It should be noted that in the example shown in FIGS. 35B and 35C-35H, the notes application is in a non-editing document-display mode, as indicated by the lack of a button labeled “Done.” When the content is non-editable, a block of the content, e.g., a block of text containing 3 lines, shown in FIG. 35B, is moved together. When the content is editable (not shown in the figures), the normal speed of scrolling may be one line for each tap detected on the arrow key.

FIG. 35C illustrates that in response to a double-tap on the down arrow, while displaying lines 1-9 of text on the touch screen 112 (FIG. 35A), the device scrolls the content faster than the normal speed, e.g., scrolling six lines of text between T₀ and T₂. Further, FIGS. 35B and 35C show that after T₂, responsive to the continued contact with the arrow key, the device maintains the scrolling speed, e.g., the normal speed of scrolling is maintained in FIG. 35B and the faster speed is maintained in FIG. 35C.

This method for adjusting the scrolling speed in response to different types of input on the arrow key is intuitive for users, thereby reducing the cognitive burden on the user, and creating a more efficient human-machine interface. Conventional methods of content scrolling often move content at a fixed speed and by a fixed distance responsive to each arrow key stroke. In contrast, the methods disclosed herein take into consideration the user's intent and scroll the content at various speeds responsive to different types of inputs. The repetitive pressing of an arrow key, e.g., double, triple, or quadruple tap etc., may indicate that the user wants faster scrolling. Thus, increasing the speed responsive to the multi-tap creates a more efficient human-machine. A more efficient input mechanism also requires less computing resources, thereby increasing battery life of the device.

Returning to the method 3400, in FIG. 34A, upon determining that the input is of the second type, the device determines (3418) a contact intensity of the input and scrolls the content on the display at a second speed determined based on the contact intensity of the input. In some embodiments, the second type is a press-and-hold (3420) on the arrow key. In such embodiments, the faster scrolling is performed in response to the deep press, as shown in FIGS. 35D-35E. For example, in response to the input 3524-1 on the down arrow while displaying lines 1-9 of text on the touch screen 112 (FIG. 35A), the device determines whether the input is a light press or a deep press by analyzing the contact intensity of the press. In FIG. 35D, the device scrolls the text at a first speed upon determining that the input is a light press with the contact intensity at T₁ below IT_{D}, e.g., scrolling three lines of text between T₀ and T₁. In comparison, in FIG. 35E, the device scrolls the content at a second speed faster than the first speed upon determining that the input is a deep press with the contact intensity at T₁ above IT_{D}, e.g., scrolling six lines of text between T₀ and T₁. In some embodiments, the device further detects continued contact with the arrow key with varying contact intensities. In such embodiments, the device adjusts the scrolling speed in accordance with the varying contact intensities. For example, the device scrolls the content in a slow-fast-slow pattern responsive to a continuous press on the arrow key in a pattern of light pressure/more pressure/less pressure on the arrow key.

Adjusting the scrolling speed in accordance with the force detected by the sensors is intuitive for users, thereby reducing the cognitive burden on the user, and creating a more efficient human-machine interface. For example, when a user wants faster scrolling, the user may press harder on the key. Thus, the more efficient scrolling mechanism requires less computing resources, thereby increasing battery life of the device.

Returning to the method 3400, in FIG. 34B, in some embodiments, when the device subsequently detects (3422) a lift-off of the input, the device continues to scroll the content on the display with gradually decreasing speed. For example, in FIG. 35F, between T₀ and T₂, the input remains in contact with the arrow key as indicated by the contact intensity above zero. In response to detecting the input on the arrow key, the device scrolls the text while the input remains in contact with the arrow key. At T₂, a lift-off of the input is detected, as indicated by the contact intensity decreasing to zero, and after the lift-off is detected, the device continues to scroll the text at a decreasing speed, e.g., further scrolling from line 4 to line 7 after T₂ before the scrolling stops.

Providing scrolling with this inertia effect is intuitive for users, e.g., like a user taking their foot of an accelerator pedal of a vehicle and the car rolling slowly to rest. This reduces the cognitive burden on the user and creates a more efficient human-machine interface. A more efficient input mechanism also requires less computing resources, thereby increasing battery life of the device.

Referring back to the method 3400, in FIG. 34B, in some embodiments, the device stretches or expands (3424) the content (e.g., expands the line spacing of the content as described below), before scrolling the content on the display. In some embodiments, the expanding is performed regardless of the input contact intensity. In some embodiments, the expanding is performed when the contact intensity exceeds a predetermined threshold. For example, in FIG. 35G, between T₀ and T₁, the contact intensity is below IT_{D}, indicating the input is a light press on the arrow key. In response to detecting the light press, the device scrolls at a first speed, e.g., scrolling approximately two lines of the content between T₀ and T₁, such that line 3 is displayed at the top of the touch screen 112 and line 11 is displayed at the bottom of the touch screen 112. At T₁, the contact intensity increases above IT_{D}, indicating a deep press on the arrow key. In response to detecting the deep press, the device expands the content before scrolling the content, as described in further detail below.

In some embodiments, the expanding is implemented by increasing the line spacing between the lines until the threshold pressure is reached, and thereafter the entire text scrolls as normal. Based on a direction associated with the arrow key, one or more lines are moved in the direction associated with the arrow key to make room for the increased line spacing. The combination of line movement and the increase in line spacing creates the visual effect of stretching the content. For example, in FIG. 35G, at T₁, prior to detecting the deep press, line 3 on the display has been moved up and off of the touch screen display 112 while line 11 at the bottom of the display 112 remains stationary. The device increases the line spacing prior to scrolling the content to create the visual effect of stretching or expanding the displayed content. After T₁, where the intensity threshold has been met, the device scrolls the content with the line space shrinking back to normal. Though FIG. 35G illustrates expanding the content by increasing line spacing and line moving, in some embodiments, the expanding is accomplished by increasing the size of images and/or font of text.

Stretching the content before scrolling provides a natural scrolling experience, and provides feedback to the user that scrolling will occur. This method is intuitive for users, thereby reducing the cognitive burden on the user, and creating a more efficient human-machine interface. A more efficient input mechanism also requires less computing resources, thereby increasing battery life of the device.

Referring back to the method 3400, in FIG. 34B, in some embodiments, the device detects (3426) an increase in contact intensity of the input; and in response to detecting the increase of the contact intensity of the input, increases the first or second speed proportional to the increase of the contact intensity. For example, in FIG. 35H, the contact intensity of the input at T₂ is approximately twice the intensity at T₁. As a result, between T₀ and T₁, the device scrolls at a slower speed, e.g., approximately three lines of the content between T₀ and T₁. At T₂, in response to the intensity increase, the device scrolls at a faster speed, scrolling approximately ten lines between T₁ and T₂.

Adjusting the scrolling speed proportionate to the force detected by the sensors is intuitive for users, thereby reducing the cognitive burden on the user, and creating a more efficient human-machine interface. For example, when a user wants twice the speed of scrolling, the user may press twice as hard on the key. Thus, the more efficient scrolling mechanism requires less computing resources, thereby increasing battery life of the device.

It should be understood that the particular order in which the operations in FIGS. 34A-34B have been described is merely exemplary and is not intended to indicate that the described order is the only order in which the operations could be performed. One of ordinary skill in the art would recognize various ways to reorder the operations described herein. For brevity, these details are not repeated here.

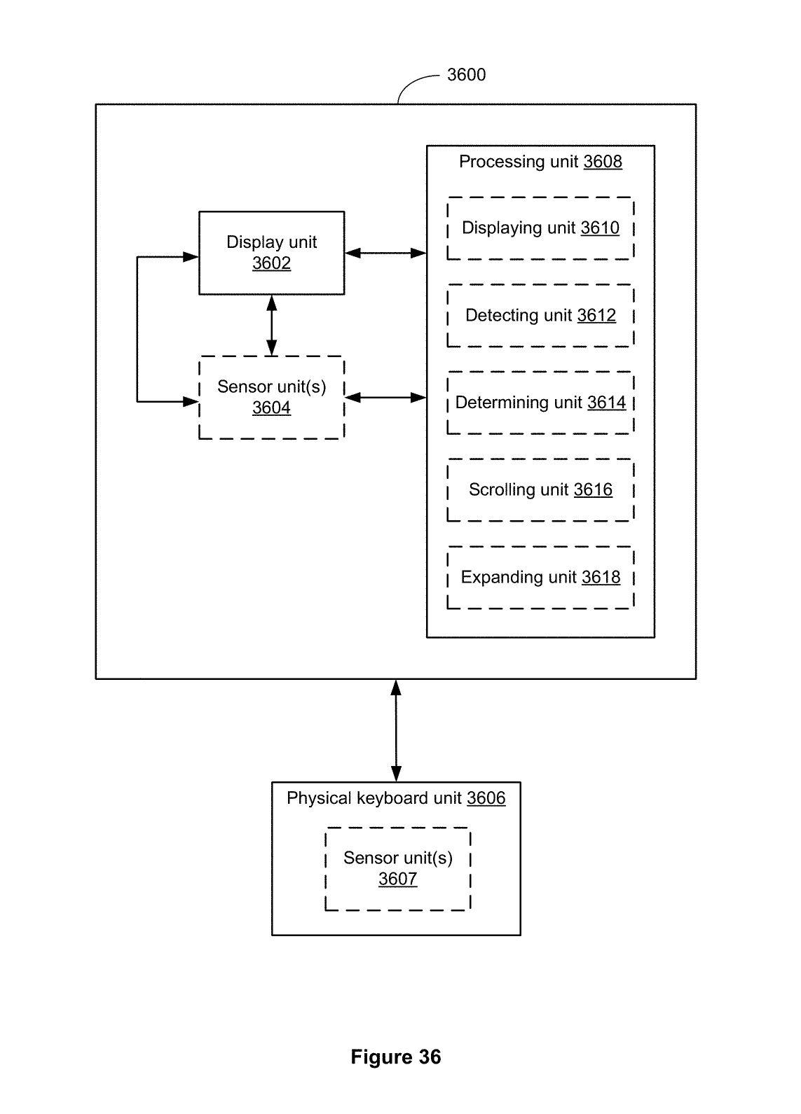

In accordance with some embodiments, FIG. 36 shows a functional block diagram of a portable multifunction device 3600 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 36 are, optionally, combined or separated into sub-blocks to implement the principles of the various described embodiments. Therefore, the description herein optionally supports any possible combination or separation or further definition of the functional blocks described herein.

As shown in FIG. 36, a portable multifunction device 3600 includes a touch-sensitive display unit 3602 configured to display user interfaces (editable content on the display unit) and configured to detect touch inputs (contacts), and a processing unit 3608 coupled with the touch-sensitive display unit 3602. In some embodiments, the portable multifunction device includes one or more sensor units 3604 and the processing unit 3608 is coupled with the touch-sensitive display unit 3602 and the one or more sensor units 3604. In some embodiments, processing unit 3608 includes one or more of the following sub-units: displaying unit 3610, detecting unit 3612, determining unit 3614, scrolling unit 3616, and expanding unit 3618. In some embodiments, the portable multifunction device 3600 is removably coupled to a physical keyboard unit 3606 (e.g., the physical keyboard 370), which further includes one or more sensor units 3607 (e.g., the sensors 374, FIG. 3B).

The processing unit 3608 is configured to detect (e.g., with the detecting unit 3612) an input of an arrow key located on the physical keyboard unit 3606, where one or more contact intensity sensor units 3607 are coupled to the arrow key for detecting contact intensities of inputs on the arrow key. In response to detecting the input, the processing unit 3608 is configured to determine (e.g., with the determining unit 3614) whether the input is of a first type or a second type different from the first type. Upon determining that the input is of the first type, the processing unit 3608 is configured to scroll (e.g., with the scrolling unit 3616) the content on the touch screen display unit 3602 at a first speed faster than a normal scrolling speed. When the input is of the first type, the processing unit 3608 is further configured to detect (e.g., with the detecting unit 3612) a continued contact with the arrow key, and in response to detecting the continued contact with the arrow key, maintain (e.g., with the scrolling unit 3616) the first speed of the scrolling faster than the normal scrolling speed. On the other hand, upon determining that the input is of the second type, the processing unit 3608 is configured to determine (e.g., with the determining unit 3614) a contact intensity of the input and scroll (e.g., with the scrolling unit 3616) the content on the display at a second speed determined based on the contact intensity of the input.

In some embodiments, the physical keyboard unit 3606 is decoupled from the portable multifunction device and connected to an electronic device.

In some embodiments, the content is editable or non-editable.

In some embodiments, the first type is a multi-tap on the arrow key.

In some embodiments, the second type is a press-and-hold on the arrow key.

In some embodiments, the processing unit 3608 is further configured to detect (e.g., with the detecting unit 3612) a lift-off of the input. In response to detecting the lift-off, the processing unit 3608 is further configured to continue to scroll (e.g., with the scrolling unit 3616) the content on the touch screen display unit 3602 with gradual decreasing speed after detecting (e.g., with the detecting unit 3612) the lift-off of the input.

In some embodiments, the processing unit 3608 is further configured to expand (e.g., with the expanding unit 3618) the content before scrolling (e.g., with the scrolling unit 3616) the content on the touch screen display unit 3602.

In some embodiments, the processing unit 3608 is further configured to detect (e.g., with the detecting unit 3612) an increase of contact intensity of the input. In response to detecting the increase of the contact intensity of the input, the processing unit 3608 is configured to increase (e.g., with the scrolling unit 3616) the first or second speed proportional to the increase of the contact intensity.

The operations in the information processing methods described above are, optionally implemented by running one or more functional modules in information processing apparatus such as general purpose processors (e.g., as described above with respect to FIGS. 1A and 3A-3B) or application specific chips.

The operations described above with reference to FIGS. 35A-35H are, optionally, implemented by components depicted in FIGS. 1A-1B or FIG. 36. For example, displaying operation 3610, detecting operation 3612, determining operation 3614, scrolling operation 3616, and expanding operation 3618 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Inchworm Movement

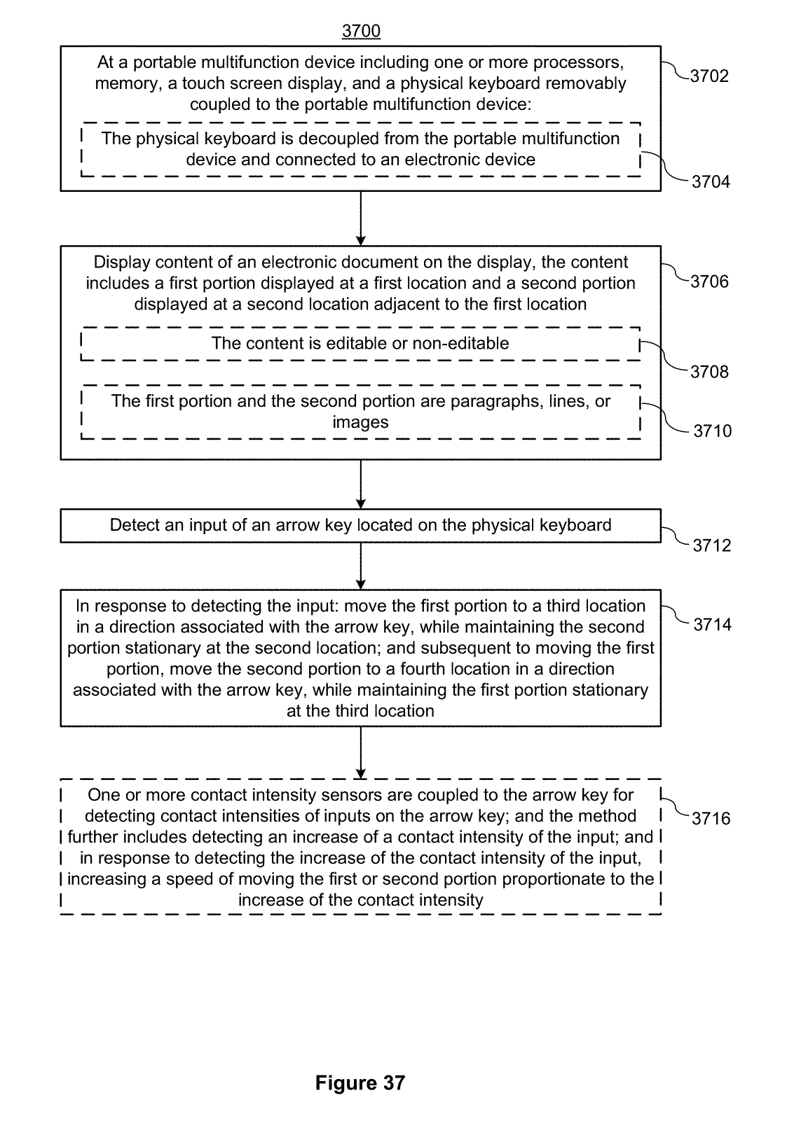

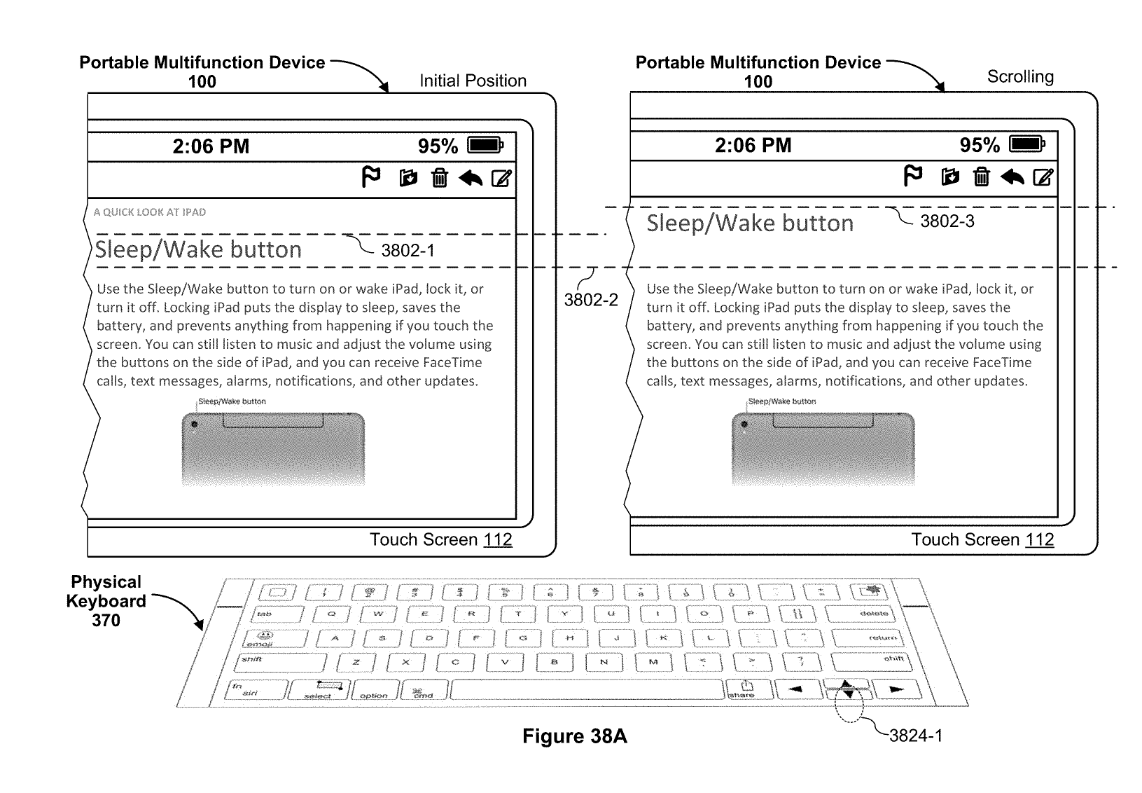

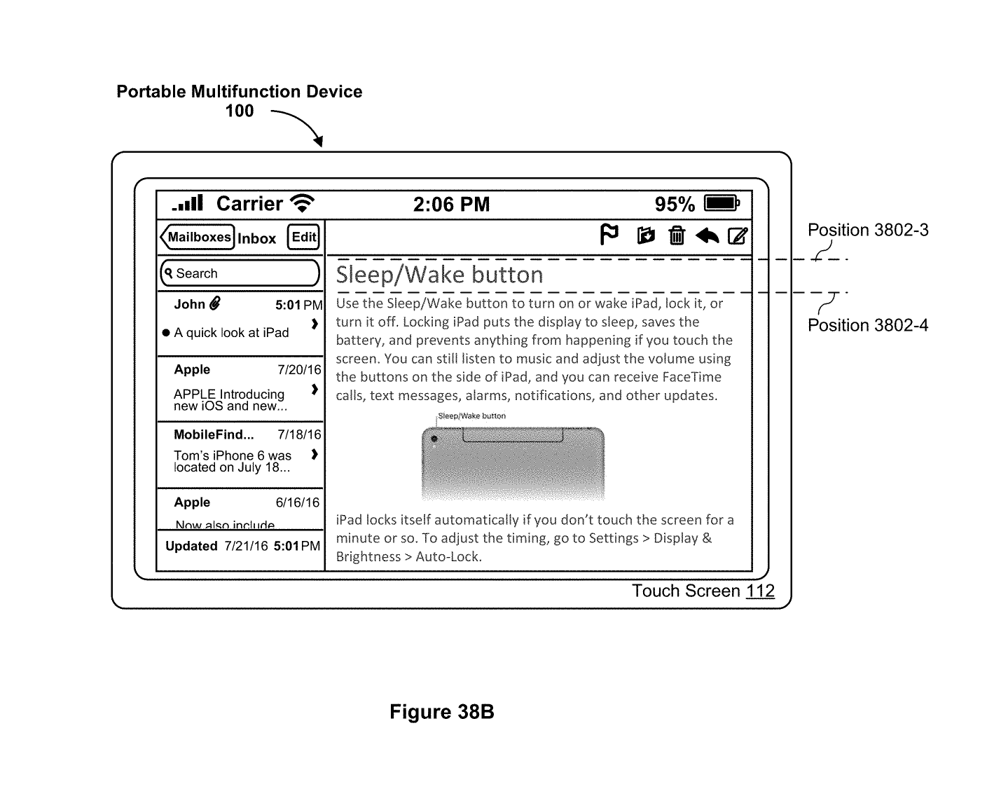

FIG. 37 is a flow chart illustrating a method 3700 of text scrolling using an arrow key, in accordance with some embodiments. FIGS. 38A-38B, which illustrate exemplary user interfaces for arrow key scrolling, are used to illustrate the processes in FIG. 37. The method 3700 is performed (3702) at a portable multifunction device (e.g., the device 100 in FIG. 1A) with a touch-sensitive display (e.g., the touch screen display 112 in FIG. 1A) and a physical keyboard (e.g., the physical keyboard 370 in FIG. 3B) removably coupled to the portable multifunction device. As explained above in connection with FIGS. 3B and 31A-31B, in some embodiments, the keyboard 370 is communicatively coupled to the portable multifunction device 100 by contact (e.g., Smart Connect from Apple Computer, Inc. of Cupertino, Calif.), via a wired connection (e.g., USB, PS/2), or via a wireless communication link (e.g., optical, Bluetooth, Wi-Fi, or the like). In some embodiments, the physical keyboard is (3704) decoupled from the portable multifunction device and connected to an electronic device. For example, the physical keyboard 370 as shown in FIG. 3B and FIGS. 31A-31B can be connected to a different electronic device that does not have a touch screen. In some embodiments, as shown in FIGS. 31A-31B, one or more contact intensity sensors are coupled to the arrow key for detecting contact intensities of inputs on the arrow key.

As described below, the method 3700 provides an efficient and intuitive mechanism for scrolling content using an arrow key on a physical keyboard coupled with a portable multifunction device. The method changes how scrolling behaves by moving portions of chunks of content together. The visual effect is an inchworm-like motion, where the content appears to double-up on itself at intervals, then stretch itself straight again when advancing. The scrolling behavior of keeping chunks together reduces the cognitive burden on the user, and creates a more efficient human-machine interface. A more efficient input mechanism also requires less computing resources, thereby increasing battery life of the device.

The device 100 displays (3706) content of an electronic document on the display, the content includes a first portion displayed at a first location and a second portion displayed at a second location adjacent to the first location. The content is (3708) editable (e.g., the content includes editable text, such as an email in an email composition window) or non-editable (e.g., the content is web content in a browser). In some embodiments, the first portion and the second portion are (3710) paragraphs, lines, or images.

For example, FIG. 38A illustrates a portion of an email application interface. Initially, a first paragraph of an email with the text “Sleep/Wake button” is displayed in the partial email application interface at a first location 3802-1. Below the first paragraph, a second paragraph with the text “Use the Sleep/Wake button to . . . ” is displayed at a second location 3802-2 adjacent the first paragraph. These paragraphs can be editable or non-editable.

Referring back to FIG. 37, the device then detects (3712) an input of an arrow key located on the physical keyboard. In response to detecting the input, the device moves (3714) the first portion to a third location in a direction associated with the arrow key, while maintaining the second portion stationary at the second location; and subsequent to moving the first portion, moves the second portion to a fourth location in a direction associated with the arrow key, while maintaining the first portion stationary at the third location.

For example, in FIG. 38A, the device detects an input 3824-1, e.g., a tap on the arrow key. In response to detecting the tap input, the device scrolls the content displayed in the email application interface by first moving the first paragraph “Sleep/Wake button” to a third location 3802-3 while maintaining the second paragraph “Use the Sleep/Wake button . . . ” stationary at the second location 3802-2. Subsequently, as shown in FIG. 38B, after moving the first paragraph to the third location 3802-3, the device moves the second paragraph to a fourth location 3802-4 while maintaining the first paragraph stationary at the third location 3802-3, such that after the move, the spacing between the first paragraph and the second paragraph is the same as the initial spacing between these two paragraphs prior to the moves.

In some embodiments, one or more contact intensity sensors are coupled to (3716) the arrow key for detecting contact intensities of inputs on the arrow key, and the device further detects an increase of a contact intensity of the input. In response to detecting the increase of the contact intensity of the input, the speed of moving the first and/or second portions is increased at a rate proportionate to the increase of the contact intensity.

It should be understood that the particular order in which the operations in FIG. 37 have been described is merely exemplary and is not intended to indicate that the described order is the only order in which the operations could be performed. One of ordinary skill in the art would recognize various ways to reorder the operations described herein. For brevity, these details are not repeated here.

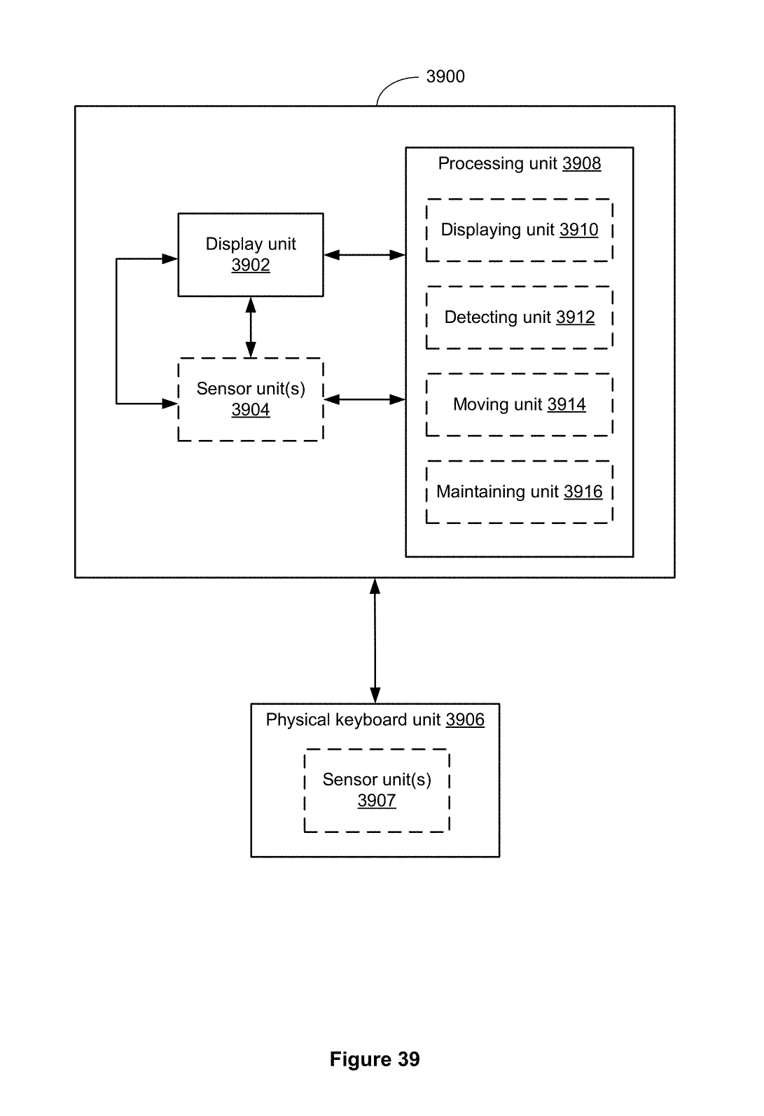

In accordance with some embodiments, FIG. 39 shows a functional block diagram of a portable multifunction device 3900 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 39 are, optionally, combined or separated into sub-blocks to implement the principles of the various described embodiments. Therefore, the description herein optionally supports any possible combination or separation or further definition of the functional blocks described herein.

As shown in FIG. 39, a portable multifunction device 3900 includes a touch-sensitive display unit 3902 configured to display user interfaces (editable content on the display unit) and configured to detect touch inputs (contacts), and a processing unit 3908 coupled with the touch-sensitive display unit 3902. In some embodiments, the portable multifunction device includes one or more sensor units 3904 and the processing unit 3908 is coupled with the touch-sensitive display unit 3902 and the one or more sensor units 3904. In some embodiments, processing unit 3908 includes one or more of the following sub-units: displaying unit 3910, detecting unit 3912, moving unit 3914, and maintaining unit 3916. In some embodiments, the portable multifunction device 3900 is removably coupled to a physical keyboard unit 3906 (e.g., the physical keyboard 370), which further includes one or more sensor units 3907 (e.g., the sensors 374, FIG. 3B).

The processing unit 3908 is configured to detect (e.g., with the detecting unit 3912) an input on an arrow key located on the keyboard. In response to detecting the input: the processing unit 3908 is configured to move (e.g., with the moving unit 3914) the first portion to a third location in a direction associated with the arrow key, while maintaining the second portion stationary at the second location. Subsequent to moving the first portion, the processing unit 3908 is configured to move (e.g., with the moving unit 3914) the second portion to a fourth location in a direction associated with the arrow key, while maintaining (e.g., with the maintaining unit 3916) the first portion stationary at the third location.

In some embodiments, the physical keyboard unit 3906 is decoupled from the portable multifunction device and connected to an electronic device.

In some embodiments, the content is editable or non-editable.

In some embodiments, the first portion and the second portion are paragraphs, lines, or images.

In some embodiments, one or more contact intensity sensor units (e.g., the sensor units 3907) are coupled to the arrow key for detecting contact intensities of inputs on the arrow key, and the processing unit 3908 is further configured to detect (e.g., with the detecting unit 3912) an increase of a contact intensity of the input; and in response to detecting the increase of the contact intensity of the input, the processing unit 3908 is configured to increase (e.g., with the moving unit 3914) a speed of moving the first or second portion proportionate to the increase of the contact intensity.

The operations in the information processing methods described above are, optionally implemented by running one or more functional modules in information processing apparatus such as general purpose processors (e.g., as described above with respect to FIGS. 1A and 3A-3B) or application specific chips.

The operations described above with reference to FIGS. 38A-38B are, optionally, implemented by components depicted in FIGS. 1A-1B or FIG. 39. For example, displaying operation 3910, detecting operation 3912, moving operation 3914, and maintaining operation 3916 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Switching Between Virtual Keyboards

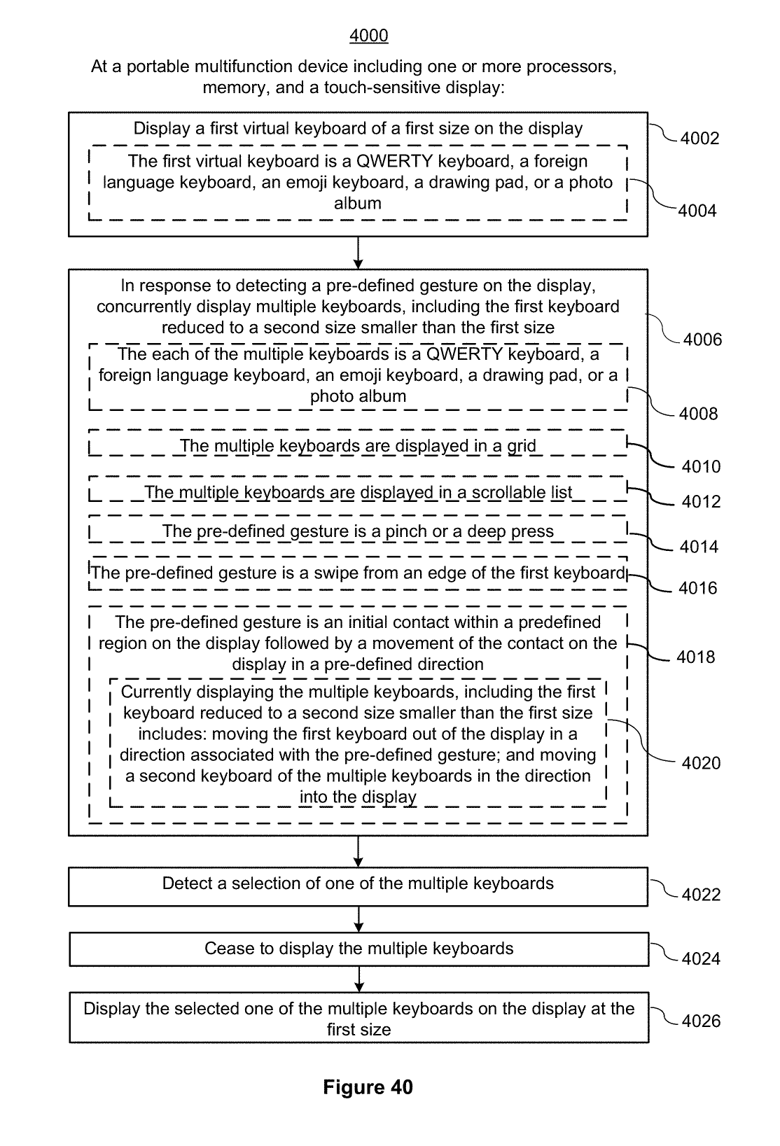

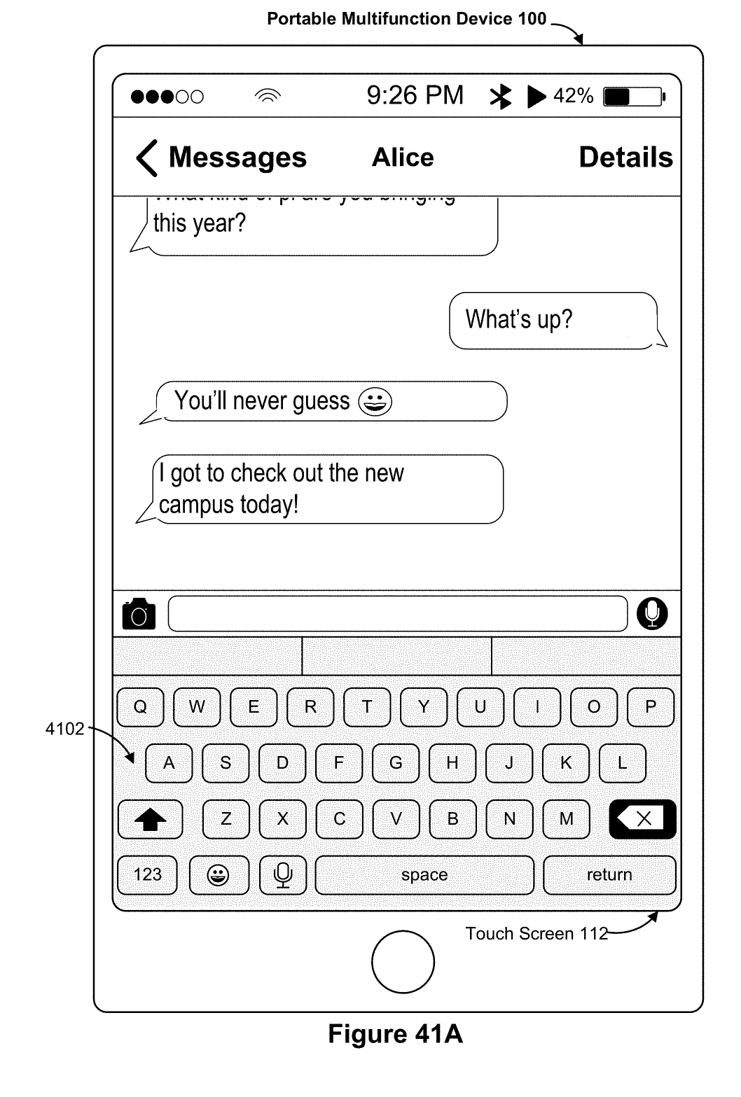

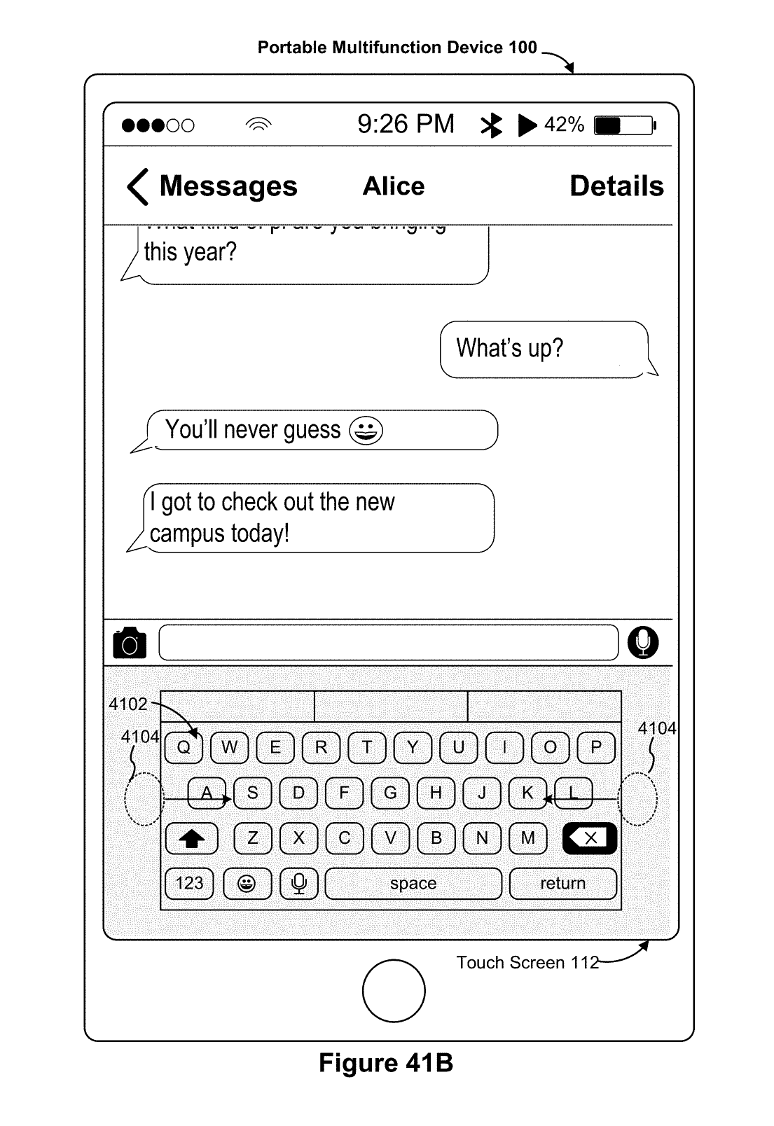

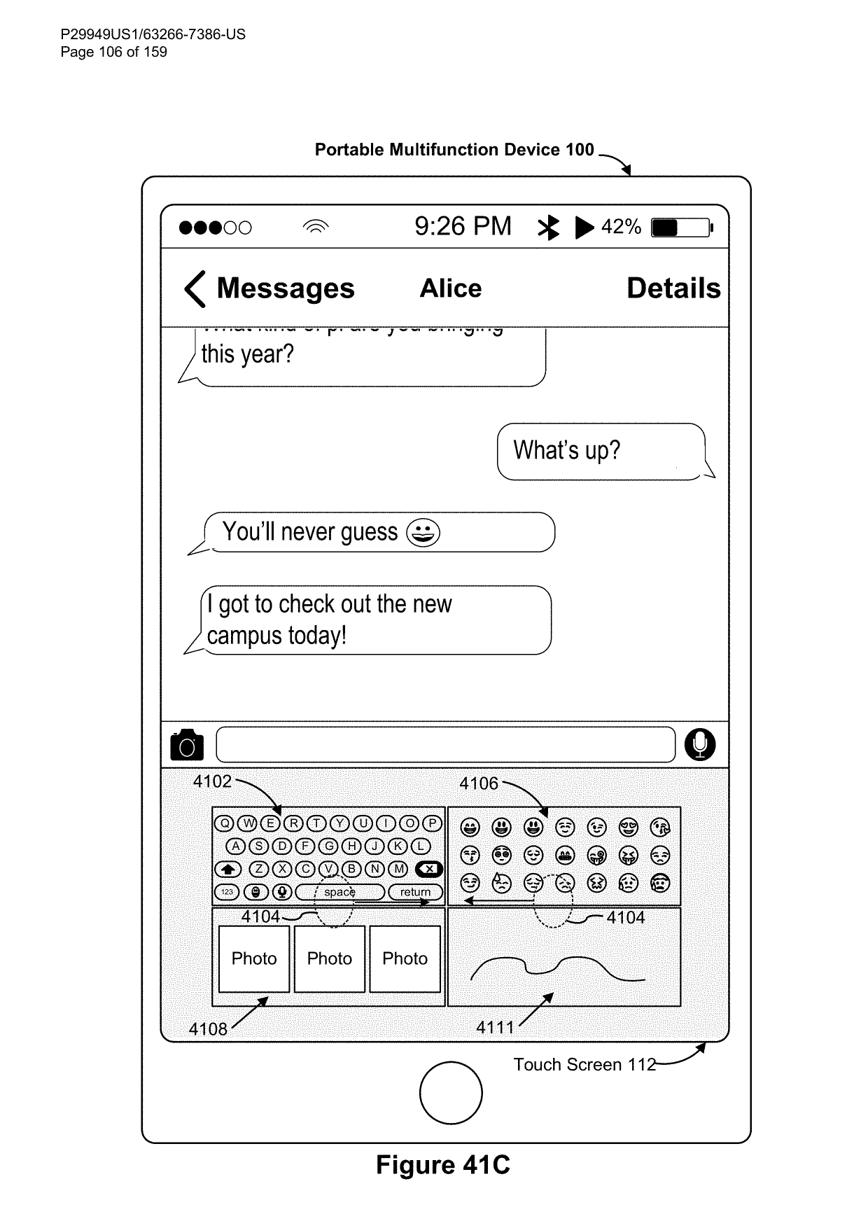

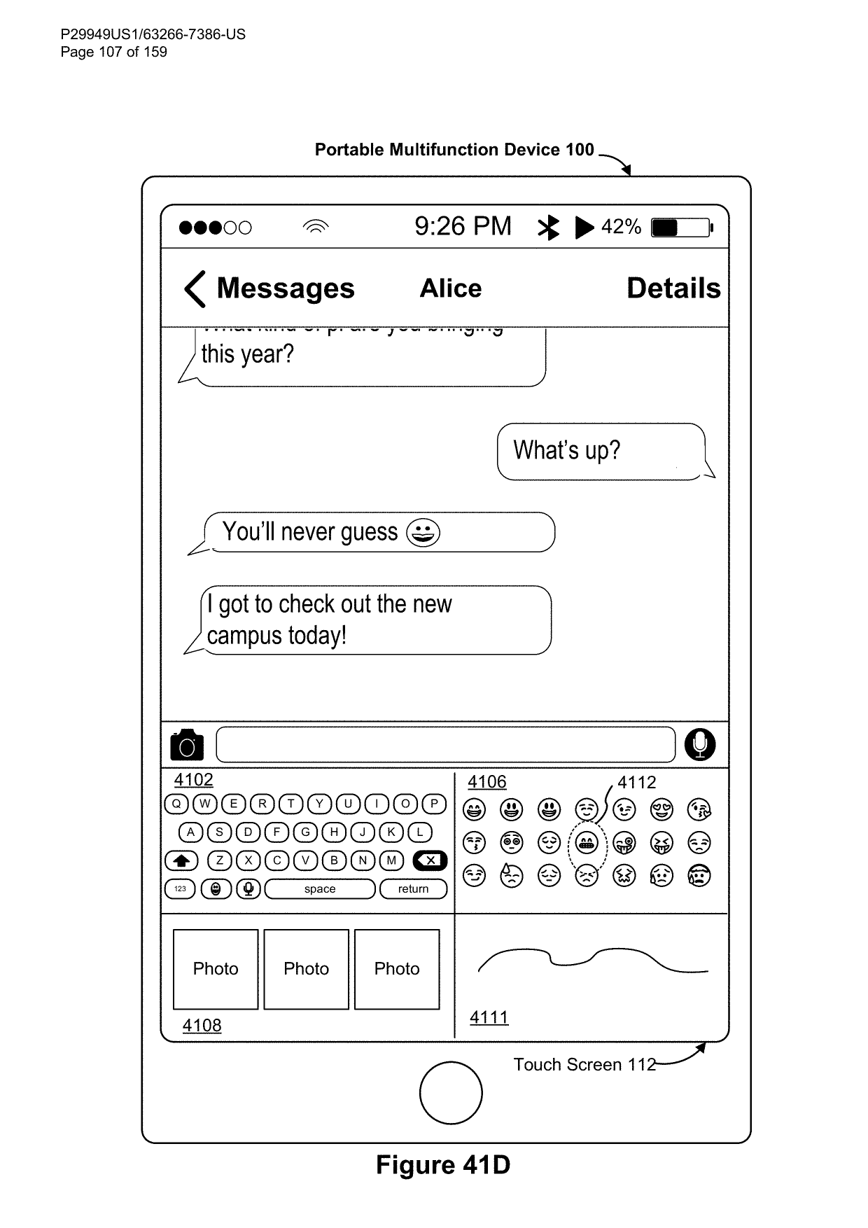

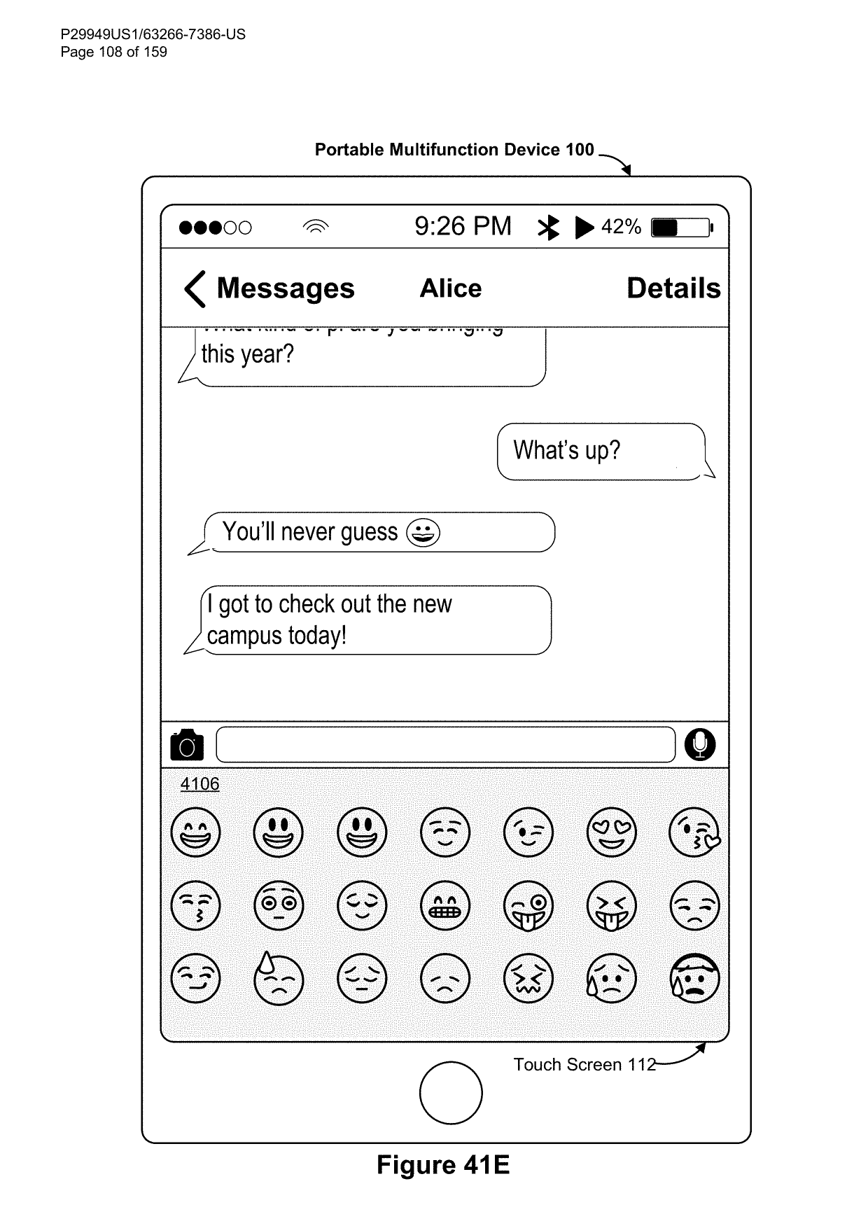

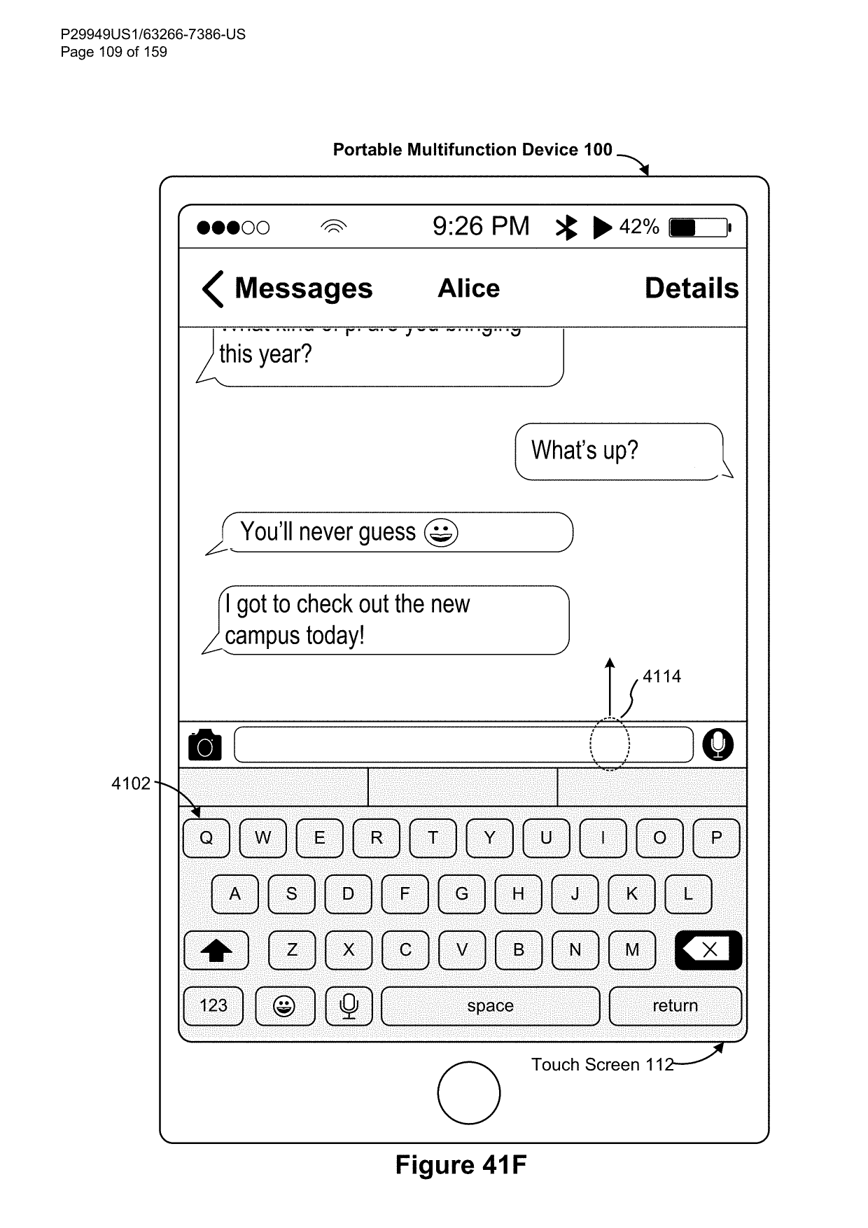

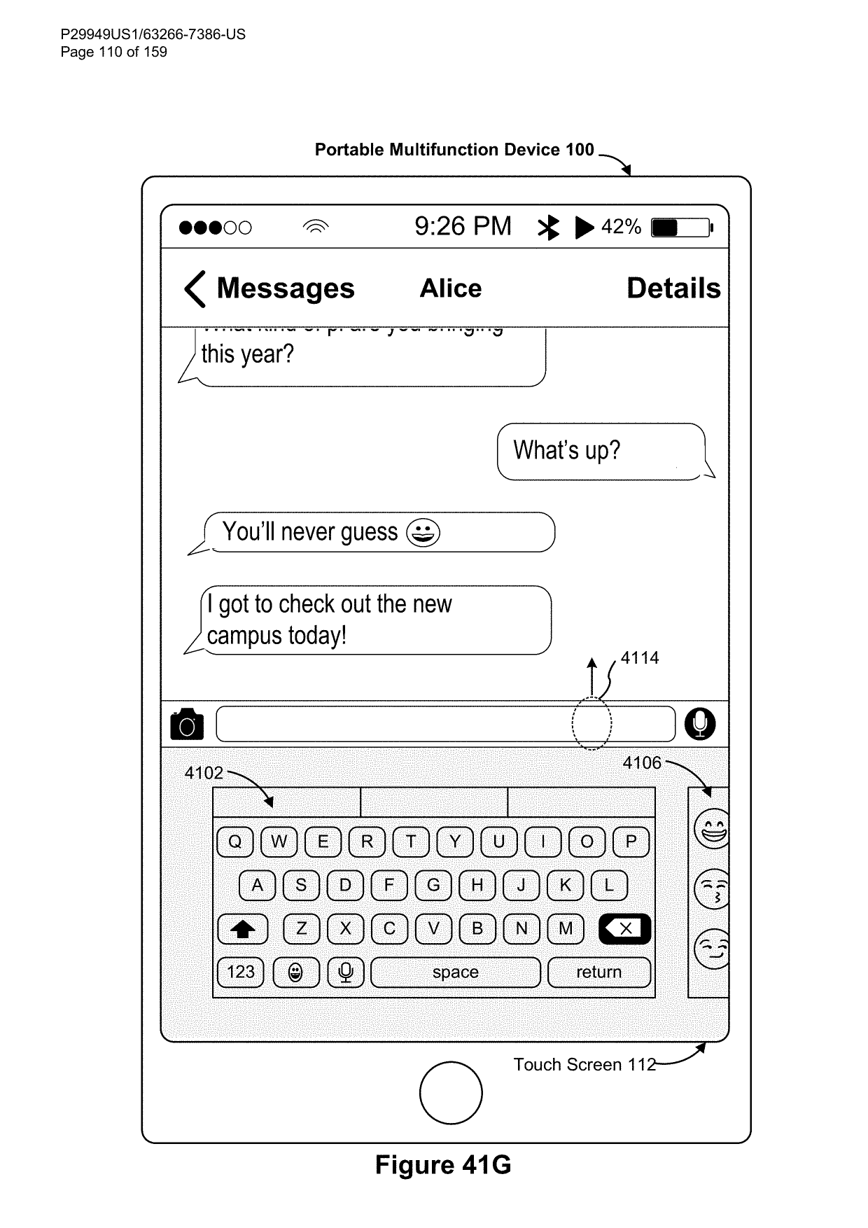

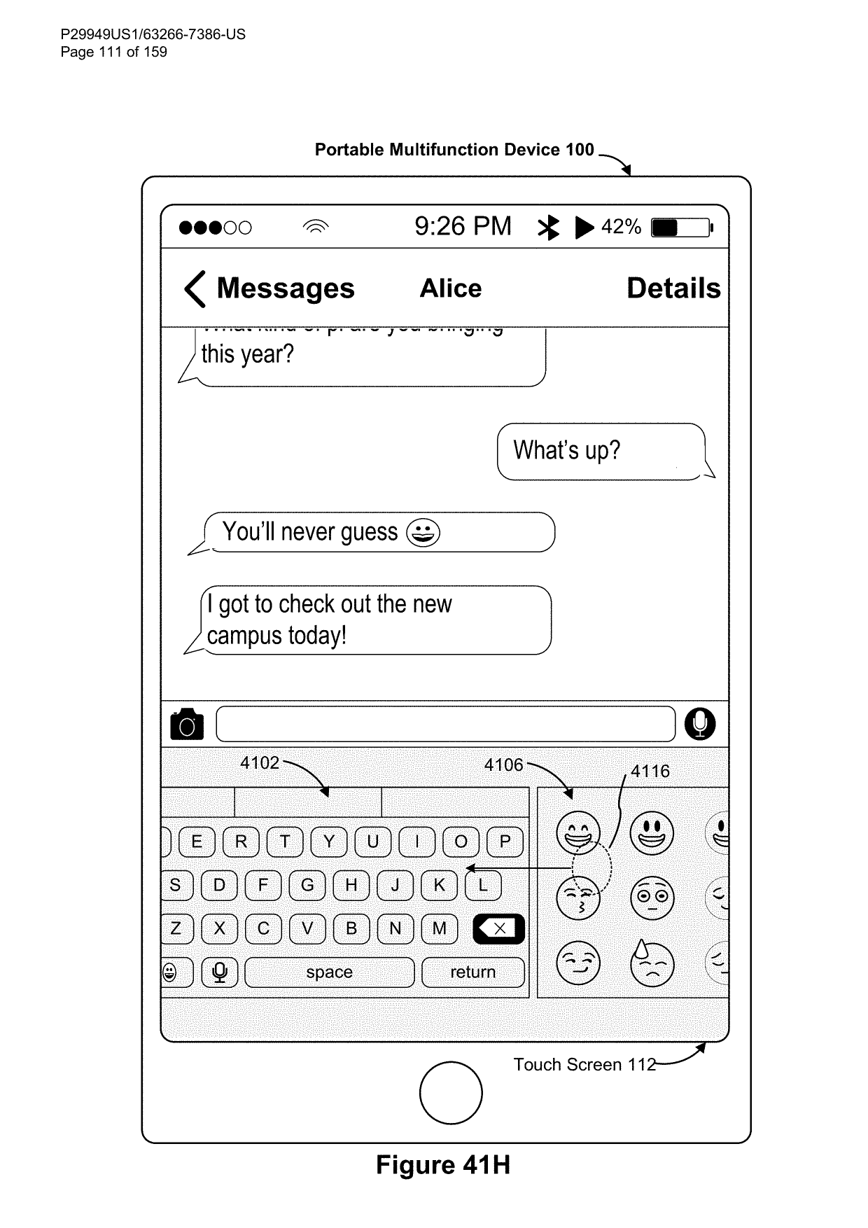

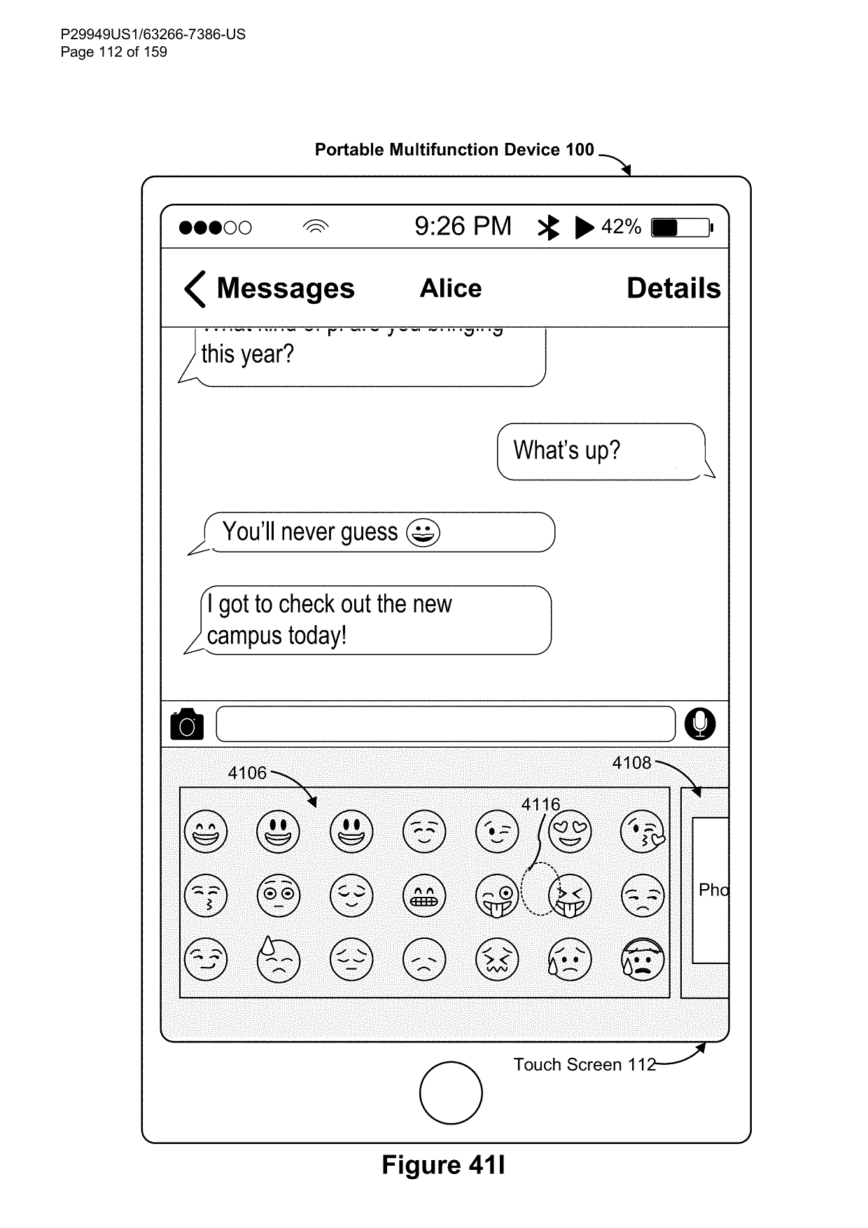

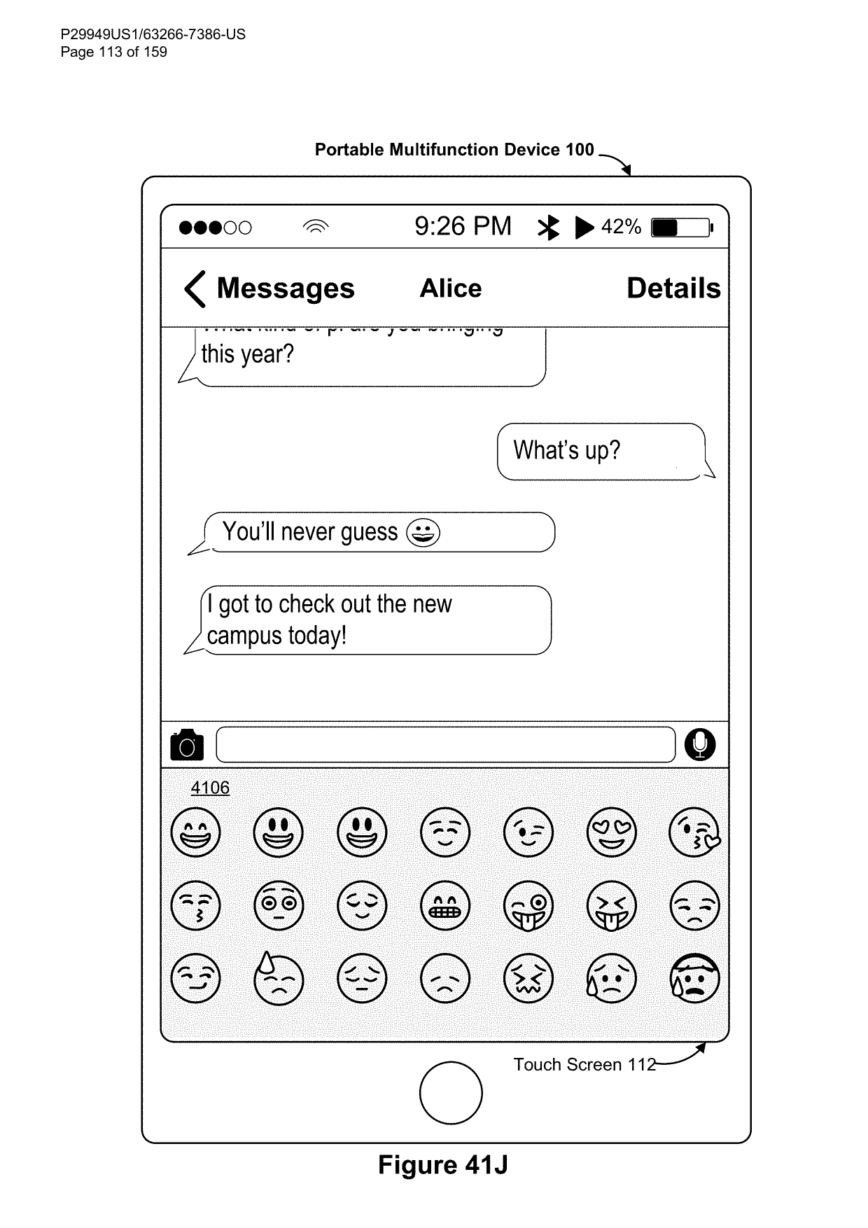

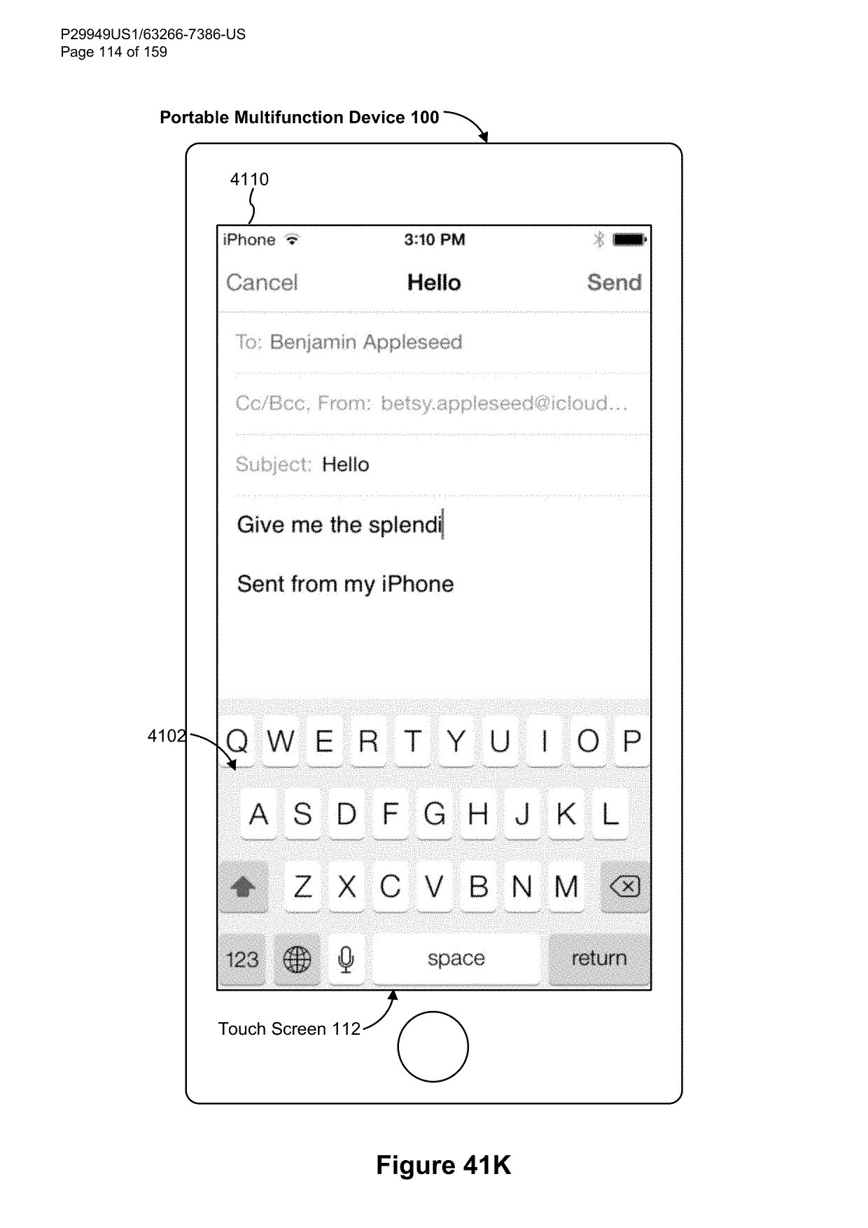

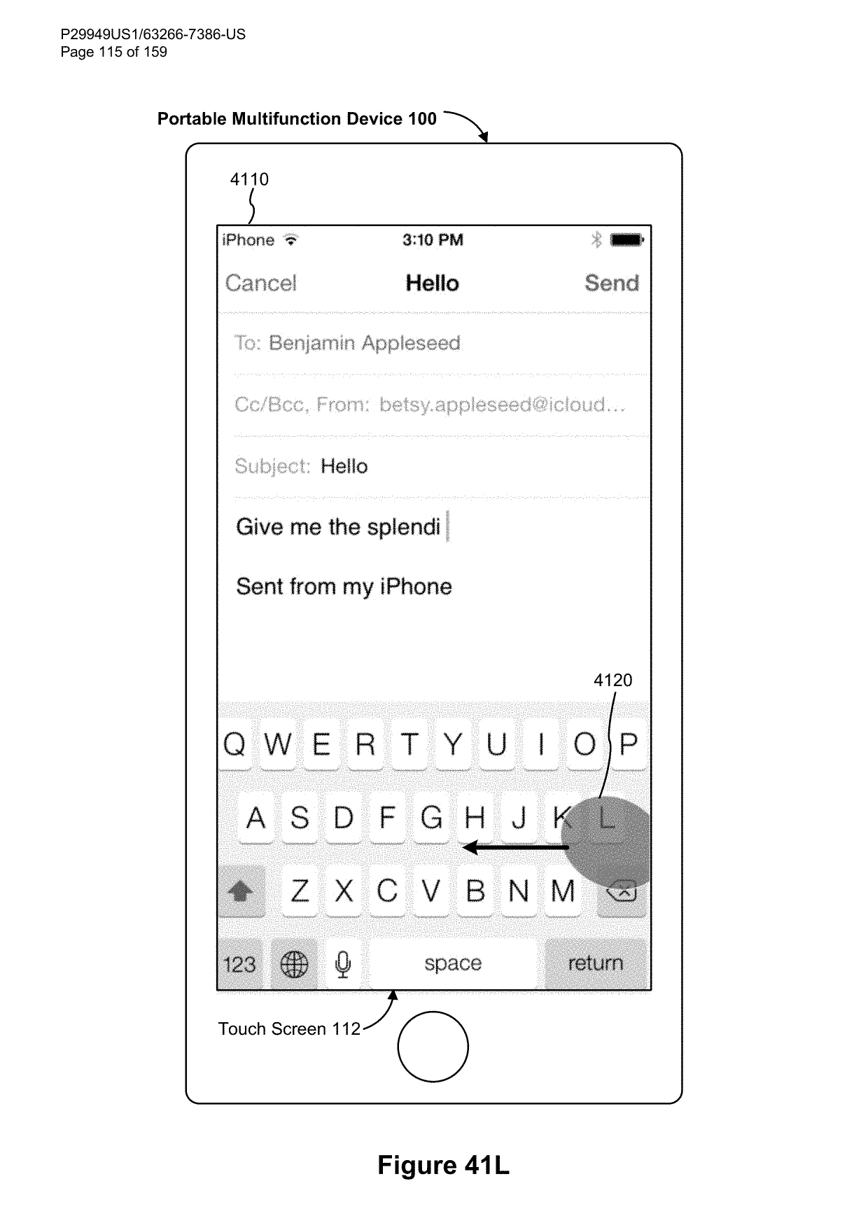

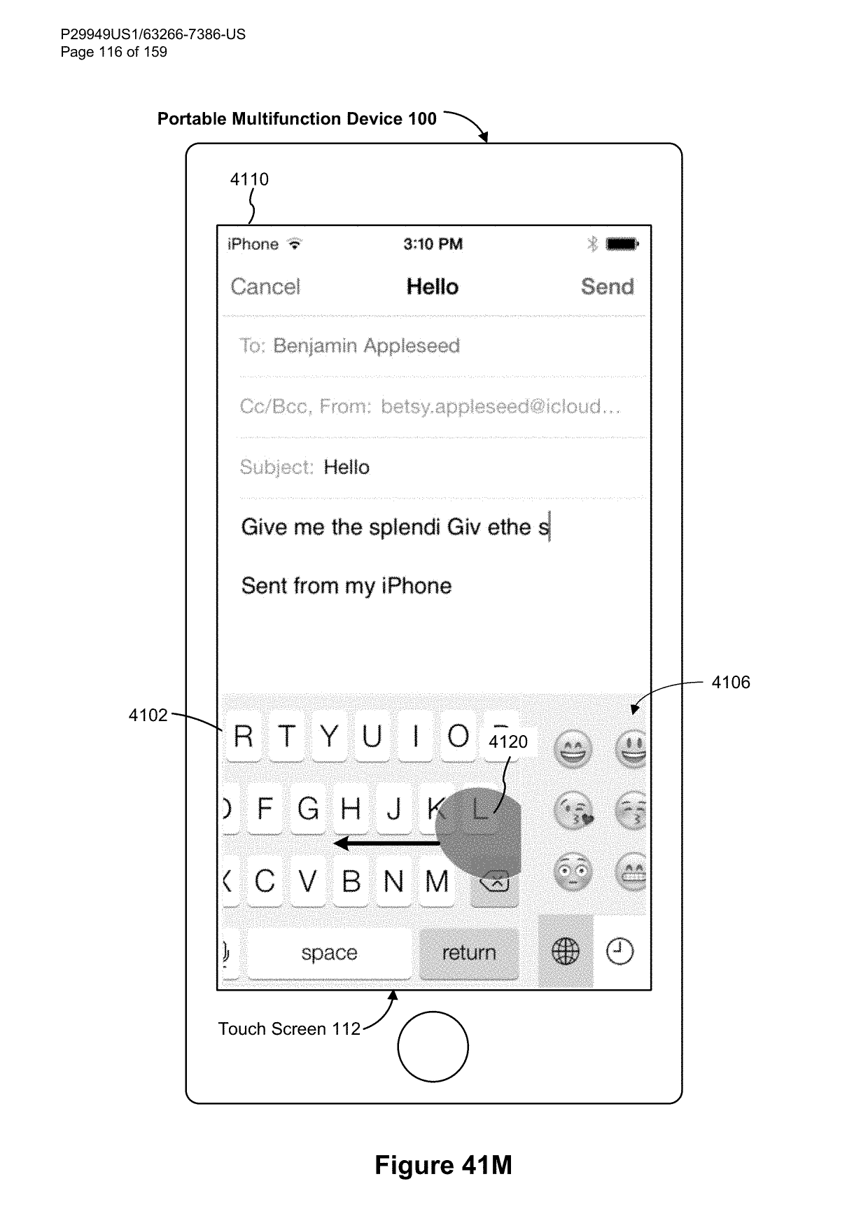

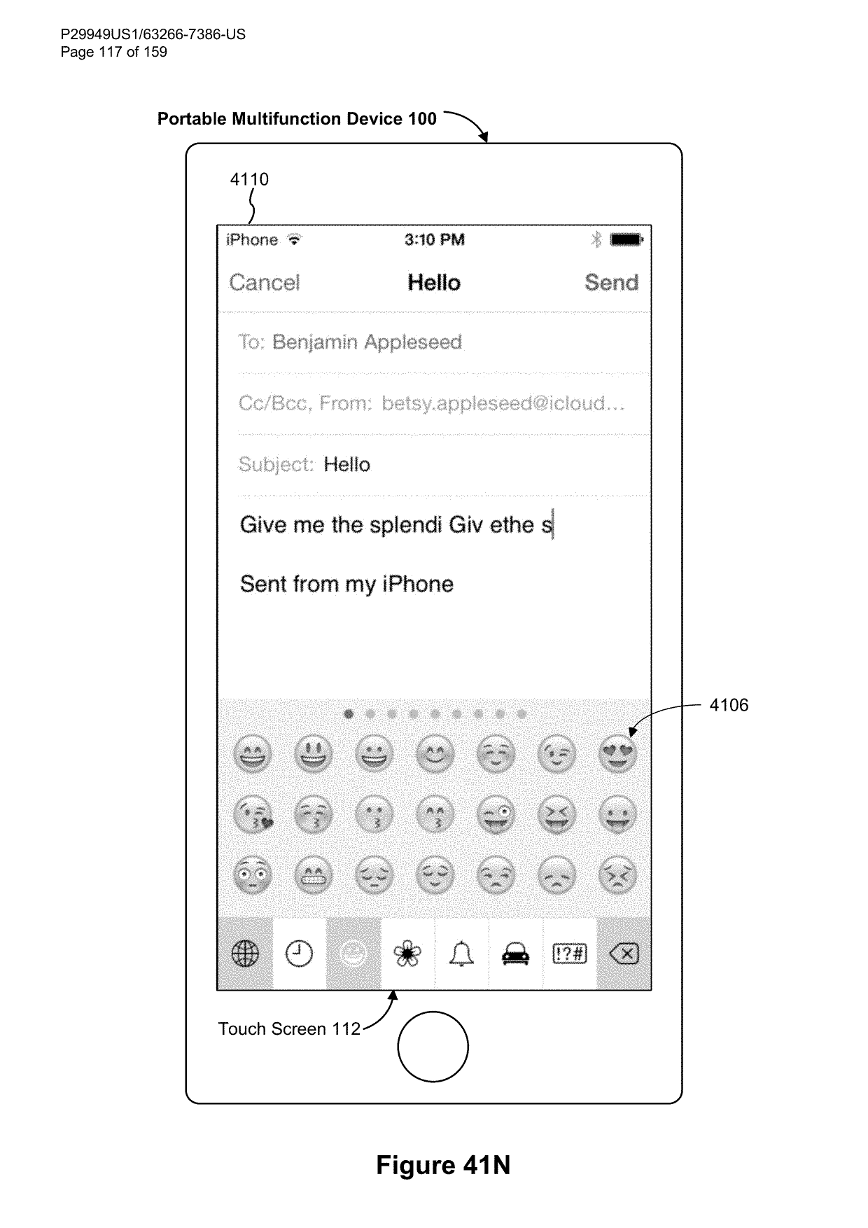

FIG. 40 is a flow chart illustrating a method 4000 for switching between virtual keyboards, in accordance with some embodiments. FIGS. 41A-41N, which illustrates exemplary user interfaces for switching between virtual keyboards, are used to illustrate the processes in FIG. 40. The method 4000 is performed at a portable multifunction device (e.g., the device 100 in FIG. 1A) with a touch-sensitive display (e.g., the touch screen 112 in FIG. 1A). As described below, the method 4000 provides an efficient mechanism for seamlessly switching between multiple virtual keyboards. This method is faster, easier to perform, and makes more efficient use of the display area than conventional methods that require the application to display an alternative keyboard affordance for selection by a user, which consumes valuable display screen space. The method is also intuitive for users, thereby reducing the cognitive burden on the user when selecting content, and creating a more efficient human-machine interface. A more efficient input mechanism also requires less computing resources, thereby increasing battery life of the device.

The device 100 displays (4002) a first virtual keyboard of a first size on the display. In some embodiments, the first virtual keyboard is (4004) a QWERTY keyboard, a foreign language keyboard, an emoji keyboard, a drawing pad, or a photo album. For example, in FIG. 41A, an instant messenger application is displayed on device 100. The instant messenger application includes a QWERTY keyboard 4102 at full-scale to allow a user to provide inputs to the instant messenger application.

In response to detecting a pre-defined gesture on the display, the device 100 concurrently displays (4006) multiple keyboards, including the first keyboard reduced to a second size smaller than the first size. In some embodiments, each of the multiple keyboards is (4008) a QWERTY keyboard, a foreign language keyboard, an emoji keyboard, a drawing pad, or a photo album. For example, FIG. 41C depicts a QWERTY keyboard 4102, an emoji keyboard 4106, a drawing pad 4111, and a photo album 4108. In some embodiments, the multiple keyboards are (4010) displayed in a grid. For example, FIG. 41C depicts a QWERTY keyboard 4102, an emoji keyboard 4106, a drawing pad 4111, and a photo album 4108 in a grid pattern. In some embodiments, the multiple keyboards are (4012) displayed in a scrollable list. For example, in FIGS. 41H-41I, the device 100 displays a series of keyboards (e.g., emoji keyboard 4106, and a photo album 4111) in a list that is scrollable via a swipe gesture (e.g., swipe gesture 4116).

In some embodiments, the pre-defined gesture is (4014) a pinch or a deep press. For example, in FIG. 41B, the device 100 detects a pinch gesture 4104. In response, the device 100 begins shrinking the QWERTY keyboard 4102 to a reduced-scale representation to provide space for a display of other keyboards. In FIG. 41C, the device 100 continues to detect the pinch gesture 4104. In response, the device 100 concurrently displays a QWERTY keyboard 4102, along with emoji keyboard 4106, a photo album 4108 and a drawing pad 4111, in a reduced-scale grid pattern. In FIG. 41D, after termination of the pinch gesture, the device 100 enlarges the concurrently displayed QWERTY keyboard 4102, emoji keyboard 4106, a photo album 4108 and a drawing pad 4111, into a full-scale grid pattern.

In some embodiments, the pre-defined gesture is (4016) a swipe from an edge of the first keyboard. For example, in FIG. 41K, an email application interface is displayed with a QWERTY keyboard 4102 as the virtual keyboard. In FIG. 41L, the device 100 detects a leftward swipe 4120 starting from the right edge of the virtual keyboard 4102. In response, as shown in FIG. 41M, the device 100 slides the QWERTY keyboard 4102 off the display from the left (i.e., toward the right edge of the display). In addition, the device 100 slides the emoji keyboard 4106 adjacent the QWERTY keyboard into the display from the left, toward the right edge of the display (FIG. 41N).

Referring back to FIG. 40, in some embodiments, the pre-defined gesture is (4018) an initial contact within a predefined region on the display followed by a movement of the contact on the display in a pre-defined direction. In such embodiments, currently displaying the multiple keyboards, including the first keyboard reduced to a second size smaller than the first size includes (4020): moving the first keyboard off the display in a direction associated with the pre-defined gesture; and moving a second keyboard of the multiple keyboards in the direction onto the display.

For example, in FIGS. 41F-41G, the gesture 4114 is an initial contact in the input area of the messenger user interface followed by a movement of the contact in a direction away from the virtual keyboard 4102. For example, in FIG. 41F, an instant messenger application is displayed on device 100. The instant messenger application includes a QWERTY keyboard 4102 at a full-scale representation to allow a user to provide inputs to the instant messenger application. The device 100 detects an input 4114 that includes an initial contact in the input area of the messenger interface. The input area is located above the virtual keyboard 4102. The initial contact is followed by movement of the contact in a direction away from the virtual keyboard 4102, e.g., in an upward direction. In response, the input area is pulled upward to create the visual effect that more space is provided for keyboard switching. Further, as shown in FIG. 41G, the device 100 shrinks the QWERTY keyboard 4102 to a reduced-scale representation for a display of other reduced-scale representation keyboards, such as emoji keyboard 4106. In FIG. 41H, while displaying portions of QWERTY keyboard 4102 and emoji keyboard 4106 the device 100 detects a leftward swipe gesture 4116 at emoji keyboard 4106. In response, as shown in FIG. 41I, the device 100 slides QWERTY keyboard 4102 to the left and out of the display. In addition, the device 100 slides the emoji keyboard 4106 to the left into the display. Lastly, the device 100 slides a portion of a photo album 4108 into the display.

Referring back to FIG. 40, the device 100 detects (4022) a selection of one of the multiple keyboards. In some embodiments, the selection is a light press, a deep press, a tap gesture, a pinch gesture, a press-and-hold gesture, or a tap gesture at one of the multiple keyboards. Once a keyboard is selected, the device 100 ceases (4024) to display the multiple keyboards and displays (4026) the selected one of the multiple keyboards on the display at the first size. For example, in FIGS. 41D-41E and 41H-41J, the device displays an emoji keyboard 4106 at full-scale in response to tap gesture 4112.

It should be understood that the particular order in which the operations in FIG. 40 have been described is merely exemplary and is not intended to indicate that the described order is the only order in which the operations could be performed. One of ordinary skill in the art would recognize various ways to reorder the operations described herein. For brevity, these details are not repeated here.

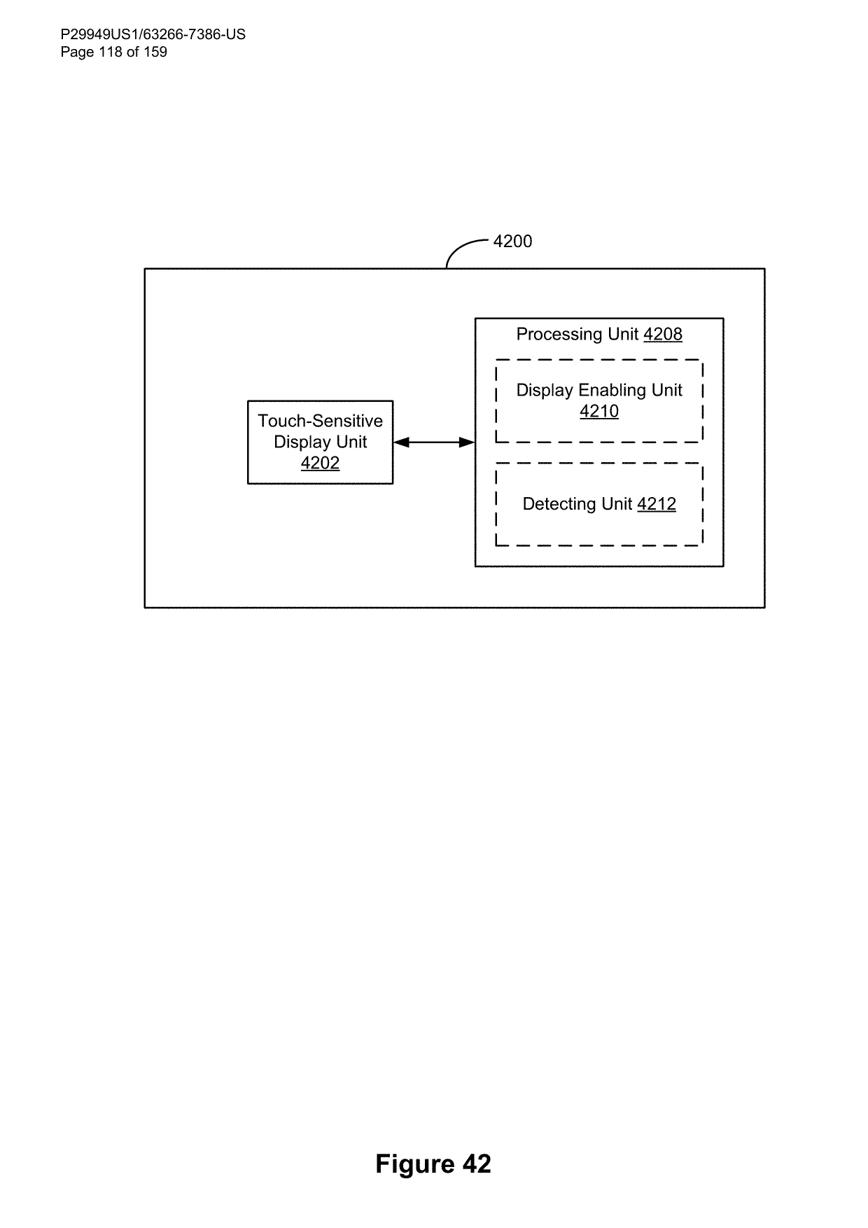

In accordance with some embodiments, FIG. 42 shows a functional block diagram of an electronic device 4200 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 42 are, optionally, combined or separated into sub-blocks to implement the principles of the various described embodiments. Therefore, the description herein optionally supports any possible combination or separation or further definition of the functional blocks described herein.

As shown in FIG. 42, an electronic device 4200 includes a touch-sensitive display unit 4202 configured to receive user inputs and display user interfaces and a processing unit 4208 coupled to the touch-sensitive display unit 4202. In some embodiments, the processing unit 4208 includes a display enabling unit 4210 and a detecting unit 4212.

In some embodiments, the processing unit 4208 is configured to display a first virtual keyboard of a first size on the display unit 4202 (e.g., with the display enabling unit 4210). In response to detecting a pre-defined gesture on the display unit 4202 (e.g., with the detecting unit 4212), the processing unit 4208 is configured to concurrently display multiple keyboards, including the first keyboard reduced to a second size smaller than the first size (e.g., with the display enabling unit 4210). The processing unit 4208 is further configured to detect a selection of one of the multiple keyboards (e.g., with the detecting unit 4212), cease to display the multiple keyboards (e.g., with the display enabling unit 4210), and display the selected one of the multiple keyboards on the display unit 4202 at the first size (e.g., with the display enabling unit 4210).

In some embodiments, the first virtual keyboard is a QWERTY keyboard, a foreign language keyboard, an emoji keyboard, a drawing pad, or a photo album.

In some embodiments, the each of the multiple keyboards is a QWERTY keyboard, a foreign language keyboard, an emoji keyboard, a drawing pad, or a photo album. In some embodiments, the multiple keyboards are displayed in a grid. In some embodiments, the multiple keyboards are displayed in a scrollable list. In some embodiments, the pre-defined gesture is a pinch or a deep press. In some embodiments, the pre-defined gesture is a swipe from an edge of the first keyboard.

In some embodiments, currently enabling display of the multiple keyboards, including the first keyboard reduced to a second size smaller than the first size includes moving the first keyboard out of the display unit 4202 in a direction associated with the pre-defined gesture; and moving a second keyboard of the multiple keyboards in the direction into the display unit 4202.

In some embodiments, the pre-defined gesture is an initial contact within a predefined region on the display unit 4202 followed by a movement of the contact on the display unit 4202 in a pre-defined direction.

The operations in the information processing methods described above are, optionally implemented by running one or more functional modules in information processing apparatus such as general purpose processors (e.g., as described above with respect to FIGS. 1A and 3A-3B) or application specific chips.

The operations described above with reference to FIGS. 41A-41N are, optionally, implemented by components depicted in FIGS. 1A-1B or FIG. 42. For example, displaying enabling operation 4210 and detecting operation 4212 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Virtual Keyboard Without Shift Key

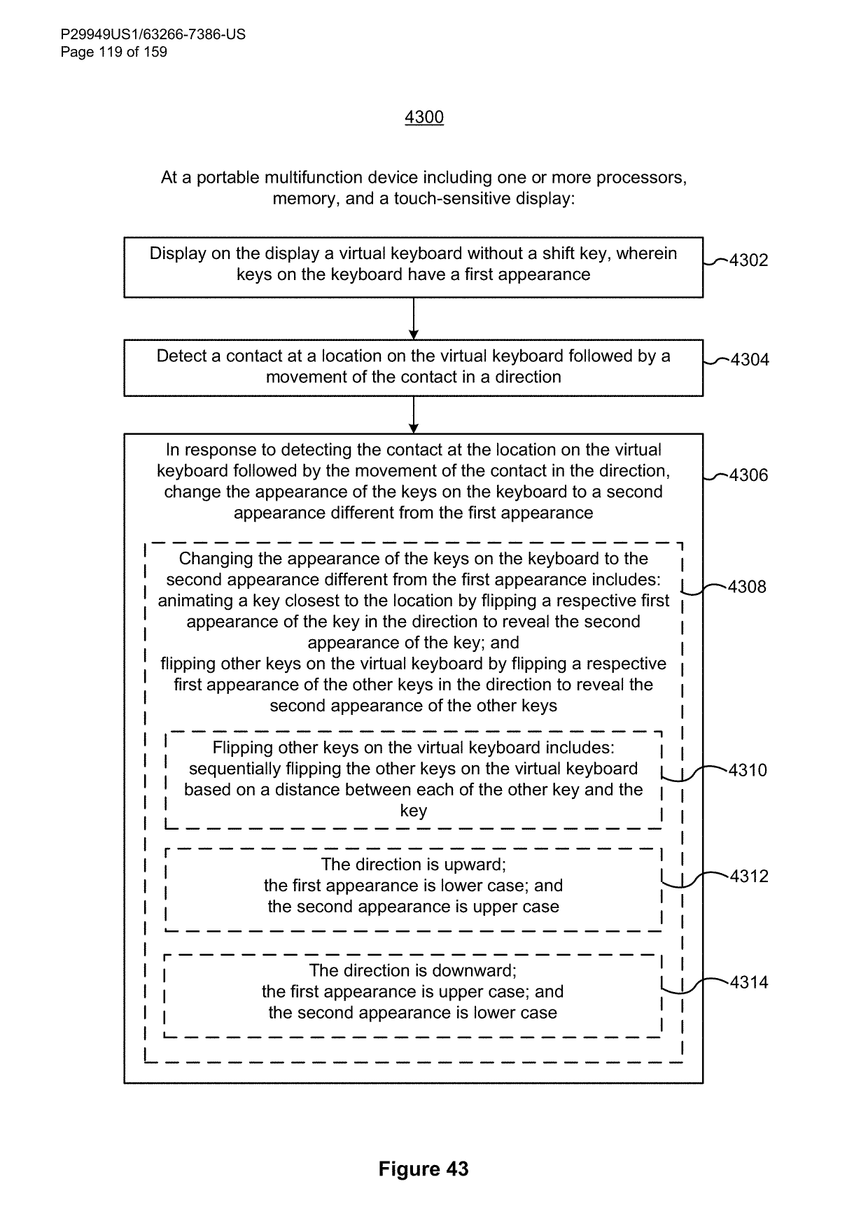

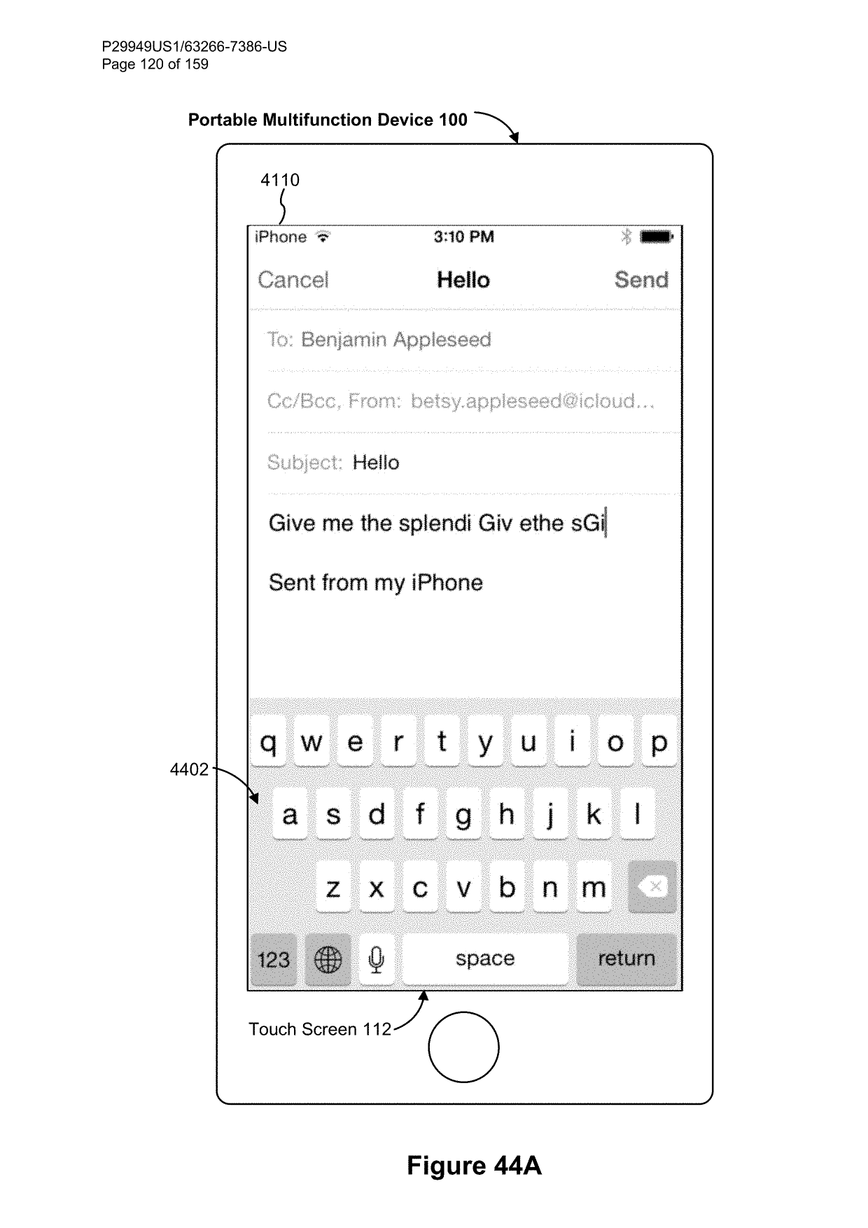

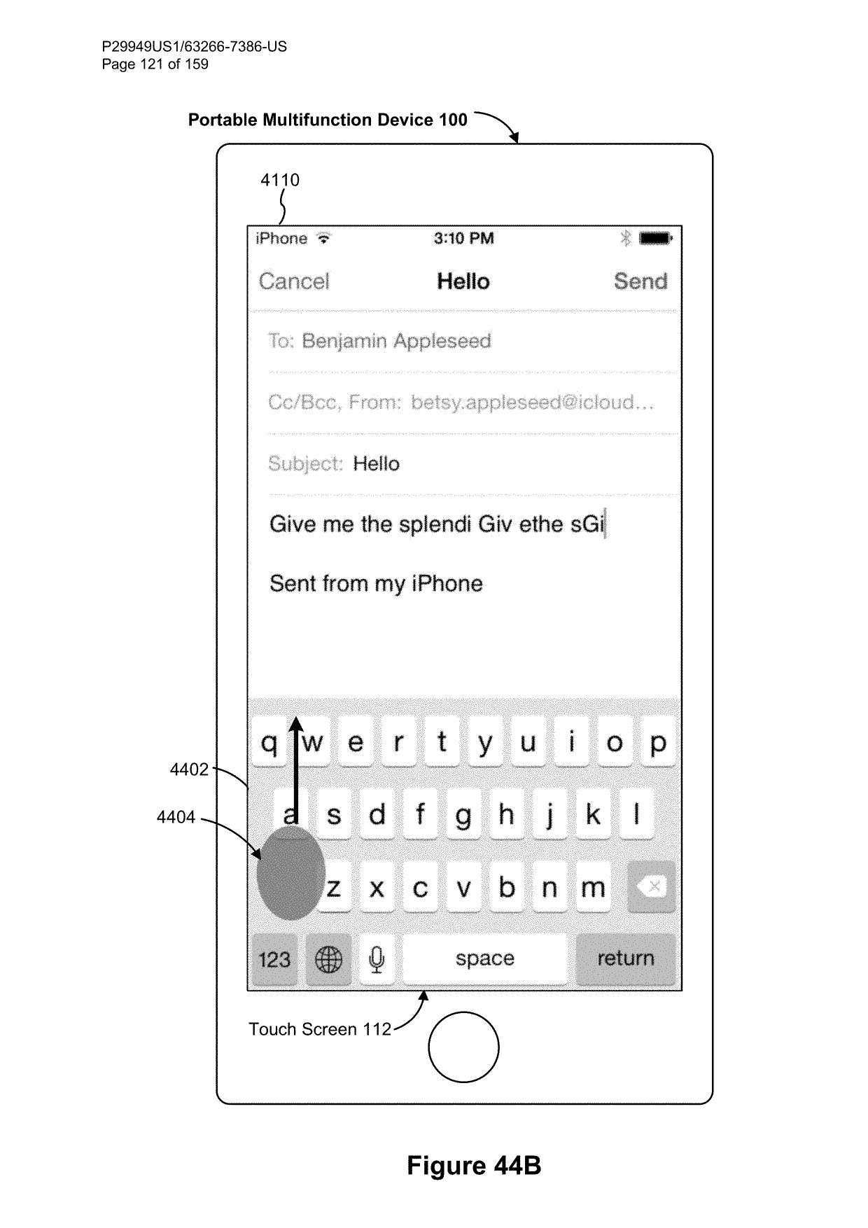

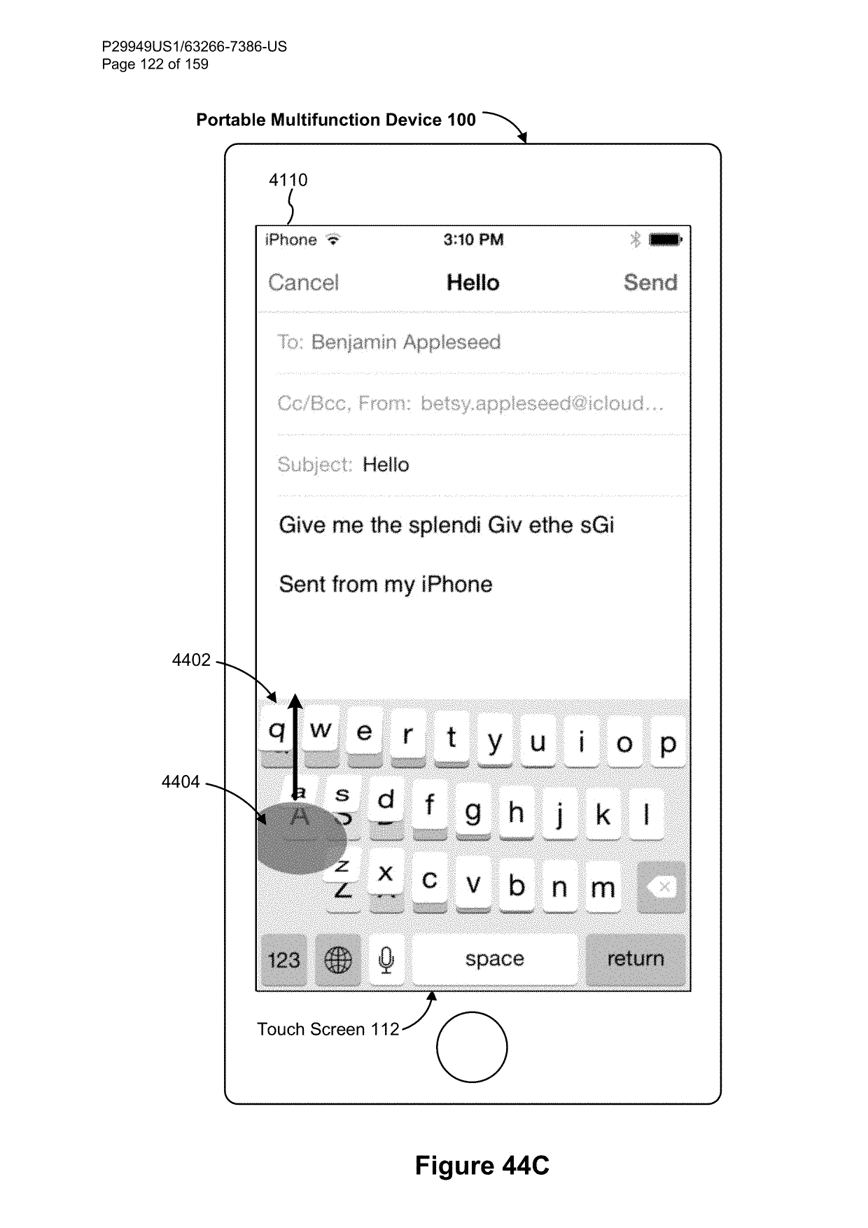

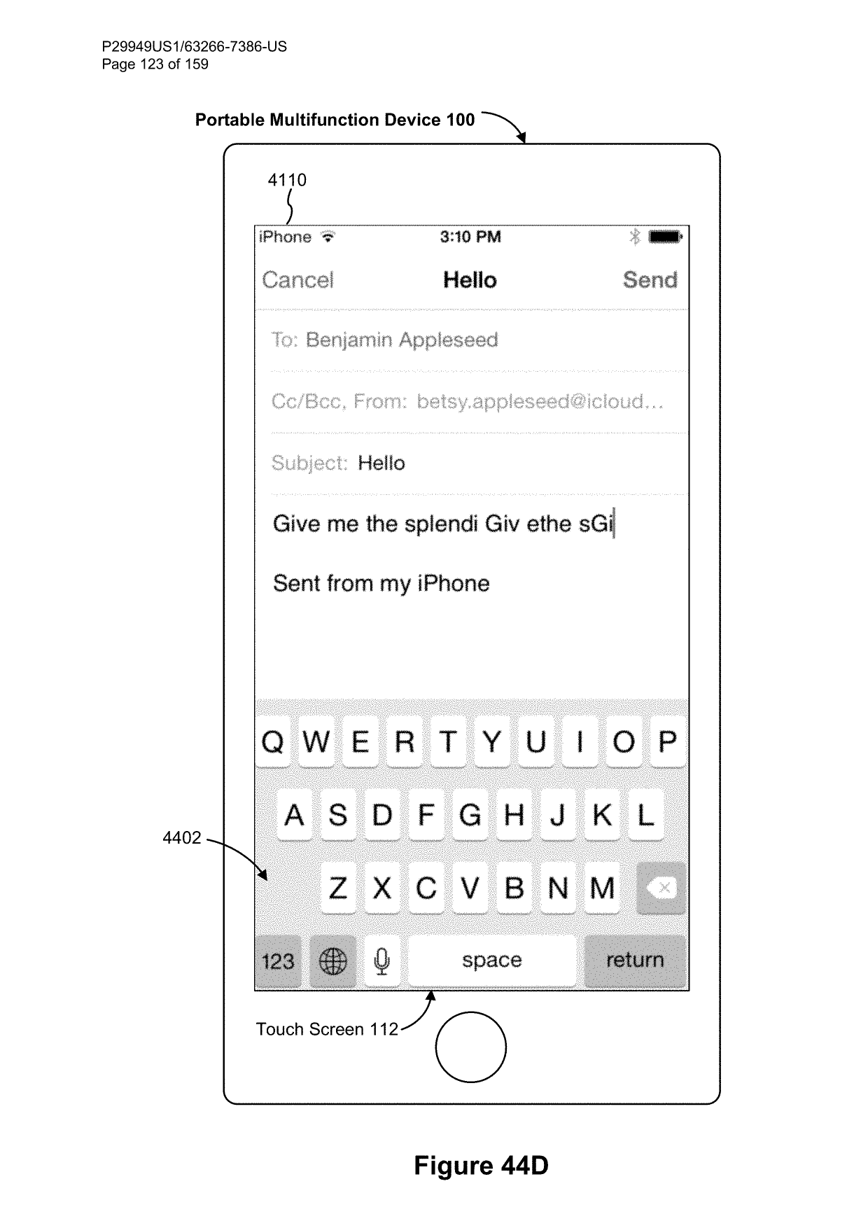

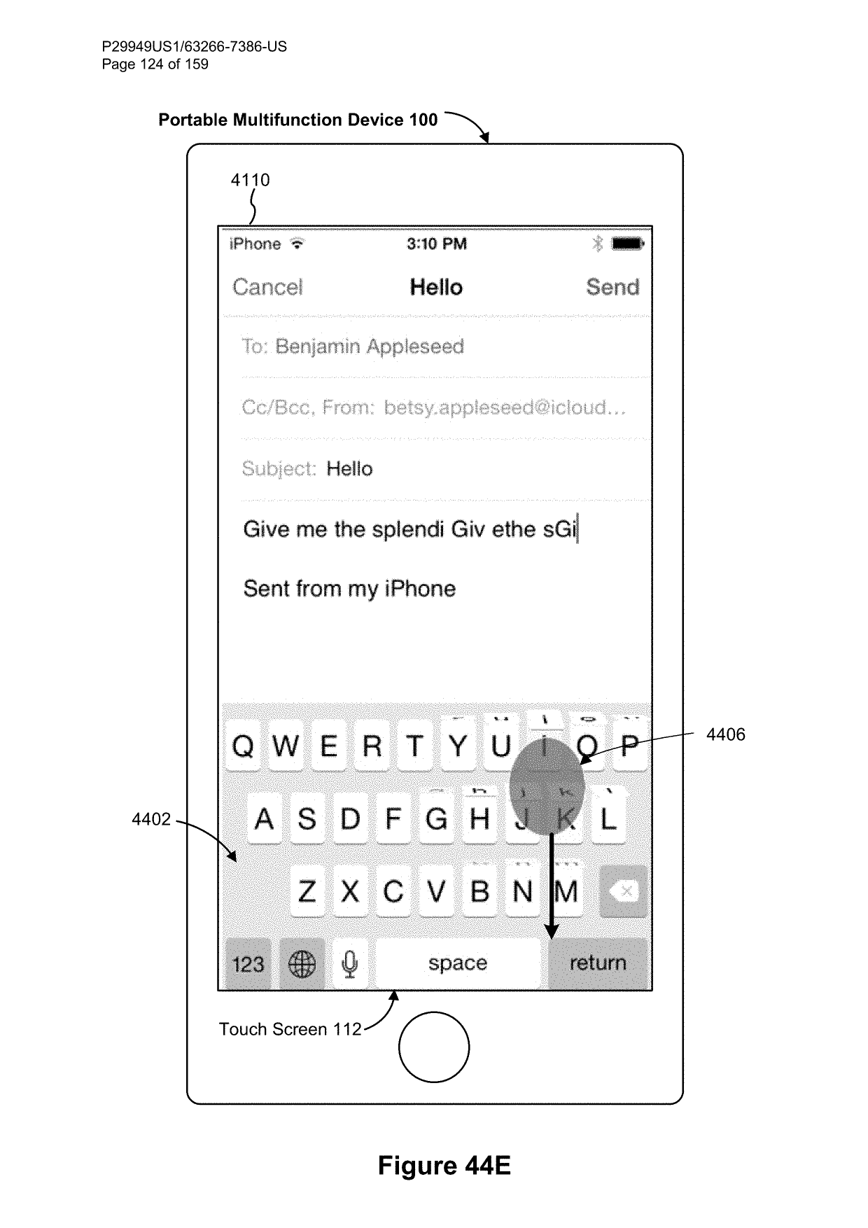

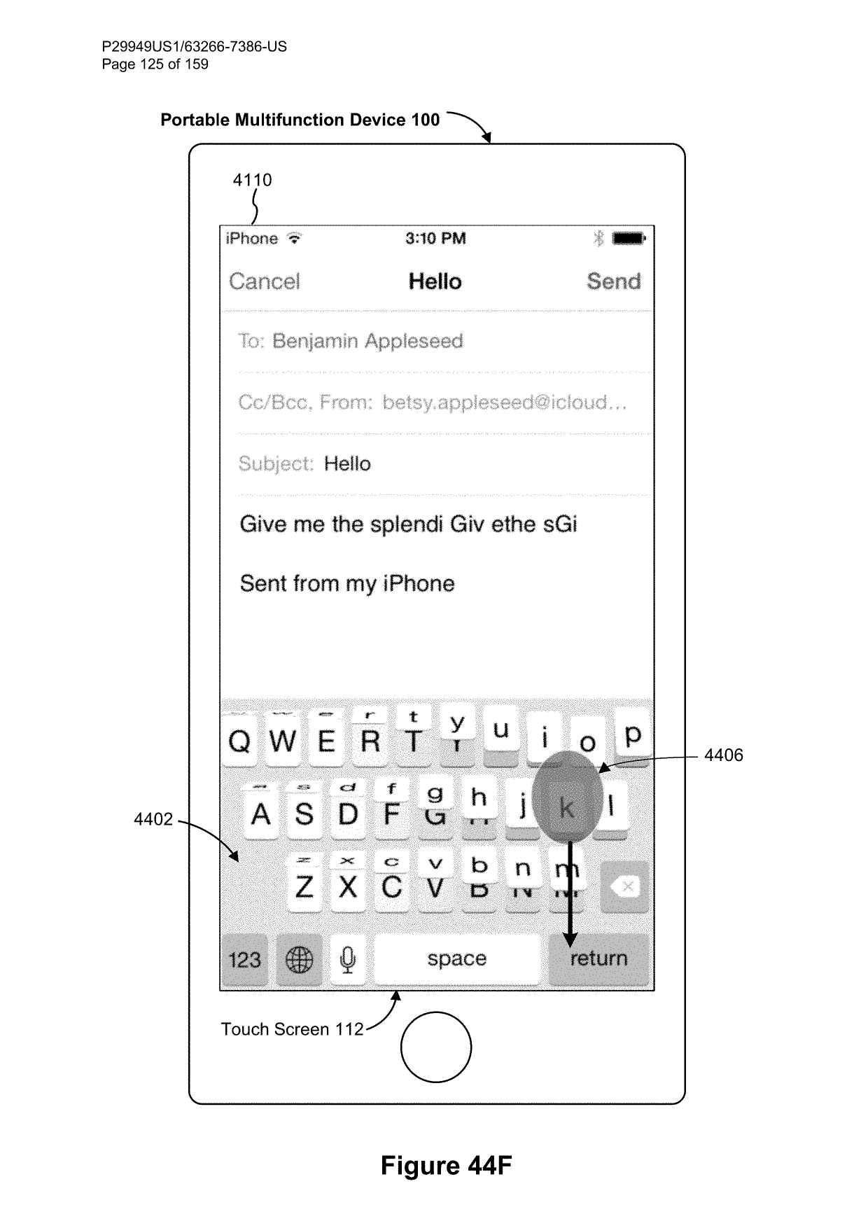

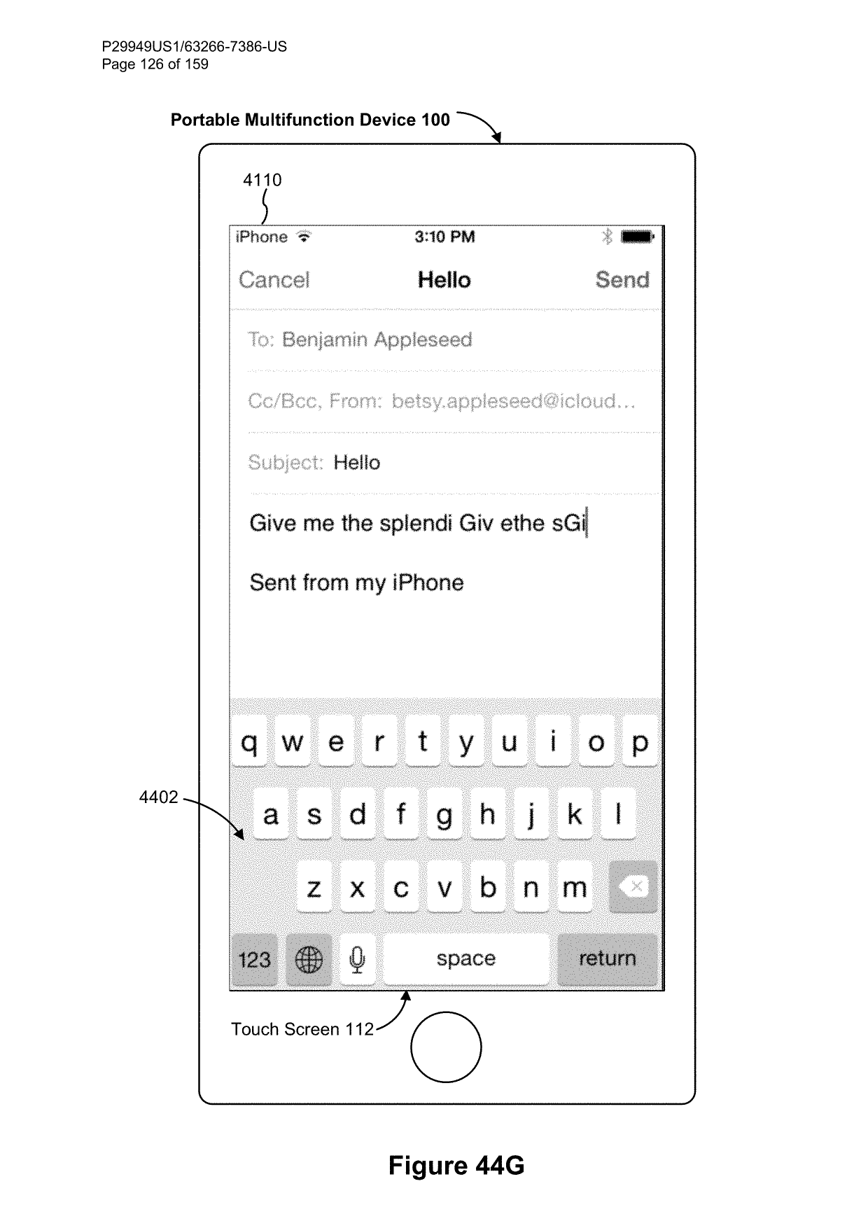

FIG. 43 is a flow chart illustrating a method 4300 for switching between different sets of characters (e.g., lower case and upper case characters) on a virtual keyboard, in accordance with some embodiments. FIGS. 44A-44G, which illustrate exemplary user interfaces for switching between different sets of characters on a virtual keyboard, are used to illustrate the processes in FIG. 43. The method 4300 is performed at a portable multifunction device (e.g., the device 100 in FIG. 1A) with a touch-sensitive display (e.g., the touch screen 112 in FIG. 1A). As described below, the method 4300 provides an efficient mechanism for seamlessly switching between different sets of characters on a virtual keyboard using a single user input. This method is faster, easier to perform, and more efficiently uses display area, as compared to conventional methods that require the application to display an affordance for selection by a user to switch between different sets of characters, which consumes valuable display screen space. The method is also intuitive for users, thereby reducing the cognitive burden on the user when selecting content, and creating a more efficient human-machine interface. A more efficient input mechanism also requires less computing resources, thereby increasing battery life of the device.

The device 100 displays (4302) on a display a virtual keyboard (e.g., QWERTY keyboard 4402 in FIG. 44A) without a shift key, wherein keys on the keyboard have a first appearance. In some embodiments, the first appearance may be lower case characters (e.g., as shown in FIG. 44A), upper case characters (e.g., as shown in FIG. 44D), or a first set of emoji characters.

The device 100 detects (4304) a contact at a location on the virtual keyboard followed by a change in the input, e.g., a movement of the contact in a direction. In some embodiments, the contact is a swipe gesture, or a deep press gesture. For example, as shown in FIG. 44B, the contact is an upward swipe gesture 4404. In response to detecting the contact at the location on the virtual keyboard followed by the movement of the contact in the direction, the device 100 changes (4306) the appearance of the keys on the keyboard to a second appearance different from the first appearance.

For example, FIGS. 44A-44D illustrate exemplary user interfaces for switching between a set of lower case characters to a set of upper case characters on a virtual keyboard. In FIG. 44A, an email application is displayed on device 100. The email application includes a QWERTY keyboard 4402 to allow a user to provide inputs to the email application. QWERTY keyboard 4402 displays a set of lower case characters on the keys. In FIG. 44B, the device 100 detects an upward swipe gesture 4404 at the QWERTY keyboard 4402, e.g., at the lower case “a” key. In response, as shown in FIG. 44C-44D, the device 100 changes the appearance of the characters on the QWERTY keyboard 4402 from displaying the set of lower case characters to displaying a set of upper case characters.

In some embodiments, the change of the display is animated. For example, starting with the lower case “a” key, the device 100 begins to “flip” the lower case “a” key to reveal an upper case “A” key (similar to flipping over a playing card). The device 100 then begins to sequentially “flip” the other lower case keys on the QWERTY keyboard 4402 to reveal the corresponding upper case keys underneath, in an order based on each key's distance from the upward swipe gesture 4404. This animation gives the appearance of a “ripple effect” over the keys of the QWERTY keyboard 4402. At the completion of the animation, as shown in FIG. 44D, the device 100 displays the set of upper case characters on the QWERTY keyboard 4402.

In some embodiments, the second appearance may be lower case characters (e.g., as shown in FIG. 44A), upper case characters (e.g., as shown in FIG. 44D), or a second set of characters, e.g., emoji characters. For example, in response to an upward swipe gesture, as shown in FIG. 44B, the device 100 changes the appearance of the keys on the QWERTY keyboard 4402 from lower case characters (e.g., as shown in FIG. 44A) to upper case characters (e.g., as shown in FIG. 44D).

Referring back to FIG. 43, in some embodiments, changing the appearance of the keys on the keyboard to the second appearance different from the first appearance includes (4308): animating a key closest to the location by flipping a respective first appearance of the key in the direction to reveal the second appearance; and flipping other keys on the virtual keyboard by flipping a respective first appearance of the other keys to reveal the second appearance of the other keys. For example, in FIG. 44C, the lower case “a” key, which is closest to the upward swipe gesture 4404 “flips” in an upward direction to reveal the upper case “A” key underneath. As another example, in FIG. 44E, the lower case “i” key, which is closest to the upward swipe gesture 4404 “flips” in an upward direction to reveal the upper case “I” key underneath.

In some embodiments, flipping other keys on the virtual keyboard includes (4310): sequentially flipping the other keys on the virtual keyboard based on a distance between each of the other keys and the key closest to the gesture. In other words, the timing of each key flip may be different depending on the distance from the key where the contact is detected. For example, in FIG. 44C, the middle row of the QWERTY keyboard 4402 contains keys “a”, “s”, “d”, “f” etc. from left to right. The contact 4404 is on the lower case “a” key. In response to detecting the upward swipe gesture 4404, the lower case “a” key is flipped first, followed by lower case “s” key, then lower case “d” key, etc. Similarly, among the keys in the top row of the QWERTY keyboard 4402, keys “e” and “r” are further away from the “a” key than keys “q” and “w”. Thus, key “e” is flipped after flipping the key “q” and “w” and key “r” is flipped after the lower case “e” key. In other embodiments, the timing of the key flips is sequential, e.g., starting from the upper left of the keyboard and ending at the lower right of the keyboard.

In some embodiments, the direction is (4312) upward; the first appearance is lower case; and the second appearance is upper case. For example, as shown in FIG. 44B-44D, in response to upward swipe gesture 4404, the device 100 changes the QWERTY keyboard keys from lower case keys to upper case keys.

In some embodiments, the direction is (4314) downward; the first appearance is upper case; and the second appearance is lower case. For example, as shown in FIG. 44E-44G, in response to downward swipe gesture 4406, the device 100 changes the QWERTY keyboard keys from upper case keys to lower case keys. In FIG. 44E, the device 100 displays the set of upper case characters on the QWERTY keyboard 4402. In FIG. 44E, the device 100 detects a downward swipe gesture 4406 at the QWERTY keyboard 4402 and specifically the upper case “I” key. In response, as shown in FIGS. 44E-44F, the device 100 changes the appearance of the characters on the QWERTY keyboard 4402 from displaying the set of upper case characters to displaying the set of lower case characters. Starting with the upper case “I” key, the device 100 begins to “flip” a previously hidden lower case “i” key to cover the upper case “I” key, similar to flipping a playing card. The device 100 then begins to sequentially “flip” other lower case keys on the QWERTY keyboard 4402 corresponding to their upper case counterparts to cover the upper case keys on the QWERTY keyboard 4402. In this example, the lower case keys are “flipped” in an order based on each upper case key's distance from the downward swipe gesture 4406. This animation gives the appearance of a “ripple effect.” At the completion of the animation, as shown in FIG. 44G, the device 100 displays the set of lower case characters on the QWERTY keyboard 4402.

It should be understood that the particular order in which the operations in FIG. 43 have been described is merely exemplary and is not intended to indicate that the described order is the only order in which the operations could be performed. One of ordinary skill in the art would recognize various ways to reorder the operations described herein. For brevity, these details are not repeated here.

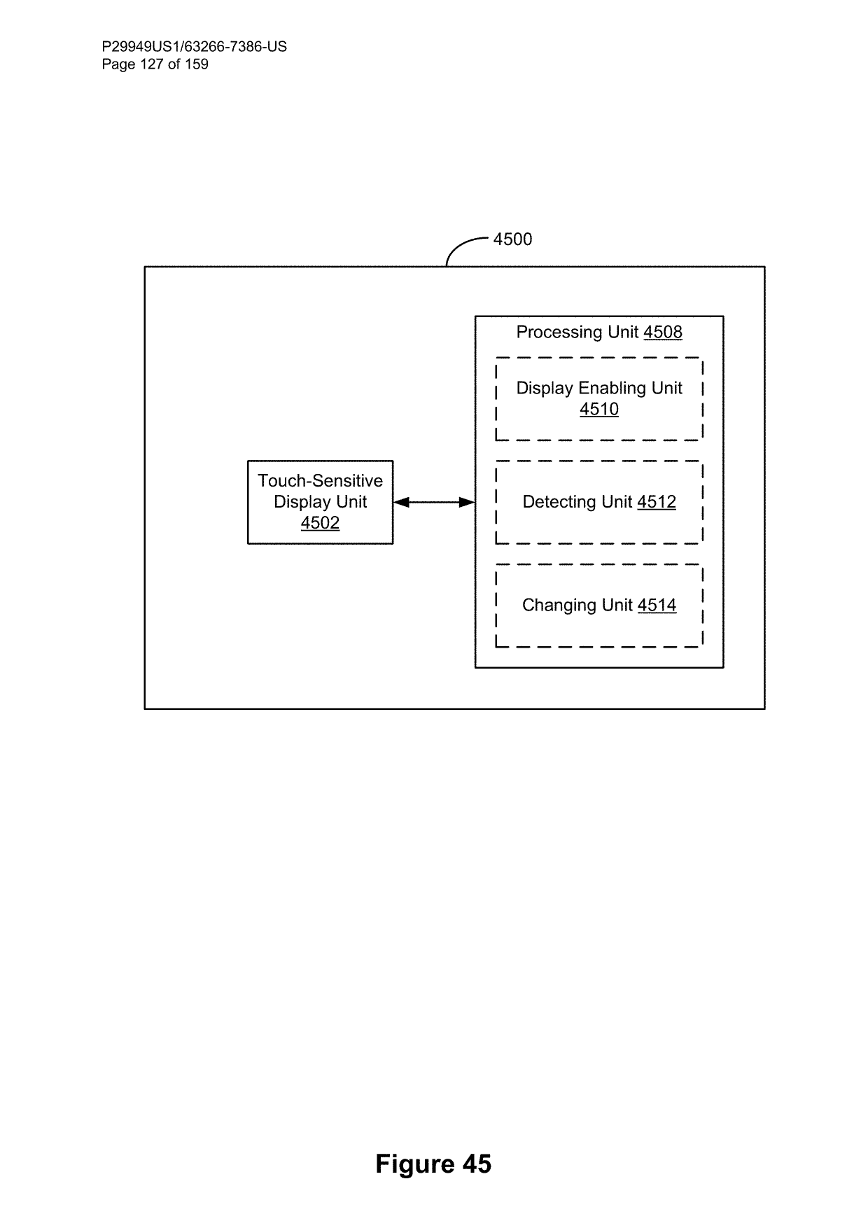

In accordance with some embodiments, FIG. 45 shows a functional block diagram of an electronic device 4500 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 45 are, optionally, combined or separated into sub-blocks to implement the principles of the various described embodiments. Therefore, the description herein optionally supports any possible combination or separation or further definition of the functional blocks described herein.

As shown in FIG. 45, an electronic device 4500 includes a touch-sensitive display unit 4502 configured to receive user inputs and display user interfaces and a processing unit 4508 coupled to the touch-sensitive display unit 4502. In some embodiments, the processing unit 4508 includes a display enabling unit 4510, a detecting unit 4512, and a changing unit 4514.

In some embodiments, the processing unit 4508 is configured to display on the display unit 4502 a virtual keyboard without a shift key, where keys on the keyboard have a first appearance (e.g., with the display enabling unit 4510). The processing unit 4508 is further configured to detect a contact at a location on the virtual keyboard followed by a movement of the contact in a direction (e.g., with the detecting unit 4512). In response to detecting the contact at the location on the virtual keyboard followed by the movement of the contact in the direction, the processing unit 4508 is configured to change the appearance of the keys on the keyboard to a second appearance different from the first appearance (e.g., with the changing unit 4514).

In some embodiments, changing the appearance of the keys on the keyboard to the second appearance different from the first appearance includes animating a key closest to the location by flipping a respective second appearance of the key in the direction to reveal the first appearance of the key; and flipping other keys on the virtual keyboard by flipping a respective second appearance of the other keys in the direction to reveal the first appearance of the other keys.

In some embodiments, flipping other keys on the virtual keyboard includes sequentially flipping the other keys on the virtual keyboard based on a distance between each of the other key and the key. In some embodiments, the direction is upward; the first appearance is lower case; and the second appearance is upper case. In some embodiments, the direction is downward; the first appearance is upper case; and the second appearance is lower case.

The operations in the information processing methods described above are, optionally implemented by running one or more functional modules in information processing apparatus such as general purpose processors (e.g., as described above with respect to FIGS. 1A and 3A-3B) or application specific chips.

The operations described above with reference to FIGS. 44A-44G are, optionally, implemented by components depicted in FIGS. 1A-1B or FIG. 45. For example, display enabling operation 4210, detecting operation 4212, and changing operation 4514 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Switching Between Text and Video Communications

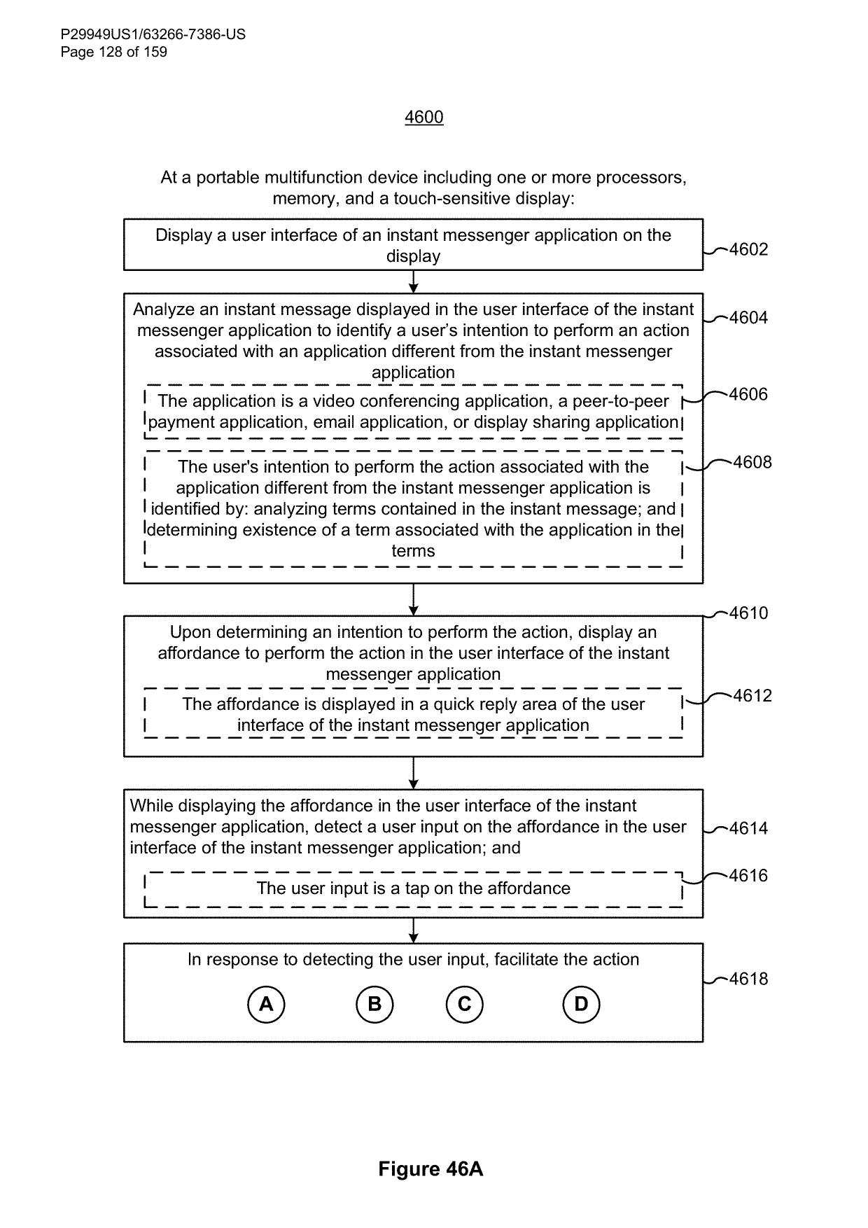

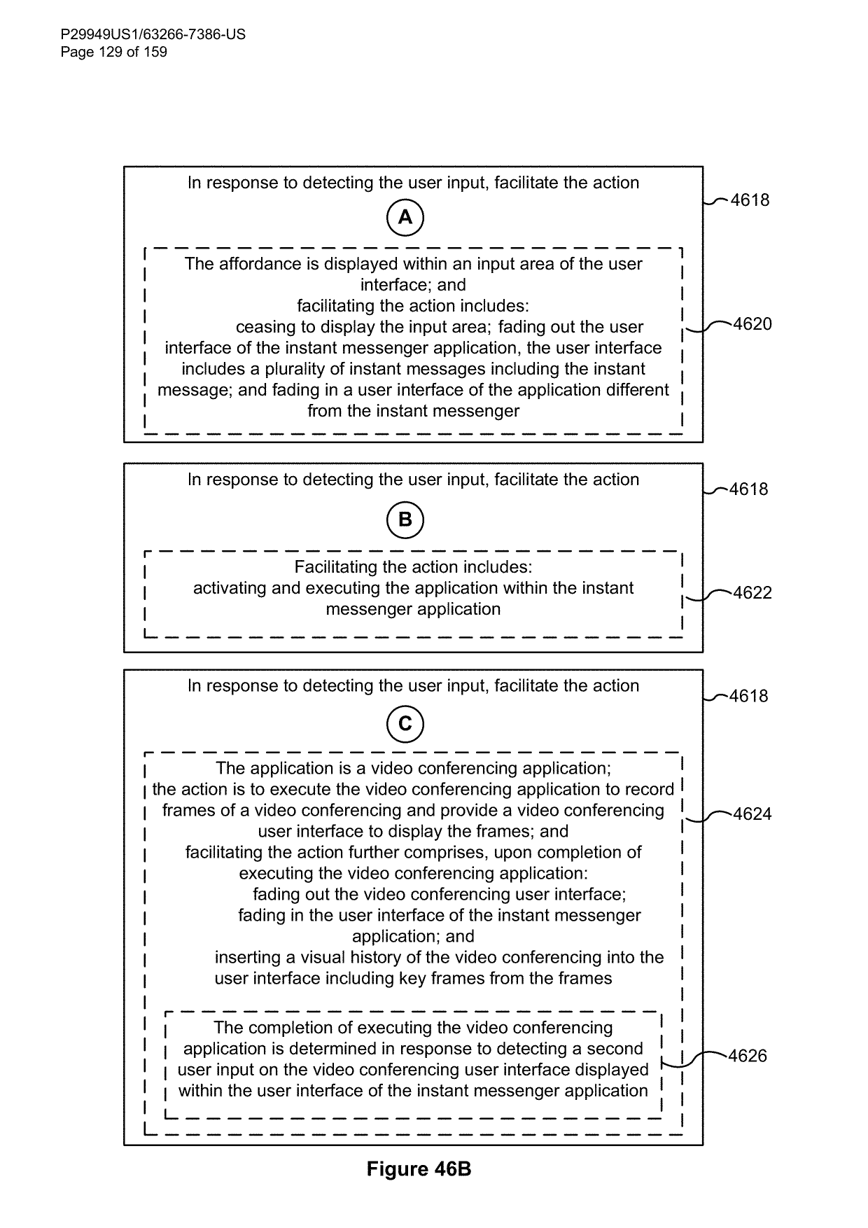

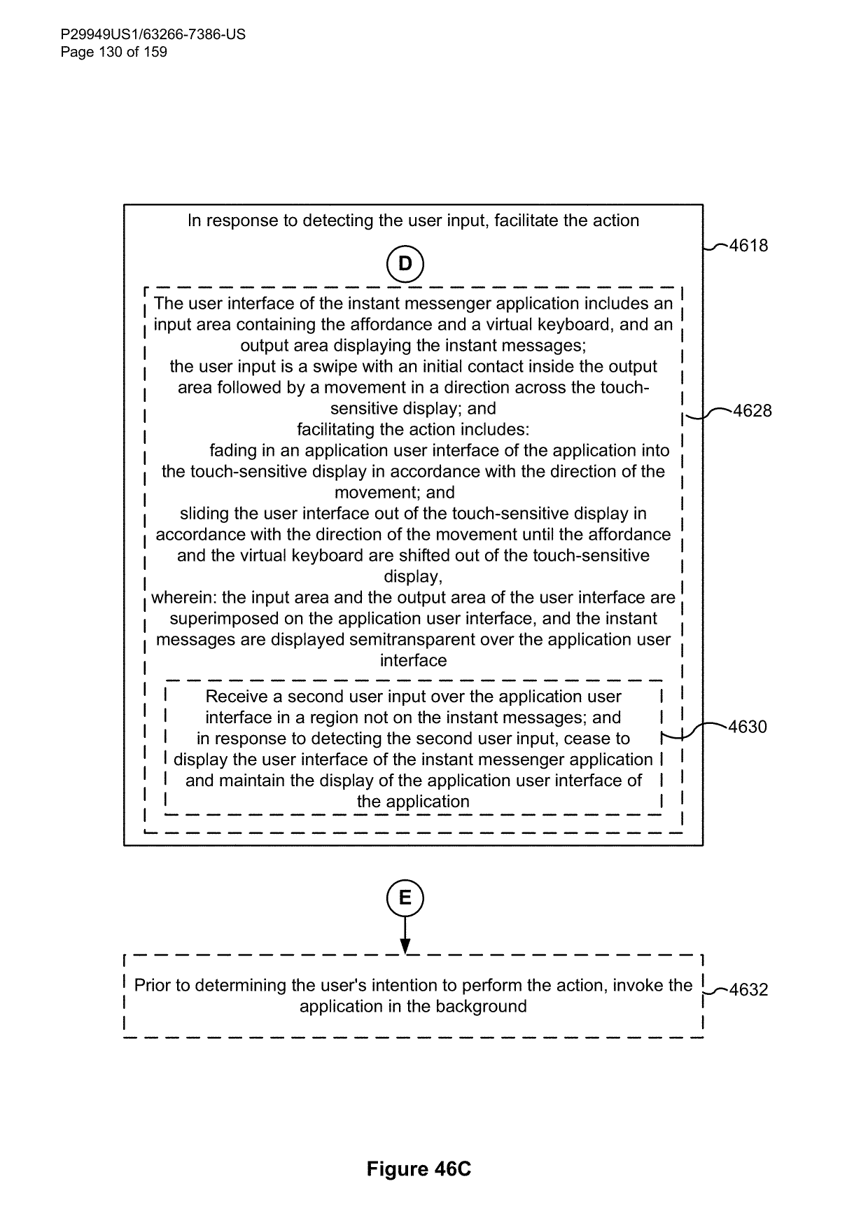

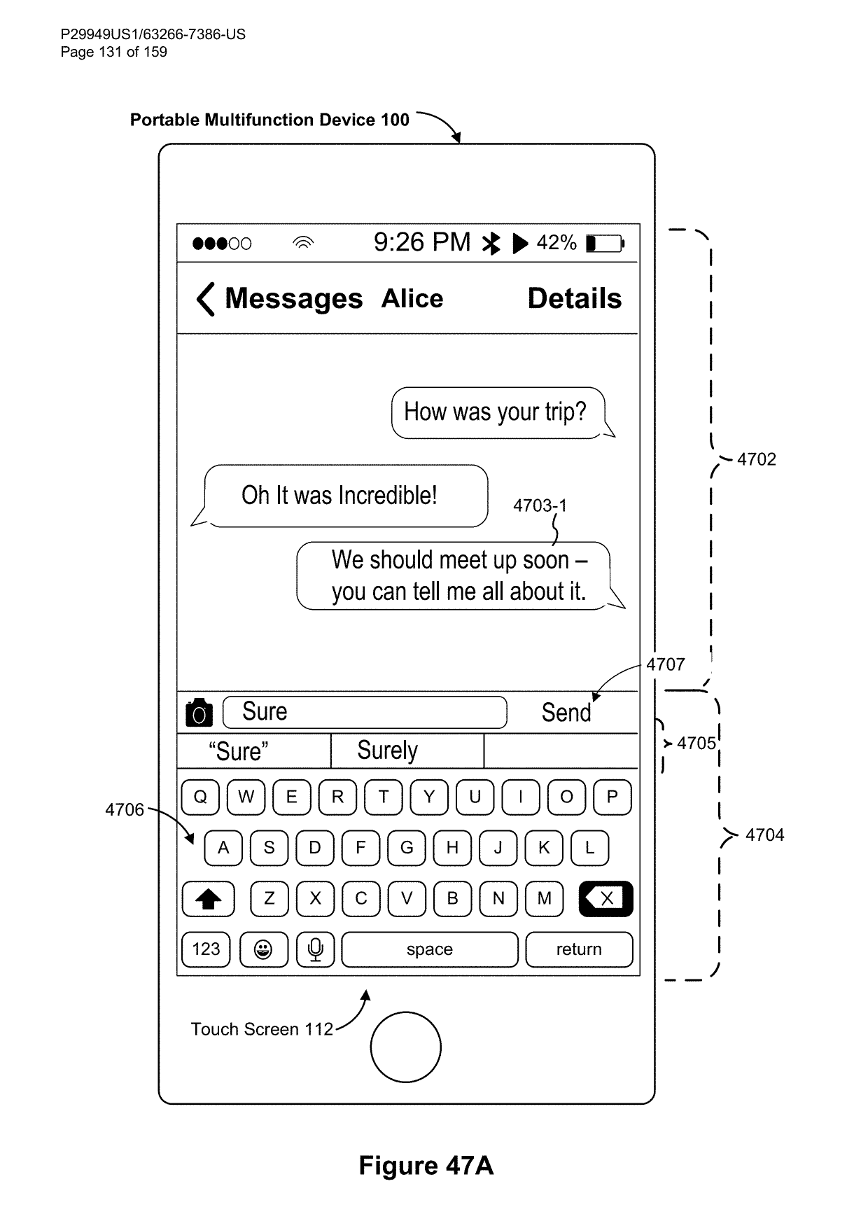

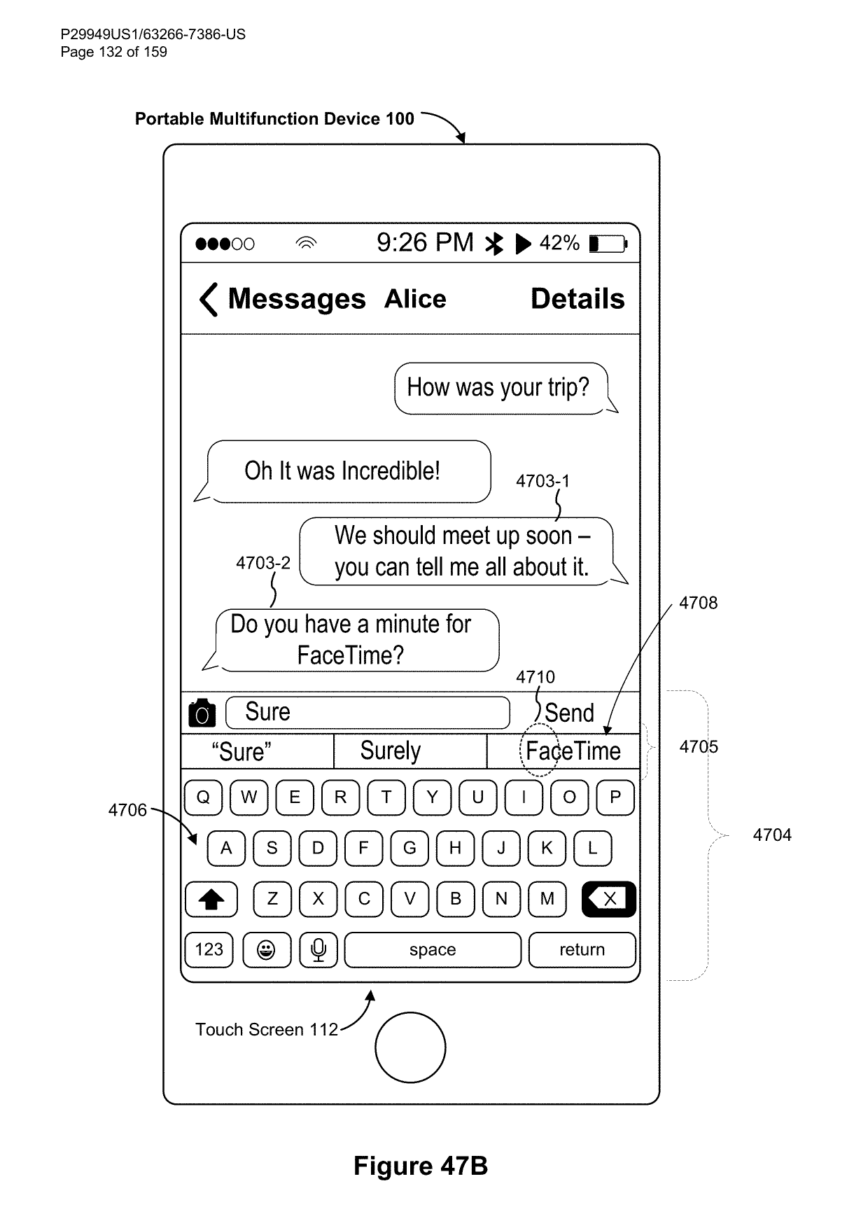

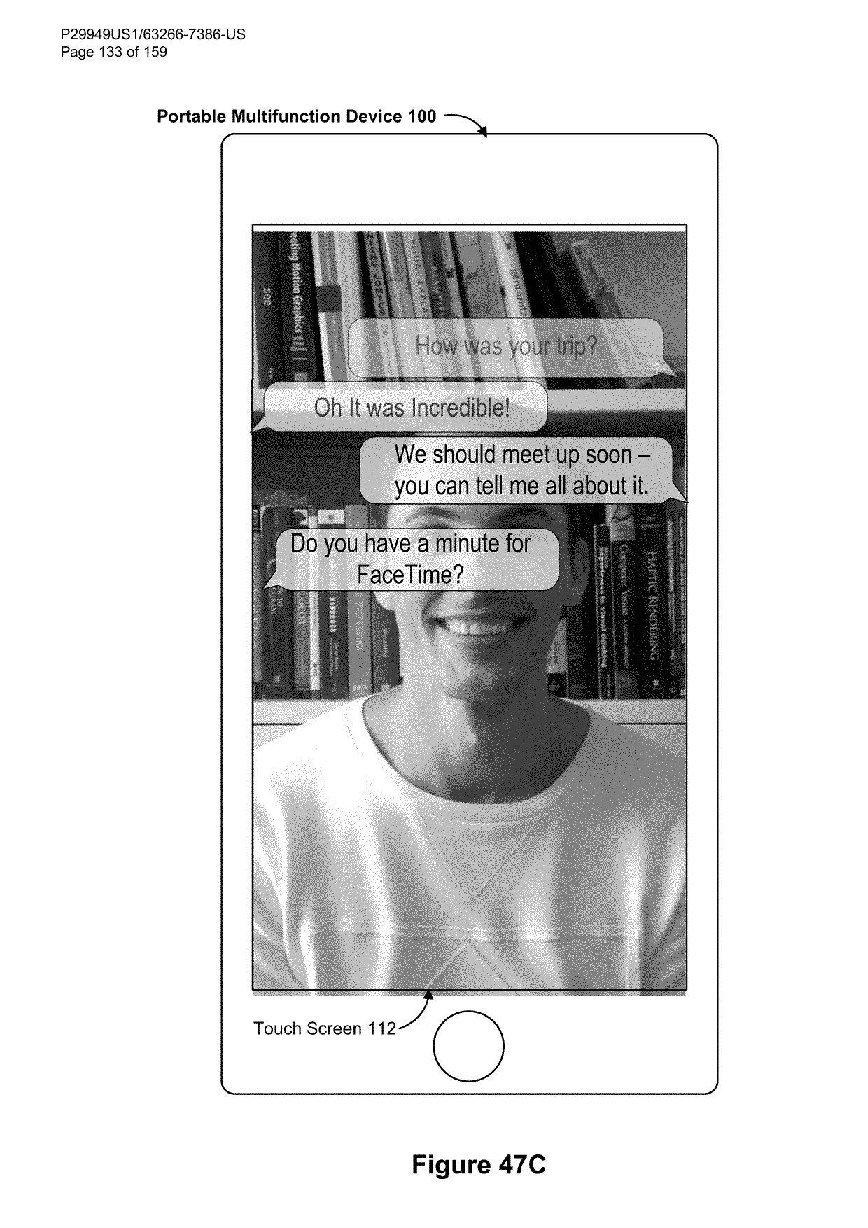

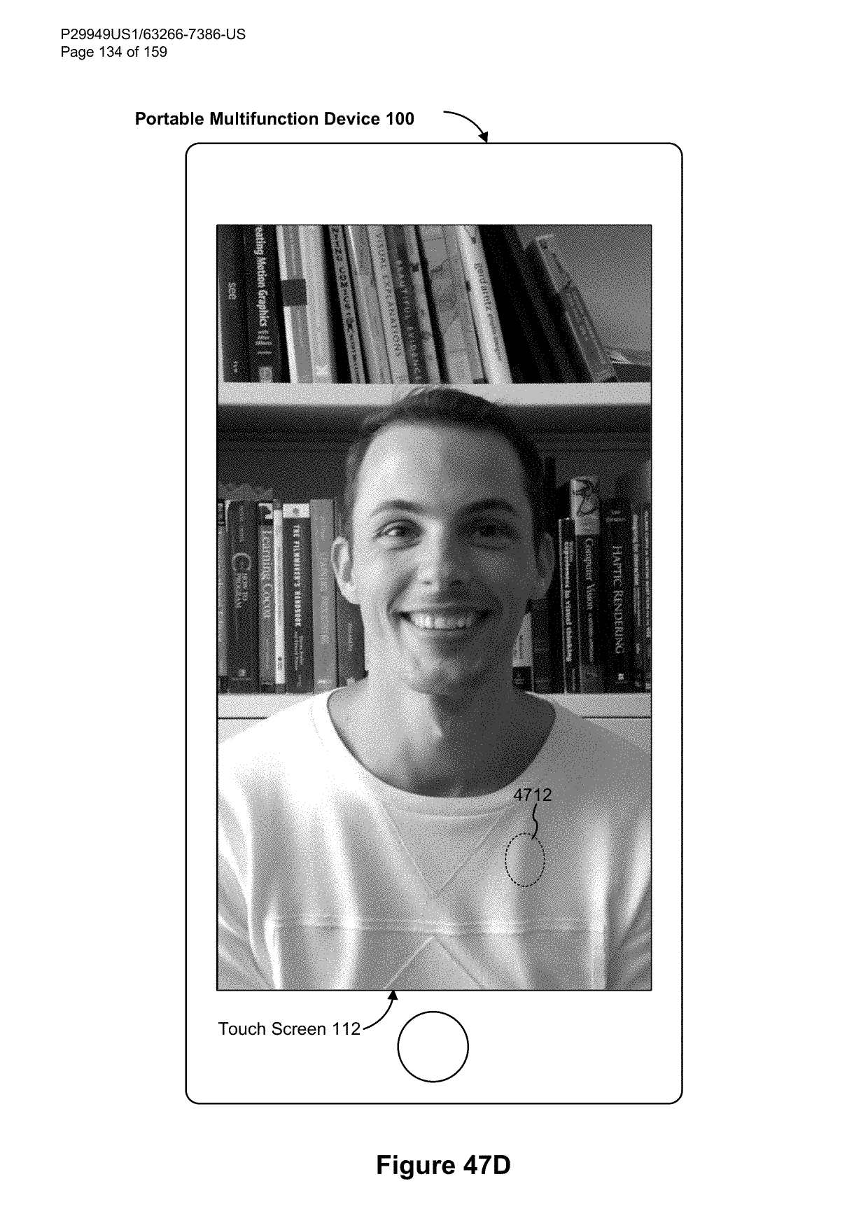

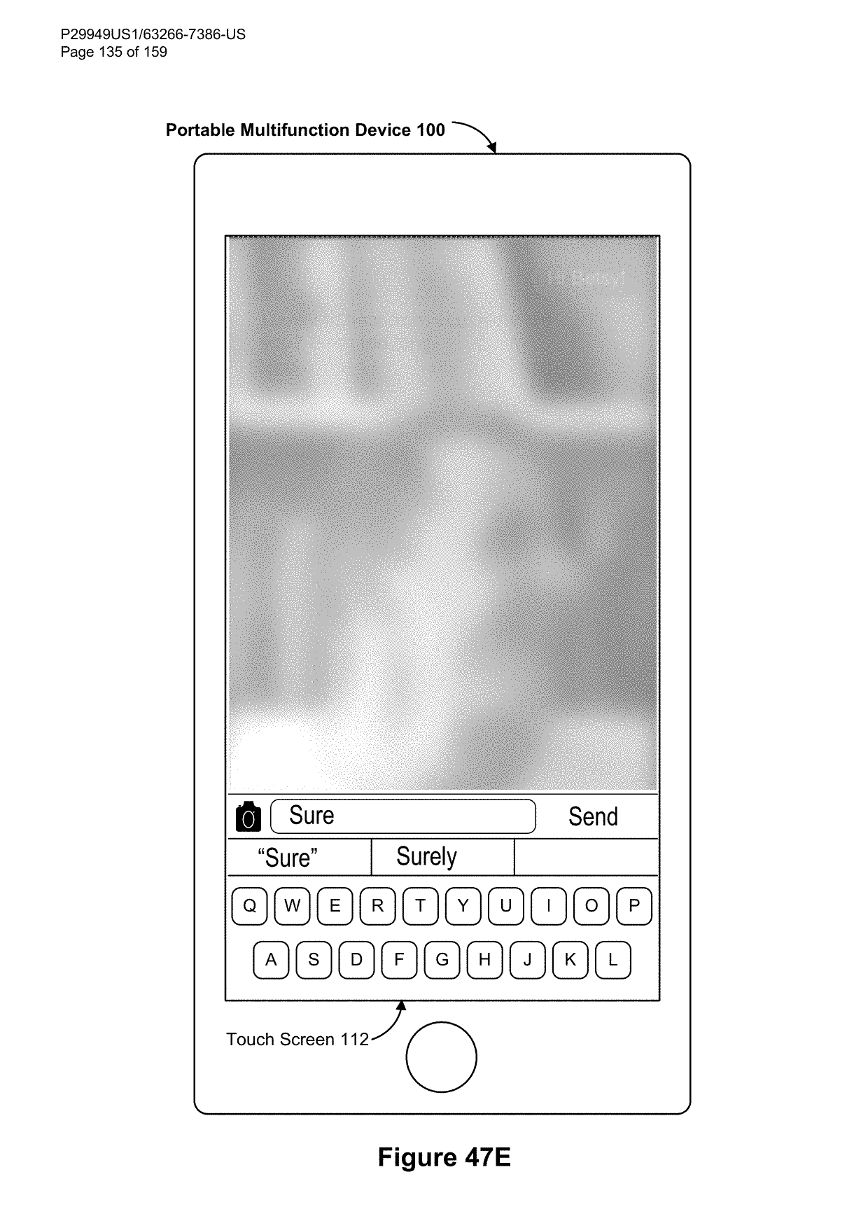

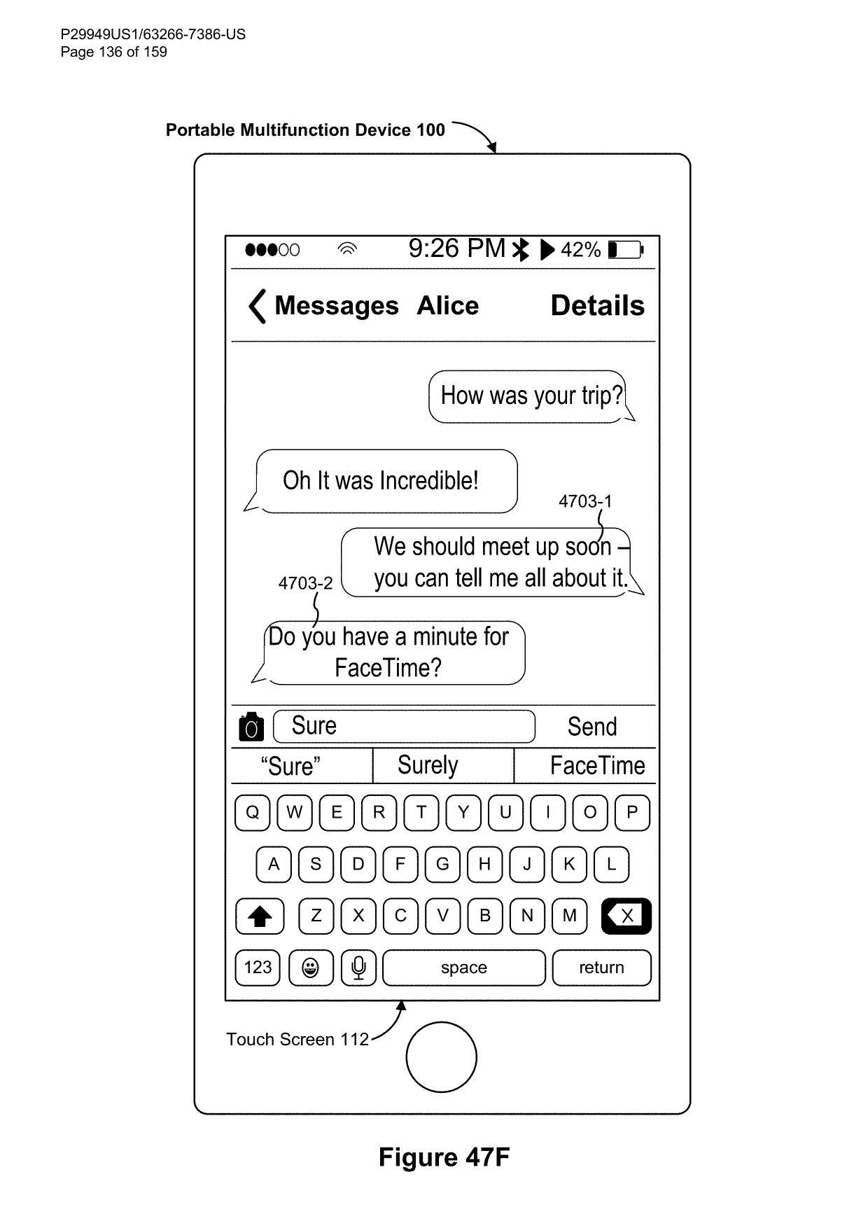

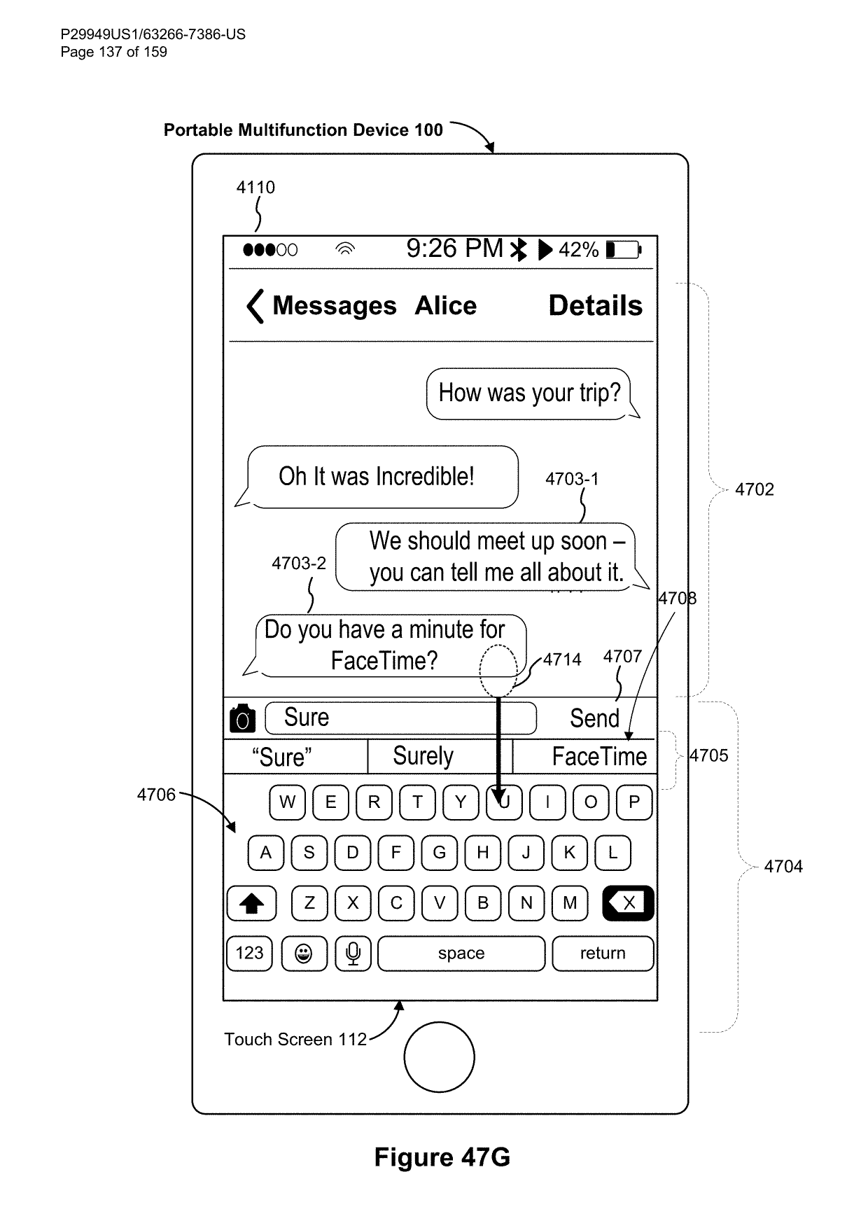

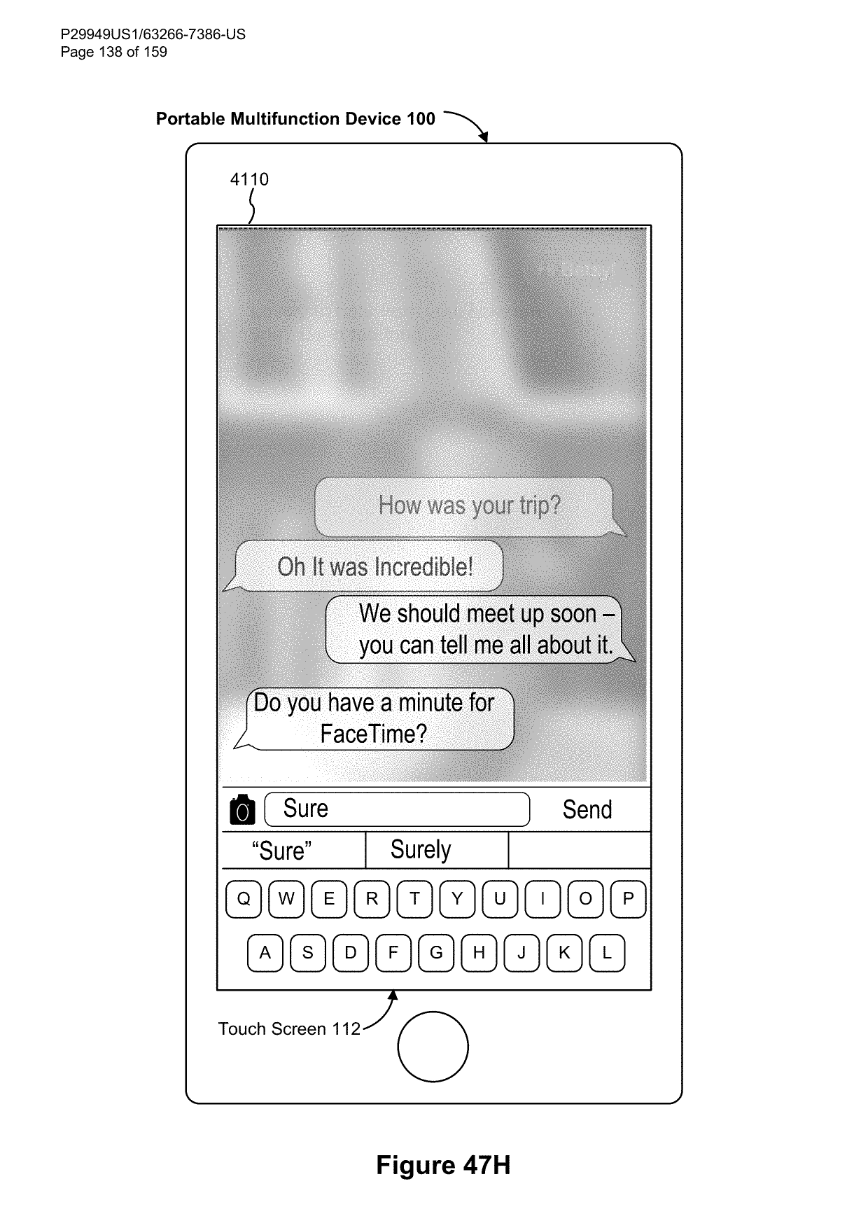

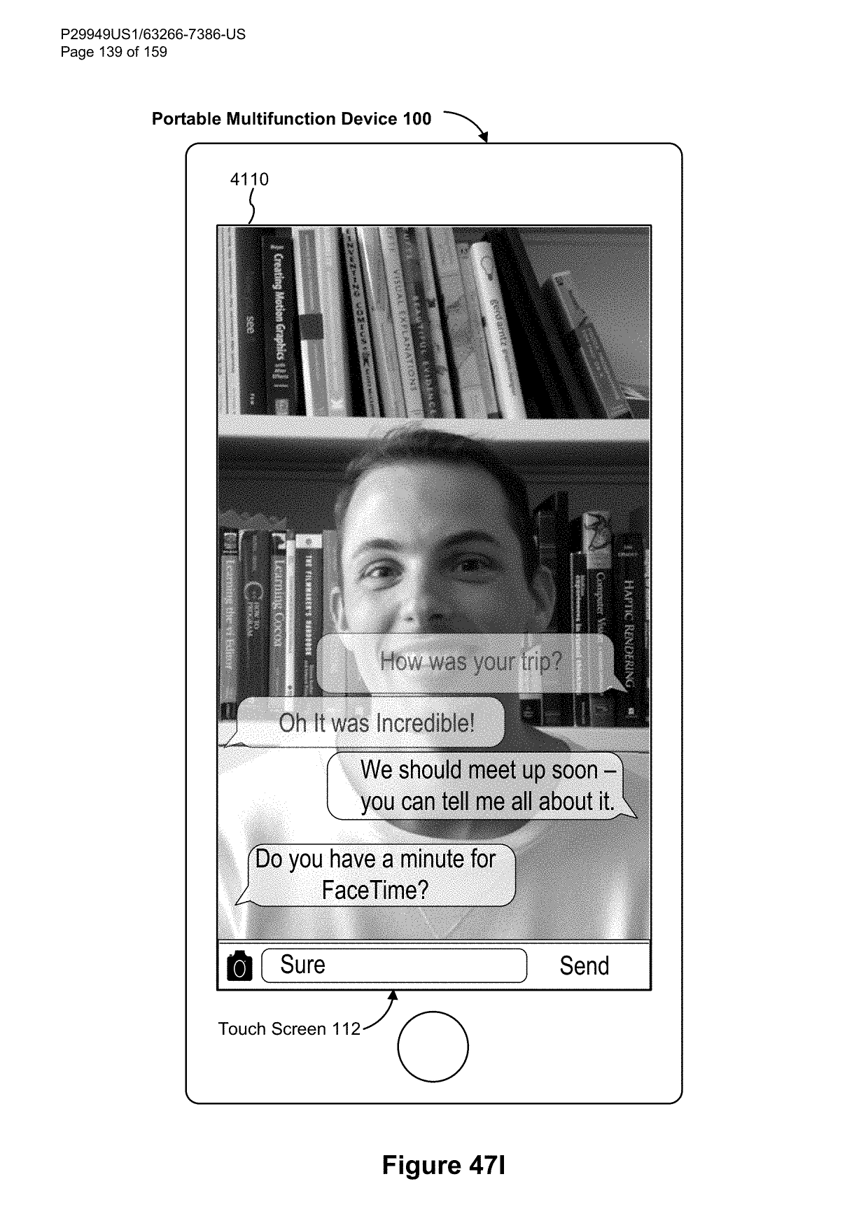

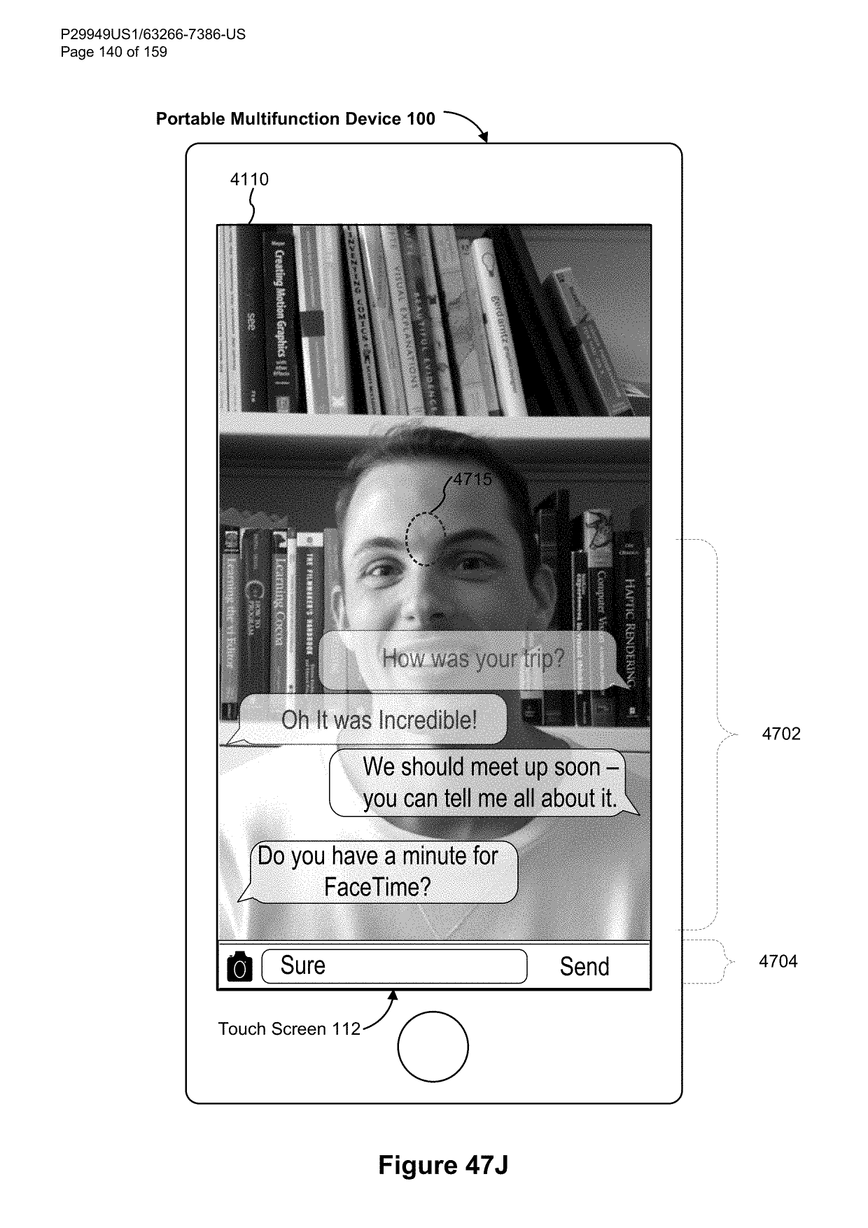

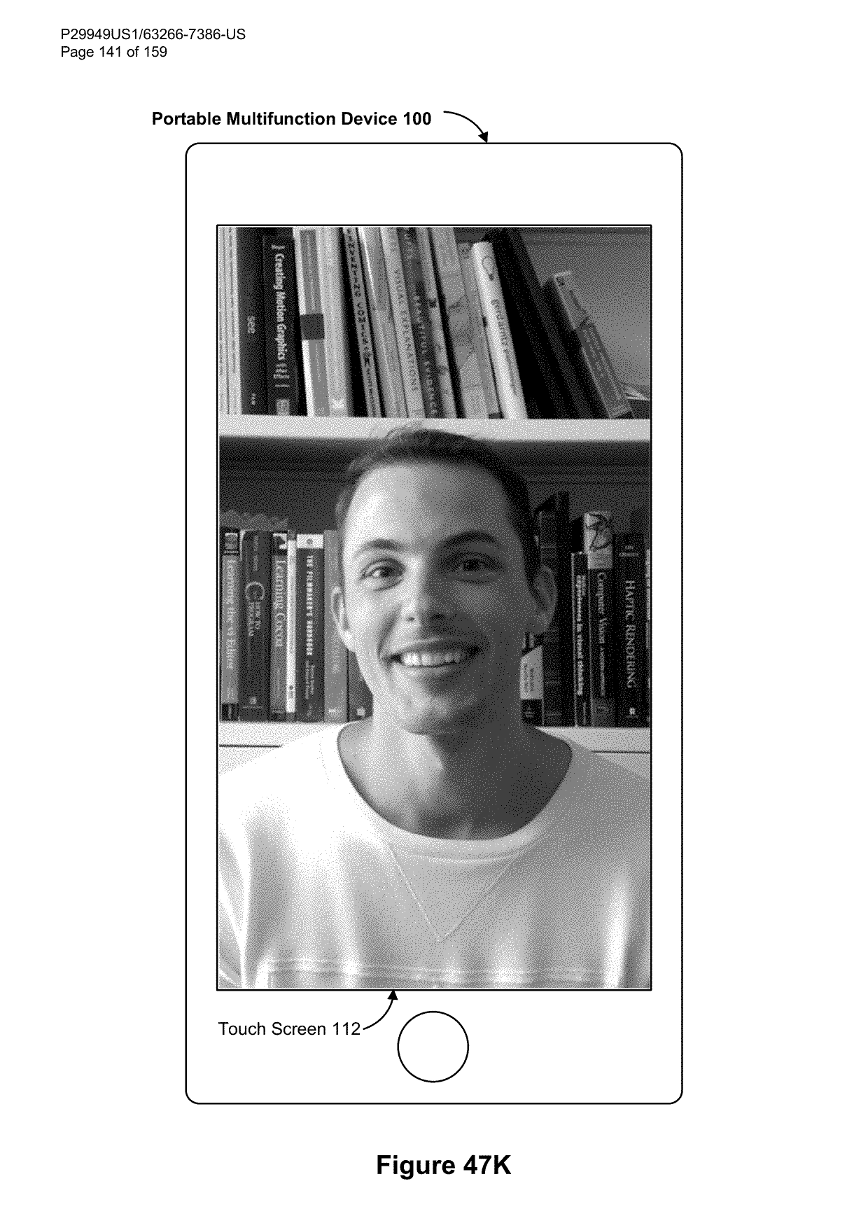

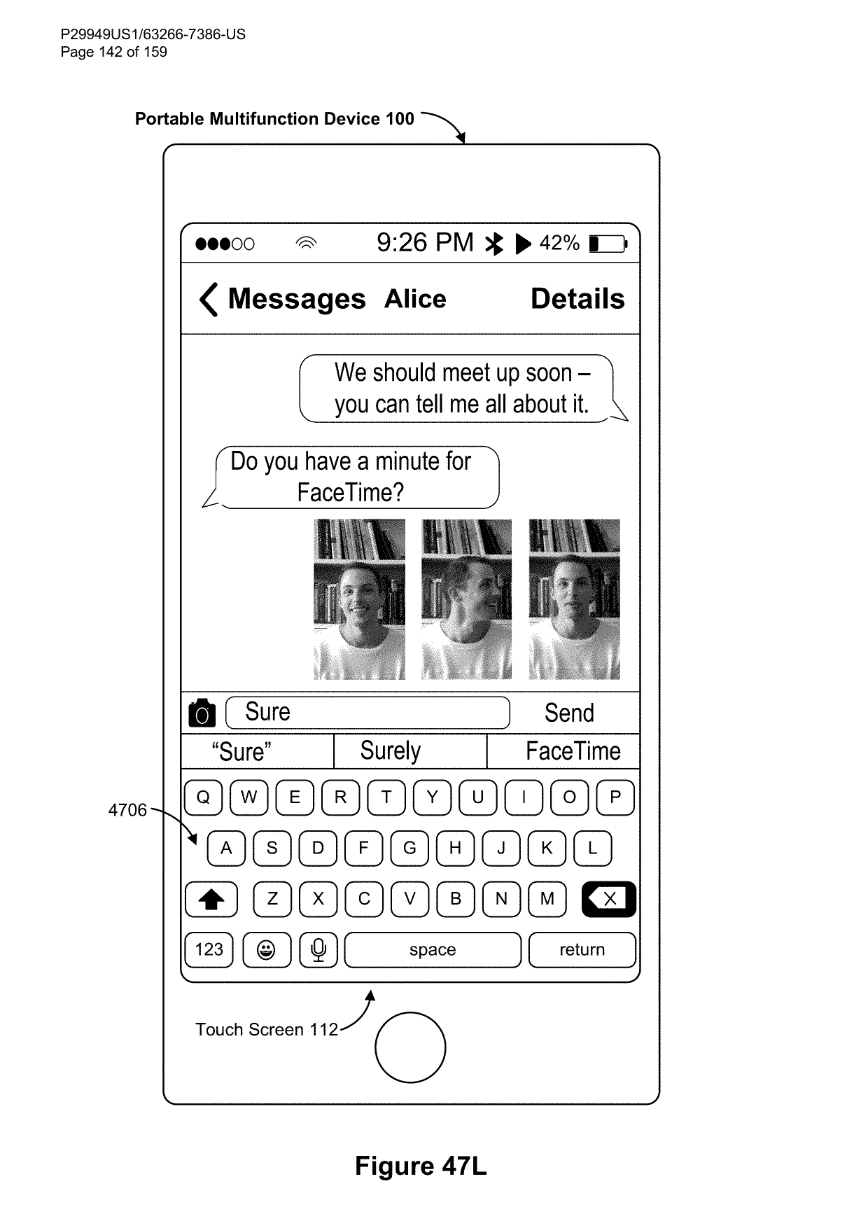

FIGS. 46A-46C illustrate a flow chart illustrating a method 4600 for communicating between users, in accordance with some embodiments. FIGS. 47A-47L, which illustrates exemplary user interfaces for communicating between users, are used to illustrate the processes in FIGS. 46A-46C. The method 4600 is performed at a portable multifunction device (e.g., the device 100 in FIG. 1A) with a touch-sensitive display (e.g., the touch screen 112 in FIG. 1A). As described below, the method 4600 provides an efficient mechanism for seamlessly switching between communication modalities at a portable multifunction device. This method is faster and easier to perform than conventional methods of switching between modalities, which require users to exit one communication application and invoke another. The method is also intuitive for users, thereby reducing the cognitive burden on the user when selecting content, and creating a more efficient human-machine interface. A more efficient input mechanism also requires less computing resources, thereby increasing battery life of the device.

Referring now to FIG. 46A, the device 100 displays (4602) a user interface of an instant messenger application on the display. For example, in FIG. 47A, the instant messenger application includes a display area 4702 and an input area 4704. The display area 4702 includes one or more instant messages (e.g., instant message 4703-1) communicated between the device 100 and another device. The input area 4704 includes a keyboard 4706 to receive a sequence of characters. The input area 4704 also includes a send button 4707 that transmits an instant message upon selection by a user.

Referring back to FIG. 46A, the device 100 constantly analyzes (4604) an instant message displayed in the user interface of the instant messenger application to identify a user's intention to perform an action associated with an application different from the instant messenger application. For example, as shown in FIG. 47B, the device 100 analyzes newly-displayed instant message 4703-2 and determines that the user intends to initiate a video chat with the other user using a video conferencing application (e.g., because the content in the instant message 4703-2 includes the term “FaceTime”).

In some embodiments, the application is (4606) a video conferencing application (e.g., as shown in FIG. 47D), a peer-to-peer payment application, an email application, or a display sharing application. In some embodiments, the action causes the device 100 to launch the application on the device 100 and connect to the other user via the application.

In some embodiments, the user's intention to (4608) perform the action associated with another application different from the instant messenger application is identified by: analyzing terms contained in the instant message (e.g., analyzing the text entered by the user of the device 100 or the user of the other device); and determining the existence of a term associated with the new application from the term. For example, as shown in FIG. 47B, the device 100 identifies the term “FaceTime” in message 4703-2 and determines that the term is associated with a video conferencing application.

Referring back to FIG. 46A, upon determining an intention to perform the action, the device 100 displays (4610) an affordance to perform the action in the user interface of the instant messenger application. For example, as shown in FIG. 47B, the device 100 displays a video conferencing application button 4708 entitled “FaceTime” as an affordance. If the video conferencing application button 4708 is selected by the user, the device 100 will launch a video conferencing application and connect to the other user via the video conferencing application, without the need for the user to first exit the instant messaging application and navigate to the other application.

In some embodiments, the affordance is (4612) displayed in a quick reply area of the user interface of the instant messenger application. For example, as shown in FIG. 47B, video conferencing application button 4708 is displayed in quick reply area 4705 of the input area 4704. Generally, in the quick reply area 4705, the device 100 displays one or more user-selectable autocomplete words based on user selection of letters via keyboard 4706. A user may then select one of the words in the quick reply area 4705 to enter text in the instant message.

Referring back to FIG. 46A, while displaying the affordance in the user interface of the instant messenger application, the device 100 detects (4614) a user input on the affordance in the user interface of the instant messenger application. In some embodiments, the user input is (4616) a tap on the affordance. For example, as shown in FIG. 47B, the device 100 detects a tap gesture 4710 at video conferencing application button 4708.

Referring back to FIG. 46A, in response to detecting the user input, the device facilitates (4618) the action. For example, as shown in FIGS. 47B-47C, upon detection of tap gesture 4710 at video conferencing application button 4708 in FIG. 47B, the device 100 launches a video conferencing application and connects to the other user, as shown in FIG. 47C.

Turning now to FIG. 46B, in some embodiments, the affordance is (4620) displayed within an input area of the user interface (e.g., video conferencing application button 4708 in input area 4704 as shown in FIG. 47B) and facilitating the action includes: ceasing to display the instant messaging input area; fading-out the user interface of the instant messenger application (where the user interface includes a plurality of instant messages including the instant message); and fading-in a user interface of the application different from the instant messenger. For example, as shown in the sequence of FIGS. 47B-47D, upon detection of tap gesture 4710 at video conferencing application button 4708 shown in FIG. 47B, and while device 100 launches a video conferencing application and connects to the other user, the device 100 transitions from displaying the instant messaging application, as shown in FIG. 47B, to displaying the video conferencing application, shown in FIG. 47D. While transitioning, the device 100 ceases to display the input area 4704, fades-out the instant messaging application and fades-in the video conferencing application, as shown in FIG. 47C.

Referring back to FIG. 46B, in some embodiments, facilitating the action includes (4622) activating and executing the application within the instant messenger application. For example, in FIGS. 47C-47E and 47H-47K, the FaceTime application is activated by the instant messenger application in response to the user selection of the FaceTime affordance 4708 (FIG. 47B) and executed such that the FaceTime application interface is displayed within the instant messenger application interface.

Referring back to FIG. 46B, in some embodiments, the application is (4624) a video conferencing application, and the action is to execute the video conferencing application (to record frames of a video conferencing and provide a video conferencing user interface to display the frames). Facilitating the action further comprises, upon completion of executing the video conferencing application (e.g., the user hangs-up the video call), fading-out the video conferencing user interface, and fading-in the user interface of the instant messenger application. In some embodiments, a visual history of the video conference may be inserted into the instant messaging user interface, e.g., key frames recorded during the video conference. For example, as shown in the sequence of FIGS. 47D-47F, after the device 100 launches a video conferencing application and connects to the other user, and upon completion of the video conference, the device 100 fades-out the video conferencing application and fades-in the instant messenger application.

In some embodiments, after the device fades-in the instant messenger application interface, a visual history of the video conferencing session including key frames captured during the conferencing session can be inserted into the messenger application interface. For example, in FIG. 47L, when the messenger application interface is back on display, key frames captured during the conferencing session are inserted into the messages to provide a visual history of the video conferencing.

Referring back to FIG. 46B, in some embodiments, the completion of executing the video conferencing application is (4626) determined in response to detecting a second user input on the video conferencing user interface displayed within the user interface of the instant messenger application. For example, as shown in the sequence of FIGS. 47D-47F, while the device 100 displays the video conferencing application as shown in FIG. 47D, the device 100 detects a tap gesture 4712. In response, the device 100 completes executing the video conferencing application and displays the instant messenger application as shown in FIG. 47F.

Turning now to FIG. 46C, in some embodiments, the user interface of the instant messenger application includes (4628) an input area containing the affordance and a virtual keyboard, and an output area displaying the instant messages. For example, as shown in FIG. 47G, the device 100 displays a user interface of the instant messenger application including an input area 4704 including video conferencing application button 4708 and a virtual keyboard 4706. The user interface of the instant messenger application also includes an output area 4702 displaying instant messages (e.g., messages 4703-1, 4703-2). In some embodiments, the user input is a swipe with an initial contact inside the output area followed by a movement in a direction across the touch-sensitive display; and facilitating the action includes: fading-in an application user interface of the application into the touch-sensitive display in accordance with the direction of the movement; and sliding the user interface out of the touch-sensitive display in accordance with the direction of the movement until the affordance and the virtual keyboard are shifted out of the touch-sensitive display, wherein: the input area and the output area of the user interface are superimposed on the application user interface, and the instant messages are displayed semitransparent over the application user interface. For example, as shown in FIGS. 47G-471, in response to detecting a downward swipe gesture 4714 in output area 4702, as shown in FIG. 47G, the device 100 fades-in the video conferencing application and slides the keyboard 4706 in a downward direction, as shown in FIG. 47H. In FIG. 47I, in some embodiments, the display area of the instant messenger application becomes semi-transparent, and the display area including the message bubbles are superimposed on the video conferencing interface, such that the user can view the messages and the video at the same time. In some embodiments, the message bubbles in the display area of the instant messenger application have a different opacity level (e.g., less transparent) from other regions of the display area so that the content of the messages can be viewed clearly on top of the video. In some embodiments, the input area is displayed below the display area of the instant messenger application so that the user can continue to input messages while the video is playing behind the messages.

Referring back to FIG. 46C, in some embodiments, the device 100 receives (4630) a second user input over the application user interface in a region not on the instant messages; and in response to detecting the second user input, the device ceases to display the user interface of the instant messenger application and maintains the display of the application user interface of the application. For example, as shown in FIG. 47J, in response to detecting a tap gesture 4715 on the video, but not within an output area 4702 that includes instant messages, e.g., not on messages 4703-1, 4703-2, the device 100 ceases displaying the user interface of the instant messenger application and maintains display of the video conferencing user interface. By dismissing the instant messenger application interface, the user can better see the video conference.

In some embodiments, prior to determining the user's intention to perform the action, the device invokes (4632) the application in the background such that in response to detecting the user input on the affordance, the application user interface can be displayed within the instant messenger application user interface almost instantaneously, e.g., applications such as FaceTime® can be connected ahead of time in the background and the video can be displayed almost instantaneously within the instant messenger application user interface.

It should be understood that the particular order in which the operations in FIGS. 46A-46C have been described is merely exemplary and is not intended to indicate that the described order is the only order in which the operations could be performed. One of ordinary skill in the art would recognize various ways to reorder the operations described herein. For brevity, these details are not repeated here.

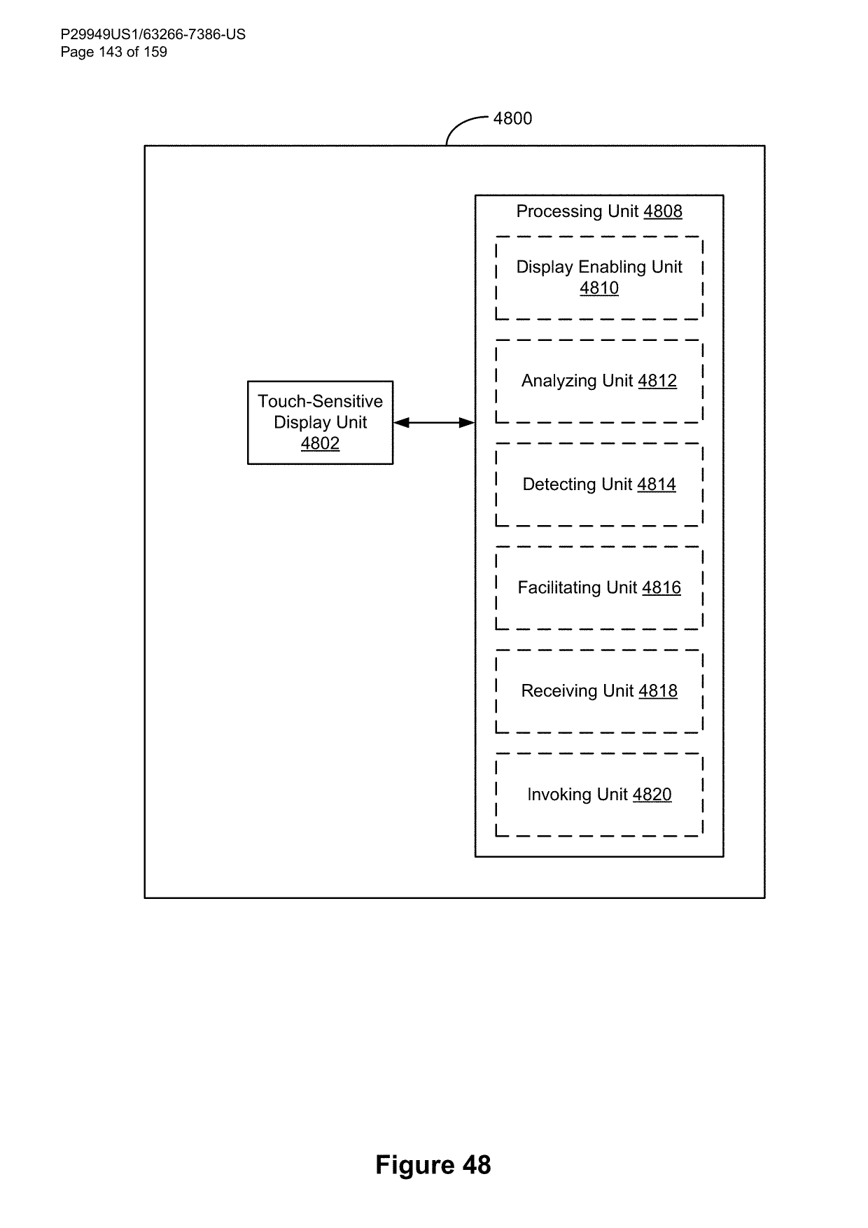

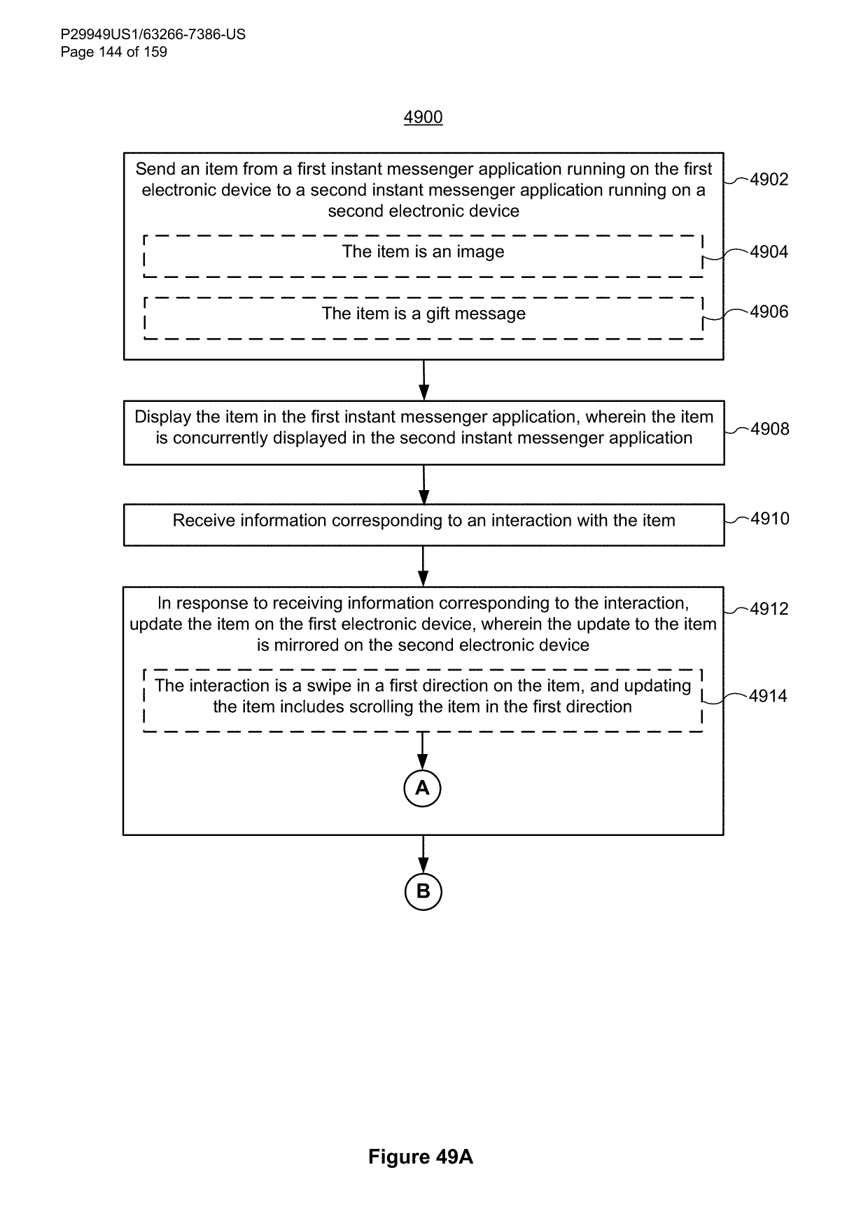

In accordance with some embodiments, FIG. 48 shows a functional block diagram of an electronic device 4800 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 48 are, optionally, combined or separated into sub-blocks to implement the principles of the various described embodiments. Therefore, the description herein optionally supports any possible combination or separation or further definition of the functional blocks described herein.

As shown in FIG. 48, an electronic device 4800 includes a touch-sensitive display unit 4802 configured to receive user inputs and display user interfaces and a processing unit 4808 coupled to the touch-sensitive display unit 4802. In some embodiments, the processing unit 4808 includes a display enabling unit 4810, an analyzing unit 4812, a detecting unit 4814, a facilitating unit 4816, a receiving unit 4818, and an invoking unit 4820.

In some embodiments, the processing unit 4808 is configured to display a user interface of an instant messenger application on the display unit 4802 (e.g., with the display enabling unit 4810). The processing unit 4808 is further configured to analyze an instant message displayed in the user interface of the instant messenger application to identify a user's intention to perform an action associated with an application different from the instant messenger application (e.g., with the analyzing unit 4812). Upon determining an intention to perform the action, the processing unit 4808 is configured to display an affordance to perform the action in the user interface of the instant messenger application (e.g., with the display enabling unit 4810). While displaying the affordance in the user interface of the instant messenger application, the processing unit 4808 is configured to detect a user input on the affordance in the user interface of the instant messenger application (e.g., with the detecting unit 4814); and in response to detecting the user input, the processing unit 4808 is configured to facilitate the action (e.g., with the facilitating unit 4816).

In some embodiments, the application is a video conferencing application, a peer-to-peer payment application, email application, or display sharing application. In some embodiments, the user's intention to perform the action associated with the application different from the instant messenger application is identified by analyzing terms contained in the instant message; and determining existence of a term associated with the application in the terms. In some embodiments, the affordance is displayed in a quick reply area of the user interface of the instant messenger application. In some embodiments, the user input is a tap on the affordance. In some embodiments, the affordance is displayed within an input area of the user interface; and facilitating the action includes ceasing to display the input area; fading out the user interface of the instant messenger application, the user interface including a plurality of instant messages including the instant message; and fading in a user interface of the application different from the instant messenger. In some embodiments, facilitating the action includes activating and executing the application within the instant messenger application.

In some embodiments, the application is a video conferencing application; the action is to execute the video conferencing application to record frames of a video conferencing and provide a video conferencing user interface to display the frames; and facilitating the action further comprises, upon completion of executing the video conferencing application: (a) fading out the video conferencing user interface; (b) fading in the user interface of the instant messenger application; and (c) inserting a visual history of the video conferencing into the user interface including key frames from the frames.

In some embodiments, the completion of executing the video conferencing application is determined in response to detecting a second user input on the video conferencing user interface displayed within the user interface of the instant messenger application.

In some embodiments, the user interface of the instant messenger application includes an input area containing the affordance and a virtual keyboard, and an output area displaying the instant messages; the user input is a swipe with an initial contact inside the output area followed a movement in a direction across the touch-sensitive display unit 4802; and facilitating the action includes: (a) fading in an application user interface of the application into the touch-sensitive display unit 4802 in accordance with the direction of the movement; and (b) sliding the user interface out of the touch-sensitive display unit 4802 in accordance with the direction of the movement until the affordance and the virtual keyboard are shifted out of the touch-sensitive display unit 4802, wherein the input area and the output area of the user interface are superimposed on the application user interface, and the instant messages are displayed semitransparent over the application user interface.

In some embodiments, the processing unit 4808 is configured to receive a second user input over the application user interface in a region not on the instant messages (e.g., with the receiving unit 4818); and in response to detecting the second user input, the processing unit 4808 is configured to cease to display the user interface of the instant messenger application and maintain the display of the application user interface of the application (e.g., with the display enabling unit 4810).

In some embodiments, the processing unit 4808 is configured to, prior to upon determining the user's intention to perform the action, invoke the application in the background (e.g., with the invoking unit 4820).

The operations in the information processing methods described above are, optionally implemented by running one or more functional modules in information processing apparatus such as general purpose processors (e.g., as described above with respect to FIGS. 1A and 3A-3B) or application specific chips.

The operations described above with reference to FIGS. 47A-47L are, optionally, implemented by components depicted in FIGS. 1A-1B or FIG. 48. For example, display enabling operation 4810, analyzing operation 4812, detecting operation 4814, facilitating operation 4816, receiving operation 4818, and invoking operation 4820 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Mirrored Control in Instant Messages

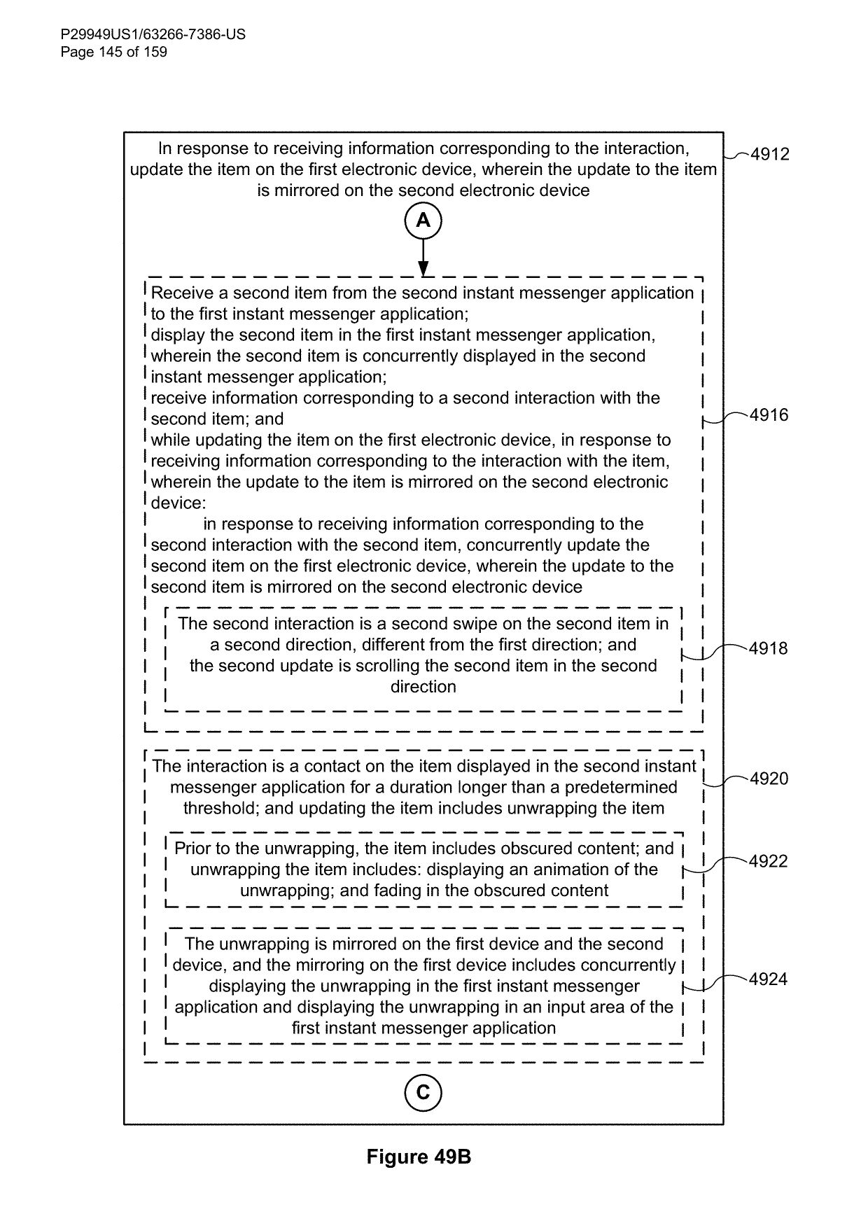

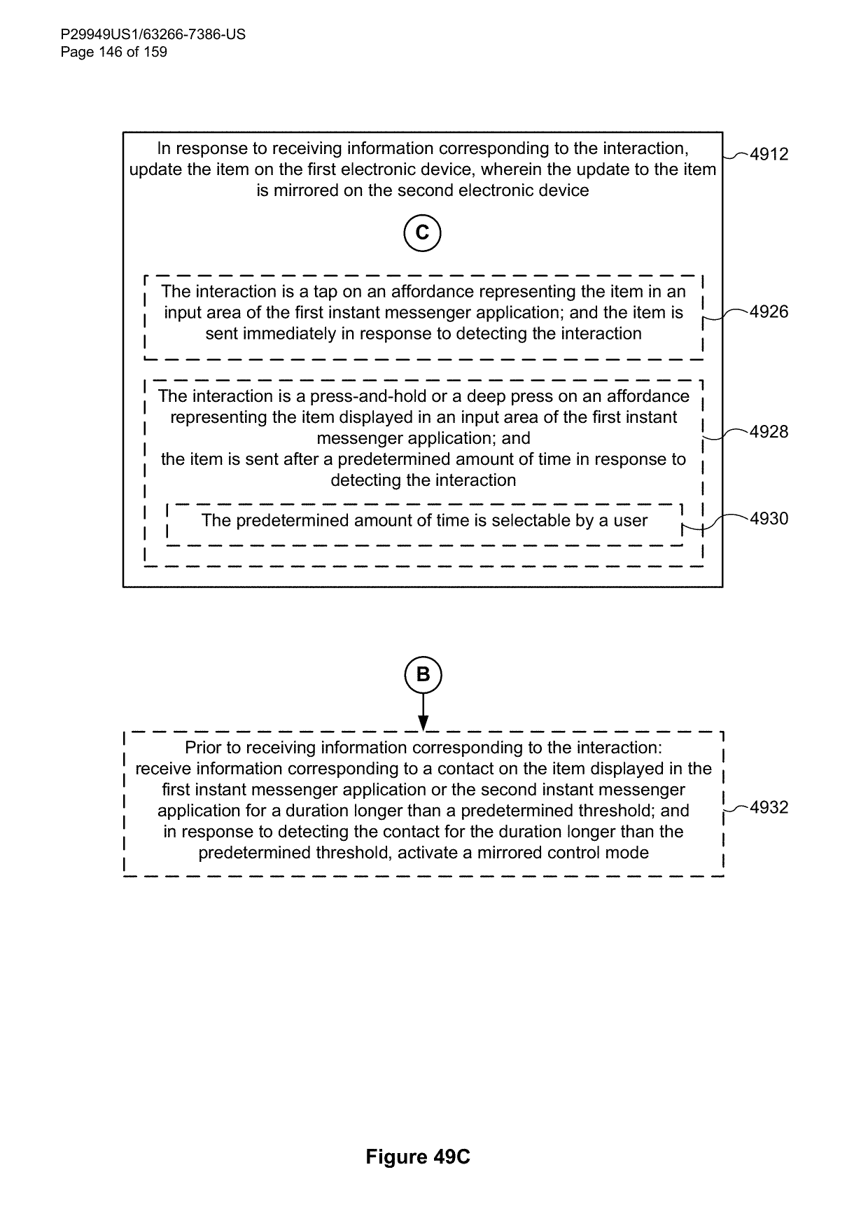

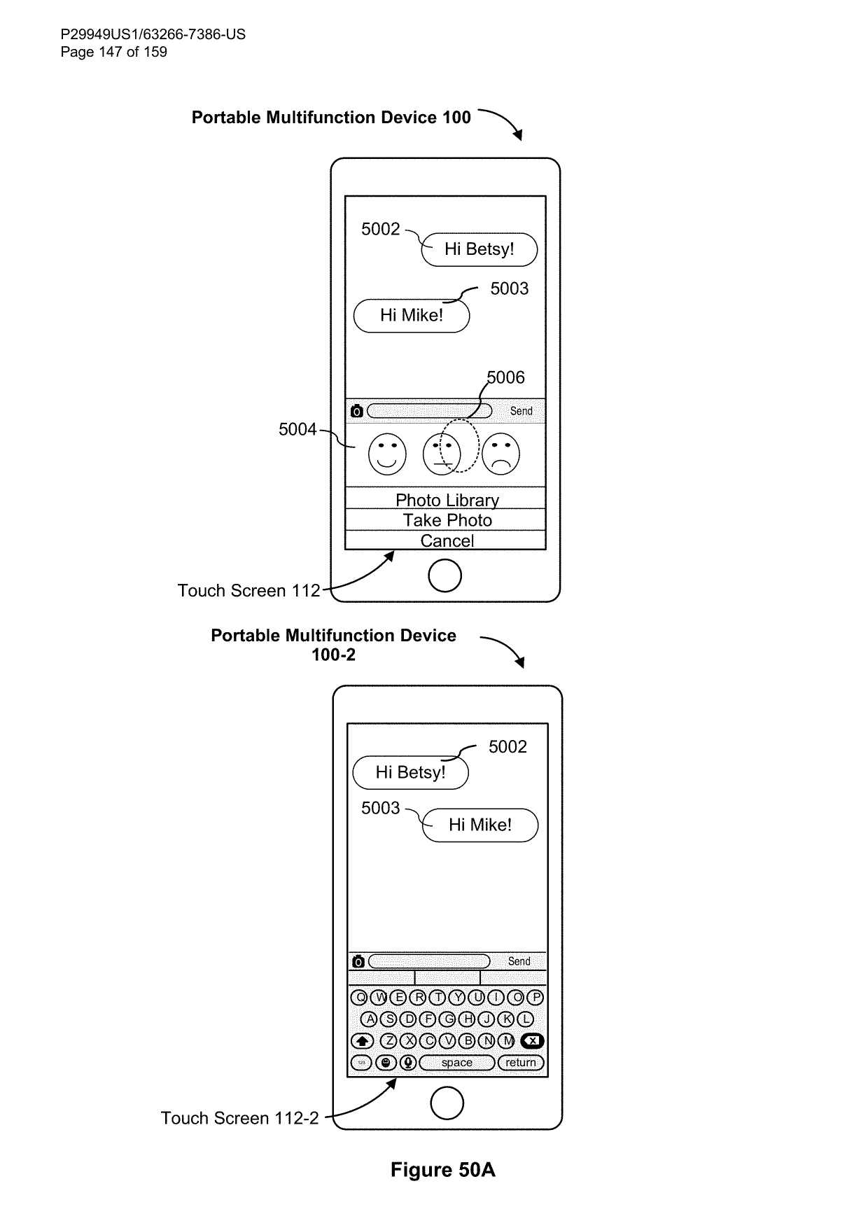

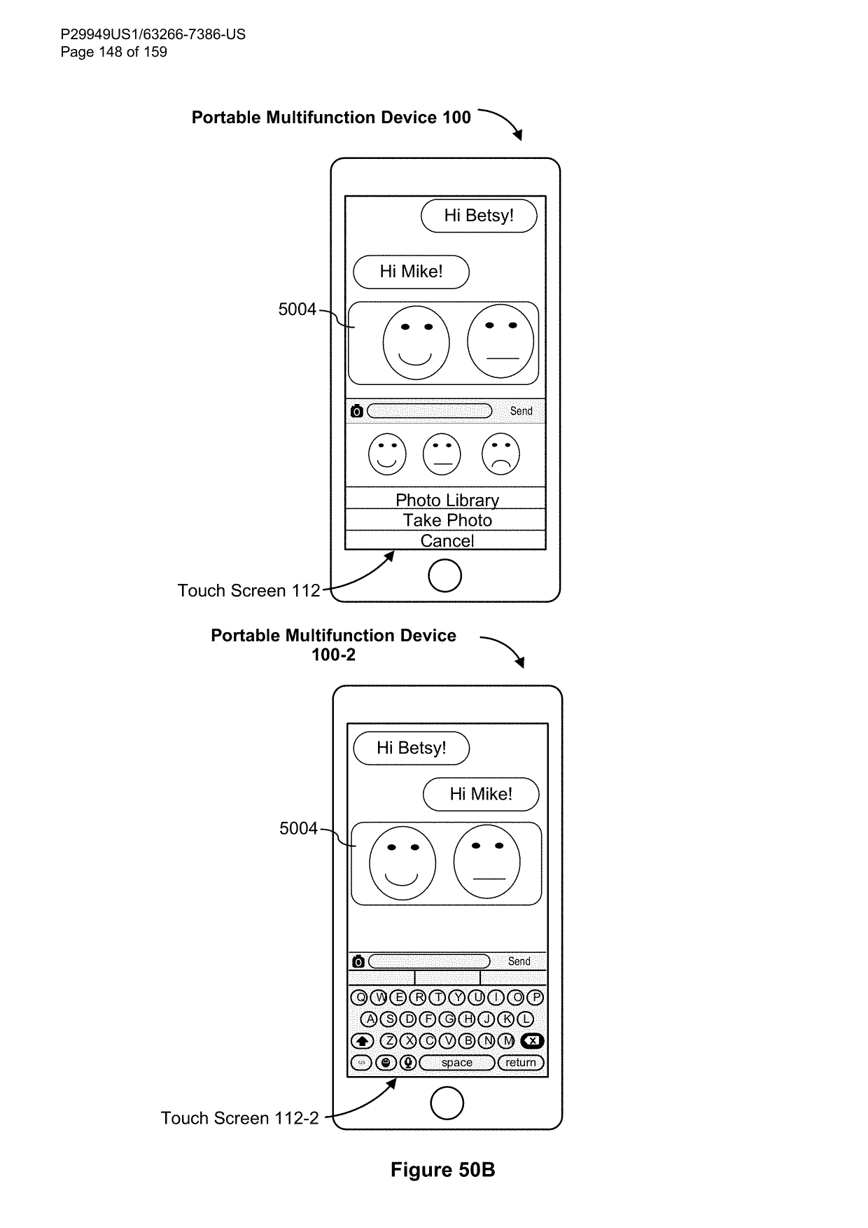

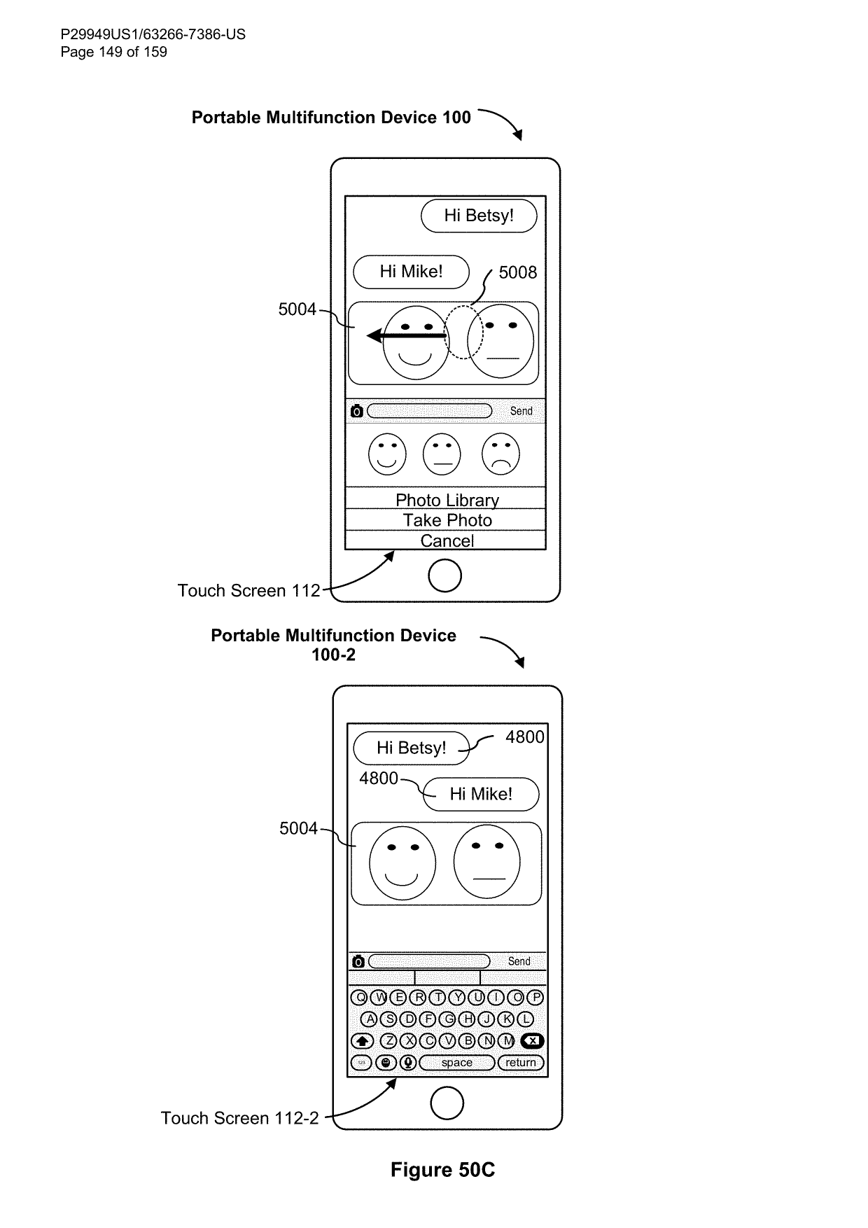

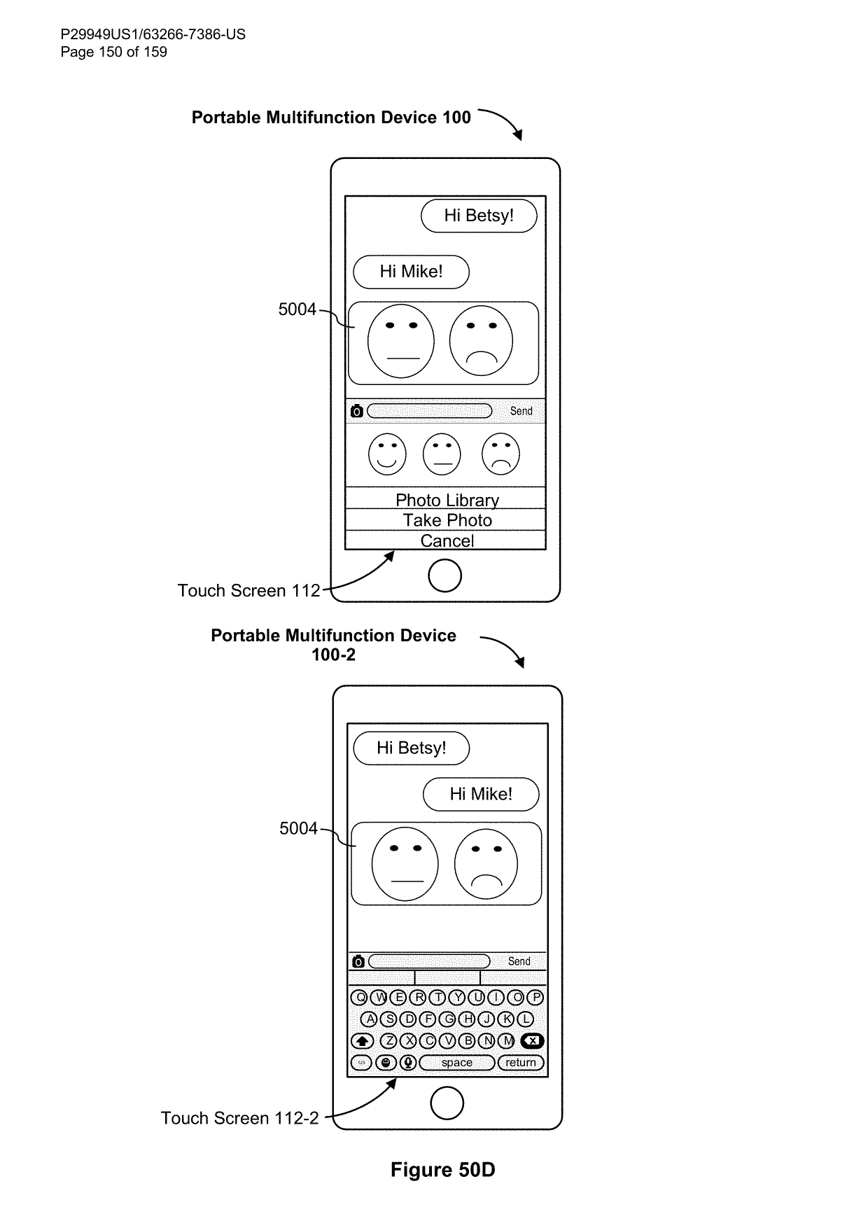

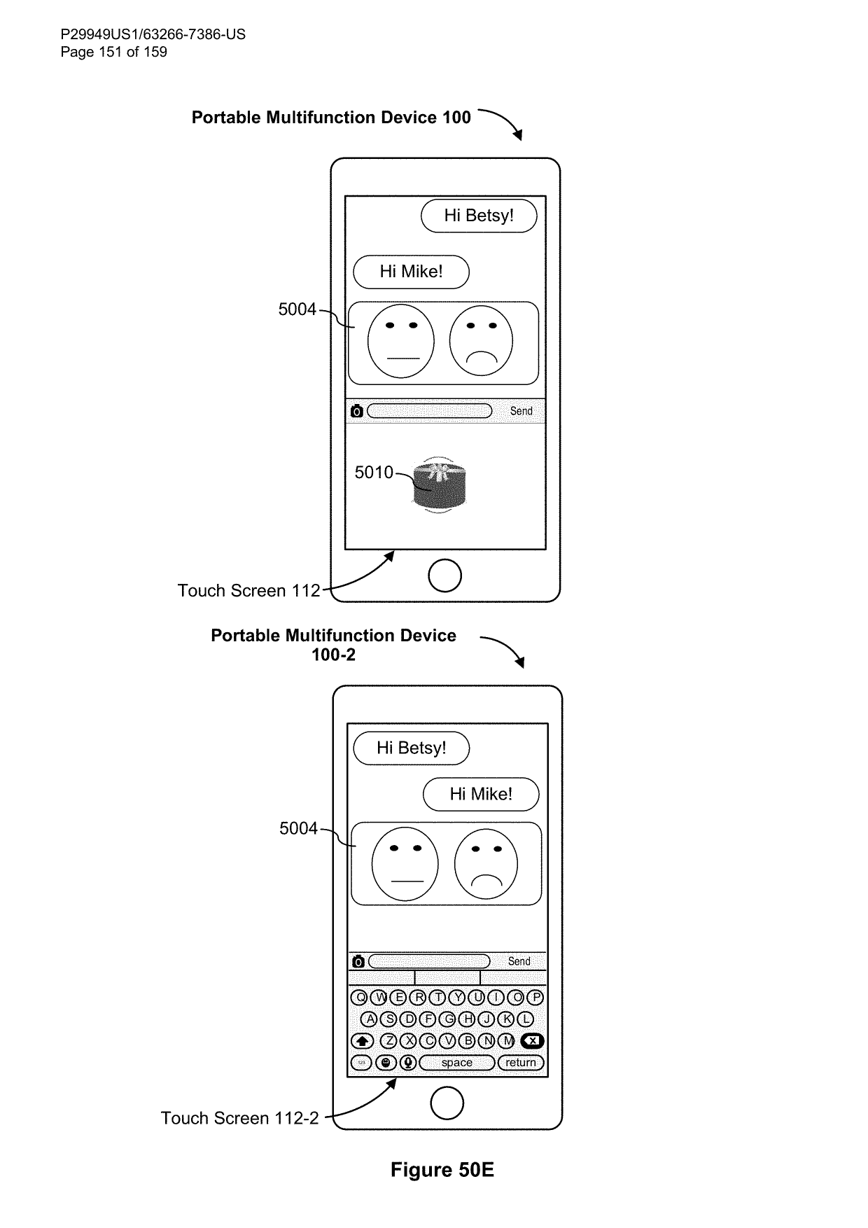

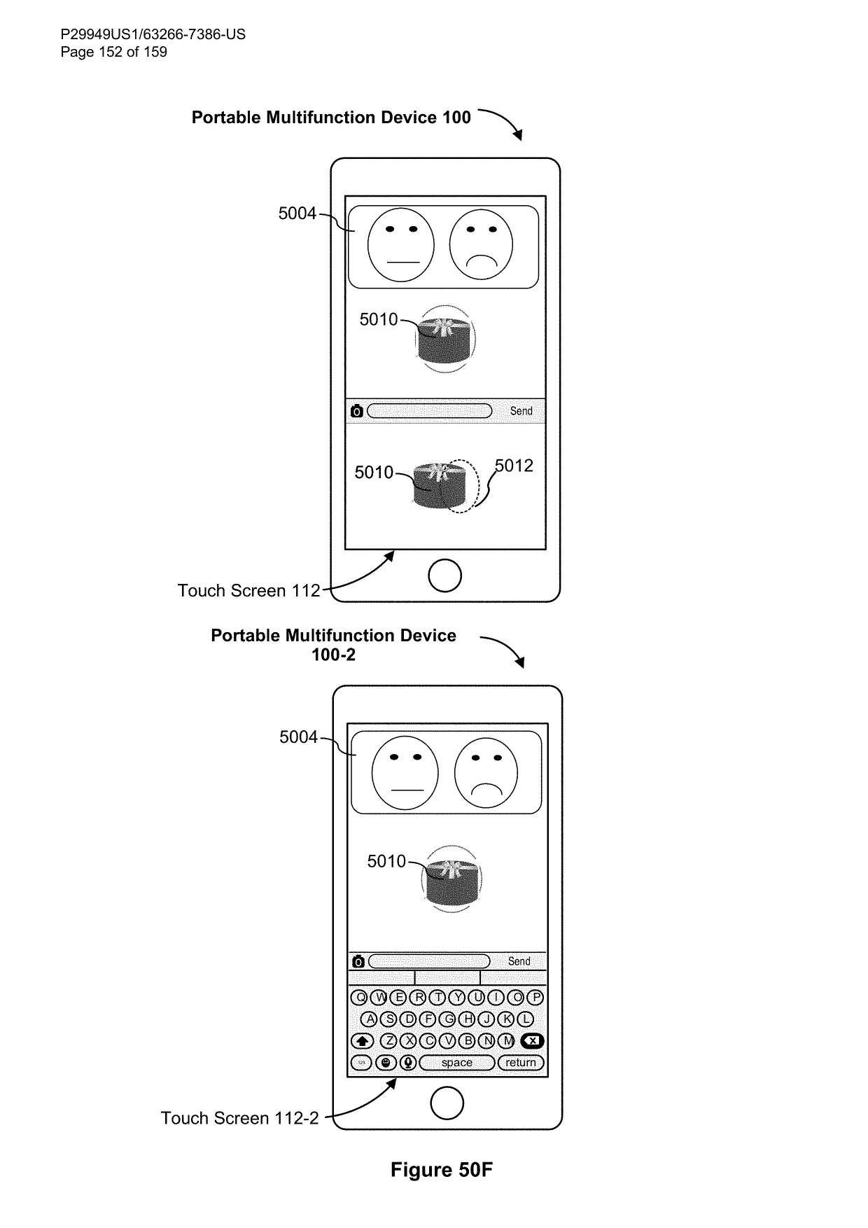

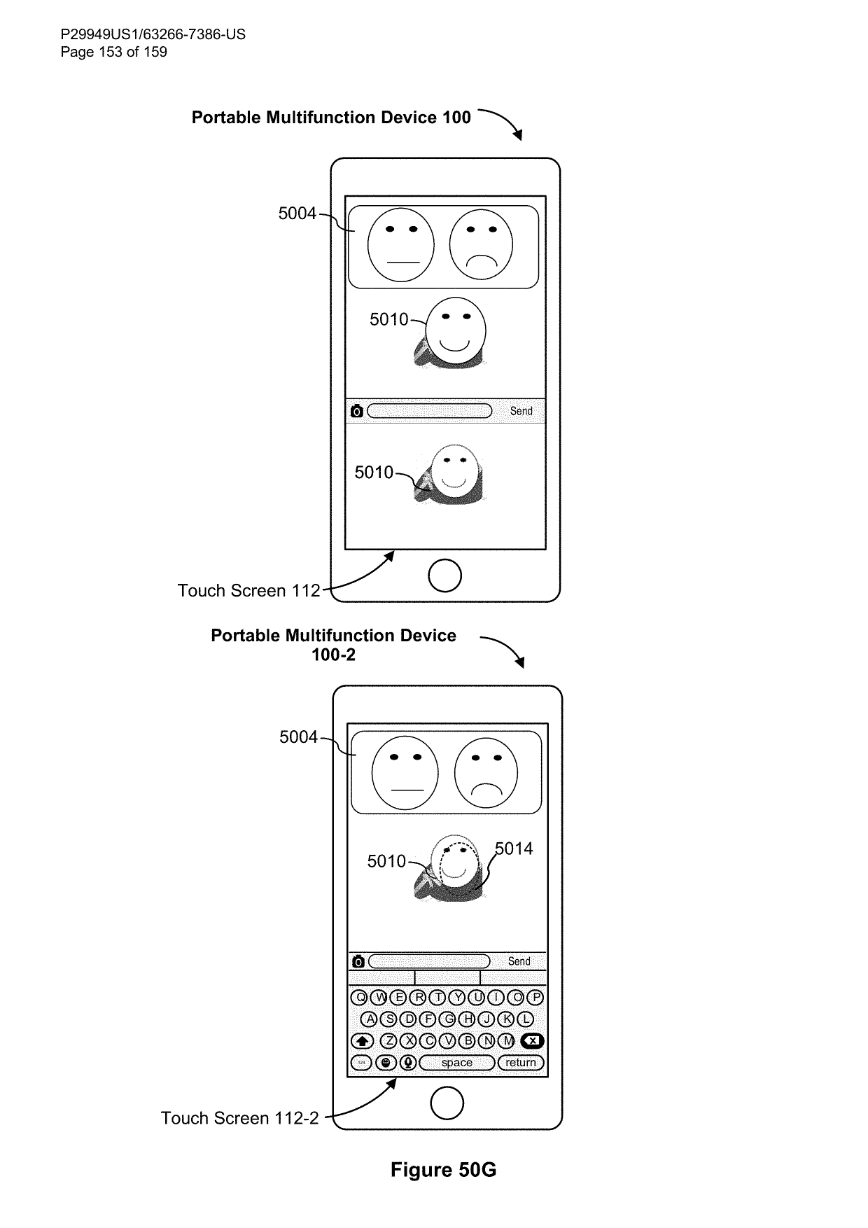

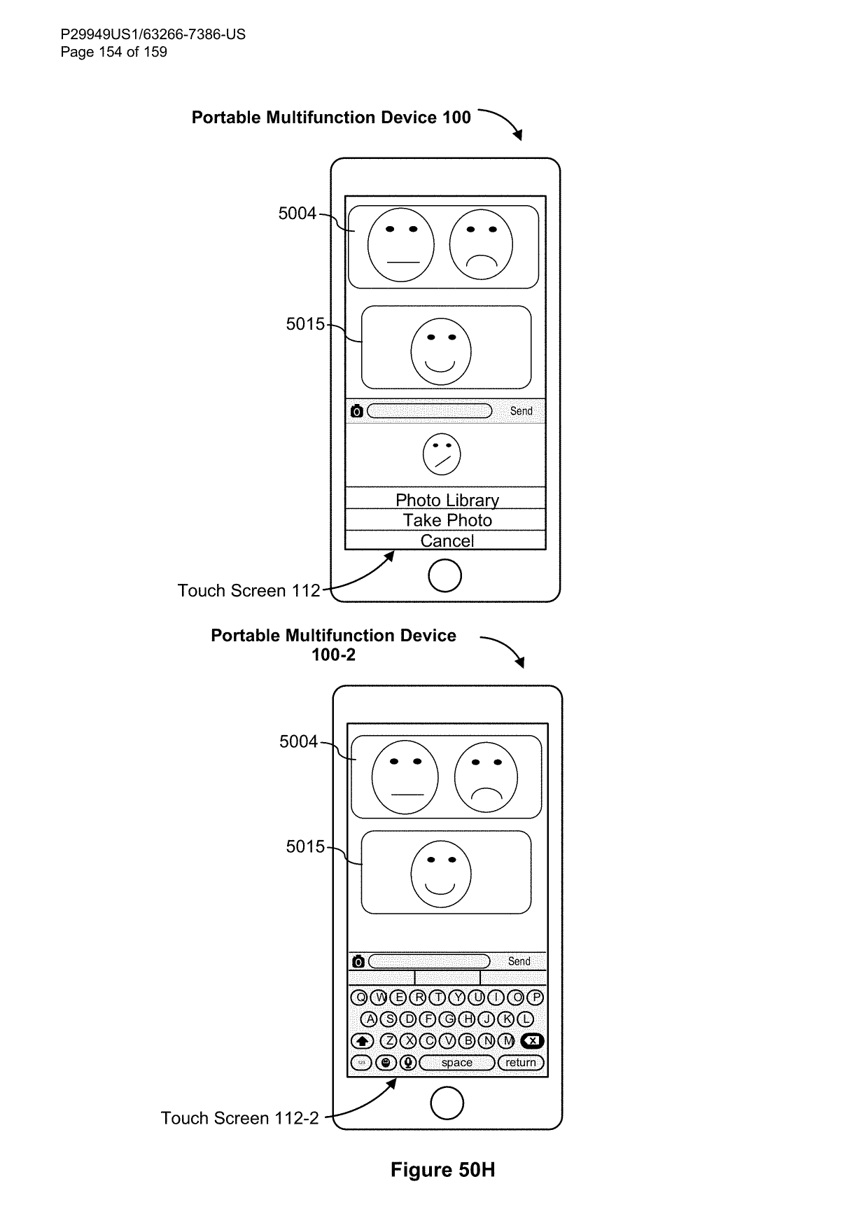

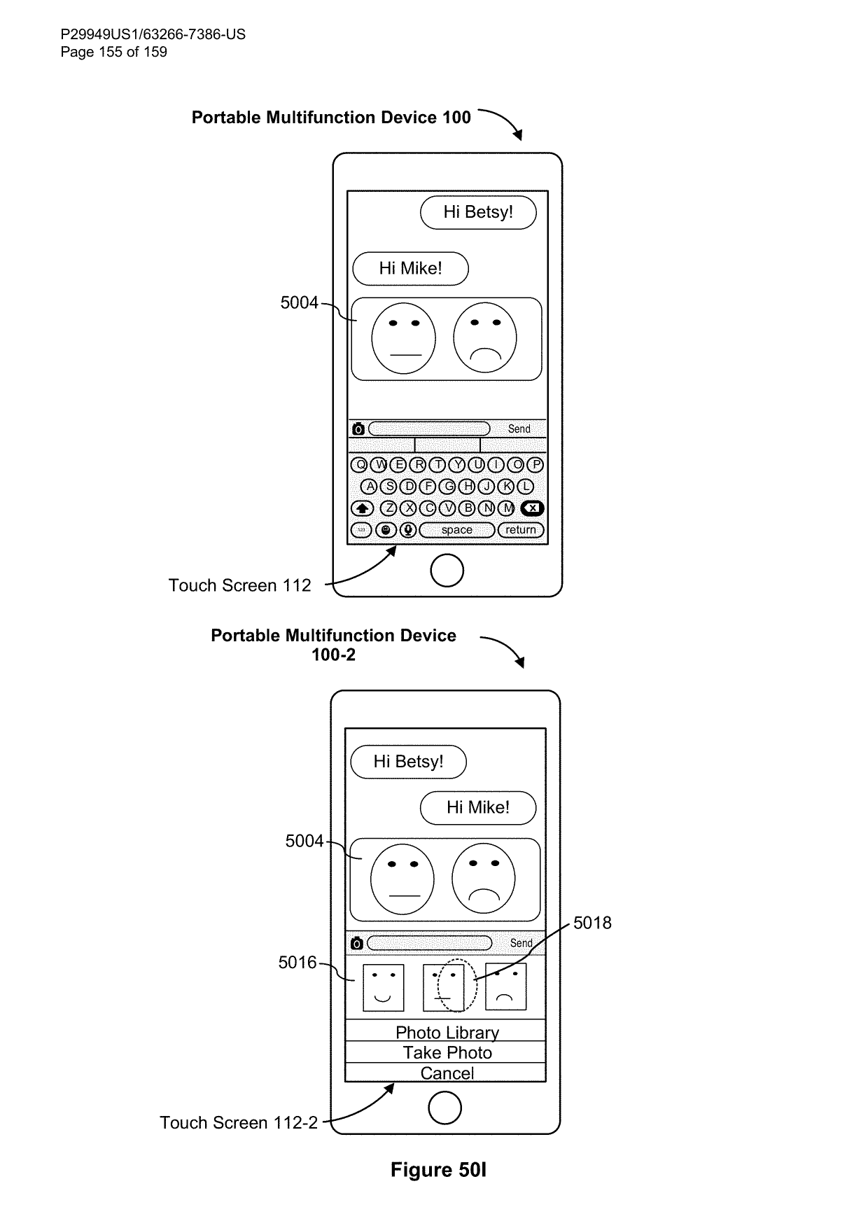

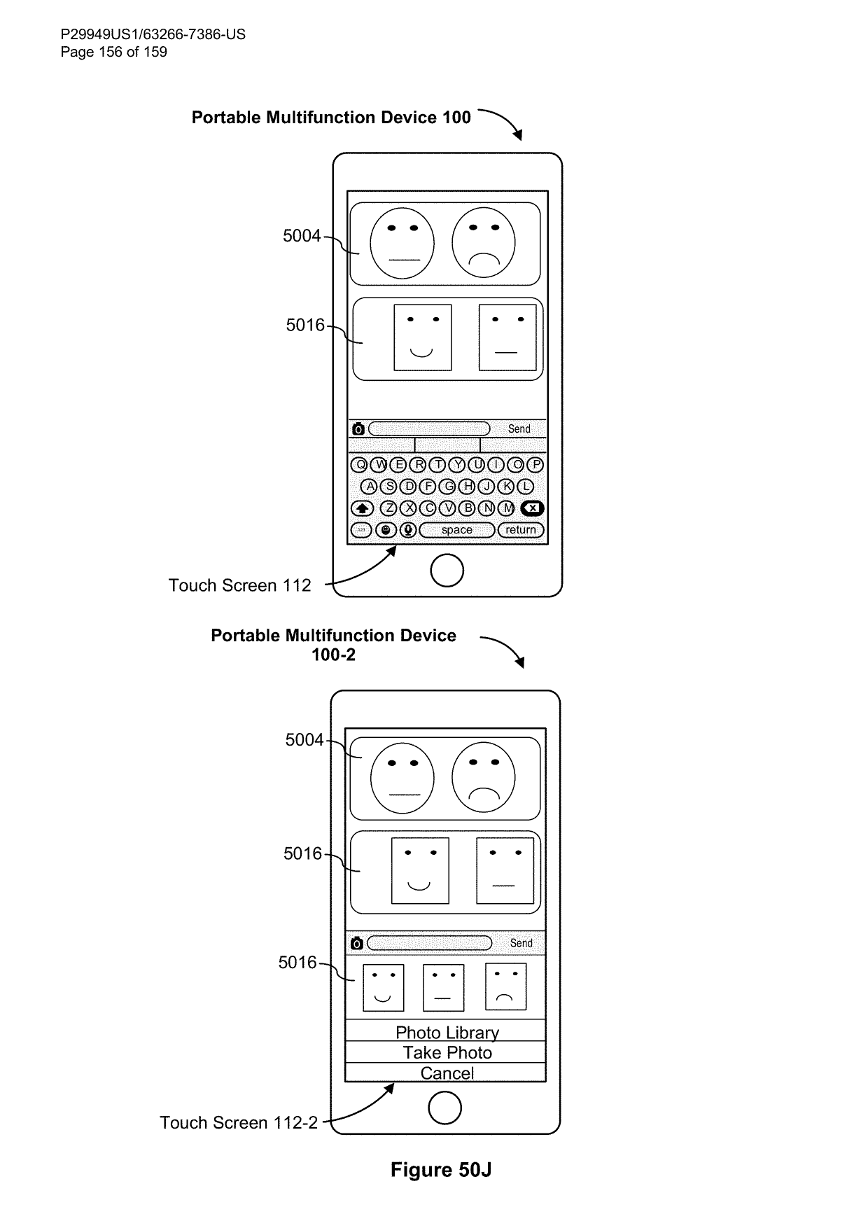

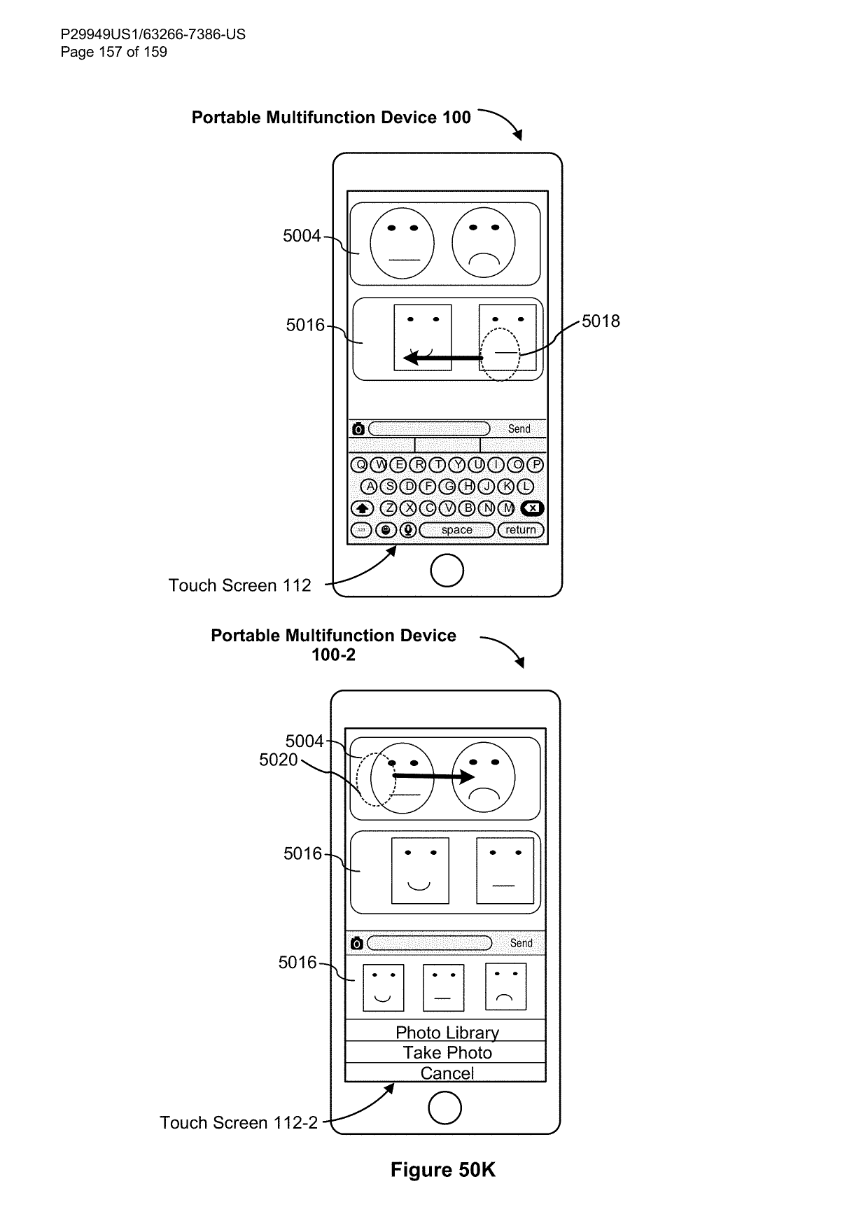

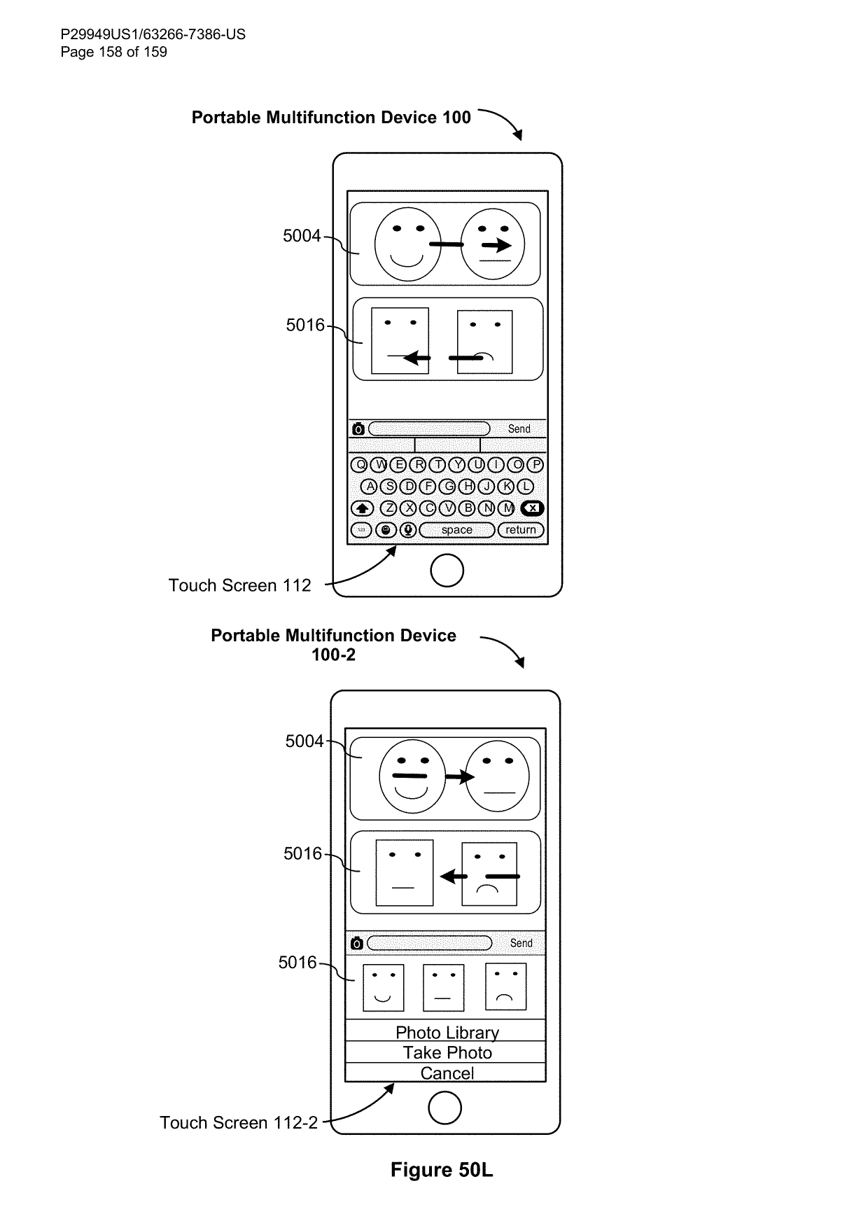

FIGS. 49A-49C are flow charts illustrating a method 4900 for mirrored control between devices, in accordance with some embodiments. FIGS. 50A-50L, which illustrate exemplary user interfaces for mirrored control, are used to illustrate the processes in FIGS. 49A-49C. The method 4900 is performed at a first electronic device (e.g., the device 100 in FIG. 1A and/or the device 100-2 in FIG. 50A) with a touch-sensitive display (e.g., the touch screen 112 in FIG. 1A or the touch screen 112-2 in FIG. 50A). As described below, the method 4900 provides an efficient mechanism for seamlessly controlling multiple devices using a single user input. This method is faster and easier to perform than conventional methods, which require a user to switch from an instant messenger application to a screen sharing application to share and control images and videos displayed on another device. The method is also intuitive for users, thereby reducing the cognitive burden on the user when selecting content, and creating a more efficient human-machine interface. A more efficient input mechanism also requires less computing resources, thereby increasing battery life of the device.

Referring now to FIG. 49A, the device 100 (e.g., the first electronic device) sends (4902) an item from a first instant messenger application running on the first electronic device (e.g., device 100, FIG. 50A) to a second instant messenger application running on a second electronic device (e.g., device 100-2, FIG. 50A). In some embodiments, the item is (4904) an image (e.g., a photo 5004 from the photo library in FIG. 50A). In some embodiments, the item is (4906) a gift message (e.g., gift message 5010 in FIG. 50F).

The device 100 displays (4908) the item in the first instant messenger application, wherein the item is concurrently displayed in the second instant messenger application. For example, in FIG. 50B, each device 100 and 100-2 displays image 5004, which was previously transmitted from device 100 to device 100-2 in response to a user selection 5006 of the image from the input area on device 100 (e.g., as shown in FIG. 50A). In another example, in FIG. 50F, each device 100 and 100-2 displays a gift message 5010, which was previously transmitted from device 100 to device 100-2 in response to a user selection 5012 of the gift message in the input area. The device 100 receives (4910) information corresponding to an interaction with the item. In response to receiving information corresponding to the interaction, the device updates (4912) the item on the first electronic device, wherein the update to the item is mirrored on the second electronic device.

Referring back to the method 4900, in FIG. 49B, in some embodiments, the interaction is (4914) a swipe in a first direction on the item, and updating the item includes scrolling the item in the first direction. For example, FIGS. 50A-50D illustrate a sequence of exemplary user interfaces for mirrored control of image 5004. FIG. 50A illustrates an exemplary user interface showing a first instant messenger application on device 100 and a second instant messenger application on device 100-2 before an item is sent. In this example, the instant messenger applications display messages 5002 and 5003 previously communicated between device 100 and device 100-2. The first instant messenger application of the device 100 also displays an image 5004, depicting a series of faces, in an input area. In response to a tap gesture 5006, the device 100 sends the image 5004 to the device 100-2. As shown in FIG. 50B, after the image 5004 is sent, the devices 100 and 100-2 concurrently display a left-most partial view of the image 5004 in the output areas of their respective instant messenger applications. In FIG. 50C, while the devices 100 and 100-2 concurrently display a partial view of the left-most portion of the image 5004 in the output areas of the respective instant messenger applications, the device 100 receives a leftward swipe gesture 5008 at the image 5004. In response, as shown in FIG. 50D, the device 100 scrolls the partial view of the image 5004 to the left in the user interfaces of both device 100 and 100-2 to display the right-most portion of the image 5004.

Referring back to the method 4900, in FIG. 49B, in some embodiments, the device 100 receives (4916) a second item from the second instant messenger application to the first instant messenger application; displays the second item in the first instant messenger application, wherein the second item is concurrently displayed in the second instant messenger application; receives information corresponding to a second interaction with the second item; and while updating the item on the first electronic device in response to receiving information corresponding to the interaction with the item, wherein the update to the item is mirrored on the second electronic device: in response to receiving information corresponding to the second interaction with the second item, concurrently updates the second item on the first electronic device, wherein the update to the second item is mirrored on the second electronic device. In some embodiments, the second interaction is (4918) a second swipe on the second item in a second direction, different from the first direction; and updating the second item includes scrolling the second item in the second direction.

For example, FIGS. 50I-50L illustrate a sequence of exemplary user interfaces showing additional functionality for mirrored control of content. FIG. 50I illustrates an exemplary user interface showing an instant messenger application on the devices 100 and 100-2, subsequent to FIG. 50D, before a new item is sent. In FIG. 50I, the devices 100 and 100-2 display the right-most partial view of image 5004 previously communicated between device 100 and device 100-2. The instant messenger application of device 100-2 also displays an image 5016 depicting a series of faces in an input area. In response to a tap gesture 5018, the device 100-2 sends the image 5016 to the device 100. As shown in FIG. 50J, after the image 5016 is sent, the devices 100 and 100-2 concurrently display a left-most partial view of image 5016 in the output areas of their respective instant messenger applications, in addition to the right-most partial view of image 5004. In FIG. 50K, while the devices 100 and 100-2 concurrently display a partial view of the right-most portion of the image 5004 and the left-most portion of the image 5016 in the output areas of the instant messenger applications, the device 100 receives a leftward swipe gesture 5018 at the image 5016 and the device 100-2 receives a rightward swipe gesture 5020 at the image 5004. In response, as shown in FIG. 50L, the device 100 scrolls the partial view of the image 5016 to the right in the user interfaces of both device 100 and 100-2 to display the right-most portion of the image 5016. In addition, the device 100-2 scrolls the partial view of the image 5004 to the left in the user interfaces of both device 100 and 100-2 to display the left-most portion of the image 5004. As indicated by the dotted line in FIG. 50L, in some embodiments, devices 100 and 100-2 concurrently scroll the images 5004 and 5016 but in opposite directions, one is to the left and the other is to the right.

Referring back to the method 4900, in FIG. 49B, in some embodiments, the interaction is (4920) a contact on the item displayed in the second instant messenger application for a duration longer than a predetermined threshold; and updating the item includes unwrapping the item (e.g., press-and-hold gesture 5014 and gift unwrapping animation of gift image 5010 as shown in FIG. 50G). In some embodiments, prior to the unwrapping, the item includes (4922) obscured content (e.g., dimmed or blurred); and unwrapping the gift message includes: displaying an animation of the unwrapping (e.g., ribbon unwrapping or box opening); and fading in the obscured content (e.g., smiley face image obscured by gift image 5010 in FIG. 50G). In some embodiments, the unwrapping is (4924) mirrored on the first device and the second device, and the mirroring on the first device includes concurrently displaying the unwrapping in the first instant messenger application and displaying the unwrapping in an input area of the first instant messenger application (e.g., gift unwrapping animation of gift image 5010 as shown in FIG. 50G).

For example, FIGS. 50E-50H illustrate exemplary user interfaces for mirrored control of content utilizing gift message functionality. Specifically, FIG. 50E illustrates user interfaces for devices 100 and 102-2 where a gift image 5010 is displayed in an input area of the user interface of device 100. As shown in FIG. 50F, in response to a tap gesture 5012, the device 100 inserts the gift image 5010 in the messages area of the display and sends the gift image 5010 to the device 100-2 for concurrent display. While displaying the gift image 5010, the device 100 also displays an obscured smiley face image, behind the gift image 5010, which will be fully displayed once the gift is “opened” by the user of device 100-2. In FIG. 50G, the device 100-2 detects a press-and-hold gesture 5014 (and in some embodiments, sends information corresponding to the press-and-hold gesture to device 100). In response, the devices 100 and 100-2 display a gift unwrapping animation while fading in the obscured smiley face. In FIG. 50H, the devices 100 and 100-2 display the smiley face image 5015.

Referring back to method 4900, in FIG. 49C, in some embodiments, the interaction is (4926) a tap on an affordance representing the item in an input area of the first instant messenger application; and the item is sent immediately in response to detecting the interaction. In some embodiments, the interaction is (4928) a press-and-hold or a deep press on an affordance representing the item displayed in an input area of the first instant messenger application; and the item is sent after a predetermined amount of time in response to detecting the interaction. In some embodiments, the predetermined amount of time is (4930) selectable by a user (e.g., with a slider). For example, in response to the tap gesture 5012 in FIG. 50F, the device 100 sends the gift 5010 to device 100-2 immediately. Though not shown in the figures, in response to a press-and-hold or deep press on the gift message in the input area, the device can delay the gift sending. The delay is configurable by the user.

In some embodiments, prior to receiving information corresponding to the interaction: the device receives (4932) information corresponding to a contact on the item displayed in the first instant messenger application or the second instant messenger application for a duration longer than a predetermined threshold (e.g., before the leftward swipe 5008 in FIG. 50C, a press-and-hold gesture at image 5004 may be detected). In response to detecting the contact for the duration longer than the predetermined threshold, the device 100 activates a mirrored control mode. In some embodiments, the activation of the mirrored control mode is indicated by displaying an animation of the image in the instant messenger application, e.g., blinking, enlarging followed by shrinking etc.

It should be understood that the particular order in which the operations in FIGS. 49A-49C have been described is merely exemplary and is not intended to indicate that the described order is the only order in which the operations could be performed. One of ordinary skill in the art would recognize various ways to reorder the operations described herein. For brevity, these details are not repeated here.

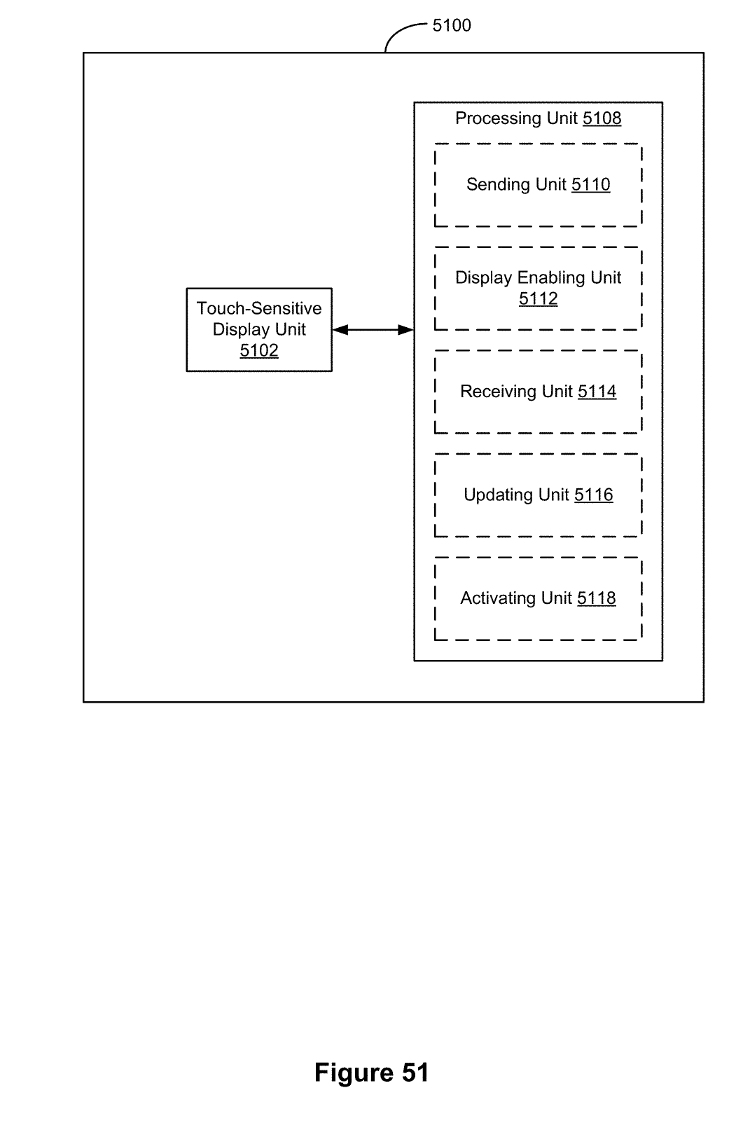

In accordance with some embodiments, FIG. 51 shows a functional block diagram of an electronic device 5100 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 51 are, optionally, combined or separated into sub-blocks to implement the principles of the various described embodiments. Therefore, the description herein optionally supports any possible combination or separation or further definition of the functional blocks described herein.

As shown in FIG. 51, a first electronic device 5100 includes a touch-sensitive display unit 5102 configured to receive user inputs and display user interfaces and a processing unit 5108 coupled to the touch-sensitive display unit 5102. In some embodiments, the processing unit 5108 includes a sending unit 5110, a display enabling unit 5112, a receiving unit 5114, an updating unit 5116, and an activating unit 5118.

In some embodiments, the processing unit 5108 is configured to send an item from a first instant messenger application running on the first electronic device to a second instant messenger application running on a second electronic device (e.g., with the sending unit 5110). The processing unit 5108 is further configured to display the item in the first instant messenger application (e.g., with the display enabling unit 5112), where the item is concurrently displayed in the second instant messenger application. The processing unit 5108 is further configured to receive information corresponding to an interaction with the item (e.g., with the receiving unit 5114), and in response to receiving information corresponding to the interaction, update the item on the first electronic device (e.g., with the updating unit 5116), where the update to the item is mirrored on the second electronic device.

In some embodiments, the item is an image. In some embodiments, the item is a gift message. In some embodiments, the interaction is a swipe in a first direction on the item, and updating the item includes scrolling the item in the first direction. In some embodiments, the interaction is a contact on the item displayed in the second instant messenger application for a duration longer than a predetermined threshold; and updating the item includes unwrapping the item. In some embodiments, prior to the unwrapping, the item includes obscured content, and unwrapping the item includes enabling the display of an animation of the unwrapping and fading in the obscured content. In some embodiments, the unwrapping is mirrored on the first device and the second device, and the mirroring on the first device includes concurrently enabling display of the unwrapping in the first instant messenger application and enabling display of the unwrapping in an input area of the first instant messenger application.

In some embodiments, the processing unit 5108 is configured to receive a second item from the second instant messenger application to the first instant messenger application (e.g., with the receiving unit 5114). The processing unit 5108 is configured to display the second item in the first instant messenger application (e.g., with the display enabling unit 5112). The second item is concurrently displayed in the second instant messenger application. Information corresponding to a second interaction with the second item (e.g., with the receiving unit 5114) is then received, and while updating the item on the first electronic device and in response to receiving information corresponding to the interaction with the item, where the update to the item is mirrored on the second electronic device, in response to receiving information corresponding to the second interaction with the second item, the processing unit 5108 is configured to concurrently update the second item on the first electronic device (e.g., with the updating unit 5116), where the update to the second item is mirrored on the second electronic device.

In some embodiments, the second interaction is a second swipe on the second item in a second direction, different from the first direction; and updating the second item includes scrolling the second item in the second direction. In some embodiments, the interaction is a tap on an affordance representing the item in an input area of the first instant messenger application; and the item is sent immediately in response to detecting the interaction. In some embodiments, the interaction is a press-and-hold or a deep press on an affordance representing the item displayed in an input area of the first instant messenger application; and the item is sent after a predetermined amount of time in response to detecting the interaction. In some embodiments, the predetermined amount of time is selectable by a user.

In some embodiments, the processing unit 5108 is configured to, prior to receiving information corresponding to the interaction, receive information corresponding to a contact on the item displayed in the first instant messenger application or the second instant messenger application for a duration longer than a predetermined threshold (e.g., with the receiving unit 5114). In response to detecting the contact for the duration longer than the predetermined threshold, the processing unit is configured to activate a mirrored control mode (e.g., with the activating unit 5118).

The operations in the information processing methods described above are, optionally implemented by running one or more functional modules in information processing apparatus such as general purpose processors (e.g., as described above with respect to FIGS. 1A and 3A-3B) or application specific chips.

The operations described above with reference to FIGS. 50A-50L are, optionally, implemented by components depicted in FIGS. 1A-1B or FIG. 51. For example, sending operation 5110, display enabling operation 5112, receiving operation 5114, updating operation 5116, and activating operation 5118 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method for mirrored control between devices, comprising:
at a first electronic device including one or more processors, memory, and a touch-sensitive display:
sending an item from a first instant messenger application running on the first electronic device to a second instant messenger application running on a second electronic device;
displaying the item in the first instant messenger application, wherein the item is concurrently displayed in the second instant messenger application;
receiving information corresponding to an interaction with the item; and
in response to receiving information corresponding to the interaction, updating the item on the first electronic device, wherein the update to the item is mirrored on the second electronic device.

2. The method of claim 1, wherein the item is an image.

3. The method of claim 1, wherein the item is a gift message.

4. The method of claim 1, wherein the interaction is a swipe in a first direction on the item, and updating the item includes scrolling the item in the first direction.

5. The method of claim 1, wherein:
the interaction is a contact on the item displayed in the second instant messenger application for a duration longer than a predetermined threshold; and
updating the item includes unwrapping the item.

6. The method of claim 5, wherein:
prior to the unwrapping, the item includes obscured content; and
unwrapping the item includes:
displaying an animation of the unwrapping; and
fading in the obscured content.

7. The method of claim 5, wherein the unwrapping is mirrored on the first electronic device and the second electronic device, and the mirroring on the first electronic device includes concurrently displaying the unwrapping in the first instant messenger application and displaying the unwrapping in an input area of the first instant messenger application.

8. The method of claim 4, wherein:
the item is a first item; and
the method further comprises:
receiving a second item sent from the second instant messenger application to the first instant messenger application;
displaying the second item in the first instant messenger application, wherein the second item is concurrently displayed in the second instant messenger application;
receiving information corresponding to a second interaction with the second item; and
while updating the first item on the first electronic device in response to receiving information corresponding to the interaction with the first item, wherein the update to the first item is mirrored on the second electronic device:
in response to receiving information corresponding to the second interaction with the second item, concurrently updating the second item on the first electronic device, wherein the update to the second item is mirrored on the second electronic device.

9. The method of claim 8, wherein:
the second interaction is a second swipe on the second item in a second direction, different from the first direction; and
updating the second item includes scrolling the second item in the second direction.

10. The method of claim 1, wherein:
the interaction is a tap on an affordance representing the item in an input area of the first instant messenger application; and
the item is sent immediately in response to detecting the interaction.

11. The method of claim 1, wherein:
the interaction is a press-and-hold or a deep press on an affordance representing the item displayed in an input area of the first instant messenger application; and
the item is sent after a predetermined amount of time in response to detecting the interaction.

12. The method of claim 11, wherein the predetermined amount of time is selectable by a user.

13. The method of claim 1, further comprising, prior to receiving information corresponding to the interaction:
receiving information corresponding to a contact on the item displayed in the first instant messenger application or the second instant messenger application for a duration longer than a predetermined threshold; and
in response to detecting the contact for the duration longer than the predetermined threshold, activating a mirrored control mode.

14. A first electronic device, comprising:
a touch-sensitive display;
one or more processors;
memory; and
one or more programs, wherein the one or more programs are stored in the memory and configured to be executed by the one or more processors, the one or more programs including instructions for:
sending an item from a first instant messenger application running on the first electronic device to a second instant messenger application running on a second electronic device;
displaying the item in the first instant messenger application, wherein the item is concurrently displayed in the second instant messenger application;
receiving information corresponding to an interaction with the item; and
in response to receiving information corresponding to the interaction, updating the item on the first electronic device, wherein the update to the item is mirrored on the second electronic device.

15. A computer readable storage medium storing one or more programs, the one or more programs comprising instructions, which when executed by a first electronic device with a touch-sensitive display cause the device to:
send an item from a first instant messenger application running on the first electronic device to a second instant messenger application running on a second electronic device;
display the item in the first instant messenger application, wherein the item is concurrently displayed in the second instant messenger application;
receive information corresponding to an interaction with the item; and
in response to receiving information corresponding to the interaction, update the item on the first electronic device, wherein the update to the item is mirrored on the second electronic device.
